(19) United States
(12) Patent Application Publication
(10) Pub. No.: US 2004/0133526 A1
(43) Pub. Date: Jul. 8, 2004

(54) Negotiating platform

(76) Inventors: Oded Shmueli, Nofit (IL); Boaz Golany, Haifa (IL); Robert Sayegh, Haifa (IL); Hadas Shachnai, Haifa (IL); Mordechai Perry, Mevasseret (IL); Noah Gradovitch, Haifa (IL); Benny Yehezkel, Ramat Gan (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(21) Appl. No.: 10/663,858

(22) Filed: Sep. 17, 2003

Related U.S. Application Data
(63) Continuation-in-part of application No. PCT/US02/08293, filed on Mar. 20, 2002.
(60) Provisional application No. 60/276,952, filed on Mar. 20, 2001.
(60) Provisional application No. 60/279,422, filed on Mar. 29, 2001.
(60) Provisional application No. 60/327,291, filed on Oct. 9, 2001.
(60) Provisional application No. 60/287,004, filed on Apr. 30, 2001.
(60) Provisional application No. 60/305,073, filed on Jul. 16, 2001.

(51) Int. Cl. G06F 17/60

(52) U.S. Cl. 705/80

(57) ABSTRACT

A platform for supporting negotiation between parties to achieve an outcome, the platform comprising: a party goal program unit for: defining respective party's goal programs in respect of said outcome, said goal program comprising a plurality of objective functions and constraints associated with respective objective functions, for associating each of said objective functions with one of a plurality of levels of importance, and for assigning to objective functions within each level a respective importance weighting, said party goal program unit comprising a party input unit for allowing a party to provide data for a respective goal program, a goal program unifier, associated with said party goal program unit for receiving goal programs of respective parties, and carrying out unification of said goal programs by considering said objective functions objectivewise and levelwise with associated constraints in the respective goal programs to determine whether two goal programs have a common field of interest from which a mutually compatible outcome is derivable, a negotiator associated with said goal program unifier for receiving goal programs of respective parties, and carrying out negotiations using said goal programs by considering said objective functions objectivewise and levelwise with associated constraints in the respective goal programs to arrive at said mutually compatible outcome by carrying out minimization firstly objectivewise and then levelwise, therewith to form an offer, an output unit for offering said unified goal program to said respective parties, and a response receiver for receiving from respective parties either counter offers or acceptances, said response receiver being operable to provide counter offers as new goal programs to said goal program negotiator for further unification.

### RELATIONSHIP TO EXISTING APPLICATIONS

The present application is a Continuation in Part of PCT US02/08293, filed Mar. 20, 2002, which claims priority from U.S. Provisional Application 60/276,952 filed Mar. 20, 2001, U.S. Provisional Patent Application No. 60/279,422. filed Mar. 29, 2001, U.S. Provisional Patent Application No. 60/327,291 filed Oct. 9, 2001, U.S. Provisional Patent Application No. 60/287,004 filed Apr. 30, 2001, and U.S. Provisional Patent Application No. 60/305,073 filed Jul. 16, 2001.

### FIELD OF THE INVENTION

The present invention relates to an apparatus, system or method for providing users with negotiation facilities, and more particularly but not exclusively to a general purpose electronic negotiation platform. The platform includes item choosing, ranking facilities, and deal splitting functionalities.

### BACKGROUND OF THE INVENTION

Numerous methods of carrying out negotiations are known, and many negotiation methods have been transferred to the electronic realm. The techniques provide various types of electronic deal making, including one-to-one negotiations, auctions, etc. The available art is generally dedicated to particular situations and is not general purpose. In particular the available art is dedicated to situations in which the principle or only negotiable variable is price, thus excluding whole realms of real negotiating life. For example, if a farmer wishes to negotiate with neighboring residents regarding land use issues pertaining to one of his fields, or if two sons are unable to agree a division of an inherited estate, then the current art is of only marginal help. Even if price is a factor, but only one of several factors of equivalent importance, then the present art is of only marginal help. Thus if a supermarket wishes to negotiate a contract for vegetables, then important factors are price, regularity and reliability of delivery, freshness and appearance. For a supplier, important factors are the quantity ordered and the price. The remaining factors are seen by him as limitations. None of the current art is able to provide a platform for a meaningful negotiation based on such a range of factors.

An example of a patent that allows variables other than price to be taken into account is U.S. Pat. No. 6,338,050, which discloses a multivariate negotiations engine for international transaction processing which: enables a sponsor to create and administer a community between participants such as buyers and sellers having similar interests; allows a buyer/participant to search and evaluate seller information, propose and negotiate orders and counteroffers that include all desired terms, request sample quantities, and track activity; allows a seller/participant to use remote authoring templates to create a complete Website for immediate integration and activation in the community, to evaluate proposed buyer orders and counteroffers, and to negotiate multiple variables such as prices, terms, conditions etc., iteratively with a buyer. The system provides secure databases, search engines, and other tools for use by the sponsor, which enable the sponsor to define the terms of community participation, establish standards, help promote the visibility of participating companies, monitor activity, collect fees, and promote successes. All this is done through a multivariate negotiations engine system operated at the system provider's Internet site, thus requiring no additional software at the sponsors', or participant sellers', or buyer's sites. This also allows buyers and sellers to use and negotiate payment options and methods that are accepted internationally. The system maintains internal databases that contain the history of all transactions in each community, so that sponsors, buyers and sellers may retrieve appropriate records to document each stage of interaction and negotiation. Documents are created by the system during the negotiation process.

It is noted that the above-described patent however, takes price as a principle feature and allows only subsequent iterative treatment for other features. Furthermore, the disclosure is specific to the one-on-one buyer seller model.

The following documents are hereby incorporated herein by reference

1. Charnes and W. W. Cooper, Management Models and Industrial Applications of Linear Programming, Wiley, NY 1961.

2. J. P. Ignizio, Goal Programming and Extensions. Lexington Books, 1976.

3. J. P. Ignizio, Linear Programming in Single & Multiple Objective Systems. Prentice-Hall, 1982.

4. J. P. Ignizio, T. M. Cavalier. Linear Programming. Prentice-Hall, 1994.

5. M. J. Osborn and A. Rubinstein, A course in game theory, The MIT Press, 1999.

6. T. L. Saaty, The Analytic Hierarchy Process: Planning Setting Priorities, Resource Allocation. Pittsburgh, Pa.; RWS Publications, 1990.

7. M. J. Schniederjans, Goal Programming Methodology and Applications. Kluwer Academic Publishers, 1995.

8. R. E. Steuer, Multiple Criteria Optimization: Theory, Computation and Application. John Wiley & Sons, 1986.

9. C. Romero, Handbook of Critical Issues in Goal Programming. Pergamon press, 1991

[CHW-76] A. K. Chandra, D. S. Hirschberg and C. K. Wong, Approximate Algorithms for Some Generalized Knapsack Problems. Theoretical Computer Science 3, pp. 293-304, 1976.

[CK-00] C. Chekuri and S. Khanna, A PTAS for the Multiple Knapsack Problem. In Proc. of the 11^{th} ACM-SIAM Symposium on Discrete Algorithms (SODA), pp. 213-222, 2000.

[GJ-79] M. R. Garey and D. S. Johnson, Computers and intractability: A Guide to the Theory of NP-Completeness. W. H. Freeman, 1979.

[GL-79] G. V. Gens and E. V. Levner, Computational Complexity of Approximation Algorithms for Combinatorial Problems. Proc. of the 8^{th} Int. Symp. on Mathematical Foundations of Computer Science, LNCS #74, pp.292-300 (1979).

[L-76] E. L. Lawler, Combinatorial Optimization: Networks and Metroids. Holt, Reinhart and Winston, 1976.

[L-79] E. L. Lawler, Fast Approximation Algorithms for Knapsack Problems. Mathematics of Operations Research, vol. 4, #4, pp.339-356, 1979.

[FA-00] Peyman Faratin: “Automated Service Negotiation between Autonomous Computational Agents”, Ph.D. Thesis, University College London, London UK.

### SUMMARY OF THE INVENTION

According to a first aspect of the present invention there is provided a platform for supporting negotiation between parties to achieve an outcome, the platform comprising:

a party goal program unit for defining respective party's goal program in respect of the outcome, the goal program comprising at least one objective function, having at least one goal expressed by at least one constraint comprising at least one of a deviation variable, a decision variable and a target value, the deviation variable being usable to form the objective function,

for associating each of the objective functions with a level of importance, and

for assigning each of the goals an importance weighting within its level, and

for assigning to deviation variables within each objective function a respective importance weighting, the party goal program unit comprising a party input unit for allowing a party to provide data for a respective goal program,

a negotiator associated with the party goal program unit for receiving a goal program of at least one of the respective parties, and carrying out negotiations using the at least one goal program by considering the objective functions levelwise in the respective goal program to approach at the mutually compatible outcome by carrying out minimization at a respective level, therewith to form an offer,

an output unit for offering the offer to the respective parties,

a response receiver for receiving from respective parties either counter offers or acceptances, the response receiver being operable to provide counter offers expressed as modified goal programs to the goal program negotiator for further negotiation, the platform advancing to a next level upon an acceptance.

The platform preferably comprises a goal program unifier, associated with the party goal program unit for receiving goal programs of respective parties, and carrying out unification of the goal programs to determine whether two goal programs have a common field of interest from which a mutually compatible outcome is derivable.

Preferably, the party goal program unit comprises a constraint arrangement unit for arranging goal constraints levelwise in a first party's goal program such that conditional weakening from the outcome for a goal in a trade-off involves strengthening of other goals within the same level of the first party.

Preferably, the goal program unit comprises a trade-off unit for arranging goals levelwise in a first party's goal program such that goals of a given level are negotiated with goals of a same level of another party.

Preferably, the party goal program unit is operable to place the objective functions in a hierarchy according to the respective associated level of importance, and to express each goal in terms of at least one decision variable and at least one deviation variable.

Preferably, the party goal program unit is operable to use data from the party data input unit to apply coefficients to the deviation variables.

Preferably, the party goal program unit is operable to apply user input to provide different values of coefficients to the deviation variables for deviations from a corresponding target value in respective positive and negative directions.

Preferably, the party goal program unit is operable to apply the user input to apply the coefficient values to define any one of a group comprising:

a strong one sided goal,

a weak one sided goal,

a complex single sided goal,

a simple two sided goal,

a complex two sided goal,

a simple first side-complex second side goal,

a simple two-sided goal with an range of indifference,

a complex two sided goal with an range of indifference, and

a simple first side-complex second side goal with an indifferent range.

Preferably, at least one goal comprises a series of discrete values.

Preferably, the party goal program unit is operable to apply user input to formulate weightings for respective ones of the discrete values, thereby to express a preference between the discrete values.

Preferably, at least one goal constraint comprises a continuous variable, and wherein the party goal program unit is operable to apply user input to determine whether the at least one of the goal's deviation variables is to be maximized or to be minimized.

Preferably, the negotiator is operable to set a maximum bound per deviation.

Preferably, the negotiator is operable to modify the goal program.

Preferably, the negotiator is operable to modify the goal program by at least one of adding and deleting objective functions.

Preferably, the negotiator is operable based on a received offer, to modify the objective function via respective constraints.

Preferably, the negotiator is operable to carry out minimization for an expression comprising first ones of the deviation variables and then to modify at least one of the constraints for a further minimization stage.

Preferably, the party input unit is configured to receive data from a user interface.

Preferably, the party input unit is configured to receive data from a software agent.

Preferably, the party input unit is operable to identify parameter data missing from an input and wherein the party goal program unit further comprises a default value generator for generating the missing parameter.

Preferably, the party input unit is operable to identify parameter data missing from an input and wherein the party goal program unit further comprises a default register of values for expected parameters, the default register being associated with the party input unit, to provide the missing parameters.

Preferably, the party input unit is operable to request lower and upper bounds for at least some of the decision variables.

Preferably, the party goal program unit further comprises a trade-off unit, the trade-off unit being operable to use the upper and lower bounds to express deviations of a respective decision variable from a target value relative to an interval defined by the lower and the upper bound, thereby to render the deviations subject to comparison by the negotiator.

Preferably, the party input unit is operable to request a decision variable interval, and a penalty specification for deviating from a target within the interval, and wherein the unifier is operable to define a working interval as an intersection between respective intervals of two parties.

Preferably, the trade-off unit is operable to determine that a target value of one of the objective functions is outside the working interval, and to modify the target value to approach a closest boundary of the working interval.

Preferably, the trade-off unit is operable to apportion the penalty in accordance with the target value modification.

Preferably, the intersection is a point.

Preferably, the party goal program unit comprises operability for determining that an intersection is small to the satisfaction of respective parties and, when the intersection is recognized as small, the negotiator is operable to select a point within the intersection being a midpoint between respective target values.

Preferably, the negotiator is operable to measure deviations within the interval as a fraction of a total size of the interval.

Preferably, the party goal program unit is operable to obtain importance values for deviations from the target and wherein the negotiator is operable to use the importance value as a multiplier to weigh the deviation.

Preferably, the unifier is operable to identify intersections that are small and distant from a target value compared to one of the objective functions and large and inclusive of a target value compared to another of the objective functions, to set an effective target at the closest intersection boundary and to set a transformed deviation as giving an original deviation when multiplied by the effective target and then added to the difference between the old target and the effective target, to produce a result which is divided by the old target.

Preferably, the party input unit is operable to permit a party to define at least one single dimension interval goal in respect of the outcome, and to associate the goal with a range of indifference having an upper bound and a lower bound, a first weighting value for deviations below the lower bound, a second weighting value for deviations above the upper bound and a relative importance for the goal,

the unifier being operable to use the range of indifference, the weightings and the relative importance to unify the at least one goal with at least one other goal to determine the compatibility.

Preferably, the at least one other goal is a corresponding goal in a goal program of an opponent.

Preferably, the party input unit is operable to permit a party to define a two dimensional trade-off goal constraint by entering two two-dimensional points, the party goal program unit being operable to define a trade-off line between the two points.

Preferably, the party input unit is operable to permit a party to define weights for deviation from the trade-off line.

Preferably, the party input unit is operable to permit a party to define a relative importance for the two dimensional trade-off goal constraint.

Preferably, the party input unit is operable to permit a party to associate the two dimensional trade-off goal constraint levelwise with other goal constraints.

Preferably, party enterable weightings, the relative importance, and an associated level are usable by the trade-off unit to insert additional terms to the objective function of a respective level.

Preferably, the party input unit is operable to allow a party to define at least one single dimension two-point goal in respect of the outcome, and to associate the goal with an upper point of preference, and a lower point of preference, a first weighting value for deviations below the lower point of preference, and a second weighting value for deviations above the upper point of preference, the goal program unit being operable to provide a first and a second included weighting to a region included between the points of preference by assigning a first included weighting value below the upper point of preference and a second included weighting value above the lower point of preference and defining an overall weighting within the region as a minimum of the weighting values.

Preferably, the party input unit is operable to permit a party to define a relative importance for the single dimensional two point goal.

Preferably, the party input unit is operable to permit a party to associate the single dimensional two point goal levelwise with other goals.

Preferably, the weights and the relative importance is usable by the trade-off unit to insert additional terms into respective objective functions.

Preferably, the party input unit is operable to permit a user to define a piecewise linear two-dimensional goal by entering at least three two-dimensional points, the party goal program unit being operable to define a trade-off line between the three points,

the trade-off unit being operable to apply penalty values to points away from the trade-off line in accordance with respective distances from the line.

Preferably, the party input unit is operable to permit a user to define a first deviation weight for deviating in a first direction from the trade-off line and a second deviation weight for deviating in a second direction therefrom.

Preferably, the party input unit is operable to permit parties to define goals comprising pairwise variable trade-offs having at least two points and a trade-off function defined for distance from a line joining the points.

Preferably, the party goal program unit is operable to prevent inconsistent trade-offs to be defined within the platform by preventing the party input unit from accepting more than one trade-off from referring, directly or indirectly, to any given pair of decision variables.

Preferably, the party goal program unit is operable to warn users of inconsistent trade-offs by outputting a warning whenever a trade-off being entered has already been determined directly or indirectly.

Preferably, the party input unit further comprises a trade-off unit, wherein the party input unit is further operable to allow a party to define disjunctive constraints in respect of decision variables, and wherein the goal program unit comprises a disjunctive constraint processor, associated with the trade-off unit, for translating a disjunctive expression into a plurality of conjoined expressions, and wherein the unifier is operable to utilize the conjoined expressions to unify the at least one disjunctive constraint with other constraints to determine the compatibility.

Preferably, the disjunctive expression comprises a series of relationships including equality relationships.

Preferably, the disjunctive constraint processor is operable to carry out the translation by expressing at least one of the equality relationships as the union of two corresponding inequalities that meet at a point of equality of the equality relationship.

Preferably, the disjunctive constraint processor is operable to define binary variables for the relationships, for setting wherever the relationships are satisfied, and wherein the negotiator is operable to sum the variables to determine a satisfaction level for the disjunctive constraint.

Preferably, the trade-off unit is operable to set a requirement of a minimum number of satisfied relationships by the negotiator.

Preferably, the party input unit is further operable to permit each party to define weighting values for a discrete variable predefined per outcome, for use in the goal program definition, and

the negotiator is operable to carry out negotiation of the goal programs by considering the weighting values to arrive at an outcome comprising an offered one of the values.

Preferably, the party goal program unit is operable to use the weightings for respective values of the discrete variable to arrange values for the variable in an order of desirability, the order being usable by the negotiator to arrive at the offered one of the discrete values.

Preferably, the party goal program unit is operable to use the values and respective weightings and continuous relaxation variables to build summation functions, therefrom to create goal constraints, for use by the platform.

Preferably, the negotiator is operable to attempt offer formation by converting the relaxation variables into binary values, thereby setting one of the binary variables to one and the remainder to zero, and thereby determining the discrete value. Preferably, the negotiator is operable to reattempt offer formation.

Preferably, the party goal program unit is operable to represent date information as accumulated units of time from a threshold starting date, and further to modify the dates relative to upper and lower bounds entered via the party input unit.

Preferably, the units of time are minutes.

Preferably, the party input unit is further operable to allow input of variables in association with the objective functions and a linkage between a first and a second of the variables, the linkage defining a trade-off line and deviations thereof with respect to the target values, the negotiator being operable to use the series of variables including the trade-off line to negotiate an outcome in respect of the at least one objective function with other objective functions, thereby to arrive at formation of an offer.

The platform preferably comprises a trade-off unit operable to express the second variable as a function of the first variable, thereby to represent the linkage, and wherein the negotiator is operable to represent deviations from respective target values as deviations from the target value of the first variable.

The platform preferably comprises a trade-off unit operable to express the trade-off as separate deviation variables in respect of the first variable and in respect of the second variable.

Preferably, the trade-off unit is operable to permit an association of a relative importance level to the trade-off.

Preferably, the trade-off unit is operable to calculate a relative importance level for the trade-off as an average of respective relative importance of goals involving the first and second variables.

Preferably, the unifier comprises a goal program generalizer to form a modification of received goal programs for use in the negotiation.

Preferably, the party goal program unit is operable to translate the input received from the party input unit into the objective functions and respective constraints on the objective functions within the goal program, the negotiator comprising an optimizer to find best values for the objective functions and constraints, therewith to obtain a best solution for the goal program for output as a first offer, and then iteratively to produce further solutions until an offer is accepted, thereby to achieve the outcome.

Preferably, the negotiator comprises a percentage modifier for taking ones of the objective functions in turn, and modifying them by a predetermined percentage, thereby to produce the further solutions.

Preferably, the percentage modifier is settable to take each of the objective functions in turn beginning with a most important objective function, until a solution is accepted.

Preferably, the objective functions are arranged in levels and the percentage modifier is settable to take an objective function of a first of the levels only.

Preferably, the negotiator comprises a worst case calculator for determining a worst case level for ones of the objective functions, thereby to obtain a worst acceptable offer.

Preferably, the deviation variables are arranged pairwise, the negotiator comprises an arbitrary case calculator for taking one of each the pair of deviation variables, attaching thereto an arbitrary coefficient, creating therefrom an objective function and using a minimization of the objective function to generate an arbitrary solution.

Preferably, the negotiator further comprises an average case calculator, associated with the optimizer and with the worst case calculator, for

taking the best solution and the worst solution, each solution having corresponding values,

associating ones of the corresponding values, and

constraining variables of the goal program towards an average of each of the corresponding values, therewith to provide an average solution.

Preferably, the goal program objective functions are arranged levelwise and the average case calculator is operable to carry out the associating and the constraining successively levelwise, thereby to produce the series of iterative solutions.

Preferably, the negotiator comprises a solution sorter for comparing goal program solutions by solving the goal program constrained by each one of a series of solutions and ranking the solutions, the negotiator being operable to use the ranking to apply preference to different solutions.

Preferably, the negotiator further comprises a thresholder associated with the solution sorter for applying a threshold to the evaluations to exclude ones of the series of solutions.

Preferably, the solution sorter further comprises a solution completer for applying best values to incompleted variables in incomplete ones of the solutions, thereby to allow the goal program to be evaluated for the incomplete solutions.

Preferably, the solution sorter is settable to find the best solution from the series of solutions by identifying the highest ranked solution and discarding the remaining solutions.

Preferably, the solution sorter comprises a memory, set to hold a predetermined number of solutions, and a comparator to compare a new solution with each solution in the memory, and further comprising a control unit for adding the new solution to the memory if its evaluation is larger than any solution in the memory, and for discarding a lowest ranked solution in the memory.

Preferably, the goal program unit comprises a data input unit for receiving user defined output values, and wherein the goal program unit is operable to set the output values as single value constraints and to flag the constraints as unchangeable.

Preferably, the goal program unit is operable to output an error indicator if the single value constraints render the goal program insoluble.

Preferably, the unifier further comprises a goal program input unit for receiving a local party's goal program and an opponent's goal program to be unified therewith, the goal programs comprising objective functions associated with deviation variables of goal constraints and being arranged in levels, and the negotiator further comprises:

an optimizer for finding best solutions to goal programs, connected to find best values for the objective functions and constraints of the local party's goal program levelwise, and

a worst case calculator for finding worst solutions for goal programs, connected to find worst values for the objective functions and constraints of the opponent's goal program levelwise,

the negotiator being operable to:

use the optimizer and the worst case calculator in succession, level by level to produce successive value sets for evaluation therefrom to form level by level unification offers, and

advance from one level to another level only following acceptance by the parties of a unification offer regarding a previous level.

Preferably, level by level unification offers each comprise an exchange of offers between the parties.

Preferably, the negotiator comprises a constraint updater for updating constraints upon advance from one level to another level in accordance with the respective acceptance.

Preferably, the negotiator comprises a constraint updater for updating goal program constraints.

Preferably, the constraint updater is operable to update goal program objective functions.

Preferably, the negotiator further comprises an offer improver operable to provide an improved offer by making at least one change in a selected one of the variables to bring about an improvement in the evaluation of the opponent's goal program.

Preferably, the change in the variable is calculated such that the improvement is a predetermined proportion of a difference between a previous offer made and a best possible evaluation made for the opponent.

Preferably, the offer improver is operable to use a value of the selected variable in a last opponent's offer to moderate the change.

Preferably, the offer improver is operable to calculate a protection value, and to use the protection value to limit a reduction in the evaluation of the local party's goal program as a consequence of the improvement to the opponent's goal program evaluation.

Preferably, the protection value is a proportion of the difference between a worst case evaluation of the local party's goal program and an evaluation of a last previous offer thereof.

The platform preferably comprises an offer improver for taking goal program values of a previous local party offer and one value in turn from a previous opponent offer, testing the opponent value against local constraints, and if it fits within the constraints then substituting it into the previous local party offer thereby to provide an improved offer.

Preferably, the negotiator further comprises a goal program input unit for receiving a local party's goal program, the goal program comprising objective functions associated with deviation variables of goal constraints and being arranged in levels, and the negotiator further comprises:

an optimizer for finding best solutions to goal programs, connected to find best values for the objective functions of the local party's goal program levelwise, and

a stay close processor for determining variable improvement directions from monitoring of received offers from the opponent and carrying out value perturbations in the directions,

the negotiator being operable to:

use the optimizer to produce a first offer for a first level,

to advance from one level to another level only following acceptance by the parties of an offer regarding a previous level, and

use the stay close processor to produce a subsequent offer, thereby to arrive at the outcome.

Preferably, the stay close processor is operable for use during offer exchange within a level.

Preferably, the negotiator comprises a constraint updater for updating constraints upon advance from one level to another level in accordance with the respective acceptance.

Preferably, the negotiator further comprises

a gap value determiner, for determining a gap for use in offer improvement, and

a value improver, associated with the gap value determiner, for inserting a predetermined proportion of the gap as a constraint of the goal program, and wherein the stay close processor is associated with the value improver thereby to apply a predetermined gap proportion in the direction to provide an improved offer.

Preferably, the stay close processor is operable to monitor two successive opponent offers for value changes therebetween, and to assign to each respective changing variable a weight for use in providing an improved offer, the magnitude of the weight being selected in accordance with a monitored relative size of a corresponding value change of the opponent.

Preferably, the gap is a constant.

Preferably, the constant is a difference between a best value and a worst value of a corresponding variable.

Preferably, the gap is a difference between a last local proposal and a last opponent proposal.

The platform preferably comprises a negotiation necessity tester, associated with the unifier, for joint solving of the local and the other goal program to form a joint goal program comprising optimal solutions for each of the local and the other goal program, the negotiation necessity tester being set to determine whether there lies a single solution that includes both optimal solutions within the common ground, and if so, to inhibit passing of the goal programs to the negotiator.

The platform preferably comprises a mediation unit callable by both parties levelwise during the negotiations, the mediation unit being operable to retain agreed objective function results of previously solved levels and to apply a summation formula to solve a current level.

Preferably, the summation formula as an objective function is:

$$\{ \frac{\sum {w}_{kj}^{+} \cdot {δ}_{kj}^{+} + \sum {w}_{kj}^{-} \cdot {δ}_{kj}^{-}}{\sum {w}_{kj}^{+} + \sum {w}_{kj}^{-}} \} + \{ \frac{\sum {v}_{kj}^{+} \cdot {γ}_{kj}^{+} + \sum {v}_{kj}^{-} \cdot {γ}_{kj}^{-}}{\sum {v}_{kj}^{+} + \sum {v}_{kj}^{-}} \}$$

wherein the respective sides of the summation represent the respective parties, k is a current level, j is is used as a running index on deviation variables at the current level, + and − represent respective sides of a target value, w and v are respective parties weighting factors, and δ and γ are respective parties deviation variables.

The platform preferably comprises a mediation unit, callable by both parties during the negotiations, the mediation unit being operable to stop operation of the negotiator, apply a summation formula to provide a median solution between respective goal programs, and to provide the median solution as an offer to both parties.

Preferably, each goal program is expressed as a series of decision variables each having an upper bound, a lower bound, a target value and one or more constraints, the platform further comprising a form offer unit for providing a compromise offer to the parties, the unit being operable to assign to each of the goal programs a weighting such that the sum of the weightings is unity for each variable, and to calculate the offer by minimizing relative deviations for each variable over the goal programs weighted according to the assigned weightings.

The platform preferably comprises a discrete variable form offer unit operable to transform values of the discrete variable into a continuous domain, to carry out minimization in light of goal program objective functions of the two parties in the continuous domain, and to transform the minimization results related to the continuous variable back to discrete values, thereby to provide a form offer.

The platform preferably comprises an item catalog for storing a plurality of items to be evaluated in terms of values of the objective functions, wherein the negotiator is operable to provide offers in terms of nearest items in the catalog to user prescribed objective function values.

Preferably, the negotiator comprises:

an item manager for determining which items of the catalog are currently within the scope of negotiations,

a first stage manager, associated with the item manager, for managing levelwise goal program negotiation to successively reduce the number of the items within the scope to a predetermined threshold number of items,

a second stage manager, associated with the item manager, for managing levelwise program negotiation to produce successive offers, and

an item associator, connected to the second stage manager and to the item manager, for expressing the successive offers in terms of items within the scope.

Preferably, the item manager is operable to measure distance from a prescribed specification in terms of a goal program of the prescribing user.

Preferably, the item manager is operable to measure distance from a prescribed specification in terms of a goal program of another prescribing user.

Preferably, the item manager is operable to measure a distance from a prescribed specification in terms of a joint goal program.

Preferably, the item manager is operable to measure distance from a prescribed specification initially in terms of a local goal program, to order the items and iteratively to remove most distant items.

The platform preferably comprises compatibility restraints with a second item.

The platform preferably comprises compatibility constraints amongst a plurality of items.

Preferably, the negotiator is operable to carry out a semijoin operation to eliminate items of a first type for which no matching items of a second type are available.

Preferably, the negotiator is operable to carry out a semijoin operation to eliminate items of a first type for which no matching items of a plurality of types are available.

The platform preferably comprises an offer delay timer, associated with the negotiator, for introducing determinable delays between issuance of successive offers to an opponent.

Preferably, the offer delay timer is operable to set successively increasing delays.

Preferably, the offer delay timer is operable to set delays to change levelwise.

Preferably, a magnitude of the delay is based on a relative change between succeeding opponent offers.

Preferably, the offer delay timer is operable to set user determined delays.

Preferably, at least one of the goals comprises a dynamically changing value.

Preferably, at least some of the constraints are associated with dynamically changing values.

According to a second aspect of the present invention there is provided a platform for supporting negotiation between parties to achieve an outcome, the platform comprising:

a party goal program unit comprising a party input unit for allowing each party to define a plurality of goals in respect of the outcome, and to associate each of the goals with a respective level of importance, therefrom to form for each party a goal program,

the party input unit being operable to obtain a target value and upper and lower bounds relating to at least one of the goals, the party goal program unit being operable to use the upper and lower bounds to express deviations from the target values in relative terms, thereby to render deviations from different goals' targets comparable.

The platform preferably comprises a negotiator, operable to define an interval between the upper bound and the lower bound and to measure deviations within the interval as a fraction of a total size of the interval.

According to a third aspect of the present invention there is provided a platform for supporting negotiation between parties to achieve an outcome, the platform comprising:

a party goal program unit comprising a party input unit for allowing a party to define a plurality of goals in respect of the outcome, and to associate at least one of the goals with a target value, an acceptable interval, and a penalty for deviation from the target value, and

a unifier, for determining common ground between the goal program and at least one other goal program,

and a negotiator, operable to form offers within the common ground by mutual quantifying of an objective function of the at least one goal program with objective function of the at least one other goal program having a target value and an interval, by determining an intersection between the intervals and if the target value is outside the intersection then moving the target value by a deviation amount to a closest boundary of the intersection, the negotiator further being operable to apportion the penalty for deviation amount in accordance with an extent of the deviation of the target value.

Preferably, the intersection is a point.

Preferably, the party goal program unit comprises operability for determining that an intersection is small to the satisfaction of respective parties and, when the intersection is recognized as small, the unifier is operable to select a point within the intersection being a midpoint between respective target values.

Preferably, the negotiator is operable to measure deviations within the interval as a fraction of a total size of the interval.

Preferably, the party goal program unit is operable to obtain importance values for deviations from the target and is further operable to use the importance values as a multiplier to measure the deviation.

Preferably, the party goal program unit further comprises a trade-off unit, the trade-off unit being operable to:

recognize intersections that are small and distant from the target value of the at least one goal and at the same time large and inclusive of a target value of the other goal,

set a unified target at the intervening intersection boundary at a determinable deviation from each target,

calculate the deviation of the unified target from the distant target,

multiply the deviation by a value of the unified target,

add the result of the multiplication to the difference between values of the distant target and the unified target, and

divide the result by a value of the distant target, thereby to produce a transformed deviation value for the at least one goal.

Preferably, the trade-off unit is further operable to normalize the deviation.

Preferably, the trade-off unit is operable to normalize the transformed deviation.

The platform preferably comprises an offer delay timer, associated with the negotiator, for introducing determinable delays between issuance of successive offers to an opponent.

Preferably, the offer delay timer is operable to set successively increasing delays.

Preferably, the offer delay timer is operable to set delays to change levelwise.

Preferably, a magnitude of the delay is based on a relative change between succeeding opponent offers.

Preferably, the offer delay timer is operable to set user determined delays.

According to a fourth aspect of the present invention there is provided a platform for supporting negotiation between parties to achieve an outcome, the platform comprising:

a party goal program unit comprising a party input unit for allowing a party to define at least one goal program having a plurality of goals in respect of the outcome, and to associate a goal constraint of at least one of the goals with a range of indifference having an upper bound and a lower bound, a first weighting value for deviations below the lower bound, a second weighting value for deviations above the upper bound and a relative importance for the goal constraints,

and a negotiator, associated with the goal program unit, the negotiator being operable to use the range of indifference, the weightings and the relative importance to obtain an outcome for the at least one goal in view of other goals, by producing successive offers.

Preferably, the party input unit further comprises a prioritizer for allowing the goal to be assigned a level to define a level by level relationship with other objective functions.

Preferably, the party goal program unit further comprises a trade-off unit, the trade-off unit being operable to use the relative importance to establish contributions of deviation variables of respective goal constraints to a corresponding objective function.

The platform preferably comprises an offer delay timer, associated with the negotiator, for introducing determinable delays between issuance of successive offers to an opponent.

Preferably, the offer delay timer is operable to set successively increasing delays.

Preferably, the offer delay timer is operable to set delays to change levelwise.

Preferably, a magnitude of the delay is based on a relative change between succeeding opponent offers.

Preferably, the offer delay timer is operable to set user determined delays.

According to a fifth aspect of the present invention there is provided a platform for supporting negotiation between parties to achieve an outcome, the platform comprising:

a party goal program unit comprising a party input unit operable to permit a party to define a two dimensional trade-off goal constraint by entering two two-dimensional points, the party goal program unit being operable to define a trade-off line between the two points, and a negotiator, associated with the goal program unit, the negotiator being operable to use the trade-off line to solve the goal program containing the at least one trade-off goal constraint taking into account other constraints to arrive at the outcome via a series of successive offers.

Preferably, the party input unit is operable to permit a party to define weights for deviation from the trade-off line.

Preferably, the party input unit is operable to permit a party to define a relative importance for the two dimensional trade-off goal constraint.

Preferably, the party input unit is operable to permit a party to associate the two dimensional trade-off goal constraint levelwise with other goal constraints.

Preferably, the relative importance is usable by the negotiator to establish contributions of deviation variables of respective goal constraints to a corresponding objective function.

Preferably, the party goal program unit further comprises a trade-off line evaluator for assigning a trade-off penalty value to points off the trade-off line.

Preferably, the party goal program unit further comprises a scaling unit, associated with the trade-off line evaluator for scaling the trade-off penalty value, to produce a scaled penalty value.

The platform preferably comprises an offer delay timer, associated with the negotiator, for introducing determinable delays between issuance of successive offers to an opponent.

Preferably, the offer delay timer is operable to set successively increasing delays.

Preferably, the offer delay timer is operable to set delays to change levelwise.

Preferably, a magnitude of the delay is based on a relative change between succeeding opponent offers.

Preferably, the offer delay timer is operable to set user determined delays.

According to a sixth aspect of the present invention there is provided a platform for supporting negotiation between parties to achieve an outcome, the platform comprising:

a party goal program unit comprising a party input unit for allowing a party to define at least one single dimension two-point goal constraint in respect of the outcome, and to associate the goal constraint with an upper point of preference, and a lower point of preference, a first weighting value for deviations below the lower point of preference, and a second weighting value for deviations above the upper point of preference, the goal program unit being operable to provide weightings to a region included between the points of preference by assigning the first weighting value below the upper point of preference and the second weighting value above the lower point of preference and defining an overall weighting within the region as a minimum of the weighting values,

and a negotiator, associated with the goal program unit, the negotiator being operable to use the included region, the weightings, and the minimum to consider the at least one goal constraint with other goal constraints to arrive at successive offers to achieve the outcome.

Preferably, the party input unit is operable to permit a party to define a relative importance for the single dimensional two point goal constraint.

Preferably, the party input unit is operable to permit a party to associate the single dimensional two point goal constraint levelwise with other goal constraints.

Preferably, the relative importance is usable by the unifier to establish contributions of deviation variables of respective goal constraints to a corresponding objective function.

The platform preferably comprises an offer delay timer, associated with the negotiator, for introducing determinable delays between issuance of successive offers to an opponent.

Preferably, the offer delay timer is operable to set successively increasing delays.

Preferably, the offer delay timer is operable to set delays to change levelwise.

Preferably, a magnitude of the delay is based on a relative change between succeeding opponent offers.

Preferably, the offer delay timer is operable to set user determined delays.

According to a seventh aspect of the present invention there is provided a platform for supporting negotiation between parties to achieve an outcome, the platform comprising:

a party goal program unit comprising a party input unit operable to permit parties to define goal constraints comprising pairwise variable trade-offs having at least two points and a trade-off function for deviating from a line drawn between the points, wherein the party goal program unit is operable to prevent inconsistent inclination values to be defined within the platform by preventing the party input unit from accepting more than one trade-off that refers directly or indirectly to a same pair of variables,

and a negotiator for negotiating with other parties via goal programs to achieve an outcome consistent with the constraints.

According to an eighth aspect of the present invention there is provided a platform for supporting negotiation between parties to achieve an outcome, the platform comprising:

a party goal program unit comprising a party input unit operable to permit parties to define constraints relating to pairwise trade-offs having at least two points and a trade-off function for deviations from a line extending therebetween, wherein the party goal program unit is operable to warn users of inconsistent inclination values by outputting a warning whenever a trade-off being entered refers directly or indirectly to a pair of variables already included in a previously entered trade-off, and

a negotiator for negotiating with other goal programs to achieve an outcome consistent with the constraints.

According to a ninth aspect of the present invention there is provided a platform for supporting negotiation between parties to achieve an outcome, the platform comprising:

a party goal program unit comprising a party input unit for allowing a party to define at least one objective function in respect of the outcome, and to associate the objective function with a series of variables and disjunctive constraints, the goal program unit comprising a disjunctive constraint processor for translating a disjunctive expression into at least one linear conjunctive expression,

and a negotiator, associated with the goal program unit, the negotiator being operable to use the series of variables including the linear conjunctive expression to negotiate an outcome consistent with the goal program and with other goal programs.

Preferably, the disjunctive expression comprises a series of relationships including equality relationships.

Preferably, the disjunctive constraint processor is operable to carry out the translation by expressing at least one of the equality relationships as the union of two corresponding inequalities that meet at a point of equality of the equality relationship.

Preferably, the disjunctive constraint processor is operable to define binary variables for the relationships, for setting wherever the relationships are satisfied, and wherein the negotiator is operable to sum the variables to determine a satisfaction level for the constraint.

Preferably, the party goal program unit is operable to set a requirement of a minimum number of satisfied relationships for use by the negotiator.

According to a tenth aspect of the present invention there is provided a platform for supporting negotiation between parties to achieve an outcome, the platform comprising:

a party goal program unit comprising a party input unit for allowing each party to define a plurality of goals in respect of the outcome, each goal comprising a plurality of deviation variables associated with decision variables, therefrom to form for each party a goal program, wherein a variable having discrete values is predefined, and wherein the party input unit is operable to receive allowed discrete values of the variable for use in the objective function definition,

a unifier, associated with the party goal program unit for receiving goal programs of respective parties, the goals including discrete values of the variable, the unifier being operable to carry out unification of the goal programs by considering the discrete values to arrive at a common region of the discrete variables amongst the goal programs, and

a negotiator operable to utilize fulfillment levels associated with the discrete values to produce successive offers to converge on an outcome within the common region.

Preferably, the party input unit is operable to accept weightings for respective discrete values of the variable, the weightings being usable to arrive at the fulfillment levels.

Preferably, the party goal program unit is operable to use the discrete values and respective weightings to build summation functions, therefrom to express the variable in quantitative manner.

Preferably, the party goal program unit is further operable to normalize the summation function by dividing by a largest one of the weightings.

Preferably, the discrete values comprise binary zero-one variables, the binary zero-one variables serving as multipliers of respective weightings in the summation functions, wherein the negotiator is operable to reach the outcome by setting the binary zero-one variable of one of the discrete values to one and the remainder to zero, and then to calculate the summation functions, thereby to obtain a respective fulfillment level for each goal.

Preferably, the unifier is operable to reattempt unification by setting binary zero-one variables of different ones of the discrete values to one, thereby to find a discrete value of the variable which maximizes the fulfillment levels, for setting as the unified value.

Preferably, the negotiator is operable to use a continuous variable as a transformation of the binary zero-one variables for carrying out the negotiating, the continuous variable being transformable back into the binary zero-one variables to express the outcome.

The platform preferably comprises an offer delay timer, associated with the negotiator, for introducing determinable delays between issuance of successive offers to an opponent.

Preferably, the offer delay timer is operable to set successively increasing delays.

Preferably, the offer delay timer is operable to set delays to change levelwise.

Preferably, a magnitude of the delay is based on a relative change between succeeding opponent offers.

Preferably, the offer delay timer is operable to set user determined delays.

According to an eleventh aspect of the present invention there is provided a platform for supporting negotiation between parties to achieve an outcome, the platform comprising:

a party goal program unit comprising a party input unit for allowing a party to define at least one objective function and at least one associated goal constraint in respect of the outcome, and to associate the goal constraint with at least two variables, the party input unit further allowing input of a linkage between a first and a second of the variables, the linkage defining a trade-off of deviations with respect to the target values,

a unifier, associated with the goal program unit, the unifier being operable to use the series of variables to unify the at least one goal constraint with other constraints to find a common area of interest, and

a negotiator, associated with the unifier, for using the trade-off to find a mutually acceptable outcome within the common area.

Preferably, at least one of the two variables has a target value.

Preferably, the party goal program unit is operable to express the second variable as a function of the first variable, thereby to represent the linkage, and further to represent deviations from respective target values as deviations from the target value of the first variable.

Preferably, the deviations are weighted.

Preferably, the party goal program unit is operable to express the trade-off as separate deviation variables in respect of the first variable and in respect of the second variable wherein the separate deviation variables are orthogonal.

Preferably, the party input unit is operable to permit an association of a relative importance level to the trade-off, the relative importance level used to calculate contribution to respective objective function.

Preferably, the party goal program unit is operable to calculate a relative importance level for the trade-off as an average of respective relative importance levels of the first and second variables, the relative importance level used to calculate contribution to respective objective function.

The platform preferably comprises an offer delay timer, associated with the negotiator, for introducing determinable delays between issuance of successive offers to an opponent.

Preferably, the offer delay timer is operable to set successively increasing delays.

Preferably, the offer delay timer is operable to set delays to change levelwise.

Preferably, a magnitude of the delay is based on a relative change between succeeding opponent offers.

Preferably, the offer delay timer is operable to set user determined delays.

According to a twelfth aspect of the present invention there is provided a platform for supporting negotiation between parties to achieve an outcome, the platform comprising:

a party goal program unit for defining goal programs in respect of an outcome, the goal program unit comprising a party input unit for allowing a party to input data relating to the goal program, the goal program unit being operable to translate the values into objective functions and constraints on the objective functions within the goal program,

and a negotiator, associated with the goal program unit, the negotiator comprising an optimizer to find best values for the objective functions under constraints, therewith to obtain a best solution for the goal program for output as a first offer, and then iteratively to produce further solutions until an offer is accepted, thereby to achieve the outcome.

Preferably, the negotiator comprises a percentage modifier for taking ones of the objective functions in turn, and worsening them by a predetermined percentage, thereby to produce the further solutions.

Preferably, the percentage modifier is settable to take each of the objective functions in turn beginning with a most important objective function, until a solution is accepted.

Preferably, the objective functions are arranged in levels and the percentage modifier is settable to take an objective function of a first of the levels only.

Preferably, the negotiator comprises a worst case calculator for determining a worst case evaluation for ones of the objective functions under constraints, thereby to obtain a worst acceptable offer.

Preferably, the goal program contains pairs of bounded deviation variables, and the negotiator comprises an arbitrary case calculator for taking one of each pair of variables, setting it to an arbitrary value within its respective bounds, taking the other of the pair of variables and setting it to zero, therefrom to calculate ones of the iterative solutions.

Preferably, the goal program contains pairs of bounded deviation variables, and the negotiator comprises an arbitrary case calculator for taking one of each pair of variables, associating therewith an arbitrary weight, forming therefrom an objective function as a summation of the arbitrary weights and minimizing of the objective function.

Preferably, the negotiator further comprises an average case calculator, associated with the optimizer and with the worst case calculator, for

taking the best solution and the worst solution, each solution having corresponding values,

associating ones of the corresponding values, and

constraining variables of the goal program towards an average of each of the corresponding values, therewith to provide an average solution.

The platform preferably comprises an offer delay timer, associated with the negotiator, for introducing determinable delays between issuance of successive offers to an opponent.

Preferably, the offer delay timer is operable to set successively increasing delays.

Preferably, the offer delay timer is operable to set delays to change levelwise.

Preferably, a magnitude of the delay is based on a relative change between succeeding opponent offers.

Preferably, the offer delay timer is operable to set user determined delays.

Preferably, the goal program objective functions are arranged levelwise and the average case calculator is operable to carry out the associating and the constraining successively levelwise.

Preferably, the data input unit is operable to receive user defined output values, wherein the goal program unit is operable to set the output values as single value constraints and to flag the constraints as unchangeable.

Preferably, the goal program unit is operable to output an error indicator if the single value constraints render the goal program insoluble.

According to a thirteenth aspect of the present invention there is provided a platform for supporting negotiation between parties to achieve an outcome, the platform comprising:

a party goal program unit for defining goal programs in respect of an outcome, the goal program unit comprising a party input unit for allowing a party to input values, the goal program unit being operable to translate the values into objective functions and constraints on the objective functions within the goal program,

and a negotiator, comprising a solution sorter for comparing goal program solutions by evaluation of the goal program for each one of a series of proposed solutions and ranking the solutions according to the evaluations, the negotiator being operable to use the ranking to apply preference to different solutions.

Preferably, the negotiator further comprises a thresholder associated with the solution sorter for applying a threshold to the evaluations to exclude ones of the series of solutions.

Preferably, the negotiator further comprises a solution completer for applying best values to unspecified values of variables in incomplete ones of the solutions, thereby to allow the goal program to be evaluated for the incomplete solutions.

Preferably, the solution sorter is settable to find the best solution from the series of solutions by identifying the highest ranked solution and discarding the remaining solutions.

Preferably, the solution sorter comprises a memory set to hold a predetermined number of solutions, and a comparator to compare a new solution with each solution in the memory, and further comprising a control unit for adding the new solution to the memory if its evaluation is larger than any solution in the memory, and for discarding a lowest ranked solution in the memory if the memory already contains the predetermined number.

The platform preferably comprises an offer delay timer, associated with the negotiator, for introducing determinable delays between issuance of successive offers to an opponent.

Preferably, the offer delay timer is operable to set successively increasing delays.

Preferably, the offer delay timer is operable to set delays to change levelwise.

Preferably, a magnitude of the delay is based on a relative change between succeeding opponent offers.

Preferably, the offer delay timer is operable to set user determined delays.

According to a fourteenth aspect of the present invention there is provided a platform for supporting negotiation between a local party and an opponent party to achieve an outcome, the platform comprising:

a goal program input unit for receiving a local party's goal program and an opponent's goal program to be unified, the goal programs comprising objective functions associated with constraints and being arranged in successive levels,

an optimizer for finding best solutions to goal programs, connected to find best values for the objective functions and constraints of the local party's goal program levelwise, and

a worst case calculator for finding worst solutions for goal programs, connected to find worst values for the objective functions and constraints of the opponent's goal program levelwise,

the negotiator being operable to:

use the optimizer and the worst case calculator in succession level by level to produce successive best local and worst opponent value sets for evaluation therefrom to form level by level offers, and

to advance from one level to another level only following acceptance by the parties of an offer regarding a previous level.

Preferably, each best local and worst opponent value set is obtained using a current and each remaining successive level.

Preferably, the value sets are obtained while negotiating a current level.

Preferably, the negotiator comprises a constraint updater for updating constraints upon advance from one level to another level in accordance with the respective acceptance.

The platform preferably comprises an offer improver operable to provide an improved offer by making a change in a selected one of the variables to bring about an improvement in the evaluation of the opponent's goal program.

Preferably, the change in the variable is calculated such that the improvement is a predetermined proportion of a difference between a previous offer made and a best possible evaluation made for the opponent.

Preferably, the offer improver is operable to use a value of the selected variable in a last opponent's offer to moderate the change.

Preferably, the offer improver is operable to calculate a protection value, and to use the protection value to limit a reduction in the evaluation of the local party's goal program as a consequence of the improvement to the opponent's goal program evaluation.

Preferably, the protection value is a proportion of the difference between a worst case evaluation of the local party's goal program and an evaluation of a last previous offer thereof.

The platform preferably comprises an offer improver for taking goal program values of a previous local party offer and one value in turn from a previous opponent offer, testing the opponent value against local constraints, and if it fits within the constraints then substituting it into the previous local party offer thereby to provide an improved offer.

According to a fifteenth aspect of the present invention there is provided a platform for supporting negotiation between a local party and an opponent party to achieve an outcome, the platform comprising a negotiator, and

a goal program input unit for receiving a local party's goal program, the goal programs comprising objective functions associated with constraints and being arranged in levels,

the negotiator comprising:

an optimizer for finding best solutions to goal programs, connected to find best values for the objective functions under constraints of the local party's goal program levelwise, and

a stay close processor for determining variable improvement directions from monitoring of received offers from the opponent and carrying out value perturbations in the directions.

the negotiator being operable to:

use the optimizer to produce a first offer for a first level,

to advance from one level to another level only following acceptance by the parties of a unification offer regarding a previous level, and

use the stay close processor to produce a first offer for each subsequent level.

Preferably, the stay close processor is operable to produce successive offers while negotiating within a level.

Preferably, the negotiator comprises a constraint updater for updating constraints upon advance from one level to another level in accordance with the respective acceptance.

Preferably, the negotiator further comprises

a gap value determiner for determining a gap for use in offer improvement, and

a value improver, associated with the gap value determiner, for inserting a predetermined proportion of the gap as a constraint of the goal program, and wherein the stay close processor is associated with the value improver thereby to apply the predetermined gap proportion in the direction to provide an improved offer.

Preferably, the stay close processor is operable to monitor successive opponent offers for value changes therebetween, and to assign to each respective changing variable a weight for use in providing an improved offer, the magnitude of the weight being selected in accordance with a monitored relative size of a corresponding value change of the opponent.

Preferably, the gap is a constant.

Preferably, the constant is a difference between a best value and a worst value of a corresponding variable.

Preferably, the gap is a difference between a local best case and a last opponent proposal.

The platform preferably comprises a gap truncator for maintaining the gap between predetermined maximum and minimum bounds.

The platform preferably comprises an offer delay timer, associated with the negotiator, for introducing determinable delays between issuance of successive offers to an opponent.

Preferably, the offer delay timer is operable to set successively increasing delays.

Preferably, the offer delay timer is operable to set delays to change levelwise.

Preferably, a magnitude of the delay is based on a relative change between succeeding opponent offers.

Preferably, the offer delay timer is operable to set user determined delays.

According to a sixteenth aspect of the present invention there is provided a platform for joint processing of goal programs to produce an outcome, the platform comprising: a party goal program unit for formulation of at least one local goal program,

a unifier for determining common ground between the local goal program and at least one other goal program,

a negotiation necessity tester, associated with the unifier, for joint solving of the local and the other goal program to form a joint goal program comprising optimal solutions for each of the local and the other goal program, the negotiation necessity tester being set to determine whether there lies a single solution, that is optimal for both parties, within the common ground, and if so, to indicate that no negotiation is necessary.

The platform preferably comprises an output unit for outputting the single solution when negotiation is not necessary.

According to a seventeenth aspect of the present invention there is provided a resource negotiator for making successive offers for usage of a resource with at least one remote party based on a goal program of a local party, the goal program comprising a plurality of objective functions, at least one of the objective functions having a goal associated with a target value, an upper bound, a lower bound and at least one constraint, the resource negotiator comprising:

an input for receiving data from the remote party,

a minimizer for producing successively worsening minimizations of the goal program, and

an offer formulator, associated with the minimizer, for formulating the minimizations into offers for resource usage for sending to the remote party.

Preferably, the data from the remote party comprises a goal program comprising a plurality of objective functions, at least some of the objective functions being associated with goal constraints having a target value, an upper bound, a lower bound and at least one constraint, the minimizer for producing successively improving solutions of the remote party goal program, for use together with the worsening minimizations for use by the offer formulator for formulating the offers for resource usage.

Preferably, the offer formulator comprises a behavior synthesizer for governing the offer formulation in accordance with a predetermined behavior profile.

Preferably, the behavior profile comprises an opponent offer feedback feature for using opponent offer improvement levels for setting improvement levels for successive offer formulations.

Preferably, the behavior profile comprises an opponent offer feedback feature for using opponent offer data for setting time intervals for successive offer outputs.

Preferably, the profile comprises a scenario for a whole negotiation.

Preferably, the profile is built by the resource negotiator based on input at the input unit.

Preferably, the behavior profile comprises a negotiation refusal condition for breaking off negotiations when the condition is achieved.

Preferably, the refusal condition comprises a predetermined number of opponent offers that fail a predetermined improvement threshold.

Preferably, the refusal condition comprises a predetermined time during which the negotiation fails to reach a predetermined improvement threshold.

Preferably, the input is operable to receive data from a plurality of remote parties.

The negotiator is preferably operable to negotiate with a plurality of parties.

Preferably, the offers are based on changes to one of the variables only.

The resource negotiator may comprise a bound setter for setting at least one of respective upper and lower bounds of a respective one of the variables as a function of bounds of other goals in the goal program.

The resource negotiator may comprise a dynamic bound setter for setting at least one of respective upper and lower bounds of the variable as a function of data received at the input.

According to an eighteenth aspect of the present invention there is provided a resource negotiator for negotiating for usage of a resource with a plurality of remote parties based on a goal program of a local party, the goal program comprising a plurality of objective functions with associated goal constraints, at least one of the goal constraints having at least one variable with an upper bound, and a lower bound, the resource negotiator comprising:

an input for receiving data from the remote parties,

an objective function minimizer for calculating a value required to be provided by remote parties of the at least one objective function, and

an offer acceptor, associated with the minimizer, for receiving offers from the remote parties, comparing the calculation with the offers and for accepting one of the offers based on the minimizations.

Preferably, the offer acceptor is operable to accept an offer representing a best offer.

Preferably, the offer acceptor is operable to accept an offer representing a second best offer.

The resource negotiator may comprise an output for revealing received offers to each of the remote parties.

The resource negotiator may comprise a bound setter for setting at least one of respective upper and lower bounds of a respective variable as a function of bounds of other constraints in a respective goal program.

The resource negotiator may comprise a dynamic bound setter for setting at least one of respective upper and lower bounds of the variable as a function of data received at the input.

Preferably, the minimizer is set to perform minimization over a plurality of objective functions.

Preferably, the minimizer is set to perform minimization over a single objective function.

Preferably, the minimizer is set to perform minimization over a penalty function of the objective functions.

The resource negotiator may comprise a goal program output unit for sending to the plurality of remote parties at least some of the local party goal program objective functions and associated constraints and variables therewith to enable the remote parties to form or calculate potential offers in light thereof.

According to a nineteenth aspect of the present invention there is provided a resource negotiator for negotiating for usage of a resource with a plurality of remote parties based on a goal program of a local party, the goal program comprising at least one objective function having at least one goal comprising a variable assignable with at least one of an upper bound, and a lower bound, the resource negotiator comprising:

an active bid monitor for monitoring remote parties remaining in the negotiating,

a resource quality increaser for successively decreasing a value of the at least one predetermined objective function,

an offer acceptor, associated with the active bid monitor and with the quality increaser, for ending the negotiation at a time at which only a predetermined number of remote parties remains active, and at a corresponding value of the at least one predetermined objective function, the offer acceptor being operable to deem the negotiation successful if the corresponding value is within any assigned bounds, the predetermined number being related to a number of available resources.

The resource negotiator may comprise a bound assigner for calculating at least one bound of the predetermined variable according to other goal constraints of the local goal program.

The resource negotiator may comprise a goal program output unit for sending to the plurality of remote parties at least some of the local party goal program objective functions and associated constraints and variables to enable the remote parties to evaluate potential offers in light thereof.

Preferably, the quality increaser is operable to reduce the value to an intermediate level between a current and a previous level when a number of remaining parties drops from a level above the predetermined number to a level below the predetermined number, thereby to raise the number of remaining parties to correspond with the number of resources.

Preferably, the predetermined number is one.

Preferably, the active bid monitor comprises an output unit for revealing to the remote parties a number of remote parties remaining in the negotiating.

Preferably, the active bid monitor comprises an output unit for revealing to the remote parties identities of remote parties remaining in the negotiating.

Preferably, the predetermined number is one.

The resource negotiator may comprise a drop out decision unit for use by one of the remote parties, the unit comprising:

a current offer evaluator for expressing a current value demand issued by the value increaser in terms of a goal program of the remote party,

an active bid unit for storing the number of remote parties remaining in the negotiating,

a drop out function for calculating a drop out probability as a function of the current value and the number of remote parties remaining in the negotiating, and

a decision maker for using the drop out probability to decide whether to leave the negotiating.

According to a twentieth aspect of the present invention there is provided a platform for performing ranking between database entries, each of the entries comprising a series of values arranged in fields, the platform comprising:

a goal program unit for taking data from a user and defining therewith a goal program, variables thereof being related to the fields, and

a ranking unit for performing ranking amongst the entries in accordance with the goal program.

Preferably, the goal program unit is operable to take the values in twos, thereby to determine tradeoffs between respective fields.

Preferably, the trade-offs comprise a change in a first of the variables being traded for a proportional indicated change in a second of the variables.

Preferably, the change is one of a group comprising an increase and a decrease.

Preferably, the goal program unit is operable to take the trade-offs in groups of three or more.

Preferably, the goal program unit is operable to compile statements of a ranking sub-language.

Preferably, the statements comprise at least one of a group comprising: constraint, preference, deviation, and trade-off statements.

Preferably, the goal program unit is operable to take the trade-offs in a plurality of trade-off groups, and to compile a separate trade-off statement for each group.

Preferably, the ranking unit is operable to determine an average of the deviations for each trade-off statement for use in the ranking.

Preferably, the goal program unit further comprises a weight assigner for assigning weights to fields, therewith to perform summation over each of the entries.

Preferably, the weight assigner comprises a user preference input for receiving a user defined preference order between ones of the entries, and wherein the weight assigner is operable to select weights for assignment to fields of the entries such as to enforce the user defined preference.

Preferably, the weight selection is such as to maximize the expression of the user preferences.

Preferably, the fields are ordered preferentially and wherein the weight assigner is operable to assign weights according to a position of a respective field in the order.

Preferably, the weight assigner comprises a user input for receiving a parameter defining a number of entries of high desirability from the start of an ordered list, the weight assigner being operable to select weights to reflect the desirability.

A preferred embodiment may comprise a ranking expression unit for providing an expression basis for defining at least one of a group comprising a condition, a deviation, a deviation condition, a constraint, a simple trade-off relationship, a complex trade-off relationship, a preferred value within a range, a preferred range, a weighting, therefrom to form an objective function for use in the ranking.

According to a twenty first aspect of the present invention there is provided a platform for supporting negotiation between parties to achieve an outcome, the platform comprising:

an input for receiving an overall deal request from a first party relating to multiple items, and availability data from at least one second party relating to available items,

a deal partitioner for partitioning of the deal request into a plurality of sub-deals each corresponding to at least one item of the sub-deal request that is to be obtained from a single second party, such that the deal request overall is applicable to one or more second parties, and

a deal minimizer for selecting second parties for each sub-deal such as to minimize a cost parameter for the first buyer for the deal request.

Preferably, there are a plurality of the second parties, and each the sub-deal relates to item availability data of a single one of the second parties.

Preferably, a sub-deal comprises a group of items defined by a first party.

Preferably, at least one item is available from a plurality of the second parties.

Preferably, the deal request comprises a specified quantity of a single item.

Preferably, the deal request comprises specified quantities of each of a plurality of items.

Preferably, the deal request comprises items some of which are only available in combinations from at least one of the second parties.

Preferably, the combinations comprise a fixed number of each item of the combination.

Preferably, the combinations comprise a range of number of at least one item of the combination.

Preferably, the cost parameter is expressible via a goal program.

Preferably, the availability data comprises quantity-variable availability data.

Preferably, the deal splitting is carried out using an approximation price-based algorithm.

Preferably, the approximation price-based algorithm is of the residual greedy family.

Preferably, the approximation price-based algorithms include polynomial time approximation scheme-based algorithms.

Preferably, the approximation price-based algorithms are exact algorithms based on linear and integer programming algorithms for use with a limited number of second parties.

Preferably, a number of item types is fixed.

Preferably, a number of parties is fixed.

Preferably, the approximation-based algorithm is a (1+epsilon) approximation wherein epsilon is a number lying between 0 and 1.

Preferably, the approximation-based algorithm is a (1+epsilon) approximation wherein epsilon is a number lying between 0 and 1.

Preferably, a number of parties and a number of item types are unbounded.

Preferably, the approximation-based algorithm is a (1+epsilon) approximation wherein epsilon is a number lying between 0 and 1.

Preferably, the items are available as packages of at least one item and the residual greedy algorithm takes as input a set of all possible packages.

Preferably, the set is subjected to a rounding procedure.

Preferably, the rounded set is subjected to integer knapsack analysis to obtain a minimal cost of obtaining a predetermined number of units.

Preferably, the residual greedy family of algorithms comprises at least a residual greedy algorithm, an improved residual greedy algorithm and a multi-item residual greedy algorithm.

Preferably, the deal partitioner is operable to carry out optimal deal splitting for a single item carried by each of a predetermined maximum number of second parties, each of the second parties presenting to the deal partitioner a quantity-cost table.

Preferably, the deal partitioner is operable to use a polynomial time algorithm to carry out the deal splitting.

Preferably, the deal partitioner is operable to carry out optimal deal splitting for multiple items carried by a predetermined maximum number of second parties, each of the second parties offering at least some of the items and at least some of the suppliers offering items in multi-item packages.

Preferably, the deal partitioner is operable to use a polynomial time algorithm to carry out the deal splitting.

Preferably, there is an unrestricted number of second parties, the platform using a residual greedy approximation algorithm to carry out the deal splitting.

Preferably, at least some of the items are available as multi-item packages.

Preferably, each second party has an unlimited quantity of the at least one item.

Preferably, at least some of the items are available in multi-item packages.

Preferably, the deal splitting is carried out using a pseudo-polynomial time algorithm.

Preferably, each second party has a limited quantity of the at least one item, the deal splitting being carried out using a pseudo-polynomial time algorithm.

Preferably, at least some of the items are available in multi-item packages.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIGS. 1-17E are simplified block diagrams which show various aspects of a platform according to the present invention,

FIGS. 18-28 show various kinds of trade-offs and constraints for use with the platform of FIGS. 1-17E, and

FIGS. 29-50 illustrate uses of examples of the present invention.

### DESCRIPTION OF THE PREFERRED EMBODIMENTS

The present embodiments describe a general-purpose electronic negotiating platform that uses the concept of a goal program as the basis for allowing negotiations. The goal program can be formulated for users whatever their requirements and used in the conduct of the negotiations, thus freeing the platform from any particular format for the negotiations. Furthermore the goal program format does not require any particular type of goal such as price to form the centerpiece of the negotiation, thus extending the field of electronic negotiation beyond the business field.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

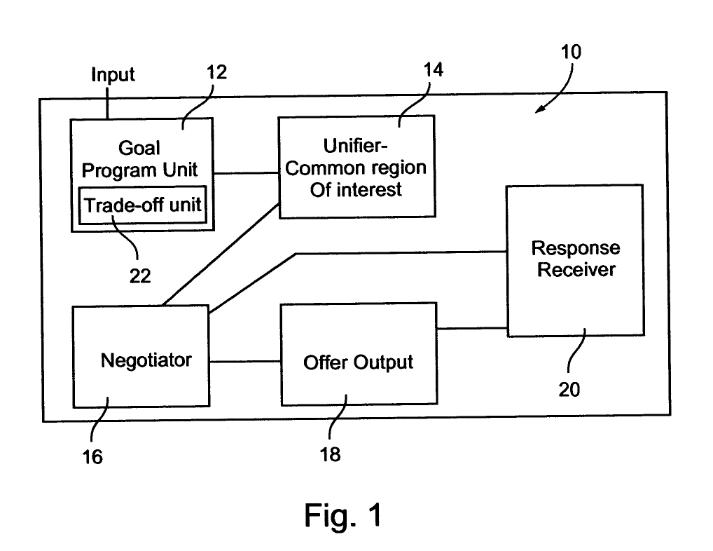

Reference is now made to FIG. 1, which is a simplified diagram showing a platform for supporting negotiation between parties to achieve an outcome, operative in accordance with a first preferred embodiment of the present invention. The platform 10 comprises five basic units as detailed hereinbelow.

The first unit is a party goal program unit 12, which defines a respective party's goal programs in respect of the desired outcome. The goal program is a way of expressing a party's needs, constraints and desires regarding a particular outcome in quantitative form so that the party's position regarding the outcome can be compared in automatic manner with that of another party in order to ensure that the outcome takes on a mutually acceptable form. To this end the goal program comprises a plurality of objective functions, which are expressions that include variables of various kinds and associated with constraints. The variables may be deviation variables which measure deviation in a specified direction from a target value and different objective functions may be defined for different levels of importance, each objective function including all of the variables and constraints deemed to be of the corresponding level of importance. The constraints may include goal constraints, that is constraints representing a party's goals, which may be associated with respective objective functions. In fact the party goal program unit may physically be located with the respective party remote from the rest of the platform, or the platform may have a party goal program unit for each party involved or, as shown in FIG. 1, it may have one party goal program unit for a local party and simply expect a remote party to provide a goal program already formulated. As will also be discussed below, the remote party's goal program may not always be known to the local party. The negotiation may proceed in a mode known as “ignorant” in which some or all of the other party's goal program features are not known.

At the level of the party goal program unit 12 the possibilities for the outcome are expressed as a goal program. The individual objective functions are then divided, one per level, into levels of importance, for example primary, secondary and tertiary, and the goals within each level are then preferably assigned goal importance weightings. Typically, the assignment of objective functions importance levels and of goal importance weightings is carried out by means of a dialog box based interaction with the party.

Additionally, the platform 10 preferably comprises a goal program unifier 14, which is connected to the one or more party goal program units 12 for receiving goal programs of the respective parties. The unifier carries out a task known as unification of the goal programs which involves determining whether two (or more) goal programs have a common field of interest from which a mutually compatible outcome is derivable. If there is no common field of interest then there is no point in making any further attempt to find a mutually acceptable outcome. Thus if a farmer wishes to use a field as a helipad, but is prepared to settle for a camp site, and the second party is the local noise abatement society which is totally opposed to aircraft noise but may be persuaded regarding tourist traffic provided that certain constraints are observed, then the unifier may identify the camp site use as the common field of interest.

Following the unifier 14 is a negotiator 16 which receives the goal programs of the respective parties, and carries out negotiations using the goal programs. Preferably, negotiations are carried out by considering the objective functions per se and considering them levelwise, that is to say by solving for the objective functions over a first level before moving on to a second level. Solving the goal programs involves a process of minimization of expressions associated with the objective functions and will be explained in greater detail below. Each individual attempt at a solution between goal programs, or, in ignorant mode, between one goal program and what is known or can be assumed about another party, provides the content of an offer which is made to the opposing party. Typically the solution of a given level involves an exchange of offers between the parties until acceptance at that level is reached.

The platform preferably comprises an output unit 18 formulating the content into an offer and sending it to the respective parties.

The platform further comprises a response receiver 20 for receiving from respective parties either counter offers or acceptances. The response receiver uses the counter offers as new input to the negotiator to arrive at a new offer. It will be appreciated that when both parties accept an offer, then the negotiation for the given level is complete. Objective function values, as well as some variable values, settled in the current level may be used to constrain lower levels.

The goal program unit 12 preferably comprises a trade-off unit 22 which has a number of tasks involving the variables of goals associated with the various objective functions. One of its tasks is to arrange the variables and thereby the goals into the different levels, thereby to ensure that they are traded off against in accordance with their goal importance. Thus variables in the same level in a goal program can be traded off against each other in succeeding offers, so that for example a conditional weakening, in terms of contribution to the respective objective function, of one variable can be offered in return for strengthening of another variable within the same level. Another kind of trade-off that the trade-off unit may provide, simply by arranging the variables etc. correctly in levels, concerns identifying certain variables at a given level in a first party's goal program which the first party is prepared to have weakened in return for concomitant weakening of certain of the other party's variables. The trade-off may involve weakening of other variables within the same level of the other party, if the other party's goal program is sufficiently known to the party's negotiation apparatus. In ignorant mode the other party's goal program is not explicitly known, although information about it may be gathered or assumed during the course of the negotiation.

As mentioned above, the party goal program unit 12 preferably expresses objective functions within the goal program in a hierarchy according to a respective associated level of objective function importance, typically provided by the user but in the absence of user input, default values can be used. Each constraint is preferably expressed in terms of at least one constraint variable. The goal program comprises the collection of these objective functions, one per level, each function being expressed in a manner suitable for minimization within the negotiator.

Data from the user input is preferably used to apply coefficients to the constraint deviation variables of various kinds, the coefficients being in the form of deviation penalties, bonuses, other importance factors and the like.

Typically, the party goal program unit 12 applies user input to provide different values of coefficients to the constraint deviation variables for deviations off a corresponding target in respective positive and negative directions. That is to say a given variable has a preferred region or preferred value, the latter referred to herein as a target value, which the party wants to achieve. The preferred region or target value are referred to herein by the single term “goal”. The user objects to the variable being outside that preferred region or away from that target value, and his objection is expressed in terms of coefficients. The variable can conceivably take values above or below the preferred region or target value and the user may apply different coefficients for the different directions, expressing different levels of dislike for the respective directions. Thus, for example, in scheduling a train service, a railway official may have an ideal time range for the journey to take. Deviation below the range is allowable to a limited extent but beyond that to be discouraged strongly because of unsafe speeds. Deviation above the range is discouraged as it is unpopular with passengers, but no question of public safety arises. Using a negative coefficient indicates a desired deviation towards a direction, also known as a bonus.

In general, a certain class of variables consists of continuous variables, and goal constraints are expressed via coefficients of deviation variables referring to parts of their ranges. The goals may be categorized according to the arrangements of coefficients of the corresponding deviation variables in various ways, for example a strong one sided goal has a target value or region of preference and a strong weighting on one side of that region or value. A weak one sided goal has the same but with a weaker weighting to the side of that region. A complex single sided goal has two (or more) different weightings making up two different parts of an otherwise continuous non-preferred region. A simple two sided goal has single weighting coefficients on either side of a centrally included target value or preferred region. A complex two sided goal has two (or more) different weightings on both sides of a centrally included target value or preferred region. A simple first side-complex second side goal has different weightings on one side and a single weighting on the second side of a centrally included target value or preferred region. A simple two-sided goal with an indifference range is a simple two sided goal in which a centrally included region is entirely flat, that is to say has no preferences associated with it at all, likewise a complex two sided goal with an indifference range, and a simple first side-complex second side goal with an indifference range. All these are further explained in the examples section.

The above applies to continuous variables. However, as will be described in greater detail hereinbelow, the platform may also take into account goals that are described by a series of discrete values. In such a case, the party goal program unit 12 applies user input to formulate weightings for the different discrete values. Thus it is possible to express a preference between the discrete values. As will be discussed in more detail below, the discrete variables are transformed into ones over a continuous domain for processing and then transformed back into discrete form for offer formation. The discrete variable allows the goal program to express objective functions involving discontinuous values. For example a proposed land use variable may be expressed as a series of discrete values, say, 1) heliport, 2) camping site, 3) industrial building, 4) commercial building, 5) domestic building, 6) agricultural use. It will be appreciated that a continuous variable would be of little use in such circumstances.

Notwithstanding the presence of discrete variables, the main workhorse of the goal program is likely to be the continuous variable, and the party goal program unit may generally apply user input to determine whether the continuous variable closeness to a target is to be maximized or to be minimized, once the above-discussed constraints have been applied. For example an important variable in many circumstances is time, time to completion or the like, and the direction of desirable movement of time depends on who the party is. A passenger wants a shorter time. A transportation provider would rather have the flexibility which a looser determination of the time would give. The negotiator preferably works using minimization so that if a party wishes an item to be increased then the corresponding objective function uses a term that decreases as the item increases.

The negotiator 16 preferably deals with goals as arranged in a hierarchy of levels. Within each level, goals are given goal importance weightings so that a hierarchy of importance exists within the level as well. Minimization at a level typically involves summing over deviation variables values multiplied by deviation weighting, as well as goal importance weighting, coefficients, and then altering various deviation variables which are associated with individual goals and associated constraints, then resuming and comparing, such functionality may be provided by an outside solver. The minimization is preferably carried out level by level in the hierarchy, which is to say that first one level is solved for minimizing its objective function, and then the negotiator moves on to the next level. This point is made in terms of mathematical equations hereinbelow.

The negotiator may carry out minimization per objective function, and may set a maximum bound per deviation. Such a maximum bound is used to ensure that the system does not arbitrarily select a variable and stretch it beyond realistic expectation. Such a selection may succeed in balancing the opponent party mathematically but produces unrealistic offers.

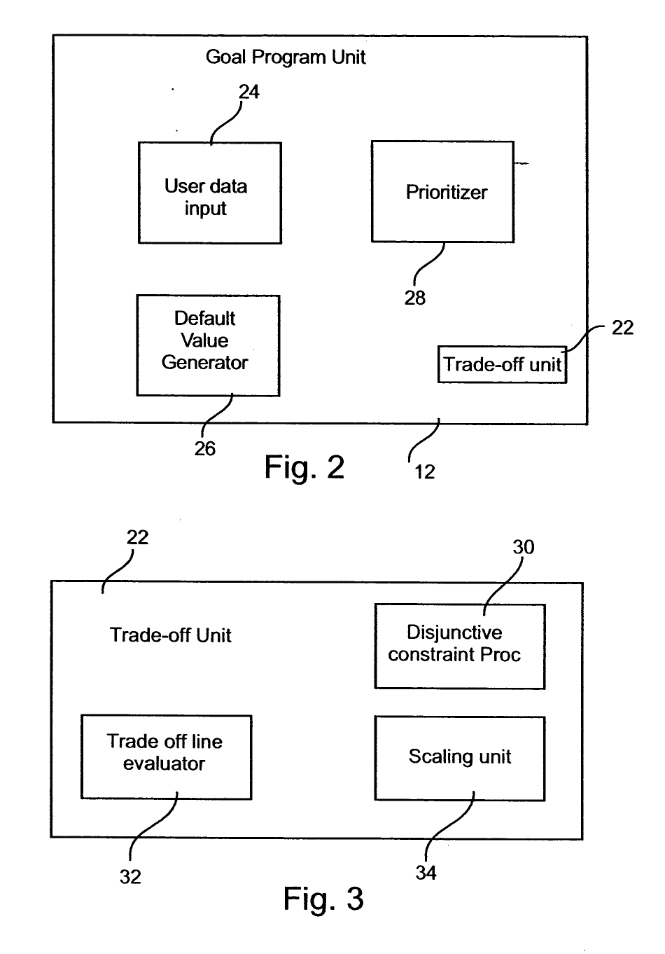

Reference is now made to FIG. 2, which is a simplified block diagram showing in greater detail the goal program unit 12 of FIG. 1. The goal program unit 12 preferably comprises the trade-off unit 22 as discussed above, a user data input unit 24, a default value generator 26 and a prioritizer 28. Preferably, the input unit 24 is configured to receive data from a user interface, for example through a dialog box as discussed. As an alternative, the input is configured to receive data from a software agent. In a particularly preferred embodiment data can be accepted, by the input unit 24, from either kind of source.

As mentioned above, goal programs can be completed with default values, and for this purpose, the goal program unit 12 identifies parameter data missing from an input and further comprises a default value generator 26 which may generate a default value for the missing parameter according to a predefined criterion. Typically the generator 26 may use a default register of values for expected parameters.

The goal program unit preferably obtains lower and upper bounds for at least some of the variables. Again these bounds may be obtained directly from the user input, adapted from the user inputs or default values may be used. The use of upper and lower bounds to a parameter or variable ensures that parts of the range expressed by the parameter may be expressed as a proportion of the whole, thereby rendering different ranges comparable. The goal program unit 12 is thereby enabled to use the upper and lower bounds to express deviations of a variable from a target value relatively, thereby to render the deviations subject to comparison by the unifier 14 or by the negotiator 16.

The goal program unit 12 preferably obtains an interval or target value and a value for a penalty or bonus for deviating from the interval or target value, as described above. Subsequently, the unifier may define a working interval between the goal programs of two opposing users as an intersection between the respective intervals.

The unifier may for example notice that a target value in one of the goal programs is actually outside the working interval that it has just defined. In such a case it may modify the target value to approach a closest boundary of the working interval.

The unifier may then reapportion the deviation penalty in accordance with the target value modification.

In the above modification, the intersection itself may be a single point or it may be a length or an area or may be of any higher dimension, depending on the dimensions of the underlying variables.

The goal program unit 12 preferably is able to determine when an intersection is small or distant to the satisfaction of respective parties, relative to the underlying ranges. When the intersection is recognized as small, the negotiator selects a point within the intersection, which may be a midpoint between respective target values.

Returning to the issue of bounds, the use of bounds to define any kind of interval in respect of a variable allows the negotiator to measure deviations within the interval as a fraction of a total size of the interval. Alternatively, deviations may be measured as fraction of a target value, possibly normalized.

The party goal program unit 12 preferably uses data from the user to obtain objective function importance level values, goal importance weighting within a level of its objective function, deviation weighting values for deviations from the target of a goal. These various importance and weighting values can then be used by the negotiator as multipliers to scale deviations from the target values, thus providing the deviation penalties referred to hereinabove.

Preferably, the negotiator 18 identifies intersections that are small and distant from a target value compared to one of parties' definitions and large and inclusive of a target value compared to another party's definitions. In such circumstances, the negotiator attempts to set an effective target at the closest intersection boundary and then applies a transformed deviation. That is to say, since, from the point of view of the more distant target, an artificial target value is being used, the deviations from the artificial target cease to reflect the actual cost of the deviation from the point of view of the respective party. Thus a transformed deviation is calculated from the arithmetic deviation when computed relative to the effective target and then added to the difference between the old target and the effective target, then to produce a result which is divided by the old target. The calculation is shown mathematically in the examples section below.

The party input unit preferably provides a dialog which permits a party by answering questions at the user interface, to define variables, constraints and in particular coefficients for variables and equations, goals, weightings, penalties and any other features of the objective functions according to any one of the categories discussed above. Thus for example the user may define, for a decision variable, a single dimension indifference interval, and may associate the variable with a range of indifference having an upper bound and a lower bound, a first weighting value for deviations below the lower bound, a second weighting value for deviations above the upper bound and a relative goal importance for the goal as a whole, which allows the deviation variables associated with this decision variable, appropriately weighted with coefficients, to be added to an objective function at the respective level.

Returning now to FIG. 1, the unifier 14 may then use the range of indifference, the weightings and the relative importance factors to unify the objective function as a whole with a corresponding opponents' objective function of the same level to determine whether or not there is a common area of interest at the given level. More commonly, such unification will be applied to goal programs as a whole. In fact unification usually treats a whole goal program. In general, goal importance weightings, objective function importance levels and deviation weighting are immaterial in unification, and what counts are the constraints themselves—which may be ordinary as well as goal constraints.

The prioritizer 28 allows a respective party to assign a level to an objective function to thereby define a level by level relationship with other objective functions. As an alternative, importance levels are assigned to individual variables, and so implicitly to goals, and the variables are then assembled into objective functions at different levels according to the assigned level of importance. The two alternatives above define different extents to which the user is involved in the definition of the goal program. In the first alternative the user knows only of the variables and their goals, and in the second the user is aware of the levels and the way in which the variables are assembled into objective functions. The former alternative is preferable in most cases but certain users may wish to have a greater amount of control by manipulating objective functions directly. The association can then be used to choose at which levels individual goals may be placed relative to each other. The user may indicate that give on one of the linked variables, that is to say variables now placed in the same level, should correspond to take on the other. Likewise the user input may be used to establish a priority amongst variables within a single level.

The input may also permit a party to define a two-dimensional trade-off goal by entering two two-dimensional points. The party goal program unit 12 preferably defines a trade-off line between the two points. The principle may be extended to three and higher dimensions, as mentioned briefly above.

Briefly, trade-off relationships are of four kinds (this is further explicated herein below and in the examples section). A first kind is implicit tradeoffs implied by setting targets for different decision variables. A second kind is between two decision variables, one of them with a target and the other without, a trade-off line thereby defines a dynamic target for said other variable in terms of value of said first variable. In this second case, deviations are measured relative to said dynamic target. A third kind is between variables, neither of which is associated with a target. In this case deviation is measured relative to distance from the tradeoff line, which is then converted to deviation relative to first variable, and for a second variable, relative to a point on said tradeoff line. The fourth kind is when there is a tradeoff line and both variables have targets. This case is less desirable as compared to previous ones.

The multi-dimensional trade-off includes a similar facility for defining weights for deviation from the trade-off line in accordance with the kind of trade-off discussed hereinabove.

The input unit preferably allows a party to define a goal importance weighting for the two (or higher) dimensional trade-off goal.

Again, as with the single dimensional goals, the input unit permits a party to associate the two-dimensional trade-off goals with other goals at a desired level.

The input unit preferably allows a party to define a single dimension two-point goal, in other words a goal having more than one target value. The objective may thus be associated with an upper point of preference, and a lower point of preference. The two points of preference divide the objective into three regions, a first region above the upper point of preference, a second region included between the points of preference and a third region which is below the second or lower point of preference. Separate weighting values for deviations may be attached to these regions, thus a first weighting value for deviations below the lower point of preference, and a second weighting value for deviations above the upper point of preference. Generally the included region is a region of indifference but if weightings are to be attached thereto, then generally two are required. The goal program unit is preferably able to provide weightings to the included region by assigning a first included weighting value below the upper point of preference and a second included weighting value above the lower point of preference. Then an overall weighting is defined within the included region as the minimum of the two weightings. The application of the two weightings will be explained both graphically and mathematically in the examples section below.

In addition, the input unit preferably allows a party to define a relative goal importance weighting for the single dimensional two point goal, and generally applies to the two point goal any other of the features applied to any of the other types of goal discussed hereinabove.

The input unit preferably permits a party to associate the single dimensional two point goal in levels with other goals. As before, the relative importance applied to the two point goal is usable by the negotiator to establish a priority between goals within any given level.

The input unit preferably permits a user to define a piecewise linear two-dimensional goal by entering at least three two-dimensional points. The goal program unit or the negotiator is then able to define a trade-off line, composed of two segments, between the three points.

The negotiator applies penalty values to points away from the trade-off line in accordance with their distances from the line, the weightings of deviations and the kind of trade-off.

The party input unit preferably permits a user to define a first deviation weight for deviating in a first direction from the trade-off line and a second deviation weight for deviating in a second direction therefrom.

The party input unit preferably permits parties to define goals comprising pairwise trade-offs having at least two points and a trade-off line therebetween, and to associate a penalty value or a penalty function with deviation from the trade-off line.

The party goal program unit preferably prevents inconsistent trade-offs to be defined within the platform by preventing the input unit from accepting more than one trade-off from referring, directly or indirectly, even just transitively, to any already specified trade-off. More stringently, the prohibition may prevent any trade-off that indirectly relies on variables already specified in a different trade-off. Alternatively, the goal program unit may simply warn users of inconsistent trade-offs by outputting a warning whenever a trade-off being entered contradicts, or more stringently, potentially contradicts a previously defined trade-off.

Reference is now made to FIG. 3, which is a simplified diagram showing the trade-off unit 22 of FIG. 1 in greater detail. The trade-off unit comprises a disjunctive constraint processor 30, whose operation will be described below, a trade-off line evaluator 32 and a scaling unit 34. The trade-off line evaluator 32 preferably carries out the trade-offs described hereinabove and the scaling unit 34 preferably applies scaling based on upper and lower bounds to make different parameters comparable.

Preferably, the party input unit permits parties to define disjunctive constraints in respect of objectives, and to this end the disjunctive constraint processor 30 translates a disjunctive expression into a plurality of conjoined expressions. The unifier and the negotiator are then both able to use the conjoined expressions for their respective purposes.

The disjunctive expression may typically include a series of relationships, and the individual relationships may include equality relationships.

Preferably, the disjunctive constraint processor carries out translation by expressing any one of the equality relationships as the union of two corresponding inequalities that meet at a point of equality of the equality relationship. This point and the necessity for it is discussed at greater length in the examples section below.

The disjunctive constraint processor allows binary variables to be defined in respect of the relationships, for setting wherever said relationships are satisfied, and wherein the negotiator is operable to sum the variables to determine a satisfaction level for the disjunctive constraint as a whole.

The party goal program unit may set a requirement of a minimum number of satisfied relationships for use by the negotiator.

The party input unit preferably permits each party to define weighting values for a discrete variable which is predefined per outcome, so that the definition can then be used throughout the setting up of the various objective functions for the outcome. The negotiator is then able to carry out negotiation between the goal programs by considering the weighting values and arriving at one of the values to make as an offer.

The party goal program unit preferably applies weightings to each of the different discrete values that a discrete variable is able to take. The discrete values can then be arranged as a weighted hierarchy. Subsequently, the hierarchy can be used by the negotiator to choose between the various discrete values for inclusion in an offer.

The party goal program unit preferably uses the values and corresponding weightings to build summation functions. The summation functions will be discussed in greater detail in the examples section below and enable expression of the discrete variable in quantitative manner.

The negotiator may involve the discrete variable in offer formation by a process of setting one of the binary variables to one and the remainder to zero, and then calculating the summation function and using it to contribute to an overall fulfillment level of each goal. The process can be repeated with different values to arrive at different attempts at an offer, thereby to find a value which maximizes the fulfillment level. Alternatively, the negotiator may use continuous variables instead of binary variables, carry out negotiation in a continuous domain, then transform a collection of such continuous variables into binary variables so that one of said binary variables is set to one and the remainder to zero.

As mentioned above, time information can often be significant in outcomes., and the platform therefore requires a way of measuring time that is directly applicable to the trade-off mathematics that has been described above. The party goal program unit therefore preferably represents date information as accumulated minutes from a threshold starting date, so that it takes on the characteristics of a continuous variable. The goal program unit is further operable to modify the dates relative to upper and lower bounds entered via the party input unit, in the same way as described for any other kind of variable.

The input unit further allows input of variables in association with given objective functions and allows setting of a linkage between the variables. The linkage preferably defines a trade-off relationship of deviations with respect to respective target values. The negotiator uses the series of variables, including a trade-off line or path, to carry out negotiation involving other variables to arrive at formation of an offer. This defines the first kind of trade-off referred to hereinabove.

The goal program unit may express the trade-off as separate deviation variables in respect of the first variable and in respect of the second variable. Preferably, the first variable is associated with a target and the second variable is not associated with a target. Therefore, the second variable is effectively assigned a dynamic target depending on the value assigned to the first variable and the trade-off line. This case is similar to the case of a variable having a target and is handled similarly. Preferably, the party goal program unit expresses the second variable as a function of the first variable in order to represent the linkage. The negotiator then uses the linkage to represent deviations from second variable target values in terms of deviations from the target value of the first variable. This refers to the second kind of trade-off referred to hereinabove.

The goal program unit may express the trade-off as separate deviation variables in respect of the first variable and in respect of the second variable. The separate deviation variables are preferably orthogonal, that is point in the direction of distinct decision variables. This refers to the third kind of trade-off referred to herein above.

Similarly, the goal program unit may express the trade-off associated with the fourth kind of trade-off referred to herein above.

The input unit preferably permits an association of a relative goal importance weighting to the trade-off, as for the previous examples.

In a possible embodiment, the party goal program unit calculates a relative importance level for the trade-off as an average of respective relative importance levels of the first and second variables.

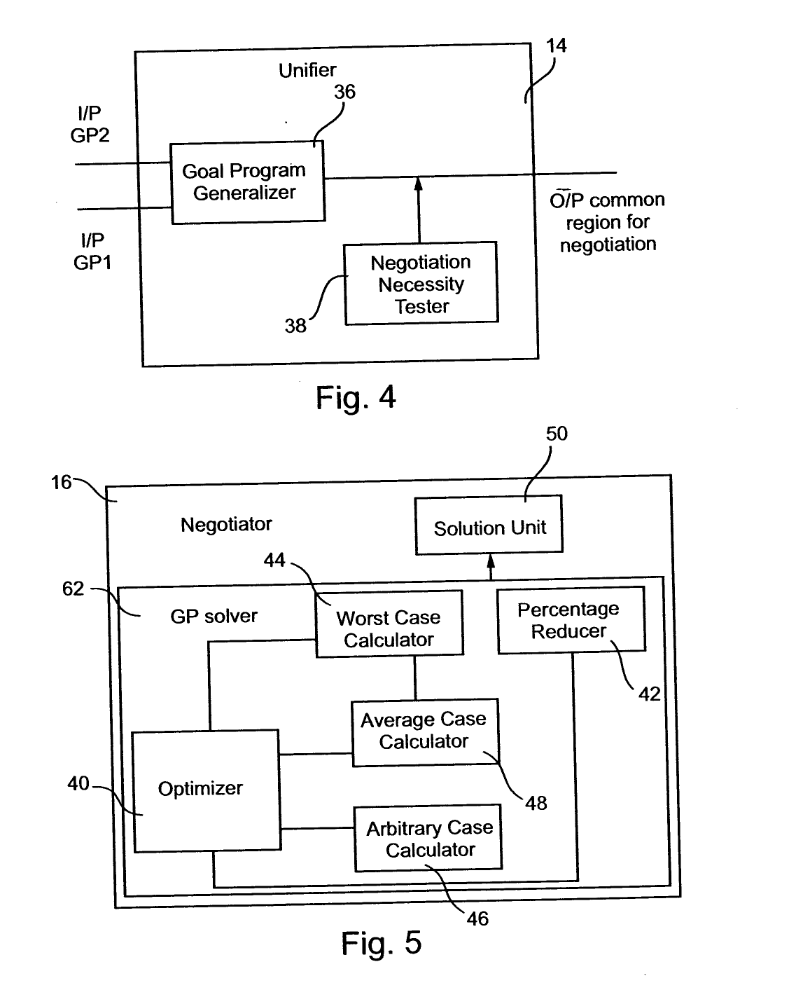

Reference is now made to FIG. 4 which is a simplified block diagram showing the unifier of FIG. 1 in greater detail. The unifier 14 comprises a goal program generalizer 36 to form a generalization of received goal programs for use in subsequent processing. The generalized goal program, otherwise referred to as a joint goal program, combines the constraints of both the local and opponent goal programs. Following the goal program generalizer 36 is a negotiation necessity tester 38, whose purpose is to determine whether any advantage can come to either party from negotiating, that is to say, it determines from the objective functions and constraints, whether there already is a solution of maximal advantage to both or each party. If there is then such is presented as the offer and there is no point entering into negotiations.

Preferably, the goal program unit translates the input received from the input unit into objective functions, and into constraints on the objective functions within the goal program.

Reference is now made to FIG. 5, which is a simplified diagram showing in greater detail a first part of the negotiator 16. The negotiator 16 has an optimizer 40 whose task is to find best values for the objective functions and constraints. The optimizer 40 then uses the best values to obtain a best solution for the local goal program, bearing in mind constraints of the opponent party, for output as a first offer. The optimizer 40 then iteratively produces further solutions, each possibly respectively worse from the point of view of the local party goal program until an offer is accepted. In the case where the opponent's goal program is known, the optimizer may produce improvements in the opponent's goal program with possible worsening of the local goal program, in order to form the successive offers.

The negotiator preferably further includes a percentage reducer 42 which is connected to the optimizer 40, and which serves to take offers, worsening them by a predetermined percentage, and therefrom to produce the additional offers.

In a preferred embodiment, the percentage reducer, which works level by level, can be set to take each of the variables within a level in turn according to orders of weighting within the level, until a solution is accepted.

The negotiator 16 preferably additionally comprises a worst case calculator 44 for determining a worst case level for individual objective functions and for the goal program as a whole, thereby to obtain a worst acceptable offer, the minimum acceptable to the local party. As will be discussed in more detail below, having a worst case offer acts as a boundary for a negotiation space against which movement between offers can be measured. For example it becomes possible to decide that each succeeding offer may approach the worst case boundary by a certain percentage of the space remaining.

If the opponent's goal program is known then the worst case calculator can calculate a worst case for the opponent to use as an opening offer in place of an optimization of the local goal program. Alternatively, a first offer can be calculated by generating the best objective function values for the local party within a level, modulo preserving the best values, then producing worst values for the opponent at said the same level. The method then proceeds to the next level and likewise obtains the modulo best for the local party and worst for the remote party, to be added to the data already established for levels of higher importance.

One or more of the goal program deviation variables may be arranged as pairwise bounded variables, that is to say variables covering alternative positions so that in any given offer one of them will be set to a value within certain bounds, and the other to zero. Thus for example one of the variables may be for negative deviation from a given point and the other for a positive deviation. The two variables are mutually exclusive so that in any attempt at a solution one of them has to be set to zero. The optimizer enforces such pairwise relationships between the pairs.

The negotiator 16 preferably additionally comprises an arbitrary case calculator 46 for taking one of each of the mutually exclusive pairwise bounded variables, setting it to an arbitrary value within its respective bounds, taking the other of the pair of variables and setting it to zero, and using the various arbitrary settings to arrive at different solutions.

The negotiator further comprises an average case calculator 48, also connected to the optimizer 40. The average case calculator takes the best solution and the worst solution, and the variable values that correspond to them, associates corresponding best and worst values together and finds an average. The goal program is then constrained towards the averages for each variable and an average solution is produced for the level currently being considered.

The average case calculator preferably makes use of the arrangement of variables and goals into levels of importance to process the variables level by level. Such level by level processing may be used to produce a series of iterative solutions to serve as offers.

In the above, constraining towards the average produces deviations from target values, as the average and the target values are not necessarily the same. It is therefore desirable to minimize the deviations, and this minimization is carried out using a weighting so that those variables which are more important are weighted more strongly, and therefore are less changed by the minimization, since their cost of minimization is greater; similarly, less important variables can more easily deviate from said average positions. In addition, the original objective functions are added in successive levels, for further optimization.

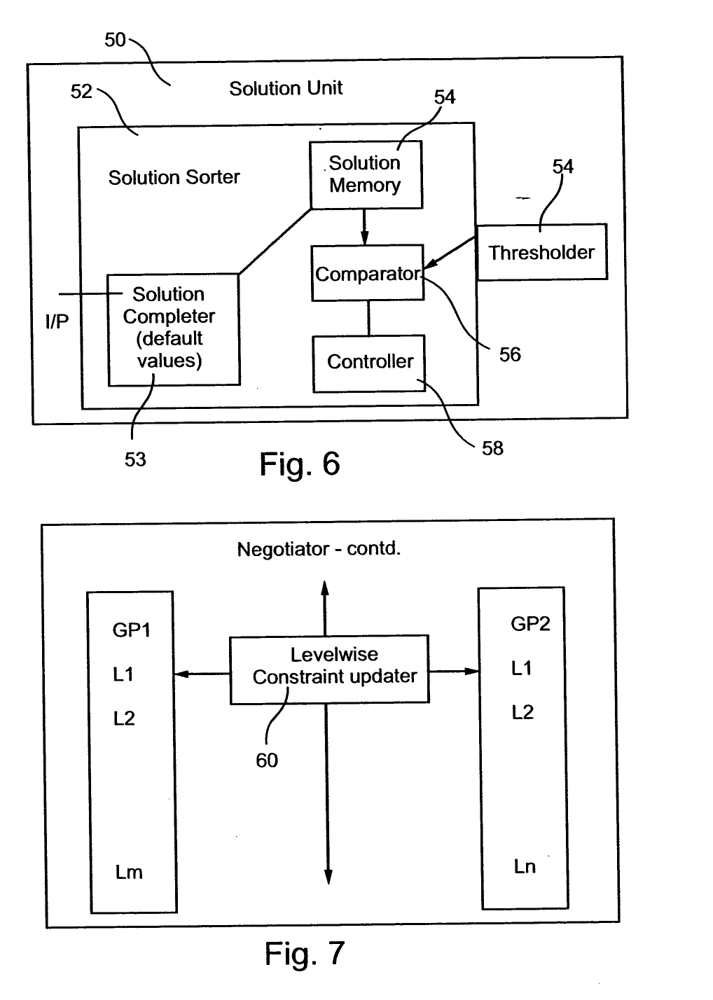

The negotiator further includes a solution unit 50 for applying strategy considerations to different goal program solutions produced using the optimizer 40. The strategy considerations are used in producing offers. The solution unit is shown in greater detail in FIG. 6, to which reference is now made. The solution unit comprises a solution sorter 52 which carries out a comparison between goal program solutions by solving the goal program for each one of a series of solutions (set of values provided using the optimizer) and then ranking the solutions using various strategic considerations, for example involving the opponent's latest offer and negotiation history in general. The negotiator 16 then uses the ranking to apply preferences to different solutions.

The solution unit 50 additionally includes a thresholder 54 which is connected to the solution sorter 52, and which applies a threshold to the evaluations. Any solution not meeting the threshold may be rejected as undesired.

Preferably, the solution sorter further comprises a solution completer 53 for applying best values to unspecified variables in incomplete solutions, thereby to allow the goal program to be evaluated for the incomplete solutions. The reason some of the solutions may be incomplete may be due to incomplete data received from the respective party.

Even if a default value generator is used as described above, the situation of an incomplete goal program may still arise for a number of reasons. For example, the situation behind the goal program may not be sufficiently well defined for the default value generator to help, or the lack of completeness may be due to the absence of something more complex than the simple lack of a target value, variable boundaries or weighting values.

Typically, the solution sorter 52 is set to find the best solution from the series by identifying the highest ranked solution and discarding the remaining solutions. In a preferred embodiment, the solution sorter 52 comprises a memory 54, which holds a certain number of solutions and is initialized in the obvious way. A comparator 56 compares any new solution with each solution in the memory 54, and a control unit 58 adds the new solution to the memory 54 if its evaluation is larger than any solution currently in the memory. In such a case the lowest ranked solution currently held is typically discarded.

Preferably, the input unit is able to accept user defined output values, that is variables in which the particular party desires a single output and is not interested in any negotiation in respect thereof. The goal program unit sets the output values as single value constraints and flags the constraints as unchangeable for subsequent processing. Thus for example a fisheries authority may use the system to negotiate fishing quotas for a particular type of fish and may be prepared to accept give and take on a wide variety of issues but is not prepared for any negotiation on a minimum net size. In such a case the minimum net size is selected as a user defined output variable.

User defined output variables acting on the goal program as a single value constraint can cause problems in finding any feasible solutions for the goal program. Preferably, the data input unit is therefore set to output an error indicator if one or more single value constraints render the goal program insoluble. In other cases the goal program may proceed to the unifier which may fail to find a common region of interest. Thus the user defined output variable is not something to be encouraged, but for the platform to be realistic it cannot be excluded.

As discussed above in respect of FIG. 5, the optimizer 40 finds best solutions to goal programs. The solutions give best values for the various objective functions of the local party's goal program by proceeding in a level by level process. The worst case calculator 44 finds worst solutions for the goal programs, and itself finds the worst values for the objective functions, level by level. The worst acceptable case can be calculated for the local party or for the opponent if his goal program is known. Either way the worst case is used in the same way, as a way of determining appropriate distances to move between offers, either towards the local party's worst case or away from an opponent's worst case.

Another way of using the worst case calculator is illustrated in FIG. 7, to which reference is now made. The negotiator 16 preferably uses the optimizer 40 and the worst case calculator in succession level by level between the goal programs to produce successive value sets or solutions for evaluation. From these successive best-worst sets, offers are made for the current level only. In each level, the objective functions of the current level, of both GP1 and GP2 as applicable, are considered. The platform only advances to a succeeding level once an offer is accepted at the previous level. However, subsequent levels may be taken into account during formulation of an offer for a current level.

The negotiator 16 preferably comprises a levelwise constraint updater 60 for updating constraints upon advance from one level to another level in accordance with the acceptance of the previous level. The accepted objective function values of the previous level are taken as constraints for the succeeding levels as far as is possible.

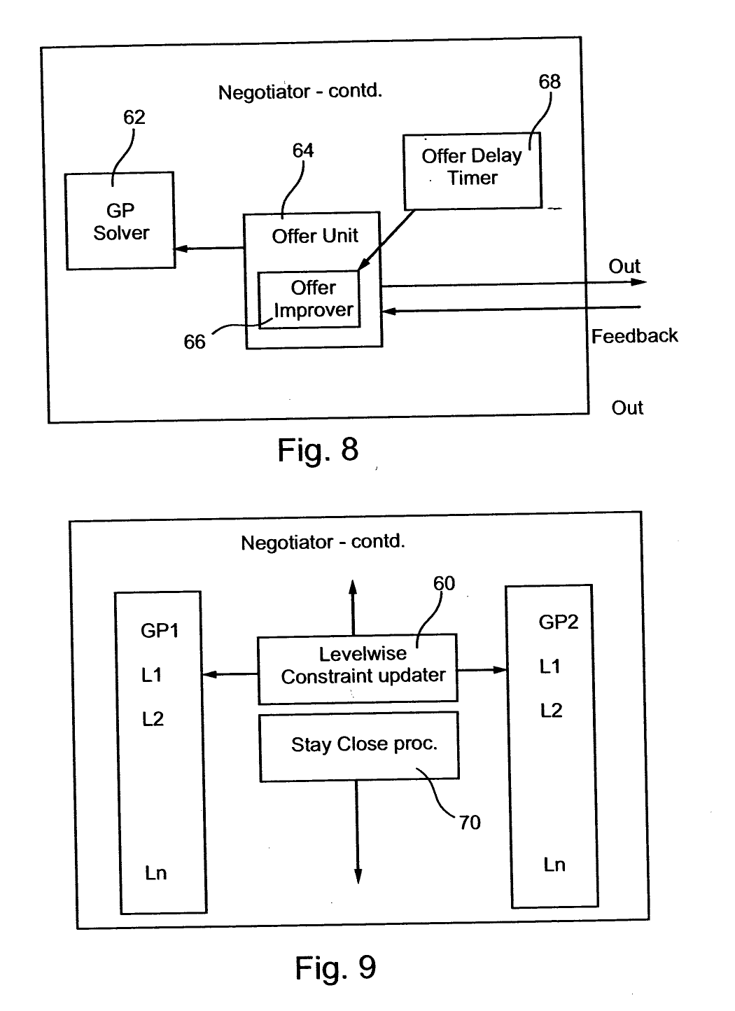

Reference is now made to FIG. 8 which is a simplified block diagram showing further features of the negotiator 16. In FIG. 8 the features involved in solving the goal program for optimum and worst cases etc. and subsequently selecting the solutions for formation into an offer are included as a single block 62 referred to as a GP solver. Thus it includes in particular the solution unit 50 and the levelwise constraint updater 60. The GP solver 62 is connected to an offer unit 64, which takes the selected solutions, generally a set of values, and formulates them into a meaningful offer for output to the parties. The local party may require to approve the offer before it is sent to the opponent and the opponent then may approve the offer or reject the offer or make a counter offer. Such approvals or rejections may involve direct human input, or that of a software agent, or that of some other computerized system. Either way, the opponent's input is accepted as feedback which is sent to an offer improver 66. The offer improver 66 preferably makes changes to selected ones of the variables to bring about an improvement in the evaluation of the opponent's goal program if known. If the opponent's goal program is not known then generally the best strategy is to worsen the evaluation of the local goal program, on the assumption that a local worsening implies an improvement for the opponent. A further strategy is to find a value that has been improved from the local party's point of view in an opponent's counter offer. Improvement by the opponent suggests that the opponent believes he is paying a price and thus suggests that the corresponding variable is a matter of importance. Another strategy is to do the exact opposite, that is to find a value that the opponent has not budged on in his last counter offer. Failure to budge may indicate that the value is important, and if the local party is prepared to be flexible then progress may be made.

An important question in offer improvements is what level of change to incorporate in successive offers. Negotiations can break down if either party perceives that progress is not being made. Likewise a party may be wary of showing weakness if it concedes too fast, and in any case is likely to get a raw deal if it makes concessions at a faster rate than the opponent. In one preferred embodiment a change between successive offers is a proportion of the difference between the previous offer and a best possible evaluation made for the opponent. Likewise it could be a proportion of the difference between the previous offer and the worst acceptable value for the local party, as has been referred to above.

In the case where the opponent's goal program is known and the offer improver 66 is being used to find improvements for the opponent's goal program, a problem arises that, because two goal programs are not symmetric, a modest improvement in the opponent's goal program may actually correspond to a drastic worsening of the local goal program. In order to mitigate against such an eventuality, the offer improver 66 may calculate what is known as a protection value. The protection value is typically used to set a limit to an allowable reduction in the evaluation of the local party's goal program over a single offer cycle as a consequence of improvements to the opponent's goal program evaluation. Protection coefficients may also apply to an aggregate of offer cycles.

Typically, the protection value is a proportion of the difference between a worst case evaluation of the local party's goal program and the previous evaluation.

In one strategy for successively improving offers, generally used when the opponent's goal program is not known, the offer improver 66 takes goal program values of a previous local party offer and one value in turn from a previous opponent offer. The opponent value is tested against local constraints, and, if it fits within the constraints, then it is substituted into the previous local party offer. The previous offer with the newly substituted opponent value is then submitted as an improved offer.

An oft-used tactic in negotiations is the use of time between offers. Experienced negotiators use time as a tool to intimidate opponents or to send a message to an opponent regarding the direction of negotiations or to give the impression that important and weighty factors have to be taken into account in considering a previous offer. The platform provides such a facility for negotiators via offer delay timer 68, which is programmable to set different kinds of delays between offers. It may set successively increasing delays, or the delays may change per changes in level, or a magnitude of the delay may be based on a relative change between succeeding opponent offers, or it may simply use user determined delays. Such user determined delays may be part of a user's supplied profile for the negotiation as a whole.

The use of offer timer 68 is discussed in detail below in the examples section.

Reference is now made to FIG. 9, which is a simplified block diagram showing a variation of the embodiment of FIG. 7. Parts that are the same as those in previous figures are given the same reference numerals and are not referred to again except as necessary for an understanding of the present embodiment. In the embodiment of FIG. 9, a stay close processor 70 determines variable improvement directions from monitoring of received offers from the opponent and carries out value perturbations in the directions that it finds that the opponent has been using.

The use of a stay close processor essentially mirrors the other party's moves and therefore is an appropriate strategy if the opponent's goal program is not known. Of course it cannot be used to make an initial offer since opponent movement directions are not yet available. A way of using a stay close processor in conjunction with level by level negotiating is as follows:

Firstly the optimizer is used to produce a first offer for a first level, since no directional data is available from the opponent. Subsequent offers are made via the stay close processor. This holds for both offers exchanged within a level as well as in moving to a subsequent level.

As before, advances from one level to another level are made only following acceptance by the parties of an offer regarding a previous level.

The stay close processor can be used in producing a first offer for each subsequent level.

As with FIG. 7, the constraint updater sets already agreed objective function values from previous levels as constraints for the later levels. In case the opponent's goal program is not known, the agreed values are only those for the party's own objective function values. In this case the parties may agree on values of some decision variables.

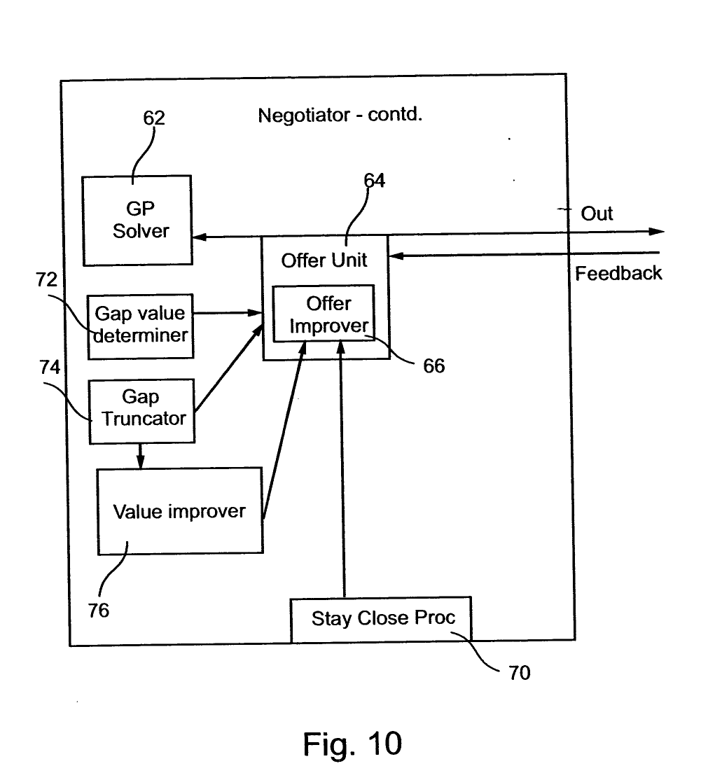

Reference is now made to FIG. 10, which is a simplified block diagram showing a variation of the embodiment of FIG. 8. Parts that are the same as those in previous figures are given the same reference numerals and are not referred to again except as necessary for an understanding of the present embodiment. In the embodiment of FIG. 10, a gap value determiner 72 is used to find a gap that can be used in subsequent offer improvement. A value improver 76 is connected to the gap value determiner 72, for inserting a proportion of the gap as a constraint into the goal program. Subsequent to and consequent on the evaluation of the goal program with the new constraint, the stay close processor 70, which is connected to the value improver 76, applies the gap proportion in the appropriate direction to provide an improved offer.

The stay close processor 70 monitors two successive opponent offers for value changes therebetween, and preferably assigns weights to the various changing variables. The weight is subsequently used in providing an improved offer. The stay close processor 70 preferably selects the magnitude of the weights in accordance with the amount of change applied by the opponent, so that the use of the weights provides a strategy for mirroring the opponent's activity in offer improvement.

Returning to the gap value determiner 72 and the gap used in each offer may be a fixed proportion of the gap for the entirety of the negotiation. That gap may be a difference between a best value and a worst value of the corresponding objective function. Alternatively, the gap may change between successive rounds. For example the gap may be the difference between the last local proposal and the last opponent proposal. The gap truncator 74 ensures that the resulting gap is not too large or too small.

Referring back to the negotiation necessity tester 38, which is part of the unifier, the negotiation necessity tester is preferably set to determine whether there lies an overall solution that includes both optimal solutions within the common ground of the two parties. If such a single solution exists then passing of the goal programs to the negotiator is preferably inhibited since there is nothing to be gained by negotiation.

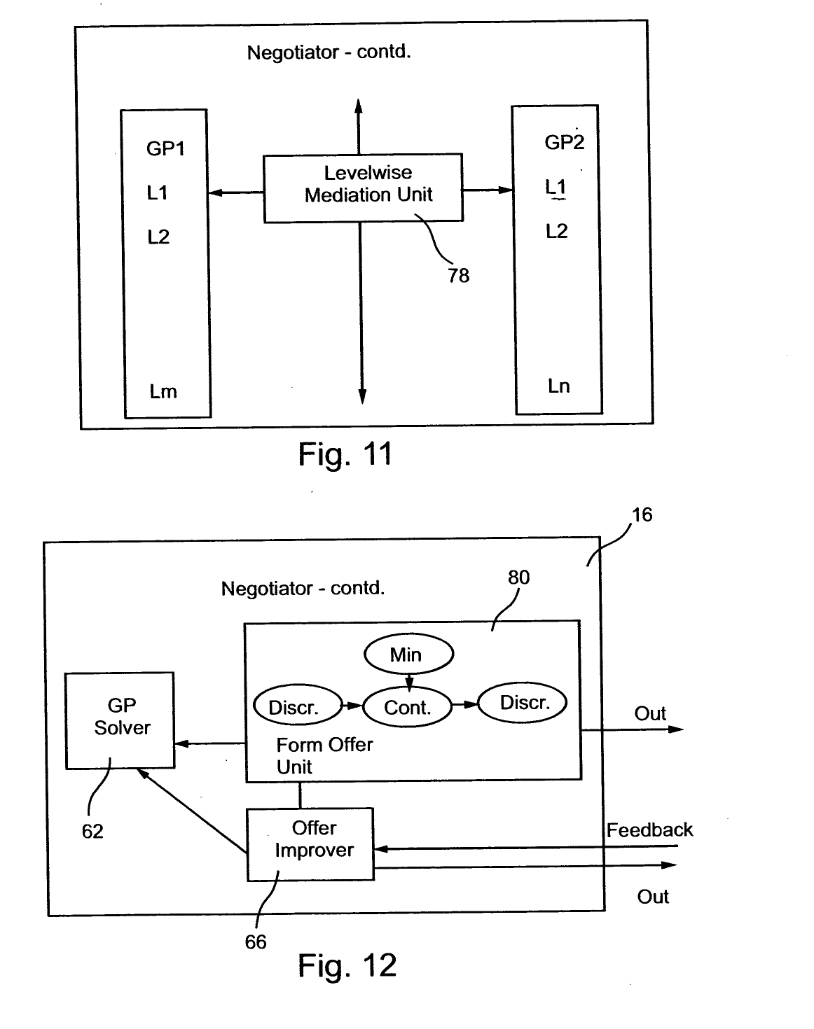

Reference is now made to FIG. 11, which is a simplified block diagram showing further details of the negotiator 16. Not always does negotiation succeed. Certain levels of the negotiations may prove intractable to the parties. The platform therefore preferably includes a mediation unit 78, which may be called by agreement between both (or all) parties upon failure to negotiate a given level during the negotiations. The mediation unit 78 retains agreed objectives of previously solved levels and applies a summation formula to solve a current level.

As discussed below in the examples section, a typical summation formula is

$$\{ \frac{\sum {w}_{kj}^{+} \cdot {δ}_{kj}^{+} + \sum {w}_{kj}^{-} \cdot {δ}_{kj}^{-}}{\sum {w}_{kj}^{+} + \sum {w}_{kj}^{-}} \} + \{ \frac{\sum {v}_{kj}^{+} \cdot {γ}_{kj}^{+} + \sum {v}_{kj}^{-} \cdot {γ}_{kj}^{-}}{\sum {v}_{kj}^{+} + \sum {v}_{kj}^{-}} \}$$

wherein k is a number of a current level, and each half of the summation represents the current level of a respective party. + and − represent respective sides of a target value, w and v are weightings for the respective parties, and γ and δ are respective parties deviation variables and j is a running index over deviation variables. As an alternative, the summation formula may be a median solution.

The mediation unit 78 may use a summation formula to provide a median solution between entire goal programs if the negotiation is not a level by level negotiation or if the negotiations are interminably stuck and level by level mediation is believed to be inadequate.

Reference is now made to FIG. 12, which is a simplified block diagram showing further details of the negotiator 16. As discussed above, each goal program is expressed as a series of objective functions related to decision variables typically having at least some of an upper bound, a lower bound, a target value or values or an indifference interval and one or more constraints. The platform preferably comprises a form offer unit for providing a form offer to the parties. The form offer unit provides a solution without negotiation but is not the same as the mediation unit. It can be used as a mediation unit in the event that negotiations reach an impasse or it can be used directly to make an offer to the parties in the event that the parties do not wish to negotiate. The form offer unit works by assigning to each of the goal programs a weighting such that the sum of the weightings is unity. It then calculates the offer by minimizing relative deviations for each variable over the goal programs for the assigned weightings. The form offer unit preferrably does not use the objective functions of the parties but rather forms a new overall single objective function that minimizes weighted deviations off targets of both parties, thereby producing a middle ground offer. The form offer unit is described in greater detail in the examples section.

The form offer unit preferably includes a discrete variable unit which can transform values of a discrete variable into a continuous domain, to carry out minimization in light of goal program objectives of the two parties. As discussed above, the discrete variables are evaluated in a continuous domain, and the minimization results are translated or transformed back to discrete values for presentation in the form offer.

The negotiator 16 may be used to provide a value for just one objective by comparing the single objective, from a local goal program, against the entirety of an opponent goal program. Such a procedure is useful in an auction type of situation where a single party offers something to a plurality of opponents and selects a winner, or winners as applicable. In general an auction situation is one in which one party acts against several opponents to choose a winner. The single party may be offering something or inviting tenders for supply of a product or service. Particularly in the latter case the auctioneer may have a relatively complex goal program, although typically most of the goal program consists of fixed values with only one or a small number of variables open for negotiation. A range of types of auction are discussed in detail in the examples section below, including the English auction, second price auction, and reverse auction or tendering.

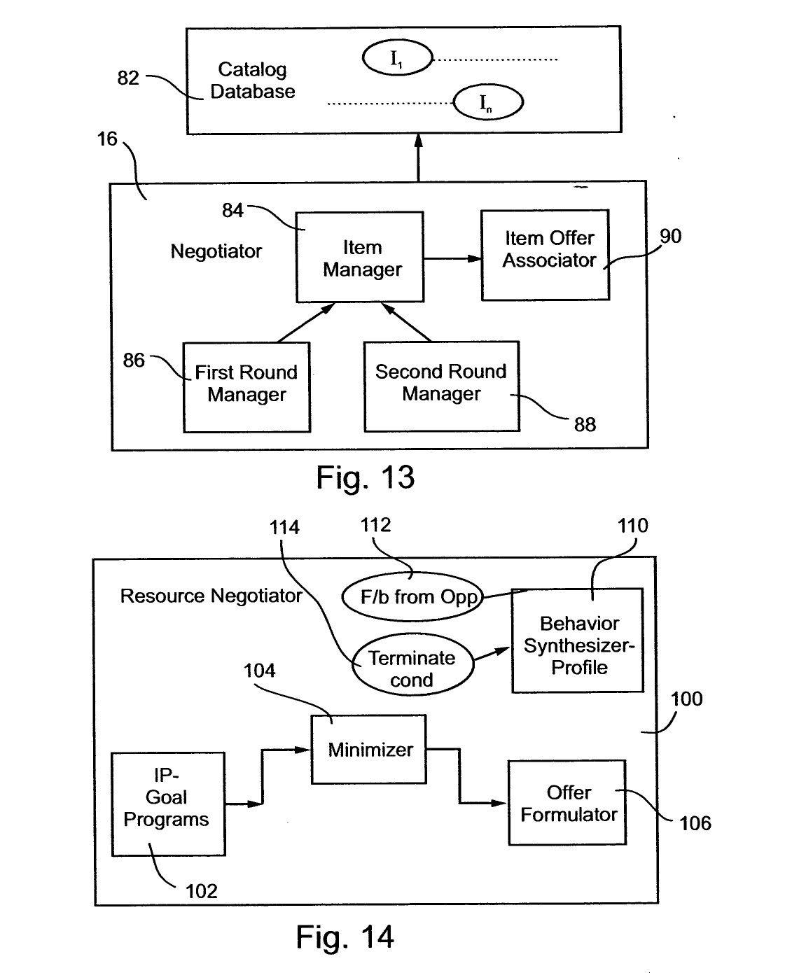

Reference is now made to FIG. 13, which is a simplified block diagram showing further details of the negotiator 16 for the specific application of matching a goal program of one party having a catalog of items, services, packages etc. and a second party who has a range of requirements that the party hopes will be met from available specific items within the catalog. The figure shows an item catalog database 82 for storing representations of the items for offer in the catalog. The items are represented in terms of values for variables in the objective functions of the corresponding goal programs, and in general, the negotiator deals with the items by solving goal programs as described above and then using the solution values to identify the nearest corresponding item in the catalog. The negotiator 16 includes an item manager 84 which continuously determines, during the negotiations, which of the catalog items are currently within the scope of negotiations, although it is stressed that negotiations are not at this stage carried out on the basis of individual catalog items but rather on the basis of goal program objectives and values as before, with matching to closest items carried out only later. As will be explained in more detail in the examples section below, such an approach reduces the computational complexity involved in finding a solution as well as the flexibility of negotiating as a whole.

A first round manager 86 is connected to the item manager 84, and manages the level by level goal program negotiation in respect of the catalog items by controlling the item manager to preferably successively reduce the number of catalog items within the scope of the current negotiations to a predetermined threshold number of items, or until no more items are available in which case the process reverts to items of the last previous step which is more applicable when dealing with purchasing multiple dependent items from one or more catalogs.

A second round manager 88 is also connected to the item manager 84, and manages level by level program negotiation to produce successive offers. The second round manager deals in terms of explicit items, rather than hypothetically assumed ones, as is done by the first round manager in the first round of offer formation (Alternatively, although the formation is with respect to hypothetical items, the presentation of an offer to the buyer is in terms of an actual item). An item associator 90, which is connected both to the second round manager and to the item manager 84, expresses the successive offers in terms of items that remain within the scope of the negotiations. That is to say that the party effectively is given a list of one or more items from the catalog, that answer to his preferences, to choose from.

In a preferred embodiment, the item manager 84 uses the goal program of the party selecting the item, rather than of the owner or constructor of the catalog, to measure distances from a target value. In a further preferred alternative, the item manager can measure distance from the target values in terms of a joint goal program.

Notwithstanding which goal program is used later on, the item manager 84 may begin by measuring distance in terms of a local goal program, to order the items within the catalog, and then iteratively to remove the most distant items.

In certain cases an objective of one of the parties may be compatibility with a second item. For example a party may wish to search a catalog, or catalogs, for a trailer compatible with a given car, or alternatively a party may wish to find a car that accords with a certain goal program, and which can also take a certain trailer. In such a case, compatibility is simply entered as one of the constraints in the goal program. Specialized algorithms, as described in the examples section, are used to process combinations of such items.

In a preferred embodiment of the invention, one or more of the objectives in the goal program can be related to a dynamic variable. That is to say a particular objective may relate to some kind of changing situation. For example a goal program for optimizing sea transportation routes may relate to the weather.

As well as the objectives themselves, some of the constraints may be associated with dynamically changing variables.

The unifier has been discussed above as providing the facility of finding a common area of interest in which to proceed with negotiations. Such a feature provides a certain amount of screening in that completely useless negotiations are not entered into. It is also possible to carry out a stage of prescreening based on parties business intentions, perhaps on the size of the common area of interest, in order to weed out parties less likely to produce a good outcome. Such a screening stage is preferably carried out when there exists a large number of parties for potential negotiation.

Reference is now made to FIG. 14, which is a simplified block diagram showing a resource negotiator 100 for making successive offers for usage of a resource with at least one remote party based on a goal program of a local party. The platform is the same as that described before except that in FIG. 14 the creation, unification and solution of goal programs is assumed and the figure relates to the use of the solutions in formulating offers. The goal program comprises objectives as before, the typical objective having a goal constraint with a target value, an upper bound, a lower bound and at least one constraint. The resource negotiator firstly comprises an input, IP-goal programs 102 for receiving data from the remote party, a minimizer 104 for producing successively worsening minimizations of the goal program, and an offer formulator 106, which is connected to the minimizer 104, and which is able to formulate minimizations into offers for resource usage. The offers may then be sent to the remote party.

Data from the remote party may be a goal program like any other, typically comprising a plurality of objectives, the objectives generally having goal constraints with a target value, an upper bound, a lower bound and one or more constraints. The resource negotiator further uses the minimizer 104 for producing successive improvements of the remote party goal program, by minimizing complementary variables as discussed above, for use together with the minimizations of the local goal program for formulating the offers.

The offer formulator may typically comprise a behavior synthesizer, profile 110 for governing offer formulation in accordance with a selectable behavior profile, for example, aggressive, co-operative etc.

The behavior profile may include an opponent offer feedback feature (F/b from opp) 112 which uses the extent to which an opponent's offers provide improvements, in order to choose how much to improve successive offers.

The feedback feature may use data from the opponent's offers to set time intervals for successive offer outputs. Thus small changes made by the opponent may be greeted by long waits or any other strategy deemed appropriate by the user may be set.

It is often necessary or desirable to break off negotiations at some stage, as a tactic or simply because of lack of progress. The behavior profile may therefore include a negotiation refusal condition unit 114 for breaking off negotiations when a predetermined condition is achieved. The condition set can be as simple or complex as desired, examples include a condition defining a predetermined number of opponent offers that fail a preset improvement threshold. Another possible refusal condition is a preset time interval during which the negotiation fails to reach a preset improvement threshold.

The minimizer may be associated with an offer acceptor which simply compares a current offer with a calculation, and any offer that is sufficiently close is accepted.

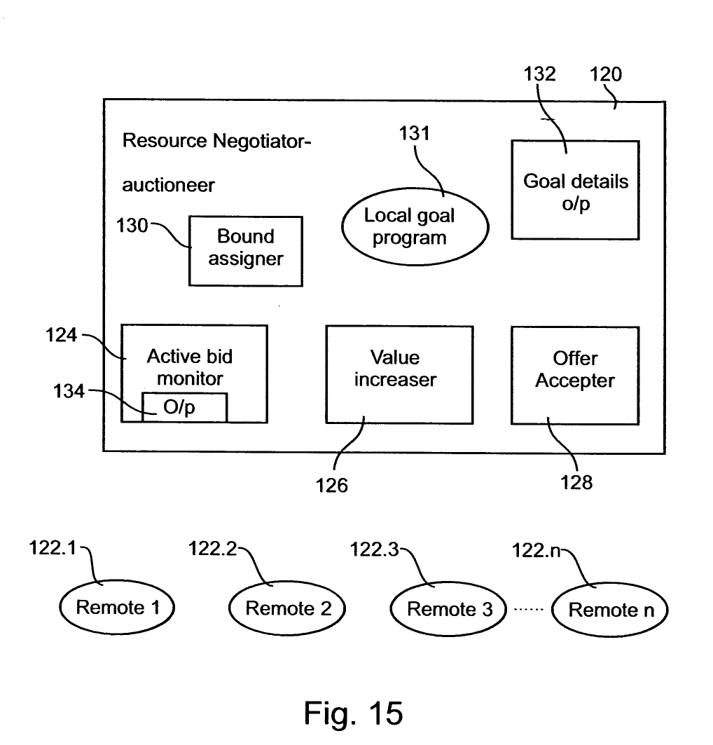

Reference is now made to FIG. 15, which is a simplified block diagram showing an embodiment of the resource negotiator specifically for an auction type situation (i.e., implementing an auctioneer), that is to say for a one to many negotiation situation, and in particular where just a single objective function is being negotiated. The resource negotiator 120 sends requirements to and receives offers from remote parties 122.1.122 . . . n. An active bid monitor 124 monitors the remote parties as they remain in the negotiations and follows them as they drop out.

A value increaser 126 successively decreases the numeric requirement of the objective, thereby increasing the goodness of required offers, as the negotiation proceeds. An offer acceptor 128, is connected to both the active bid monitor and the value increaser, and ends the negotiation when only a preset number, typically one, of remote parties remains active, and at the value of the objective at the time. The offer acceptor 128 may check that the final value is within some kind of bound of acceptability before accepting the offer.

A bound assigner 130 may be provided to calculate such a bound according to other objectives of a local party and its goal program.

Often, particularly in a reverse auction situation, it is desirable to send at least some of the details of the local goal program objectives to the remote parties. For this purpose there is provided a goal program details unit 132 which sends out selected local goal program objectives and associated constraints. The details can be used to enable the remote parties to evaluate potential offers in light thereof.

In certain cases, the method of successively raising the required deal value of remote parties may lead to a situation in which at one level there are two many active parties and at the following level there are too few. In such a case it is useful to be able to find an intermediate value and the value increaser preferably includes a facility for this.

The active bid monitor 124 optionally comprises an output unit o/p 134 for revealing to the remote parties how many other remote parties currently remain in the negotiations and their identities if applicable. The information may be used by the remote parties in various ways to support a negotiation strategy. Optionally, the output unit may reveal identities of the remaining parties.

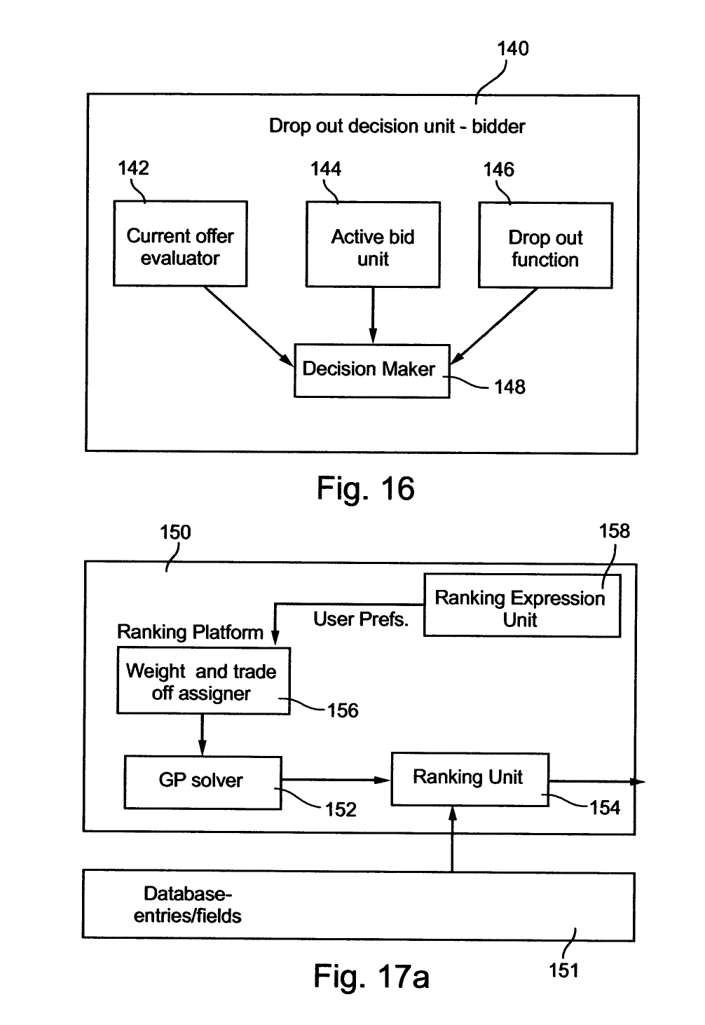

A feature of one-to-many type negotiations is the need to decide when to drop out of the negotiations. Reference is now made to FIG. 16, which is a simplified diagram showing a drop out decision unit 140 for use by the remote parties in a one-to-many negotiation.

The unit comprises a current offer evaluator 142 for expressing a current deal value in terms of the remote party's own goal program. There is no point continuing if the current value exceeds the constraints of the local goal program.

An active bid unit 144 stores the number (and identities if available) of remote parties remaining in the negotiations.

A drop out function 146 calculates a drop out probability as a function of the current deal value and the number of remote parties remaining in the negotiation, and for that matter any other available data that the user may choose to insert into the function. A decision maker 148 uses the drop out probability to decide whether to leave the negotiations.

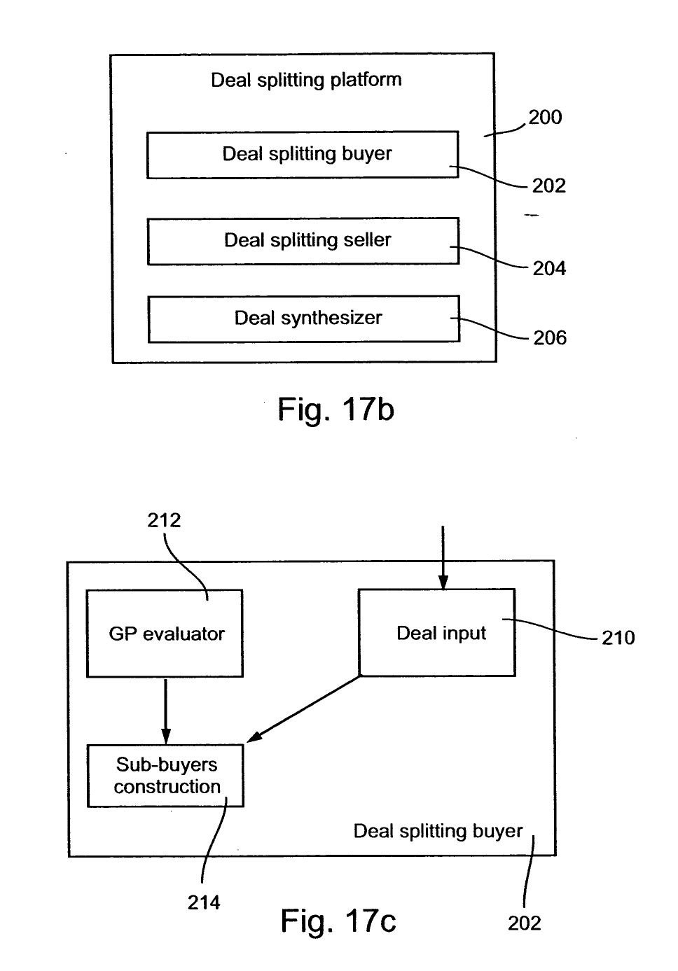

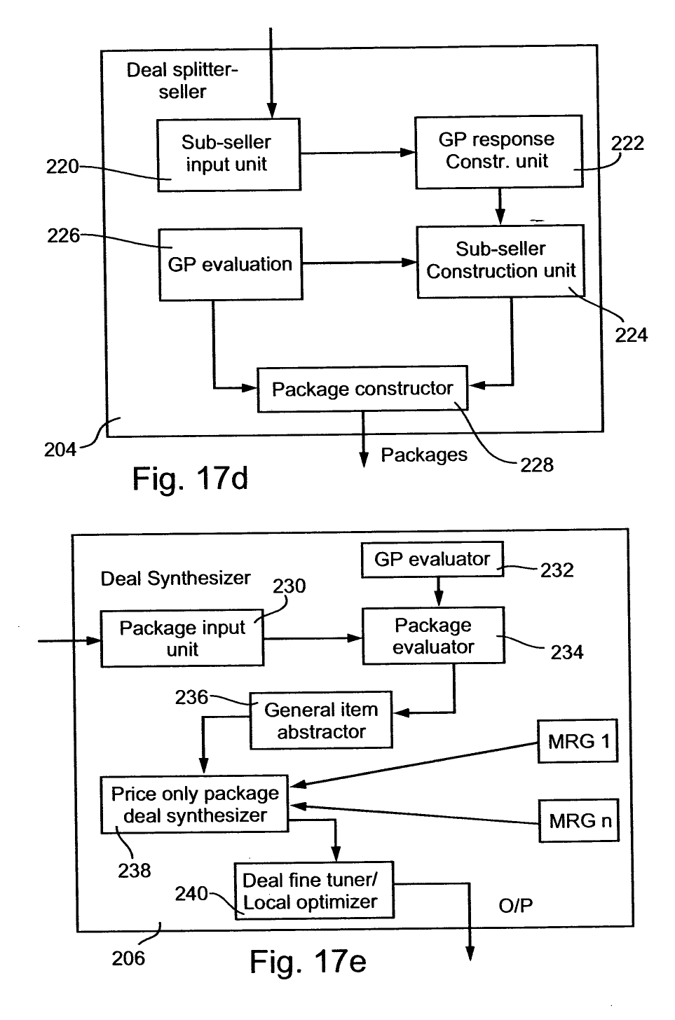

Reference is now made to FIG. 17A, which is a simplified block diagram showing a platform for performing ranking between database 151 entries which may be records or objects or other such entities. Preferably, each of the entries comprises a series of values arranged in fields, and goal programs are used to rank the entries, not in terms of a single field as is generally carried out at present, but rather on the basis of the goal program as a whole.

The platform comprises a GP solver unit 152 for taking values from the various fields, defining a trade-off relationship therebetween, and a ranking unit 154 that carries out ranking amongst the entries in accordance with a single objective function. Within equally ranked entries, a secondary ranking may be applied using another relationship, and so on.

The trade-off unit 156 may take the field values in twos, so that each trade-off value is a trade-off between two fields.

In the trade-off itself, a reduction in one variable may be traded for a proportional increase in a second variable, or any other suitable trade-off method may be used.

In another preferred embodiment, the trade-off unit may take values in groups of three or more. Generally, a goal program is formed from a series of required trade-offs and other constraints imposed by a user.

The trade-off unit may take the values in the various fields for the trade-off groups, and may for example compile a separate trade-off statement for each group, the collection of the statements comprising some or the entire goal program. Such statements may form the core of extending standard databases such as SQL or spreadsheet based ones. The trade-off statement may include a deviation over the trade-off or goal in the group from a target value. The trade-off statement may comprise compatible variables. Overall ranking is then achieved by the ranking unit by using a weighted average of the deviations for each trade-off statement. Thus, once again, ranking itself is achieved using a single value.

The trade-off relationship may be expressed in terms of an inequality between corresponding values of successive entries The trade-off unit 152 may also include a weight assigner 156 for assigning weights to fields. The trade-off relationship comprises assignment of a weight to each of the fields using the weight and trade-off assigner 156. The weight may be used in weight summation over each of the entries.

The weight assigner 156 preferably comprises a user preference input unit which allows the user to define preferences between the fields. The weight assigner 156 may then select weights for assignment to the fields in such a way as to enforce the user-defined preference.

The weight selection is preferably such as to maximize the expression of user-defined preferences.

The fields themselves may be ordered preferentially, in which case the weight assigner may assign weights according to the position of the field.

The weight assigner includes a user input unit for receiving a parameter defining a number of entrie's of high desirability from the start of an ordered list, and the weight assigner may select weights to reinforce the desirability, in the same way as was discussed above regarding arbitrary user preferences. In this capacity, the weight assigner is operable as a ranking expression synthesizer.

The platform may additionally include a ranking expression unit 158 which is able to provide an expression basis for defining different types of ranking condition, for example a condition, a deviation, a deviation condition, a constraint, a simple trade-off relationship, a complex trade-off relationship, a preferred value within a range, a preferred range, a weighting. The expressions are combined by the user to form one or more objective functions for use in ranking.

Reference is now made to FIG. 17B which is a simplified block diagram showing a a deal partitioner or deal allocator, whose purpose is to partition a desired purchasing deal by a buyer into sub-deals with possibly multiple sellers, that together strive to fulfill the buyer's needs. In some sense this is the opposite of the embodiment of FIG. 13. Either several resources are available from several sources or different resources are available from different sources. The deal partitioner comprises a deal splitting platform 200 for supporting deal allocation and includes a deal splitting buyer unit 202 which sets up the buyer position for deal partitioning. A deal splitting seller unit 204 is controlled by the seller to set up the various seller positions. A deal synthesizer 206 then takes input from both the buyer and seller units and synthesizes a deal matching up buyer requirements with resource availability in a preferably optimal manner.

The deal partitioner is preferably able to treat several cases of buyer's desired deals:

a deal in which a single item type is desired (in a certain quantity).

a deal in which several item types are desired (each in a certain quantity)

a deal in which certain item combinations need be supplied by the same supplier, called generalized items. For example, a computer-station which includes a CPU unit, a keyboard, a mouse, a printer and two screen units.

a deal in which the buyer's preferences, aside from quantities, are expressed using a goal program.

Sellers preferably have price tables for item(s) indicating prices per quantity ranges. Additionally or alternatively, sellers may have multi-item price tables, such that a seller is composed of sub-sellers. A sub-seller offers a collection of items, each with its own quantity range and price per unit, that must be bought together. In the following a distinction is made between sellers that can provide any number of items or item combinations (unbounded sellers) and those that can only supply limited amounts (bounded sellers).

As will be discussed below in the examples section, optimal partitioning algorithms, and heuristic approximation algorithms are provided, as well as combinatorial optimization approximation schemes in which a bounded deviation from an optimum solution is guaranteed.

The heuristic multi-item price-based deal partitioning algorithm (MRG) is generalized to the case where instead of money (e.g., Dollars) cost is measured in objective function values of a goal program (the buyer's) and a package “price” is calculated based on the buyer's goal program and the quantities involved in each package as well as the quantities desired. The complete algorithm involves representing a buyer as a collection of ‘splitted’ sub-buyers and representing a seller as a collection of sub-sellers. Splitting the buyer, which uses quantity ranges, into sub-buyers enable to present available deals, each designed to fulfill the original deal, specifying distinct quantities. Each sub-seller, in turn, is being associated with a seller goal program and a collection of explicit packages with specific quantities (rather than ranges). The complete algorithm also takes into account the total number of available (for sale) items of each kind that each seller has. The complete alsorithm also handles generalized items.

Reference is now made to FIG. 17C, which is a simplified block diagram showing in greater detail the buyer 202 unit. The buyer unit comprises a deal input unit 210 for allowing a user to input data regarding resources or the like that are required. A GP evaluator 212 allows goal programs to be evaluated and a sub-buyers construction unit 214 allows the construction of a desired number of sub-buyers, having explicit quantities rather than ranges. The evaluation is measured by availabilty, cost and the like, cost not necessarily being expressed in terms of a single variable but preferably rather in the form of a goal program so that numerous factors may be taken into account in assessing an overall cost.

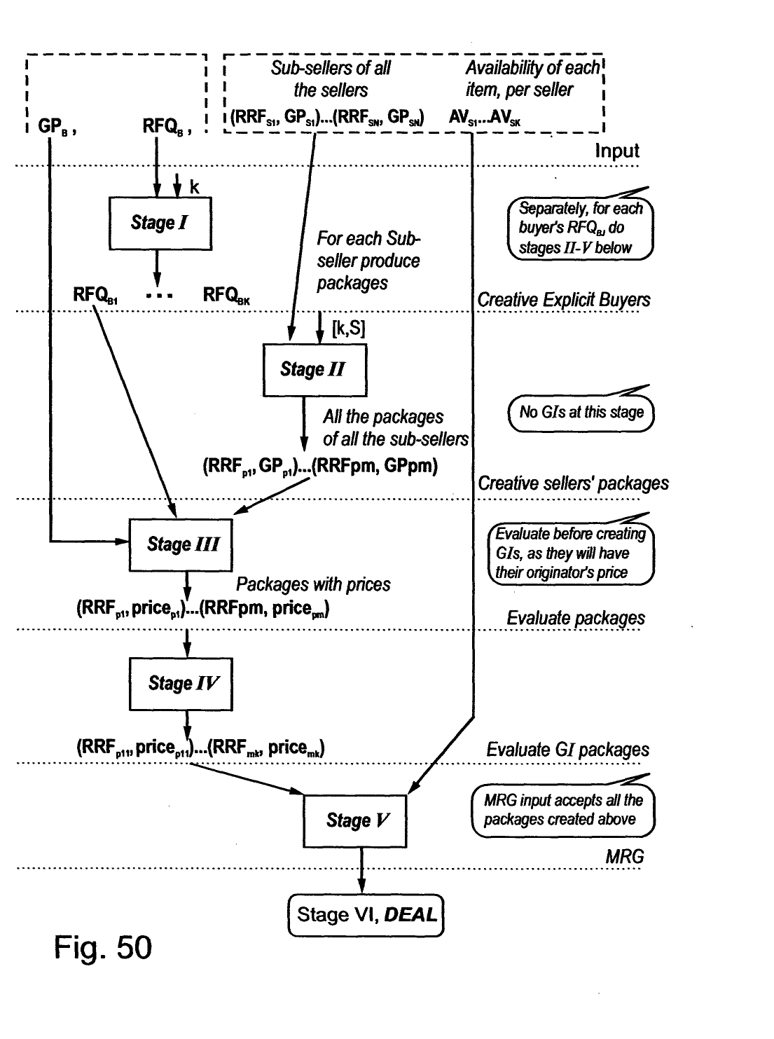

Reference is now made to FIG. 17D, which is a simplified diagram showing in greater detail the seller deal splitting unit 204 of FIG. 17B. The seller unit comprises a sub-seller input unit 220 which is connected to a GP response construction unit 222. The GP response constr. unit 222 is in turn connected to a sub-seller construction unit 224 which additionally receives data from a GP evaluator 226. The output of the sub-seller construction unit is passed to a package constructor 228 which also receives evaluation data from the GP evaluator 226. The output of the package constructor 228 is a series of packages for input to the deal synthesizer 206. Operation of the deal splitter seller 204 is explained in the examples section, particularly with respect to FIG. 50.

Reference is now made to FIG. 17E, which is a simplified diagram showing in greater detail the deal synthesizer 206 of FIG. 17B. The deal synthesizer 206 receives as input the packages from the various deal splitter sellers 204 at package input unit 230. The packages are evaluated at package evaluator 234 using GP evaluator 232. A general item abstractor 236 carries out abstraction as will be described below with respect to FIG. 50 and then a price only package deal synthesizer 238 uses one of a series of algorithms to find the best combination of packages to suit the buyer's request. It is known in the prior art to carry out such optimizations using a single value such as price. The present embodiments replace the price with a goal program evaluation figure which is obtained by the GP evaluator, and thus, whilst essentially going through the same optimization procedure, manage to take into account multiple variables, constraints, trade-offs and preferences. The algorithms however, perform their evaluation on a single number. The precise algorithm used may depend on whether the number of sellers, or items required is limited, whether different types of items are required etc. as explained below in the examples section.

The package deal synthesizer is followed by a deal fine tuner/local optimizer which makes obvious corrections to the output to ensure deal quality.

### EXAMPLES

The examples section explains in greater detail, implementations of the above embodiments. These examples cover:

1. Automated and semi-automated negotiation platforms

2. Auctions and reverse auctions

3. Ranking and selection of alternatives

4. Construction and adaptation of business intentions, and

5. Deal splitting techniques.

The basic building block is a “Deal” which is composed of “Deal components”, constraints, preferences and trade-offs. The deal components are given as a hierarchy of items (and sub-items) along with their attributes. The constraints represent real-world limitations and restrictions that must be adhered to while preferences indicate attribute values (or directions) that are more desired than others. Trade-offs are used to express situations in which decision makers are willing to change certain attribute values (thus giving up some benefits that are associated with these values) if other values are changed to compensate them for the lost benefit.

Deals are defined by users of the platform either through some user interface or through an Application Program Interface (API). The system then compiles the Deals into “Business Intentions”. Each business intention contains a structure in which the various elements of the deal are expressed through mathematical terms and a “Goal Program”—an instance of the mathematical programming methodology that lies at the core of our system. The structure of the business intentions can be given in terms of trees where each node corresponds to an attribute of the deal. Goal programs are explained next.

The examples are organized as follows. The next section explains the basic terminology of E-contracts and the section that follows describes the concepts of goal programming. Section 1 describes the compilation techniques in the system; Section 2 presents the basic utilities (mostly variants of goal programs) that are used for mathematical manipulation of the business intentions; Section 3 discusses the special case of purchasing items from catalogs; Section 4 reviews the mechanisms that are used to express the negotiation tactics and strategies of the users and how they operate; Section 5 addresses the techniques we use to search, retrieve and rank information components that are stored in databases and Section 6 provides the details of deal-splitting techniques.

E-Contract Terminology

We briefly review some of the terminology of E-contracts used in a previous patent application IL00/00516, the contents of which are hereby incorporated by reference. Business Intentions are made of components. Components may be atomic or compound (to any required depth). Components may also be inter-related (e.g., by containment, by edge or labeled-edge connection, or by arbitrary predicates). An important facet of a variable component is its possible association with one or more computational devices, although one-to-one association of a variable component with a computational device is particularly preferred, and is described herein. Such a computational device, based on its perceived state and messages, transforms a variable component into a component. The term “perceived state” is intended to include inputs, values of various components, values of certain other entities such as files, databases and the like. The “new” component is usually “more specific” than the variable component it replaces. Variable components and their associated computational devices embody transient or policy dependent aspects of the willingness to engage in a deal.

Forming an agreement, or negotiating a contract, requires the reconciliation of the constraints placed on deals by the (two or more) parties involved. Reconciliation involves forming an agreement or a contract, which, as much as possible, is subject to the directives of the parties, as well as to any general laws, which may apply. When examining two intentions, the process of reconciling the constraints may be considered to be a form of “fitting” to these constraints. Abstractly, this process fits the component structure of one party with the corresponding components of the other party.

In E-contracts, a component is represented as a rooted labeled tree. In fact, an intention is also a rooted labeled tree, which is composed of components, together with various constraints and computational devices. The most basic components are simple atomic entities, e.g., of type integer, float, string, etc. Next are basic components that are essentially (usually small) trees whose structure is agreed upon to represent a concept (e.g. car, sale, address). These basic components are called classes and they form the “words” of the common language. The word “class” hints at the fact that in an object oriented realization, these components are likely to be represented as object oriented classes, although the present invention is not limited to such a representation. A component may be a variable component. In this case it appears as a single node labeled with a typed variable. Such a type may be atomic, atomic list, class or list of classes. Such a variable component cannot exist in isolation but must be a leaf of a class.

Using classes, the parties compose their intentions, essentially forming “sentences” which in turn define possible deals. As noted, the purpose of an intention is to describe a deal that a party is willing to engage in. In E-contracts, the mechanism that composes words into sentences, or classes into intentions, relies on “variable instantiation” and the introduction of “operator nodes”. A (leaf) variable component of an intention is optionally and preferably associated with a computation device, called a “commerce automaton” (CA) in this realization, which prescribes how the variable may be instantiated further during a later phase. A commerce automaton may outline a message exchange sequence between the parties. However, it should be noted that a commerce automaton is only one realization of a device or entity for exchanging messages between the parties and other realizations are possible as well. In addition to intentions, an e-commerce party also maintains party information, a database or file containing information relevant to the party's activities. This is part of the “system state”.

A deal is manifested by creating a mutually agreed upon electronic contract (E-contract). The process of obtaining an E-contract begins with two initial intentions, presented by the parties. A formal process, called unification, a part of the realization of “fitting”, is used to construct an agreed upon E-contract, provided such a contract is feasible. An e-commerce party may use unification to determine whether an E-contract is at all possible, prior to entering actual negotiations.

Goal Programming Models

Goal programming (GP) is an Operations Research methodology that was first proposed by Charnes and Copper in 1961 and has since proliferated into many research and application sub-areas. The GP methodology was inspired in part by the concept of “Satisficing” coined by Nobel Prize laureate Herb Simon—a term that refers to a combination of satisfying some objectives or constraints while sacrificing others. The basic idea of GP is that it is rather common to find constraints that are not stringent and many times decision makers are willing to accept an achievement level that is not exactly what they prefer most if they perceive that by this sacrifice they were able to satisfy other objectives or constraints. GP is an especially useful technique when users have multiple, and sometimes conflicting, objectives. GP provides two basic techniques for goal specification: prioritization and weighting (per priority level). Using these tools a user can indicate the relative importance of constraints, preferences and goals. In the GP literature prioritization is known as Lexicographic Goal Program (LGP) and weighting is referred to Weighted Goal Program (WGP). The main difference between these two techniques is in the formulation of the objective function. In WGP the objective is to minimize a weighted sum of deviations fro targets while in LGP the objective is structured as a hierarchy of levels where in each level there is a weighted sum of deviations. The program minimizes the first level; then it assigns the value obtained for the first level as a hard constraint and solves level 2; then it assigns the values obtained for both level 1 and 2 as hard constraints and solves level 3 and so on. LGP is our method of choice and we use it to express and manipulate deals in our contract management and negotiation system.

In our context, the general idea is to use the GP technique to represent the constraints and preferences of a deal. We shall first discuss how constituent elements are handled, then proceed to a simple intention, and finally expand on more complex intentions.

The general form of a GP program is as follows:

lexicographically_minimize {Expression 1, . . . , Expression m} such that for i=1, . . . , k we have goal constraints, gᵢ, of the form:

cᵢX+(Dᵢ⁻)≧tᵢ, or

cᵢX−(Dᵢ⁺)≦tᵢ, or

cᵢX+(Dᵢ⁻)−(Dᵢ⁺)=tᵢ, and, in addition we have the constraint that

all Dᵢ's≧0, and, optionally,

some Dᵢ's=o (indicating hard constraints)

The Dᵢ variables are called deviation variables; those of the form (Dᵢ⁺) indicate an amount by which a goal is exceeded (“overshooting”), whereas those of the form (Dᵢ⁻) indicate under-achievement of goals. The Expression j's are called minimization expressions. The term lexicographically minimize (lexmin for short) implies an order on minimization, where the results of the Dᵢ's, of minimizing up to Expression i are used as values in Expression i+1, . . . , Expression m. So, the lower index expressions have a higher priority. Each Expression may refer to decision variables (X's), to deviation and other variables and to weights. Note that one may enforce hard constraints is by setting some deviation variables to zero. For example, to enforce a ≧ type constraint one may set (Dᵢ⁻)=0.

Here is an example of a simple LGP, taken from reference [2].

Minimize: Priority 1((D₁⁻)+(D₂⁻)+(D₃⁺)) Priority 2(D₄⁺) Priority 3(D₅⁻).

X₁+X₂+(D₁⁻)−(D₁⁺)=30

X₃+X₄+(D₂⁻)−(D₂)=30

3X₁+2X₃+(D₃⁻)−(D₃⁺)=120

3X₂+2X₄+(D₄⁻)−(D₄⁺)=20

10X₁+9X₂+8X₃+7X₄+(D₅⁻)−(D₅⁺)=800

Xₕ, (Dᵢ⁻), (Dᵢ⁺)≧0 i=1, . . . , 5, h=1, . . . , 4

We now explain how to transform the user's specifications into a GP. Then, we shall explain how to use such programs during negotiations.

1. Variables:

Variables are associated with atomic valued intention nodes. Variables are typed. The type may be integer or float. Variables may also be associated with discrete values as follows. Consider a variable that is associated with a color, which may be red, green, blue or yellow. Each color is associated with a value, e.g., red=1, green=2, blue=3 and yellow=4.

An important idea is that each variable is associated with a default interval. This interval is used for choosing default values. It also makes all variables range-bounded. The default interval may be a single point or a collection of ranges of values. Default values are also used when the constraints are not satisfied with the current set of variable assignments (this is an alternative to backtracking). Default intervals may be user specified or be derived from a database. A default interval is considered a hard constraint and is added to the other constraints. Choosing a value from a default interval may be done in a number of ways: minimize, maximize, percentage off maximum, average, random, etc.

2. Hard Constraints:

A hard constraint involving ‘<’ or ‘>’ is transformed into a hard constraint involving ‘≦’ or ‘≧’, respectively, by subtracting (respectively, adding) a small quantity. A hard constraint, of the form expression θ value, is compiled into expression+(D−)−(D+)=value Depending on hardness, we may add constraints (D+)=0 for θ=‘≦’ or (D−)=0 for θ=‘≧’ and (D−)=(D+)=0 for θ=‘=’. If hardness is more “limited” we may add a goal to minimize, of the highest priority, whose content is (D−)+(D+). The understanding is that at the highest priority minimization expression should evaluate to zero. Alternatively, we may simply derive a goal of the form LARGE*(D−), or LARGE*(D+) or LARGE*(D−)+LARGE*(D+) and treat it according to its weight. This latter form increases feasibility of a solution. Here LARGE is a sufficiently large value in the domain considered.

3. Soft Constraints:

A soft constraint of the form expression θ value is compiled into

expression+(D−)−(D+)=value.

For example, consider the constraint soft (Qty=20). It is compiled into

Qty+(D1−)−(D1+)=20,

Here, again, we use deviation variables. In fact, such constraints express preferences, namely being close to the target. In case a deviation in the direction (D1−) is, say, four times as undesirable as a deviation in the direction (D1+), then:

Case 1: The soft constraint is assigned a priority and it is the only one at its priority level. This means we should minimize 4(D1−)+(D1+).

Case 2: Otherwise, we need to normalize this constraint so that we can compare it to other constraints. We use the idea of percentage deviation where the percentages are based either on the target value (as demonstrated below) or on the range of permissible values for the relevant attribute (as we show later in Chapter 1).

1. Define (Dp1+)=(D1+)/target and (Dp1−)=(D1−)/target.

2. What we minimize is the expression minimize (A*(Dp1−)+(1−A)*(Dp1+), [0≦A≦1] e.g., minimize (0.80*(Dp1−)+0.20*(Dp1+)).

3. If, in addition, the overall weight of this soft constraint is W, then this value is associated with the most undesirable deviation and the weight for all other deviations are smaller than or equal to W. For example, we may solve the expression minimize W*(Dp1−)+0.20*W*(Dp1+) when negative deviations are considered 5 times as important as positive deviations.

Now consider a constraint of the form expression ≦ value. It is compiled as above into:

expression+(D−)−(D+)=value.

Here the goal to minimize is W*(Dp1+), where W and (Dp1+) are as above. The cases of θ=‘≧’, ‘>’, ‘<’ are handled similarly.

4. Preferences:

We allow minimization (min) or maximization (max) preferences on functions, e.g., min 2*X+5*Y. We can also give such preference a weight, indicating its importance. For example (W1 is the weight): W1: minimize: 2*X+5*Y.

This preference is compiled as follows. First, an “optimistic” yet “reasonable” target for the minimization is determined (by using default intervals, user specification or solving a simplified linear program). For example, if a reasonably optimistic small value for the above expression is 100, the preference is restated as the soft constraint: W1: 2*X+5*Y<100.

From this point on, it is treated as an ordinary soft constraint. As stated, the value, 100 in the example may be determined by using another linear program with the minimization objective as the only objective.

Preferences can also be applied to variables corresponding to discrete values. For example, suppose we prefer red, green, blue and yellow in that order. Further, suppose we rate our preferences on a scale from 1 to 100. We can model this using the soft constraints:

100: Color=1

50: Color=2

20: Color=3

20: Color=4

We also add the hard constraints:

Color≧1

Color≦4

integer(Color)

This formulation of soft constraints will favor the more preferred targets.

Recall that in general we have a number of preferences, each translated into a soft constraint, say P₀, . . . , Pₖ. These, and the “original”, soft constraints are partitioned into a number of priority levels. Priority levels are handled one by one using lexicographic minimization. Conceptually, the results of minimization at level i, that is, minimization expressions of higher priority, are inserted as constraints in the minimization at level i+1. Consider again the program in the example above. If we solve it using a linear programming package, we first present the highest-level linear program:

Minimize: (Expression of Priority 1) ((D1⁻)+(D2⁻)+(D3⁺))

X1+X2+(D1⁻)−(D1⁺)=30

X3+X4+(D2⁻)−(D2⁺)=30

3X1+2X3+(D3⁻)−(D3⁺)=120

X1, X2, X3, (D1⁻), (D1⁺), (D2⁻), (D2⁺), (D3⁻), (D3⁺)≧0

(D1⁻), (D1⁺), (D2⁻), (D2⁺)≦30

(D3⁻), (D3⁺)≦120

Solving, we discover that the result is ((D1⁻)+(D2⁻)+(D3⁺))=0. We therefore form the next level linear program as:

Minimize: (Expression of Priority 2) 1(D4⁺)

X1+X2+(D1⁻)−(D1⁺)=30

X3+X4+(D2⁻)−(D2⁺)=30

3X1+2X3+(D3⁻)−(D3⁺)=120

((D1⁻)+(D2⁻)+(D3⁺))=0 This is the “newlyfed” constraint.)

3X2+2X4+(D4⁻)−(D4⁺)=20

X1, X2, X3, X4, (D1⁻), (D1⁺), (D2⁻), (D2⁺), (D3⁻), (D3⁺), (D4⁻), (D4⁺)>0

(D1⁻), (D1⁺), (D2⁻), (D2⁺)<30

(D3⁻), (D3⁺)<120

(D4⁻), (D4⁺)<20

The solution turns out to be (D4⁺)=10. This is “fed” into yet one more (f) linear program that optimizes 10X1+9X2+8X3+7X4.

The remaining issue is how to compile a single priority level.

There are two basic methods for compiling objective levels, we generally use Method 1 and for the sake of completeness mention Method 2 as a possibility.

Method 1: All the soft constraints within a priority level are compiled into a single expression to be minimized, by summing up the individual minimization expressions compiled for each soft constraint in isolation.

Method 2: Use the min-max [8] idea of treating each soft constraint in isolation and then bounding the maximum deviation on any particular soft constraint. Assume we have a total of K minimization expressions corresponding to K soft constraints at priority level j. This is compiled into an overall minimization objective for level j:

min Q

expression part of minimization expression 1≦Q

expression part of minimization expression K≦Q

Observe that the result will tend to minimize more the important soft constraints, that is, those with larger weights. The advantage in min-max is more flexibility and minimization of missed goals. Observe that each minimization expression is already percentage-wise and weight-wise normalized. There are advantages and disadvantages to each method. We can preferably run the user's intention in parallel in two versions, one using Method 1 and one using Method 2. We can also decide on Method i (i=1 or i=2) as default and allow the user to change it for a particular run.

Compilation Techniques

Introduction

This part of the examples section details the compilation techniques that are used to translate the user's inputs into a goal-programming (GP) model (see Ref. 1-5). The compilation techniques are geared to cover all the compilation aspects in a way that isolates the user interface from other system layers.

The overall conceptual architecture is as follows. Business intentions, i.e., deals, are specified either through a graphical user interface (GUI) layer or through an equivalent Application Program Interface (API). This layer may correspond to such information as solicited from a computerized agent as opposed to a human, or even a human and agent combination. The compilation techniques we describe below are not affected by the source of the input data. For example, a certain compilation technique may expect to receive some weights as inputs. The user could have entered these weights through the GUI or, they might have been computed by some procedure at a higher layer. At any rate, the compilation technique is not affected by the way these weights are generated.

The inputs to the compilation layer include the various products/services that are desired along with constraints, preferences, (i.e., targets) and tradeoffs. In addition, the various preferences and tradeoffs are weighted. That is, their relative importance is indicated. These specifications are compiled into formal objects called business intentions. These intentions are used to match deals, and later on to negotiate deals in 1-1 or 1-n modes. One component of a business intention encodes constraints, preferences, and tradeoffs. This component is in the form of a goal program (GP). Goal programs are a well-known formalism for representing multiple, and often conflicting, objectives. The subject of this document is to outline the methods, by which user intentions are translated into goal programs.

In order to perform some of the techniques in the following sections, the LP package is required to have certain capabilities listed below. These features are usually found in commercial packages available today.

Ability to handle integer programming, this is used to:

a. Define binary flags.

b. Define discrete-value variables.

Epsilon techniques are used for OR compilation.

The solicitation procedure follows a “top-down” approach that forces the agent that provides the information to start with a broad outlook on the various components of the intention, including the possible intricate dependencies that might be present among them, before diving into the myriad of data that characterize each individual dimension of the intention. This is accomplished through the following general procedure:

Specification of basic intention.

To obtain this data through a GUI, the system obtains information for each decision variable. The trader is requested to fill in the values for these variables. This should be done in a flexible manner allowing for:

calling a standard “my-deal” that was defined earlier by the trader,

calling a standard “market-average” deal that is computed from market statistics,

filling in only some of the variables and letting the system to complete the rest.

Fine-tuning the basic intention.

For each variable at a time the trader is requested to define certain parameters for it. The trader has the option of changing the value that was entered earlier as part of the overall deal.

Bounds on individual variables.

Every variable must be bounded. The trader will be encouraged to put reasonable bounds (not too extreme as they may extend the computation time and not too restricted as they may severely limit the feasible region.)

Individual goals.

The default goal is the one defined within the context of the entire deal in the earlier stage. However, here this goal can be refined—for example, the single numerical value entered earlier can be extended to an interval goal.

Tradeoff relations.

These are given by pointing out equal utility combinations of values for certain decision variables.

Entering constraints of all kinds.

Any kind of linear relations among the decision variables can be entered at this stage.

The rest of this part follows the sequence of stages defined above. It will be appreciated that the trader referred to herein may be human, a software agent, or a combination thereof. Some parts of the above stages may be skipped.

Specification of Basic Intention

The basic intention is to obtain a very good (if not excellent) deal for the user by the standards of the marketplace where the negotiation takes place. In soliciting the basic intention, care should be taken to the following points.

Pareto-efficiency:

The collection of values assigned to the decision variables should be such that any improvement in any of them must be accompanied by deterioration in at least one of the other variables.

Feasibility:

The collection of values assigned to the decision variables should represent a realistic outcome of negotiations in the relevant market place where they are scheduled to take place. Otherwise, we may solicit theoretical but unrealistic target values that will be counter-productive to our efforts to facilitate successful negotiations (see the section on single-dimensional goals for more details).

Simultaneity:

The values for the decision variables should reflect simultaneous evaluation of the multiple decision dimensions that are involved. This is essential to ensure that tradeoff relations, where they exist, were taken into account in the process (see the section on tradeoff relations for further details).

“Mainstream” Proposition:

The set of efficient points in most decision problems consists of multiple points. Hence, the user may have to choose from many alternative points, all satisfying the three conditions above, one which will serve as the spring board for the compilation process. It will be helpful to the subsequent stages of the process, especially to the fine-tuning of individual goals, that a reasonable choice be made—that is, a point that is taken from a central location of the efficient set should be preferred to one taken from an extreme corner of this set.

Fine Tuning the Basic Intention

Bounds

This section is concerned with hard bounds on the problem variables, both decision and deviation ones. The latter can be associated with all the types of goals, not only the ordinary ones. The section does not address the issue of hard constraints in general—this topic will be addressed later on.

We require that all the GP problems that we compile will be bounded so as to avoid unbounded or unrealistic solutions. Bounding the problem has other important advantages. These include, easier design of the utility layer, (such as, calculating the worst solution), and easier compilations (e.g., performing the scaling described above), and more efficient run-time of the LP package.

Bounds on Decision Variables

As mentioned above, decision variables get their bounds either through the GUI level, or by interacting with the user and the Database or Catalog. It is essential that each decision variable will be bounded. Care should be taken in defining appropriate bounds. For example, even if a certain variable is in principle unlimited from above, one should look for a reasonably large number to bind it. These bounds play an important role in defining the feasible region for the mathematical programs that are used to express the negotiation process. Unnecessarily large bounds may lead to overly large regions. which in turn extend the required computation time. On the other hand, tight bounds may limit the feasible region so severely as to preclude the possibility of finding an optimal solution.

Bounds on deviation variables

Suppose we have a goal constraint of the form {gᵢ+δᵢ⁻−δᵢ⁺=Tᵢ}.

In general, we set the bounds on the deviation variables δᵢ⁻ and δᵢ⁺ here as follows:

lb(δᵢ⁻)=0 and lb(δᵢ⁺)=0

ub(δᵢ⁻)=Tᵢ−lb(gᵢ) ub(δᵢ⁺)=ub(gᵢ)−Tᵢ (1)

Notice that ub(f) is the upper bound off, and lb(f) is the lower bound of f.

When we calculate the bounds of a goal of the form gᵢ=ΣaᵣXᵣ as follows:

ub(gᵢ)=Σ(aᵣ·ub(Xᵣ))

lb(gᵢ)=Min{aᵣ·lb(Xᵣ)} (2)

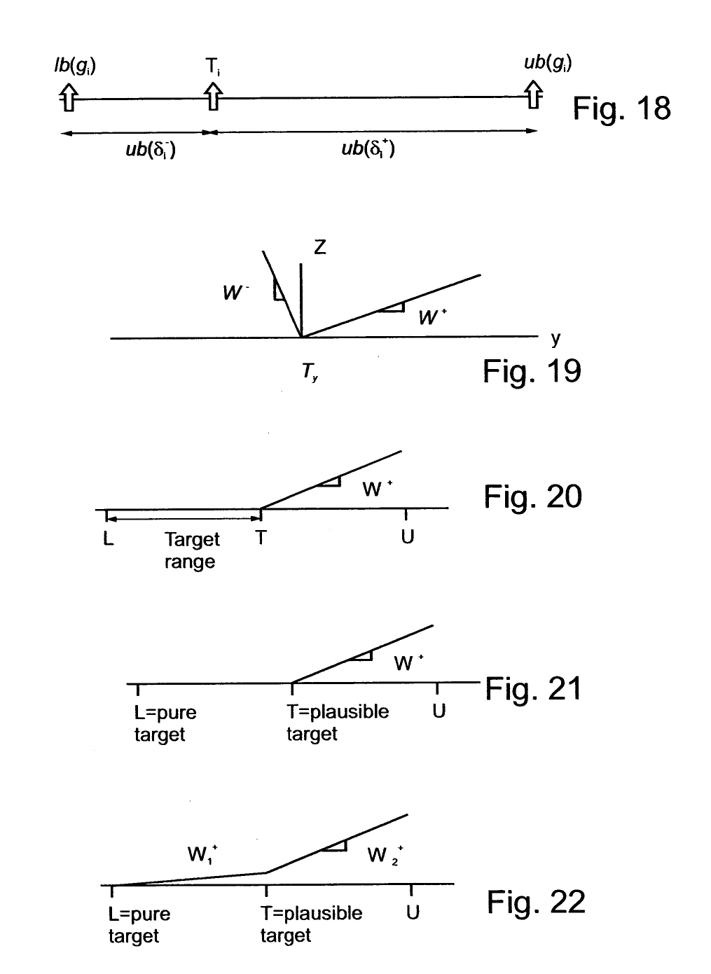

Such bounds are represented by appended FIG. 18.

Single Dimensional Goals

This section describes various alternative representations of single dimensional goals and the preferences around them. It is organized in an increasing order of complexity.

Basic Goal Representation

We start with V-shape single dimensional point goals that are the basic type of goal constraints.

Such a goal is shown in FIG. 19.

Input for Compilation

(Regarding a Decision Variable y)

Target value: T_{y}.

Level of objective function: L.

Relative importance of the variable y within the objective function level L:V_{y}.

Weights for lower and upper deviations from the target T_{y}:W_{y}⁻,W_{y}⁺.

The weights W_{y}⁻, W_{y}⁺ are penalty factors, representing how much the user dislikes a deviation in either of the two directions. To make it easy to combine objectives later on, we require, without loss of generality, that the largest of W_{y}⁻, W_{y}⁺ equals 1.0. The idea here is that only one of these two deviations can occur at any given time. If the deviation occurs in the less desired direction, the program will be penalized by the entire importance value (V_{y}) associated with that variable is in effect. If the deviation occurs in less “painful” direction, only a portion of V_{y} becomes effective. Thus, the smallest value in the pair {W_{y}⁻, W_{y}⁺} represents a proportion of the maximal penalty that is associated with deviations in less important directions. Notice that in cases where we are indifferent to deviations in a particular direction, a value of zero can be associated to the smallest weight in this pair.

Representation in the GP Problem

Given the above inputs, we append to the GP problem a goal constraint to express the user's desire to reach the target value T_{y}.

Goal constraint: y+δ⁻−δ⁺=T_{y} (3)

We also express the importance of reaching the target goal by adding a term containing weighted deviations to the suitable level (L) of the objective function.

1. Objective (at level L): Min Z=V_{y}·{W_{y}⁻·δ⁻+W_{y}⁺·δ⁺}+ . . . (4)

Strong One-Sided Goals

In these cases the user provides a point-target value T (within the [L,U] bounds specified for the attribute) and specifies a linear penalty function (through a fixed weight per unit of deviation) only on one side of the target whereas he is truly indifferent with regard to the other side. For example, a buyer who wishes to receive a product no later than 10 days from the contract date and is totally indifferent to receiving it earlier. This means that we have a target range that starts at one of the bounds and ends at the given point-target as depicted in appended FIG. 20.

This case is modeled using the following formulation (which can easily be generalized to multi-attribute cases):

Min W⁺·δ⁺

s.t.

X+δ⁻−δ⁺=T

L≦X≦U

Other constraints

Weak One-Sided Goals

The only difference between the “weak” and the “strong” cases is that in the former the user does have a preference for values on the side of the point-target for which no penalty was specified in the strong case. Using the same example, a 10-day delivery target is a plausible outcome for the user but if possible, he would prefer to receive the product as early as possible. We further assume that the user is unable to quantitatively state the preference on the undefined side of the target. Hence, the “pure” (or “theoretic”) target is the bound (L in our example), while T is a plausible target. An example of a weak one-sided goal is shown in FIG. 21.

This case is preferably handled using Hanan's procedure.

LexMin {(W⁺·δ⁺),(−δ⁻)}

s.t.

X+δ⁻−δ⁺=T

L≦X≦U

Other constraints

Single-Sided Goals With Multiple Slopes

Unlike the previous case, here the user is capable of specifying the degree by which he prefers deviations from the theoretical target up to the plausible one vis-a-vis the deviations from the plausible target. This case is depicted in appended FIG. 22.

Notice that we could have modeled the penalty function in the interval [L,T] as a “bonus” by raising the horizontal axis upwards until it intersects with the penalty function at T (changing the definition of zero penalty). This would not change anything in the outcomes of our formulation.

Min W₁⁺·δ₁⁺+W₂⁺·δ₂⁺

s.t.

X+δ⁻−δ₁⁺−δ₂⁺=L

δ₁⁺≦T−L

L≦X≦U

Other constraints

Simple Two-Sided Goals

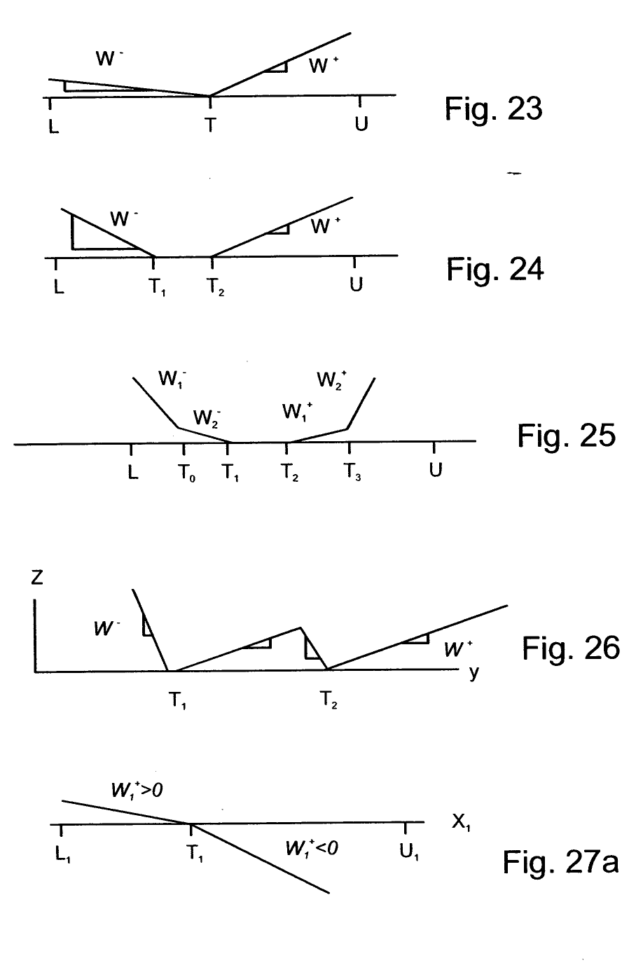

This is the classical case in which the user specifies a point target with penalties on deviations in both directions (not necessarily with the same weights). Graphically, this situation is given as in appended FIG. 23.

Mathematically, we formulate it as:

Min W⁻·δ⁻+W⁺δ⁺

s.t.

X+δ⁻−δ⁺=T

L≦X≦U

Other constraints

Two-Sided Goals With Interval Range

Similar to the previous case where instead of a point-target we have a target range as depicted in FIG. 24.

This case is formulated by:

Min W⁻·δ₁⁻+W⁺·δ₂⁺

s.t.

X+δ₁⁻−δ₁⁺=T₁

X+δ₂⁻−δ₂⁺=T₂

L≦X≦U

Other constraints

Complex Two-Sided Goals (Segmented U-Shaped Functions)

This is the most general case that we can treat at the time this document is being written. It encompasses all the cases presented earlier as special cases. It contains target range as well as multi-slop penalty functions on both sides of the range. A simple illustration of a case with two slopes on each side is depicted in appended FIG. 25. This case is solved using

Min W₁⁻·δ₁₁⁻+W₂⁻·δ₁₂⁻+W₁⁺·δ₂₁⁺+W₂⁺·δ₂₂⁺

s.t.

X+δ₁₁⁻+δ₁₂⁻−δ₁₁⁺=T₁

X+δ₂₁⁻−δ₂₁⁺−δ₂₂ ⁺=T₂

δ₁₁⁻≦T₁−T₀, δ₂₁⁺≦T₃−T₂

L≦X≦U

Other Constraints

Notice that there is no need to impose an explicit constraint to express the logical condition that would prevent the assignment of positive values to δ₁₂⁻ when δ₁₁⁻ [symbol] T₁−T₀ since the order of the weights in the objective function (W₂⁻ [symbol] W₁guarantees it. However, when the objective function is modified (e.g., by requiring a certain worsening of values that were achieved earlier), this is no longer guaranteed. This will be addressed in the “Utility” layer of the system.

Two-Point Goals

An exemplary two-point goal is shown in appended FIG. 26.

Input for Compilation

Two equally preferred targets: T₁, T₂

Level of the objective function for both targets: L

Relative importance within level: V

Relative weights for lower and upper deviations within the dimension: W⁻,W⁺ Again, without loss of generality, we assume that the largest of W⁻,W⁺ is 1.0.

Representation in the GP model

Goal constraints: y+δ₁⁻−δ₁⁺=T₁

y+δ₂⁻−δ₂⁺=T₂ (5)

Objective function (at level L):

Min Z={W⁻·Min{δ₁⁻,δ₂⁻}+W⁺·Min{δ₁⁺,δ₂⁺}+Min{W⁺·δ₁⁺,W⁻·δ₂⁻}}

Comments

1. In the objective function above, the first term corresponds to the region to the left of point T₁, the second to the region to the right of T₂, and the third to the middle region.

2. The objective function above does not lend itself easily into a linear programming formulation. Hence, at the current version of the software we shall break these situations into two intentions. The control mechanism that builds and releases intentions will be required to recall the XOR relationship between them.

3. The weights associated with negative and positive deviations from the two targets do not necessarily have to be identical (as presented in the figure above). In such cases, we'll have to rewrite the equation, e.g. instead of writing W⁻we write W_{index(Min{δ}_{₁}_{⁻}_{,δ}_{₂}_{⁻}_{})}.

Tradeoff Relations

There might be cases in which the user is incapable or unwilling to express his preferences along each individual dimension and would rather express them through some tradeoff relations among variables. This section deals with two-dimensional goal constraints, and gives some insight into more general multi-dimensional expressions.

Tradeoffs resulting from individual goals Certain mixes of deviations from individual goals that belong to the same level of the objective function, associated with either penalties or bonuses, may lead to tradeoff relations among combinations of variables (not necessarily pairs). For example, consider two variables X₁ and X₂, with targets T₁ and T₂, respectively. There is a penalty on X₁ values exceeding T₁ and a bonus for values short of it. Conversely, there is a bonus on X₂ values exceeding T₂ and a penalty for values short of it. In this case, we observe two tradeoff expressions that naturally exist between X₁ and X₂.

An upward deviation in X₁(Δ₁=x₁−T₁ [symbol] 0) can be compensated through an upward deviation in X₂(Δ₂=x₂−T₂ [symbol] 0) when W₁⁺·Δᵢ+W₂^{+·}Δ₂=0 (notice that W₁⁺ [symbol] 0, W₂⁺

A downward deviation in X₁(Δ₁=T₁−x₁ [symbol] 0) can be compensated through a downward deviation in X₂(Δ₂=T₂−x₂ [symbol] 0) when W₁⁻·Δ₁+W₂(notice that W₁⁻ [symbol] 0, W₂⁻ [symbol] 0).

In the same manner the single-dimensional parameters that were defined earlier may lead to tradeoffs (“compensations”) between deviations in a pair of variables and a deviation in a third variable (e.g., where the first two are weighted positively—as penalties, and the third has a negative weight—as a bonus). Thus, tradeoffs may occur for any combination of variables—not just pairs.

Notice that there is no need to solicit separate information on tradeoffs or to explore all possible tradeoffs since the weighted deviation terms that are built into the objective function will naturally define tradeoffs where they are relevant.

Linking an Individual Goal With a Two-Dimensional Tradeoff Line

Suppose that we have information about the target for X₁ and the weights for deviations from it, while for X₂ the information is given in terms of a linear tradeoff relation with X₁: X₂=a+b·X, along with the weights (either penalty or bonus) for being above or below the tradeoff line. This means that the target for X₂ is not static (as is the target T₁ for X₁). Instead, the tradeoff relations define a “dynamic” target that depends on the value x₁ that variable X₁ will get. Given this target, deviations will lead to either a penalty or a bonus according to the original definition. In other words, we have transformed this case to the same case we handled earlier—where we have two variables with single dimensional targets and deviations.

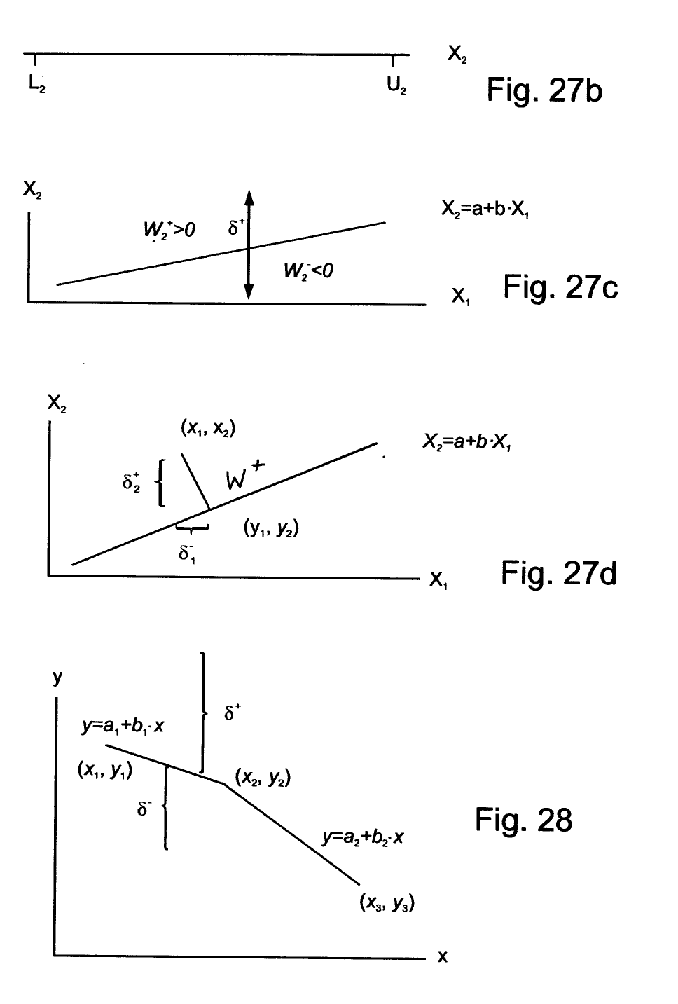

Inputs in this Case are Represented by Appended FIGS. 27a, 27b and 27c:

After proper scaling, the relevant elements in the GP should look like (notice that we use interval based scaling in this case):

Min W₁⁻·δ₁⁻+W₁⁺·δ₁⁺+W₂⁻·δ₂⁻+W₂⁺·δ₂⁺

s.t.

$$\frac{{X}_{1}}{{U}_{1} - {L}_{1}} + {δ}_{1}^{-} - {δ}_{1}^{+} = \frac{{T}_{1}}{{U}_{1} - {L}_{1}}$$

$$\frac{{X}_{2}}{{U}_{2} - {L}_{2}} - \frac{b \cdot {X}_{1}}{{U}_{2} - {L}_{2}} + {δ}_{2}^{-} - {δ}_{2}^{+} = \frac{a}{{U}_{2} - {L}_{2}}$$

$${L}_{1} \leq {X}_{1} \leq {U}_{1}$$

$${L}_{2} \leq {X}_{2} \leq {U}_{2}$$

Linking Two Variables With no Individual Targets

Suppose that information on both X₁ and X₂ was not provided in the single-dimensional mode. Rather, the only information we received for them is a tradeoff line with definitions of weights for deviations from it. The tradeoff line can be given either directly through a linear function (X₂=a+b·X₁) or through two points from which we shall compute the line equation. In the latter case, suppose we are given two equally preferred points: (x₁₁,x₂₁),(x₁₂, x₂₂). Then, the parameters of the tradeoff line which determines the relations between variables X₁ and X₂ (all other variables held fixed) are found through:

$$b = \frac{{x}_{22} - {x}_{21}}{{x}_{12} - {x}_{11}} ; a = {x}_{21} - \frac{{x}_{22} - {x}_{21}}{{x}_{12} - {x}_{11}} \cdot {x}_{11}$$

The deviations from the tradeoff line are measured according to the normal that connects the (x₁,x₂) point to the line. The reason is that here we consider the information on the two variables as symmetric while in the previous case X₂ information was expressed in terms of X₁ information.

First, we compute the point (y₁,y₂) on the tradeoff line that intersects with the normal:

$${y}_{1} = \frac{{x}_{1} + b \cdot ( {x}_{2} - a )}{1 + {b}^{2}} , {y}_{2} = a + \frac{b \cdot ( {x}_{1} + b \cdot ( {x}_{2} - a ) )}{1 + {b}^{2}}$$

The situation is illustrated in FIG. 27d.

Given the point (y₁, y₂), we know how to compute the deviations δ₁⁻ and δ₂⁺ in the X₁ and X₂ dimensions, respectively. Then, we assume equal weight on these deviations (

$$( \frac{{W}^{+}}{\sqrt{2}} \text{in each direction} )$$

in each direction) and, given the position of the point (x₁,x₂) vis-a-vis the tradeoff line (e.g., it is above the line in the example above), we multiply the deviations with the single-dimensional weights (

$$( \frac{{W}^{+}}{\sqrt{2}} )$$

) and enter the two products into the objective function.

The relevant elements in the GP should look like:

$$Min \frac{{W}^{-}}{\sqrt{2}} \cdot ( {δ}_{1}^{+} + {δ}_{2}^{-} ) + \frac{{W}^{+}}{\sqrt{2}} \cdot ( {δ}_{1}^{-} + {δ}_{2}^{+} )$$

$$\frac{{X}_{1}}{{U}_{1} - {L}_{1}} \cdot ( \frac{{b}^{2}}{1 + {b}^{2}} ) - \frac{{X}_{2}}{{U}_{1} - {L}_{1}} \cdot ( \frac{b}{1 + {b}^{2}} ) + {δ}_{1}^{-} - {δ}_{1}^{+} = - \frac{a \cdot b}{{U}_{1} - {L}_{1}} \cdot ( \frac{1}{1 + {b}^{2}} )$$

$$\frac{{X}_{2}}{{U}_{2} - {L}_{2}} \cdot ( \frac{1}{1 + {b}^{2}} ) - \frac{{X}_{1}}{{U}_{2} - {L}_{2}} \cdot ( \frac{b}{1 + {b}^{2}} ) + {δ}_{2}^{-} - {δ}_{2}^{+} = \frac{a}{{U}_{2} - {L}_{2}} \cdot ( \frac{1}{1 + {b}^{2}} )$$

$${L}_{1} \leq {X}_{1} \leq {U}_{1}$$

$${L}_{2} \leq {X}_{2} \leq {U}_{2}$$

A numerical example may help illustrate these ideas:

Assume we are given the following input:

X is in the range [10, 100].

X₂ is in the range [50, 500].

The two variables are linked by the tradeoff: X₂=50+5·X₁ (i.e., a=50, b=5)

There is a bonus of 5 for every unit deviation below the tradeoff line and a penalty of 15 for every unit deviation above the tradeoff line.

The formulation then looks like:

$$Min \frac{- 5}{\sqrt{2}} \cdot ( {δ}_{1}^{+} + {δ}_{2}^{-} ) + \frac{15}{\sqrt{2}} \cdot ( {δ}_{1}^{-} + {δ}_{2}^{+} )$$

$$\frac{{X}_{1}}{90} \cdot ( \frac{25}{26} ) - \frac{{X}_{2}}{90} \cdot ( \frac{5}{26} ) + {δ}_{1}^{-} - {δ}_{1}^{+} = - \frac{250}{90} \cdot ( \frac{1}{26} )$$

$$\frac{{X}_{2}}{450} \cdot ( \frac{1}{26} ) - \frac{{X}_{1}}{450} \cdot ( \frac{5}{26} ) + {δ}_{2}^{-} - {δ}_{2}^{+} = \frac{50}{450} \cdot ( \frac{1}{26} )$$

$$10 \leq {X}_{1} \leq 100$$

$$50 \leq {X}_{2} \leq 500$$

After algebraic simplification this formulation may be presented as:

Min −3.5353·(δ₁⁻+δ₂⁻)+10.6066·(δ₁⁺+δ₂⁺)

0.01068·X₁−0.002136·X₂+δ₁⁻−δ₁⁺=−0.1068

−0.00042735·X₁+0.00008547·X₂+δ₂⁻−δ₂⁺=0.00427

10≦X₁≦100

50≦X₂≦500

Piecewise Linear Two Dimensional Tradeoff Goal

The tradeoff line given in the two previous sub-sections might be expressed in terms of a piecewise linear (rather than linear) relations. This will lead to mixed-integer formulations that will be handled in our system through XOR operators. Such situations are demonstrated through the two-segment piece-wise linear function below, and shown in FIG. 28.

Input for Compilation

Three equally preferred points: (x₁,y₁), (x₂,y₂)) (x₃,y₃)

(all other variables held fixed)

Level of the objective function for both targets: L

Weights: W⁻,W⁺

Again, without loss of generality, we assume that Max{W_{y}⁻,W_{y}⁺}=1.

Representation in the GP Model

$$\text{Goal constraints:} \begin{matrix}y - {b}_{1} \cdot x + {δ}_{1}^{+} - {δ}_{1}^{-} = {a}_{1} \\ \text{or} \\ y - {b}_{2} \cdot x + {δ}_{2}^{+} - {δ}_{2}^{-} = {a}_{2}\end{matrix} \\ \text{Objective function:} \{ \begin{matrix}Min \{ {W}_{1}^{+} \cdot {δ}_{1}^{+} + {W}_{1}^{-} \cdot {δ}_{1}^{-} + … \} \\ \text{or} \\ Min \{ {W}_{2}^{+} \cdot {δ}_{2}^{+} + {W}_{2}^{-} \cdot {δ}_{2}^{-} + … \}\end{matrix} \qquad ( 6 )$$

Inconsistencies Among Tradeoffs

When users enter pairwise tradeoffs there is a chance that inconsistent relations will enter the system. For example, the user states that the slope of the tradeoff between variables x and y, and between x and z are +2 and +3, respectively. Then he specifies the tradeoff slope between y and z as+5. But, the slope implied through the first two tradeoffs is +6. Such potential inconsistencies will be handled in one of the following ways.

Forbidding Inconsistent Tradeoffs

To prevent any chance for inconsistencies we allow entering up to (n−1) distinct tradeoffs statements (n is the cardinality of the vector x). Consider the n x n matrix of all pairwise combinations.

Check out the n entries along the diagonal. Check out all entries j,k such that both xⱼ and xₖ have defined targets (this is a highly conservative step that may be skipped).

Accept a new tradeoff only if it refers to an entry in the matrix that is not checked. That is, stop accepting new tradeoffs when all the entries in the matrix are checked.

Each time a new tradeoff is defined (say between xᵢ and xⱼ, i≠j), check out both entries [i,j] and [j,i].

Repeatedly, for all i,j,k such that entries [i,j] and [j,k]. are already checked out, check out entries [i,k] and [k,i].

Allowing Inconsistent Tradeoffs

Here we allow up to

$$\frac{n \cdot ( n - 1 )}{2}$$

tradeoffs. But, any new tradeoff that is entered is compared to a list of implied tradeoffs that are gradually being constructed as more tradeoffs are recorded. If the new tradeoff contradicts an implied one, the system will automatically generate a warning to the user allowing him to either accept the implied relations or stay with the inconsistent definition he has just entered.

Additional Constraints and Limitations

OR Conditions (Disjunctive Compilation)

This section describes the problem of compiling several disjunctive constraints into the GP model. This is a challenging task since all the constraints of a GP model are, by definition, implicitly conjuncts. Therefore, we need to provide a translation method for a disjunctive expression so that we can require the satisfaction of an arbitrary subset of the disjoint constraints; That is, enabling solutions to problems such as asking to satisfy exactly three disjoint constraints out of seven or asking to satisfy at least two such constraints out of five, etc. Moreover, this translation must consist of only linear expressions, as we are restricting ourselves to integer and linear-programming capabilities.

Problem Description

Notation (General)

X={x₁ . . . xₖ} A set of k variables.

f(X) A linear combination over the vector X.

z, w, b Symbols for binary variables, that is, z, w, bε{0,1}. These variables will be subscripted as necessary.

dᵢ Relation of the form f(x){≦,≧,<,>,=}Tᵢ, participating in a disjunction.

dᵢ [symbol] Complementary relation for dᵢ, e.g., if dᵢ:xⱼ≦Tᵢ then dᵢ [symbol] :xⱼ

cᵢ Relation of the form f(X){≦,≧,<,>,=}Tᵢ, participating in conjunction.

cᵢ [symbol] Complementary relation for cᵢ, e.g., if cᵢ:xⱼ≦Tᵢ then cᵢ [symbol] :xⱼ

Dₘ^{k} A disjunction of m relations over the set X with k variables.

Cₙ^{l} A conjunction of n relations over the union of set X with a set of additional binary variables, and another set of constants (upper and lower bound values). The parameters l and n are defined later on.

S_{q}^{r} A predicate describing the cardinality of the subset of satisfied disjuncts in Dₘ^{k}, with a quantifier, q={At least, At most, Exactly}, and cardinality r.

The predicate has the form:

{At least, At most, exactly} r disjuncts in Dₘ^{k}, must be satisfied.

The quantifiers {At least, At most, Exactly} will be represented by the symbols {≧,≦,=}, respectively.

Comments

The disjuncts and conjuncts will necessarily use different sets of variables, as the conjuncts will be introduced with additional binary variables.

Representing Strong-Inequalities

By strong-inequality we refer to a relation with the operators {<,>}, and by weak-inequality we refer to a relation with the operators {≦,≧}.

Notice that in a LP package we do not have the capability to express strong-inequalities such as x<7 or x>12, due to the representation of LP models in those packages. Therefore, we represent strong-inequalities using weak inequalities where the targets on the RHS are perturbed by an infinitesimal amount (ε).

I.e., f(X)<T, is represented by: f(X)≦T−ε, and, (7)

f(X)>T, is represented by: f(X)≧T+ε. (8)

Although this solution seems logically incorrect, it is practically sound, since a LP package uses such an εanyway, e.g., in order to round values.

Problem Description

Given a set of disjuncts, Dₘ^{k}={d₁ . . . dₘ} over X, a requirement S_{q}^{r} and a set of bounds for all the variables: Lⱼ≦xⱼ≦Uⱼ, ∀xⱼεX, 1≦j≦k.

Our objective is to determine Cₙ^{l} so that it satisfies the requirements S_{q}^{r} over Dₘ^{k}.

The solution of the problem will be presented as follows:

1. First we introduce a solution for the general case Dₘ^{k}, S_{q}^{r}, showing how we represent inequality disjuncts as conjuncts, and then how to expand this representation to include equality disjuncts.

2. We also show a solution for the special case when k=1 (that is, for a single variable), and all disjuncts are equality relations.

Comments

1. The requirement of an upper/lower-bound for xⱼ is mandatory for the solution to work, as these bounds are used in the re-formulation of the problem.

2. Given the upper and lower bounds of the decision variables, we can calculate upper and lower bounds of any function f(X) over these variables.

Alternative Solutions

General Case Solution

In the general solution we first show how to solve inequality relations, then handle equality relations, by representing every equality relation by two inequalities.

Representation of Inequalities

First, we notice that an inequality of the general form d:f(X){≦,≧}T, may be re-represented as follows:

1. A relation of the form dᵢ:fᵢ(X)≦Tᵢ by:

cᵢ:fᵢ(X)≦zᵢ·Tᵢ+(1−zᵢ)·U(fᵢ) (9a)

If z=1, we get fᵢ(X)≦Tᵢ, thus, we require that dᵢ must be satisfied.

If z=0, we get fᵢ(X)≦U(fᵢ), thus, making it a redundant constraint, i.e., one that is trivially satisfied.

The complement dᵢ [symbol] :fᵢ(X)>T is represented by:

cᵢ [symbol] :fᵢ(X)≧(1−zᵢ)·(Tᵢ+ε)+zᵢL(fᵢ) (9

If z=1, we get fᵢ(X)≧L(fᵢ), thus, making it a redundant constraint.

If z=0, we get fᵢ(X)≧(Tᵢ+ε), thus, we require that dᵢ [symbol] must be satisfied.

Notice that the conjuncts cᵢ and cᵢ [symbol] together, are to be satisfied at the same time (they are conjuncts), thus: If z=1, dᵢ is satisfied, and if z=0, dᵢ is not satisfied.

2. A relation of the form dᵢ:fᵢ(X)≧Tᵢ, is represented respectively, as described above:

cᵢ:fᵢ(X)≧zᵢ·Tᵢ+(1−zᵢ)·L(fᵢ)

cᵢ [symbol] :fᵢ(X)<(1−zᵢ)·(Tᵢ−ε)+zᵢ·U(fᵢ) (

Comments

1. The representation above keeps the relations linear.

2. For any value of zᵢ, either dᵢ or dᵢ [symbol] will be satisfied while the other will not.

3. The presentation of U(f) and L(f) is made possible due to the requirement that all variables are bounded.

Representation of Equalities

An equality relation dᵢ:fᵢ(X)=T, can be rewritten using two inequalities as follows: (fᵢ(X)≦Tᵢ) [symbol] (fᵢ(X)>Tᵢ).

We use two binary variables, zᵢ for representing (fᵢ(X)≦Tᵢ) and wᵢ for representing (fᵢ(X)≧Tᵢ), such that dᵢ is satisfied iff zᵢ=wᵢ=1.

Using the inequality representations from the previous section we get:

c_{zi}:fᵢ(X)≦zᵢ·Tᵢ+(1−zᵢ)·U(fᵢ)

c_{zi} [symbol] :fᵢ(X)≧(1−zᵢ)·(Tᵢ+ε)+zᵢ·L(fᵢ)

c_{wi}:fᵢ(X)≧wᵢ·Tᵢ+(1−wᵢ)·L(fᵢ)

c_{wi} [symbol] :fᵢ(X)≦(1−wᵢ)·(Tᵢ−ε)+wᵢ·U(fᵢ)

c^{wz}:zᵢ+wᵢ≧1 (11)

Satisfying dᵢ:

If zᵢ=1,wᵢ=1, we get (fᵢ(X)≧Tᵢ) and (fᵢ(X)≦Tᵢ), thus, (fᵢ(X)=Tᵢ).

Unsatisfying dᵢ:

If zᵢ=1,wᵢ=0, we get (fᵢ(X)≦Tᵢ−ε), especially (fᵢ(X)≠Tᵢ).

If zᵢ=0,wᵢ=1, we get (fᵢ(X)≧Tᵢ+ε), especially (fᵢ(X)≠Tᵢ).

Comments

1. We eliminate the case zᵢ=0, wᵢ=0, as it leads to an inconsistency when requiring (fᵢ(X)≧Tᵢ+ε) and (fᵢ(X)≦Tᵢ−ε), simultaneously.

2. The formulation above has no preference for either wᵢ or zᵢ, so that if dᵢ should not be satisfied, fᵢ(X)≠Tᵢ, we can choose either direction fᵢ(X)<Tᵢ or fᵢ(X)>Tᵢ according to the values of X.

Problem Description

Given the set Dₘ^{k} of m disjunct relations and the requirement S_{q}^{r}; and given that Dₘ^{k} consists of m₁ inequalities and m₂ equalities (m₁+m₂=m), and bounds for the variables, Lⱼ≦xⱼ≦Uⱼ, ∀xⱼεX, 1≦j≦k.

We present the set Cₙ^{l} of n=2·m₁+5·m₂+1 conjuncts, and l=m₁+2·m₂+k variables, and show that cₙ^{l} is satisfied iff Dₘ^{k}S_{q}^{r} is satisfied.

Construction of Cₙ^{l}

As we showed above, an inequality relation dᵢ can be presented by two conjuncts cᵢ and cᵢ [symbol] and a binary variable zᵢ. An equality relation dᵢ can be represented by five conjuncts cᵢ^{z}, cᵢ^{z} [symbol] , cᵢ^{w}, cᵢ^{w} [symbol] and c^{wz}, and two binary v and wᵢ.

Given m₁ inequalities and m₂ equalities we construct Cₙ^{l}, by introducing m₁+2m₂ new binary variables, zᵢε{0,1}, 1≦i≦m, and Wⱼε{0,1}, 1≦j≦m₂. (Notice, m₁+2m₂=m+m₂)

$$\begin{matrix}{C}_{n}^{l} = \{ {c}_{1}^{z} … {c}_{m2}^{z} , {c}_{1}^{z ⫬} … {c}_{m2}^{z ⫬} , {c}_{1}^{w} … {c}_{m2}^{w} , {c}_{1}^{w ⫬} … {c}_{m2}^{w ⫬} , {c}_{1}^{w z} … {c}_{m2}^{w z} \} \\ ⋃ \{ {c}_{m2 + 1} … {c}_{m} , {c}_{m2 + 1}^{⫬} … {c}_{m}^{⫬} \} \\ ⋃ \{ {c}^{z} \}\end{matrix} \qquad ( 12 )$$

Where the representation of c^{z} depends on the type of relations as follows: for 1≦i≦m, 1≦j≦m₂

$$\begin{matrix}{S}_{\geq }^{r} & {c}^{z} \text{:} {\sum }_{i} {z}_{i} + {\sum }_{j} {w}_{j} \geq r + {m}_{2} \\ {S}_{\leq }^{r} & {c}^{z} \text{:} {\sum }_{i} {z}_{i} + {\sum }_{j} {w}_{j} \leq r + {m}_{2} \\ {S}_{=}^{r} & {c}^{z} \text{:} {\sum }_{i} {z}_{i} + {\sum }_{j} {w}_{j} = r + {m}_{2}\end{matrix} \qquad ( 13 )$$

Comments

1. The 2·m₁+5·m₂+1 conjuncts are: 2·m₁ conjuncts for handling the inequality relations, and 5·m₂ conjuncts for handling the equality relations, and an additional requirement to satisfy S_{q}^{r}.

The m₁+2·m₂+k variables are: m₁ binary variables for the inequality relations, and 2·m₂ binary variables for the equality relations, and the k variables in X

2. Note that all the expressions in (12) and (13) are linear.

3. The conjuncts {c₁^{z} . . . cₘ₂^{z}, c₁^{z} [symbol] . . . cₘ₂^{z} [symbol] , c₁^{w} . . represent m₂ equality relations according to (11) above.

Each equality relation dᵢ is represented in this set by {c₁^{z} . . . cₘ₂^{z}, c₁^{z} [symbol] . . . c_{and will be satisfied iff w}ᵢ=zᵢ=1 (i.e., when wᵢ+zᵢ=2); and therefore, it will not be satisfied when wᵢ+zᵢ=1.

4. The conjuncts {cₘ₂₊₁ . . . cₘ, cₘ₂₊₁ [symbol] . . . cₘ [symbol] } represent m_{1 according to (}9b), for an inequality with the ≦ operator, or (10) for an inequality with the ≧ operator.

Each inequality relation dᵢ will be satisfied iff zₖ=1; therefore, it will not be satisfied when zᵢ=0.

5. The conjunct c described in (13) represents the requirement of S_{q}^{r}:

$$\text{i.} {S}_{=}^{r} {c}^{z} \text{:} {\sum }_{i} {z}_{i} + {\sum }_{j} {w}_{j} = r + {m}_{2}$$

Notice that all the variables in the equation are binary variables, that it, they may only add one or zero to the sum.

An inequality will be satisfied iff its binary variable zᵢ adds one to the sum, or adds zero otherwise.

An equality relation will be satisfied iff its binary variables zᵢ and wᵢ add two to the sum. Otherwise they add one.

Thus, in order to satisfy any r conjuncts or disjuncts we require:

$${S}_{=}^{r} \qquad {c}^{z} \text{:} {\sum }_{inequalities} {z}_{i} + {\sum }_{equalities} ( {z}_{i} + {w}_{i} - 1 ) = r$$

However, there are m₂ equalities, providing (−m₂) to the total sum, thus, we get the equation as presented in (13).

$$\text{ii.} {S}_{\leq ( \geq )}^{r} {c}^{z} \text{:} {\sum }_{i} {z}_{i} + {\sum }_{j} {w}_{j} \leq ( \geq ) r + {m}_{2}$$

According to the explanation above, if we wish to satisfy at least (at most) r disjuncts in Dₘ^{k}, the result for the at least or respectively, at most), case is immediate, as the sum represents exactly how many disjuncts are satisfied, while all the other disjuncts will not be satisfied.

### EXAMPLE

| D₄¹: (x = 9)^{I} [symbol] (x = 13)^{II} [symbol] (x ≧ 17)^{III} [symbol] (x ≦ 8)^{IV} , | | S₌¹ |
|---|---|---|
| | (k = 1, m = 4, m1 = 2, m2 = 2) | |
| C₁₅⁷: | | |
| c₁^{z} | x ≦ z₁ · 9 + (1 − z₁) · U^{x} | (I) |
| c₁^{z} [symbol] | x ≧ (1 − z₁) · (9 + ε) + z₁ · L^{x} | |
| c₁^{w} | x ≧ w₁ · (9) + (1 − w₁) · L^{x} | |
| c₁^{w} [symbol] | x ≦ (1 −w₁) · (9 − ε) + w₁ · U^{x} | |
| c₁^{wz} | w₁ + z₁ ≧ 1 | |
| [symbol] | | |
| c₂^{z} | x ≦ z₂ · 13 + (1 − z₂) · U^{x} | (II) |
| c₂^{z} [symbol] | x ≧ (1 − z₂) · (13 + ε) + z₂ · L^{x} | |
| c₂^{w} | x ≧ w₂ · (13) + (1 − w₂) · L^{x} | |
| c₂^{w} [symbol] | x ≦ (1 − w₂) · (13 − ε) + w₂ · U^{x} | |
| c₂^{wz} | w₂ + z₂ ≧ 1 | |
| [symbol] | | |
| c₃ | x ≧ z₃ · 17 + (1 − z₃) · L^{x} | (III) |
| c₃ [symbol] | x ≦ (1 − z₃) · (17 − ε) + z₃ · U^{x} | |
| [symbol] | | |
| c₄ | x ≦ z₄ · 8 + (1 − z₄) · U^{x} | (IV) |
| c₄ [symbol] | x ≧ (1 − z₄) · (8 + ε) + z₄ · L^{x} | |
| [symbol] | | |

| | |
|---|---|
| (z₁ + w₁ − 1) + (z₂ + w₂ − 1) + z₃ + z₄ = 1 | (S₌¹) |

| | |
|---|---|
| c^{z} | ≡ z₁ + z₂ + z₃ + z₄ + w₁ + w₂ = +3 |

s.t. z₁, z₂, z₃, z₄, w₁, w₂ ∈ {0, 1},

L^{x} ≦ x ≦ U^{x}

Handling Equalities (a Single Variable)

Compiling Dₘ^{k}, is an easier task, in the special case where k=1 (a single variable) and all the disjuncts are equality relations, with the requirement S₌¹ (that is exactly one disjunct is required to be satisfied).

Another required restriction is that all the equalities in Dₘ¹ are unique, that is:

For dᵢ:x=Tᵢ and dⱼ:x=Tⱼ, i≠j implies that Tᵢ≠Tⱼ.

Constructing C₂^{m+1}

Given the set Dₘ¹ of m equality disjuncts and S₌¹, we show how to generate a conjunction C₂^{m+1}, with two conjuncts and m+1 variables, which is satisfied iff Dₘ¹, S_{q}^{r} are satisfied.

We attach to every dᵢ: x=Tᵢ a binary variable bᵢ, as a flag, to the value Tᵢ; then request, according to S_{q}^{r}, that {At least, At most, Exactly} r flags will be satisfied.

Constructing C₂^{m+1}, by introducing m new binary variables, bᵢε{0,1}, 1≦i≦m:

C₂^{m+1}={c₁}∪{c^{b}} (14)

The solution is immediate:

c₁:x=b₁·T₁,+ . . . +bₘ·Tₘ (15)

$${c}^{b} \text{:} {\sum }_{i} {b}_{i} = 1 \qquad ( 16 )$$

Comments

1. The requirement set S₌¹ aims to eliminate redundancy. Moreover, if we allow any requirement set S_{q}^{r} then a subset of disjuncts satisfying S, must be similar; that is all of them with the form x=T.

2. Notice that C₂^{m+1} is represented by two groups; the first one {c₁} is the translation of Dₘ¹ constraints from disjuncts into conjuncts; and the second {c^{b}} is the requirement for satisfaction presented by S_{q}^{r}.

3. Note that the expressions (15) and (16) are linear.

4. First we notice according to (16) that only (and exactly) one of the binary variables will have the value one, whereas all the other binary variables will have the value zero.

That is, for some 1≦i≦m, bᵢ=1, and bⱼ=0 1≦j≦m, j≠i.

5. According to the above, c₁ in (15) will always have the form x=Tᵢ(bᵢ=1).

Therefore, the above formulation allows us to choose exactly one of the values ti to be assigned to x.

### EXAMPLE

D₄¹:{(x=4) [symbol] (x=40) [symbol] (x=−10) [symbol] (x=12)}, S₌¹

C₂⁵:

c₁:x=b₁·4+b₂·40−b₃·10+b₄·12

[symbol]

c_{b}:b₁+b₂+b₃+b₄=1

s.t. b₁,b₂,b₃,b₄ε{0,1}

Discrete Variables Compilation

In the preceding two sections we described ordinary goals and tradeoffs. However, those sections dealt with continuous variables only. This section deals with the problem of representing discrete-valued variables. Especially, we are interested in representing string values, such as the names of hotels in a city, or colors of the product, etc.

The General Case

Input for Compilation

(Regarding a Variable t)

Feasible values of t {T₁ . . . Tₘ}

Level of objective function L

Preference weights for every feasible value of t {W₁ . . . Wₘ}

Relative importance within the level, Vₜ

Representation of Variables and Constraints

$$\text{Definition of t:}$$

$$t = {\sum }_{i = 1}^{m} {T}_{i} \cdot {b}_{i}$$

The definition of t is based on the binary variables, bᵢε{0,1}, 1≦i≦m. This definition is kept outside the GP. We use it only for the purpose of translating the GP outputs in order to present them to the user (or to forward them to the agent of the other party). The other variables we define below will play a role in the GP.

$$\text{Hard constraints:}$$

$${x}_{i} = {\sum }_{i = 1}^{m} {W}_{i} \cdot {b}_{i} {x}_{i} \text{is an auxiliary variable.}$$

Σbᵢ=1, bᵢε{0,1}, 1≦i≦m

During the course of the negotiations we relax the model by replacing the binary variables b, with continuous variables 0≦cᵢ≦1, 1≦i≦m.

Goal constraint: xᵢ/W^{max}+δ⁻−δ⁺=1

W^{max} is the maximal weight in {W₁ . . . Wₘ}.

Objective (at level L): Min Z=Vₜ·δ⁻+ . . . (17)

Comments

1. The goal constraint described above is a one-sided one, where δ⁺=0.

2. The representation above preserves our requirement that the objective function can consist of deviation variables only.

3. UI Issues: The definition of variable t is not within the GP problem. That is, the GP problem will deal only with the other variables we define above.

4. The variable xᵢ is auxiliary, thus, we must also set its upper/lower bounds. These may simply be xε[0, W^{max}]

### Example 1

Suppose that the variable t represents the day of delivery within a week, where the days Sunday through Saturday, are represented using the values one to seven, respectively.

A seller can deliver the product on Tuesdays, Wednesdays, and Fridays, with the following preference weights: {W_{Tue}=1, W_{Wed}=8, W_{Fri}=3}.

Also suppose that the seller asked for some Level of objective L, and some relative importance within that level Vᵢ, and that the seller cannot provide the product on any of the other days.

Definition of t (day): t=3·b₁+4·b₂+6{fourth root}b₃

Definition of x: x=1·b₁+8·b₂₂+3·b₃

b₁+b₂+b₃=1, b₁,b₂,b₃ε{0,1}, 0≦x≦8

Goal constraint: x/8+δ⁻−δ⁺=1

Objective (level L): Min Z=V_{t*}δ⁻

Preliminary Negotiation Stage

Since the xₜ variables participate in negotiation phases in which the parties may attempt to adjust them in small or moderate steps, we decompose the negotiations into a preliminary stage in which the binary variables bᵢ are relaxed through the variables cᵢ. This stage ends with an attempt by the party who is ready to accept an offer made by the other side to re-adjust the xᵢ values according to the binary (bᵢ) rather than the continuous variables (cᵢ). This is illustrated through the following example.

### Example 2

Suppose there are five colors, denoted by the index i=1, . . . , 5 and weighted by the two parties as given below (larger weight means a more desirable value).

| | Color | | | | |
|---|---|---|---|---|---|
| | Red | Orange | Yellow | Green | Red |
| Index (i) | 1 | 2 | 3 | 4 | 5 |
| Buyer's Weights (W_{B}) | 5 | 3 | 3 | 2 | 1 |
| Seller's Weights (W_{S}) | 2 | 3 | 4 | 3 | 4 |

The part in the Buyer's original GP that is relevant to our example is:

$$α = 5 \cdot {δ}_{B}^{-}$$

$${X}_{B} = 5 \cdot {b}_{1} + 3 \cdot {b}_{2} + 3 \cdot {b}_{3} + 2 \cdot {b}_{4} + 1 \cdot {b}_{5}$$

$${b}_{1} + {b}_{2} + {b}_{3} + {b}_{4} + {b}_{5} = 1$$

$$\frac{{X}_{B}}{5} + {δ}_{B}^{-} - {δ}_{B}^{+} = 1$$

$${b}_{i} ∈ \{ 0 , 1 \} ∀ i$$

The corresponding part in the Seller's GP is:

$$β = 4 \cdot {δ}_{S}^{-}$$

$${X}_{S} = 2 \cdot {b}_{1} + 3 \cdot {b}_{2} + 4 \cdot {b}_{3} + 3 \cdot {b}_{4} + 4 \cdot {b}_{5}$$

$${b}_{1} + {b}_{2} + {b}_{3} + {b}_{4} + {b}_{5} = 1$$

$$\frac{{X}_{S}}{4} + {δ}_{S}^{-} - {δ}_{S}^{+} = 1$$

$${b}_{i} ∈ \{ 0 , 1 \} ∀ i$$

$${X}_{S} \geq 3$$

Notice that since the seller's highest ranked alternative was accorded a score of 4, his GP is trying to assign that value to X_{S} while in the buyer's case the top choice was given a score of 5 and therefore his GP tries to set X_{B}=5.

To generate his initial offer, the Seller employs the original binary variables (the bᵢ's). The outcome is:

b₅=1,b₁=b₂=b₃=b₄=0, X_{S}=4,δ_{S}⁻=0 [symbol] β=0

The information that is passed to the buyer is b₅=1. The buyer then evaluates the offer according to his own objective and gets:

X_{B}=1, δ_{B}⁻=0.8, α=4

The Seller's second offer is dictated by his mode of operation (Knowledgeable, Ignorant, Semi-Ignorant, etc.). Let's assume that the seller is knowledgeable, in which case he employs a proportionate improvement factor (say, ρ=0.1) to improve the objective value for the buyer. If the seller is ignorant, similar procedure will follow except that he will be worsening his own objective rather than improving the buyer's objective. In generating this (and all subsequent) offer(s) the parties relax the binary bᵢ's with their continuous counterparts (the cᵢ's). The outcome of the seller's relaxed GP is then:

α^{new}+γ⁻−^{γ}⁺=α^{last}−ρ·(α^{last}−α*) [symbol] α^{new}+γ⁻−γ⁺=4−0.1·(4−0)=3.6 [symbol] δ_{B}⁻=0.72 [symbol] X_{B}=1.4 [symbol] c₁=0.6,c₂=0.4 [symbol] X_{S}=3.4≧3

The Seller's next offer, again dictated by the Knowledgeable mode is:

α^{new}+γ⁻−γ⁺=α^{last}−ρ·(α^{last}−+*) [symbol] α^{new}+γ⁻−γ⁺=3.6−0.1·(3.6⁻⁰)=3.24 [symbol] δ_{B}⁻=0.648 [symbol] X_{B}=1.76 [symbol] c₁=0.24,c₂=0.76 [symbol] X_{S}=3.24≧3

This will continue in the same manner until we reach acceptance. At that point we wish to translate the cᵢ's back into binary values for the corresponding bᵢ's so as to select a unique color. Suppose the buyer (who is also operating in a knowledgeable mode) is ready to accept the last seller's offer (with the values given above). To do so, the buyer will solve an extended GP in which the α^{last}=3.24, β^{last}=1.76 values given in the last seller's offer serve as targets:

$$Min 1000 \cdot {Δ}_{β}^{+} + 100 \cdot {Δ}_{α}^{+} + 10 \cdot ( {τ}^{-} + {τ}^{+} ) + ( {υ}^{-} + {υ}^{+} )$$

$$s . t . \\ \begin{matrix}α + {Δ}_{α}^{-} - {Δ}_{α}^{+} = 3.24 & β + {Δ}_{β}^{-} - {Δ}_{β}^{+} = 1.76 \\ {X}_{B} + {υ}^{-} - {υ}^{+} = 1.76 & {X}_{S} + {τ}^{-} - {τ}^{+} = 3.24 \\ {X}_{B} - {\sum }_{i} {W}_{Bi} \cdot {b}_{i} = 0 & {X}_{S} - {\sum }_{i} {W}_{Si} \cdot {b}_{i} = 0 \\ \sum {b}_{i} = 1 ; & {b}_{i} ∈ \{ 0 , 1 \} ∀ i \\ {GP}_{Buyer} & {GP}_{seller}\end{matrix}$$

If the buyer is operating in an ignorant mode, he will use the following GP to try and finalize the deal:

$$Min 10 \cdot {Δ}_{α}^{+} + ( {υ}^{-} + {υ}^{+} )$$

$$s . t . \\ \begin{matrix}α + {Δ}_{α}^{-} - {Δ}_{α}^{+} = 3.24 & \\ {X}_{B} + {υ}^{-} - {υ}^{+} = 1.76 & \\ {X}_{B} - {\sum }_{i} {W}_{Bi} \cdot {b}_{i} = 0 & \\ \sum {b}_{i} = 1 ; & {b}_{i} ∈ \{ 0 , 1 \} ∀ i\end{matrix}$$

$${GP}_{Buyer}$$

If this attempt to finalize the deal fails (e.g., due to the hard constraint embedded in the GP of either the buyer or the seller) we let the parties continue negotiate. If such failures repeat themselves we can still try to resolve the situation through the mechanism level.

Compilation of Dates

Dates are represented as continuous variables that count the minutes from the beginning of 1.1.1970. To compile date-type variables we translate the absolute date into a relative date. The GP will handle only the relative date variable. To do so, we refer to the lower bound of the absolute date variable as Offset_D (this is the number of minutes from 1.1.1970 to the lower bound). Then, we do the following translations:

The absolute target date specified by the user for D (Abs_tar_D) will be expressed in relative terms as: Rel_tar_D=Abs_tar_D−Offset_D.

The relevant goal constraint will be:

$$\frac{D}{UP\_D - Lo\_D} + {δ}_{D}^{-} - {δ}_{D}^{+} = \frac{Rel\_tar \_D}{UP\_D - Lo\_D} .$$

The optimal value (D*) will be translated back to absolute date terminology through: Abs_D*=Offset_D+D*.

A Trivial Case of Discrete Variables

Input for Compilation

(Regarding a Variable t)

Feasible values of t {T₁ . . . Tₘ}

Level of objective function L

Relative importance within level Vₜ

The values of t are ordered, i.e., tε{T₁, . . . , T₁+m−1}. Moreover, the order of the values represents the user order of preference for these values. I.e. the weights for these values are implicitly {W₁=1, . . . , Wₘ=m}.

Representation in the GP problem

In the described simple case, we set the variable t to be of an Integer type, so that it can be assigned only with integral values. Then we represent the goal as an ordinary goal.

Additional Compilation Issues

Scaling

The scaling of a GP constraint aims to handle two problems, and reference is herein made to C. Romero, Handbook of Critical Issues in Goal Programming. Pergamon press, 1991, referred to hereinabove and specifically to pages 35-6 therein.

The first problem is concerned with goals that deal with very different numerical values (e.g., price in millions of dollars vs. number of days for delivery). In such cases we face difficulties in combining the corresponding deviation variables within the same objective function level.

The second problem is concerned with objective functions that mix deviations that are associated with both discrete and continuous variables. To express ordinal preferences in the dimension of a discrete variable we use internal weights that are arbitrary with respect to the other variables that share the same level of the objective function. Such mixing must be handled with care.

Scaling by Targets

As mentioned above, scaling is concerned with representing all the values in the objective function in consistent units. Given a goal constraint {gᵢ+δᵢ⁻−δᵢ⁺=Tᵢ} we scale the deviation variables such that they express the amount of relative deviation from the target values of each goal, as follows:

$$\begin{matrix}\{ {g}_{i} + {δ}_{i}^{-} - {δ}_{i}^{+} = {T}_{i} \} , & \text{when} 0 \leq \vert {T}_{i} \vert \leq 1 \\ \{ \frac{{g}_{i}}{{T}_{i}} + {δ}_{i}^{-} - {δ}_{i}^{+} = 1 \} , & \text{when} \vert {T}_{i} \vert > 1\end{matrix} \\ \text{(i.e., goal is not scaled)} \qquad ( 18 )$$

For example, suppose we have two goals

{Y+δ_{y}⁻−δ_{y}⁺=5000}

{X+δₓ⁻−δₓ⁺=100}

The scaling described above, will assign the same numerical value to a deviation of 500 in Y and a deviation of 10 in X, (i.e., a 10% deviation in both cases).

Handling Bounds

Above, we discuss the upper and lower bounds that are defined for all the variables in a GP problem. However, after the scaling presented above, we should update the bounds for the deviation variables. Scaling the bounds, similarly to the scaling above, as follows, does this:

$$\begin{matrix}l b ( {δ}_{i}^{-} ) = 0 \\ u b ( {δ}_{i}^{-} ) = \frac{{T}_{i} - l b ( {g}_{i} )}{{T}_{i}} \text{and}\end{matrix} \\ \begin{matrix}l b ( {δ}_{i}^{+} ) = 0 \\ u b ( {δ}_{i}^{+} ) = \frac{u b ( {g}_{i} ) - {T}_{i}}{{T}_{i}}\end{matrix} \qquad ( {18}^{′} )$$

Comments

1. Currently, we ignore constraints with negative targets at the right hand side (RHS) of the goal. However, for the sake of completeness the scaling is represented in the most general way.

2. The deviation variables are apparently not affected by the scaling. However, they can be considered as new deviation variables with the same name but different semantics.

3. Notice that the scaling of bounds described above is only affected for deviation variables (i.e., the bounds on decision variables are not changed).

### EXAMPLE

Suppose we have the following goal constraints (i.e., we'd like X, to be close to 100 but we do not care if it exceeds 100, X₂ close to 1 but we don't care if it is larger than 1, X₃ close to 0.9 but we do not care if it's below 0.9, and X₄ close to 40 and we don't care if it's below 40). Further, suppose that we consider X₁, . . . , X₄ equally important. Now, writing the objective to minimize (δ₁⁻+δ₂⁻+δ₃⁺+δ₄⁺) would be mixing apples with oranges, due to the ranges of these variables. So, we scale the goal constraints as showed in the right column below. Once we do that, we can write the goal, as (δ₁⁻+δ₂⁻+δ₃⁺+δ₄⁺). Note that what we have done is to interpret the fact that the variables are equally important as meaning that percentage-wise deviations in achieving these goals are equally important. Had we been told that XI is twice as important as the other variables, the resulting goal would have been (2·δ₁⁻+δ₂⁻+δ₃⁺+δ₄⁺). Finally, we have not altered the goal constraint with 0.9 as it is reasonably close to 1.

| GP problem (before scaling) | The same GP problem (after scaling) |
|---|---|
| X₁ + δ₁⁻ − δ₁⁺ = 100 | 0.01 · X₁ + δ₁⁻ − δ₁⁺ = 1 |
| X₂ + δ₂⁻ − δ₂⁺ = 1 | X₂ + δ₂⁻ − δ₂⁺ = 1 |
| X₃ + δ₃⁻ − δ₃⁺ = 0.9 | X₃ + δ₃⁻ − δ₃⁺ = 0.9 |
| X₄ + δ₄⁻ − δ₄⁺ = 40 | 0.025 · X₄ + δ₄⁻ − δ₄⁺ = 1 |
| Bounds: | Bounds: |
| 0 ≦ X₁ ≦ 200 | 0 ≦ X₁ ≦ 200 |
| 0.3 ≦ X₂ ≦ 2 | 0.3 ≦ X₂ ≦ 2 |
| 0 ≦ X₃ ≦ 2 | 0 ≦ X₃ ≦ 2 |
| 25 ≦ X₄ ≦ 50 | 25 ≦ X₄ ≦ 50 |
| 0 ≦ δ₁⁻ ≦ 100, 0 ≦ δ₁⁺ ≦ 100 | 0 ≦ δ₁⁻ ≦ 1, 0 ≦ δ₁⁺ ≦ 1 |
| 0 ≦ δ₂⁻ ≦ 0.7, 0 ≦ δ₂⁺ ≦ 1 | 0 ≦ δ₂⁻ ≦ 0.7, 0 ≦ δ₂⁺ ≦ 1 |
| 0 ≦ δ₃⁻ ≦ 0.9, 0 ≦ δ₃⁺ ≦ 1.1 | 0 ≦ δ₃⁻ ≦ 0.9, 0 ≦ δ₃⁺ ≦ 1.1 |
| 0 ≦ δ₄⁻ ≦ 15, 0 ≦ δ₄⁺ ≦ 10 | 0 ≦ δ₄⁻ ≦ 0.375, 0 ≦ δ₄⁺ ≦ 0.25 |

Scaling by Intervals Scaling can be done in interval terminology rather than by target. The advantage is that we can naturally handle a target of 0. For example suppose that D measures delay and we prefer zero delay. Suppose that D is in the range [700,850]. Suppose the target is 800. Observe that the question to which the answer is 5 (as shown in the objective function below) is “what penalty would you assign to a deviation the size of the whole interval?” Of course, at the GUI level, the question may be phrased differently.

$$\begin{matrix}Min & 5 \cdot {δ}_{P}^{-} \cdot + … & \text{/*5 is penalty for a deviation of 150 units*/} \\ s . t . & & \\ & \frac{D}{150} + {δ}_{P}^{-} - {δ}_{P}^{+} = \frac{800}{150} & \text{/*deviation measured as fraction of interval*/} \\ & 700 \leq D \leq 850 & \end{matrix}$$

Pre- and Post-Matching Specification Via Intervals

A user specifies the importance in “interval units” prior to matching with other parties. The effective interval is the intersection of the intervals specified by the parties. Observe that when specifying, a party does not necessarily know which other parties' intervals will be encountered. We differentiate between resulting point intervals, small intervals, and normal intervals.

Normal Intervals

Suppose a party specified an importance of 5 and its interval at specification time had 150 units as in the example above. Suppose the size of the intersection with another party's interval has just 50 units. First, if the “old” target is outside the intersection (e.g., the intersection is [705,755]), we “push it” towards the closest intersection boundary (755) thereby creating a new target. If the “old target” is within the new interval (e.g., the intersection is [760,810]), we leave the target unchanged. Next, we modify the goal constraints and objective function to reflect the new interval. The resulting compilation, assuming a new interval of [705,755] and following the scheme above, is depicted below. Observe the changes in the target in the goal constraint and the new bounds on the interval. Also note the addition of the term 5(45/150) to the objective function due to a target shift from 800 to 755. This constant term does not affect optimization and we may remove it in treating the goal program. It is brought back only when the original goal program is used for ranking offers.

$$\begin{matrix}Min & 5 \cdot \frac{45}{100} + 5 \cdot {δ}_{P}^{-} \cdot + … & \text{/*5 is penalty for a deviation of 150 units*/} \\ s . t . & & \\ & \frac{D - 705}{150} + {δ}_{P}^{-} - {δ}_{P}^{+} = \frac{755 - 705}{150} & \text{/*deviation measured as fraction of interval*/} \\ & 705 \leq D \leq 755 & \end{matrix}$$

Note that we can do away with the −705 term that appears in both sides of the equation.

Point Intervals

Point intervals are simply points, namely the intersection of the parties' intervals is a point. In this case, we substitute for the variable in question its value (the point) in the constraints. This also gives values to the deviations. We introduce the resulting constants into the objective functions. As before, we have the option of removing these constants altogether.

Small Intervals

The resulting interval may be “small”. However, smallness is a relative term and what is small for party A may be large for party B. If both parties agree that the interval is small, then they may simply choose a mid-point between their targets (shifted into an interval boundary point if needed) and we are back to the case of a point interval. If the interval is large for both we treat it as normal. If one party considers it small and the other as big, we treat it as normal.

Transforming from Target-Based to Interval-Based Formulation

In the target-based compilation method we treat importance factor as related to fractional deviation from a target of one. Consider an attribute P (for price) with a domain of [1, 1000] and target of 500. Further suppose it has importance level of 7 and that only positive deviations matter. Scaling by targets would lead to:

$$\begin{matrix}Min & 7 \cdot ( {δ}_{P}^{+} ) + … \\ s . t . & \\ & \frac{P}{500} + {δ}_{P}^{-} - {δ}_{P}^{+} = 1 \\ & 1 \leq P \leq 1000\end{matrix}$$

Suppose that following unification with another party's business intention, the revised domain is [450,750]. Assume further that the other party's target for P is 700. Let us assume that we want to treat this new domain in such a way as to give an equal importance to a Dollar in the vicinity of 500 as to a Dollar in the neighborhood of 750. To do that, we measure deviations in ‘interval units’ (before it was in ‘target units’). So, the compilation is transformed into:

$$\begin{matrix}Min & \frac{7 \cdot 300}{500} \cdot {δ}_{P}^{+} \cdot + … & \\ s . t . & & \\ & \frac{P}{300} + {δ}_{P}^{-} - {δ}_{P}^{+} = \frac{500}{300} & \text{/*deviation measured as fraction of interval*/} \\ & 450 \leq P \leq 750 & \end{matrix}$$

The factor ((7*300)/500) is due to the fact that an importance of 7 was attributed to a deviation of 500 Dollars (the target size), which translates to an importance level of (7/500) for a one Dollar deviation. In the “new” version, deviation is measured as a fraction of the interval size, so to translate it to Dollars we multiply by 300. Hence the resulting factor in the objective function. So, what we showed is how to move from ‘target oriented’ compilation to ‘interval oriented compilation’.

What we showed so far is that we can represent the user 's preference in terms of intervals and that we can translate from target based representation to interval-based representation. The other direction is not always possible due to targets of zero.

Targets Outside of Their Domain

Occasionally, we may encounter target values that are outside of the feasible range of values specified by the GP for a given variable. This may happen, for example, when one of the negotiating parties defined in his intention a range that is much larger than the range defined by the other party and a target that is closer to the high end of his range (say, a range of [100,600] with a target at 500 for a Price (P) variable while the other party's range is [100,120] with a target at 110). The unification procedure sets the feasible range for this variable according to the intersection of the ranges—in our case this means that it is set according to the definition of the second party.

These situations may cause severe distortions in the evaluation of the deviation from the goals. When weights were solicited in order to be used as coefficients in the objective function, the users were thinking about the relative negative effect of deviation by one unit above or below a target in one dimension versus another. In the case described above, the proportional deviation in P for the first party will range between 0.76 to 0.8

$$( \frac{380}{500} , \frac{400}{500} ) .$$

Hence, the importance of this deviation is rather marginal since the intrinsic deviation itself is quite significant no matter which value will eventually be selected for P.

To correct these deficiencies we set the bound nearest to the target as an effective target for a variable whose original target is outside its allowed domain (in our case, 120 becomes the effective target). Consequently, we need to transform the original deviation variables into new ones. This is demonstrated through the following example (where target-based scaling is used).

Original Formulation

$$\text{Original formulation}$$

$$\begin{matrix}Min & 7 \cdot ( {δ}_{P}^{-} ) + 5 \cdot ( \frac{{δ}_{D}^{-} + {δ}_{D}^{+}}{2} ) \\ s . t . & \\ & \frac{P}{500} + {δ}_{P}^{-} - {δ}_{P}^{+} = 1 \\ & \frac{D}{80} + {δ}_{D}^{-} - {δ}_{D}^{+} = 1 \\ & 100 \leq P \leq 120 \\ & 30 \leq D \leq 90\end{matrix}$$

We define a transformation between the original deviation (δ_{P}⁻) and a new one (\hat{δ}_{P}⁻) that would relate the deviation to the effective target:

$$\frac{120 \cdot {\hat{δ}}_{P}^{-} + 380}{500} = {δ}_{P}^{-} .$$

Observe that \hat{δ}_{P}⁻ is measured as a fraction of 120 (the effective target). This leads to the following revised model.

$$\text{Transformed formulation}$$

$$\begin{matrix}Min & \frac{7 \cdot 120}{500} \cdot ( {\hat{δ}}_{P}^{-} ) + 5 \cdot ( \frac{{δ}_{D}^{-} + {δ}_{D}^{+}}{2} ) \\ s . t . & \\ & \frac{P}{120} + {\hat{δ}}_{P}^{-} - {\hat{δ}}_{P}^{+} = 1 \\ & \frac{D}{80} + {δ}_{D}^{-} - {δ}_{D}^{+} = 1 \\ & 100 \leq P \leq 120 \\ & 30 \leq D \leq 90\end{matrix}$$

Notice that the revised weight on deviations from the effective target in P is now much smaller than its original value. Also notice that the fixed term

$$( \frac{7 \cdot 380}{500} )$$

was omitted from the objective function, as we do not carry constants in these functions. (Note that we still have to “remember” this constant once we compare the end result of negotiations with this GP with an end result of negotiating with another GP obtained similarly from the original GP but for another interval.) The treatment of the other variable (D) was not directly affected by the transformation. Indirectly, however, the weight on the deviations from its target, which was inferior before, is now superior to that associated with deviations in P. This is the right thing to do as indeed all points in [100,120] are roughly of the same quality regarding a target of 500.

The general form for deriving the new deviation variable \hat{δ}_{P}⁻ is:

$$\frac{ET \cdot {\hat{δ}}_{P}^{-} + \vert OT - ET \vert}{OT} = {δ}_{P}^{-}$$

where OT is the “old” target and ET is the new effective target (an end-point of the unified interval). When the original target is greater than the upper bound, ET is equal to the upper bound of the variable and |OT−ET|=OT−ET. In the other direction, ET is equal to the lower bound and |OT−ET|=ET−OT.

Of course, the goal constraint that was originally compiled using OT is now replaced with one using ET and \hat{δ}_{P}⁻.

Cases Where OT is Smaller than 1 and ET is Larger than 1

When OT is smaller than 1 the original goal constraint was not normalized. Hence, in these cases the proper transformation is:

ET·\hat{δ}_{P}⁺+(ET−OT)=δ_{P}⁺

Notice that δ_{P}⁺ is expressed in absolute terms while \hat{δ}_{P}⁺ is expressed in relative terms.

Cases Where OT is Greater than 1 and ET is Smaller than 1

Here we go in the opposite direction. The original goal constraint was normalized and the transformed one is not. Hence, here δ_{P}⁺ is expressed in relative terms while \hat{δ}_{P}⁺ is expressed in absolute terms and,

$$\frac{{\hat{δ}}_{P}^{+} - ( OT - ET )}{OT} = {δ}_{P}^{+}$$

Cases Where OT and ET are Smaller than 1

\hat{δ}_{P}⁺+|ET−OT|=δ_{P}⁺

A General Compilation Example

An agent who sells used cars is willing to sell a car with the following requirements

Price: represented by variable p.

Price ranges between [2200-3500] in $US.

The target price is Tₚ=3000.

The Relative importance for price is Vₚ=1000.

The weights on deviations are Wₚ⁻=1, Wₚ⁺=0.5.

Delivery day: represented by variable d.

Delivery day ranges between [10-18] from the day of signing the deal.

No target day is given.

The relative importance for delivery is V_{d}=100.

Color: represented by the variable t.

Color is one of the following: Red, Black, and Silver.

Color strings have the translation values tε{17, 22, 50} respectively.

The relative importance for color is V_{d}=10.

The colors' weights are W={10, 20, 30}, respectively. For example, these weights may have some relevance to the number of cars that remain in store for some color).

All the variables are at the same level in the objective function.

Tradeoff: A tradeoff is specified between the price and the delivery day, e.g., for better usage of the parking space available to the seller. Suppose that the seller provided the following two equally desired points for the tradeoff, {12, 3000} and {15, 3090}, representing a loss of $30 for every day of delay in delivery.

The relative importance of the tradeoff is V_{dp}=300.

Also assume equal preference for deviation in either direction, i.e., W_{dp}⁻=W_{dp}⁺=1

To construct the tradeoff constraint we first find its parameters (a=−88 and b=1/30). Then, we create a dynamic target for d on the basis of its relations with p.

The example is presented in terms of target-based scaling.

$$Z = Min 1000 \cdot ( {δ}_{P}^{-} + 0.5 \cdot {δ}_{P}^{+} ) + \frac{300}{\sqrt{2}} \cdot [ ( {δ}_{pd}^{-} + {δ}_{pd}^{+} ) ] + 10 \cdot {δ}_{x}^{-}$$

subject to:

p/3000+δₚ⁻−δₚ⁺=1 (price)

x/30+δₓ⁻−δₓ⁺=1 (color)

d/88−8/2640+δ_{pd}⁻−δ_{pd}⁺=1 (price−day tradeoff)

t=b₁·17+b₂·22+b₃·50 (representation of t)

x=b₁·10+b₂·20+b₃·30

b₁+b₂+b₃=1

2200≦p≦3500 (bounds from UI)

10≦d≦18

0<δₚ⁻≦800/3000 (compiled bounds)

0<δₚ⁺≦500/3000

0≦“_{d}⁻≦2/12

0≦δ_{d}⁺<6/12

0≦x≦30

0≦δₓ⁻≦1

0≦δₓ⁺<0

0<δ_{dp}⁻≦3180/2640

0<δ_{dp}⁺≦3180/2640

b₁,b₂ b₃ε{0,1}

Utility Layer of an Automatic Negotiation System.

Introduction

This section describes the utility layer of an automatic negotiation system. An automatic negotiation system offers facilities for automated negotiations that may be used by a variety of applications in eCommerce, Communication, Financial Services, Insurance and more. The utility layer provides means for handling offers. Specifically, it includes facilities for suggesting, verifying, completing, evaluating, ranking, modifying and updating offers. Here, offers may be multi-item, multi-attribute complex offers with various constraints, preferences and trade-offs. The underlying assumption is that such constraints, preferences and trade-offs are expressed in terms of Goal Programs (GP). Goal programs are well known in the scientific literature and their usage as a foundation for negotiations was first described in PCT/IL00/00516.

To summarize:

We outline a collection of manipulation procedures. This defines an API (application program interface) for negotiations. The API is described in terms of Goal Programs. However, it is generic in concept and can apply to other formalisms for describing a user's set of constraints, preferences and trade-offs, e.g. the Analytic Hierarchy Process (AHP), see Saaty (1980).

We define the actual manipulation algorithms in terms of Goal Programs. These algorithms were implemented in the programming language C and tested in conjunction with software for linear and integer programming.

Although we use the names “Bob” and “Sue” for the negotiating agents, the procedures may apply to arbitrary parties, buyers, sellers and also symmetric ones (e.g., bartering).

Notation

In describing negotiating parties we use “Bob” and “Sue” to name the parties. Each party could be a trader (buyer, seller, barterer) or more generally a parry negotiating an issue (e.g., an environmental project decision attributes).

x this is a vector of decision variables.

X this is a vector of values for decision variables.

d this is a vector of deviation variables of a goal program.

D this is a vector of values for deviation variables of a goal program.

[X|D] this is a combined presentation of X and D above.

α this is a vector of priority levels in the objective function of Bob. Here, the levels are of the form {α₁ . . . αₖ} where αᵢ is an objective expression (min or max). We may sometimes blur the distinction between the expressions and their resulting evaluation within a particular assignment of values to deviation and decision variables.

F_{α} Set of goal constraints that link the elements of x with their respective deviation variables in Bob's program. By writing xεF_{α} we loosely mean that x and the associated deviation variables satisfy this set of constraints.

S_{B} Set of hard constraints in Bob's program, including level-by-level.

β Vector of priority levels in the objective function of the Sue.

F_{β} Set of goal constraints that link the elements of x with their respective deviation variables in the Sue's program.

S_{S} Set of hard constraints in the Sue's program, including level-by-level.

P_{agent}^{type} A proposal of type={“new”, “last” or “best”} made by the agent={“Bob” or “Sue”} (where “best” means that this proposal contains the best values offered so far from the point of view of the other agent). A proposal consists of:

1. A tuple T=[D|X] of values for the deviation, D, and decision variables, X.

2. A tuple α of the objective-functions values.

x_{agent}^{type} Values of the decision variables associated with P_{agent}^{type}.

α_{agent}^{type},β_{agent}^{type} Values for the priority levels of Bob and Sue respectively associated with P_{agent}^{type}.

α*,β* Best possible values for the priority levels of Bob and Sue respectively.

α_{*},β_{*} Worst possible values for the priority levels of Bob and Sue respectively.

ρ_{SS} Proportion of improvement in Sue's utility (β) with respect to β_{S}^{last}.

ρ_{SB} Proportion of improvement in Sue's utility (β) with respect to β_{B}^{last}.

ρ_{BB} Proportion of improvement in Bob's utility (α) with respect to α_{B}^{last}.

ρ_{BS} Proportion of improvement in Bob's utility (α) with respect to α_{S}^{last}.

ρ_{S},ρ_{B} Proportion of decrease in Sue's (Bob's) utility β(α).

R_{S} Region of acceptable β values for Sue.

R_{B} Region of acceptable α values for Bob.

W, V Vectors of weights on deviation variables

Notes

A Linear Program (LP) problem consists of a list of constraints, a list of bounded variables, and an objective function to be minimized.

To solve a LP we currently may use any LP package (e.g., lp_solver3.0), which implements the Simplex algorithm and can handle integer variables, or other relevant algorithms.

We assume there are upper and lower bounds over all the variables (decision and deviation variables alike), so that we can be sure that the problem is a bounded one; this also has the advantage of accelerating the work of the simplex LP-solver.

A GP problem consists of a list of goal-constraints, a list of hard constraints, a list of bounded variables, and a list of objective functions to be minimized.

To solve a GP problem we developed the GPSolve package that implements a lexicographic (lex-min) method and several auxiliary techniques to guarantee good results when using the LP solver.

The lex-min method is a simple inductive process that considers the next LP objective in each step, to be the next function in the objective-list (according to their given priorities) and where all prior objectives were translated into new constraints.

For the sake of clarity, the document is written as if there is a negotiation session between two agents, Sue and Bob. Thus, each algorithm or procedure is implemented from the perspective of one of these agents.

A k-level objective function is of the form

α=LexMin or LexMax{α₁ . . . αₖ}.

Notice that we extended the notion of lex-min or lex-max where all levels are minimization or maximization objectives, so that we allow each objective level αᵢεα to have its own type, noticing that Mar{X}≡Min{−X}.

Note: each level is a simple expression describing a linear combination over the problem's variables. However, in the description below, we sometimes avoid describing the objective function explicitly. That is, we sometimes combine several levels into one descriptive level just for the sake of simplicity in the presentation of the model.

Note: unless otherwise stated, procedures are presented from Bob's point of view.

An example of GP Business Intentions of two Parties—An Insurance Problem This problem deals with buying auto insurance. The parameters are: overall price, deductible, coverage, ability to choose repair shop, requirements for anti-theft devices, free towing distance, windows replacement, number of days a substitute car will be provided in case of accident and whether the customer is entitled to new replacement parts following an accident.

Min Lex problem (Bob here, a customer looking for an insurance policy)

Objective functions

G1 monetary considerations objective function, first priority level:

{π⁺+δ⁺+0.01γ⁻}

G2 qualitative terms objective function, second priority level:

{ρ⁺+σ⁺+0.1τ⁻+ω⁺+0.2ν⁻+2μ⁺}

Goal Constraints

Premium constraint P+π⁻−π⁺=1500

Pay as less as possible Premium. Not more than 5000

Deductible constraint D+ε⁻−δ⁺=1000

Pay as less as possible deductibles. Not more than 1500

Coverage constraint C+γ⁻−γ⁺=8,000,000

Gain as much Coverage as possible. No less than 1,000,000

Repair-shop constraint R−ρ⁺=0

Get free option for choosing a repair shop (R=0—free choice)

Security constraint S−σ⁺=0

Put as less Security equipment as possible. Not more than two anyway.

Towing constraint T+τ⁻=500

Get as much Towing distance as possible.

Windows constraint W−ω⁺=0

Get coverage for windows-repair (W=0—covered)

Substitute-car constraint N+ν⁻=364

Get as much as possible a longer period for a substitute car.

Spare-parts constraint M−μ⁺=0

Get free choice for choosing type of spare-parts (M=0—free-choice)

Additional bounds

0≦π⁻≦1500

0≦π⁺≦3500

0≦δ⁻≦1000

0≦δ⁺≦500

0≦γ⁻≦7,000,000

0≦γ⁺≦2,000,000

Min Lex problem (Sue here, an insurance salesperson)

Objective functions (in 2 levels)

G1 monetary considerations: {π⁻+δ⁻+0.01γ⁺}

G2 qualitative terms: {ρ⁻+σ⁻+0.1τ⁺+ω⁻+0.2ν⁺+2μ⁻}

Goal Constraints

Premium constraint P+π⁻−π⁺=2000

Premium should not go too much under 2000. Not more than 5000

Deductible constraint D+δ⁻−δ⁺=1300

Deductibles should not exceed 1300 by too much. Not more than 1500

Coverage constraint C+γ⁻−γ⁺=3,000,000

Coverage should not exceed 3,000,000 by too much. No less than 1,000,000

Repair-shop constraint R+ρ⁻=1

Prefer not giving a free option for choosing a repair shop (R=1—no free choice)

Security constraint S+σ⁻=2

Prefer as much Security equipment as possible.

Not more than two anyway.

Towing constraint T−τ⁺=0

Give as little Towing distance as possible.

Windows constraint W+ω⁻=1

Do not provide coverage for windows-repair (W=1—not covered)

Substitute-car constraint N−ν⁺=0

Prefer as little as possible a period for a substitute car.

Spare-parts constraint M+μ⁻=1

Prefer not providing a free choice for choosing type of spare-parts (M=1—no free-choice)

### Additional Bounds

0≦π⁻≦2000

0≦π⁺≦3000

0≦δ⁻≦1300

0≦δ⁺≦200

0≦γ⁻≦2,000,000

0≦γ⁺≦7,000,000

GP Solver

All the basic utilities described in this document, use GP(s) as their input. Moreover, they generally construct a derived GP and solve it, to realize a desired functionality.

Generally speaking, a GP that is used during negotiation may be modified, to contain information regarding previous “achievements” of the negotiation, usually at higher levels of the objective function (see Switch Level Utilities).

Certain Utilities, in particular the ones dealing with negotiation support, assume that the necessary information is already contained in the GP(s) at the input.

On the other hand, the GP solver described herein makes no assumptions as to how the GP it handles was created, and solves it in a generic way. That is, it simply handles a GP model by finding, lexicographically, the minimum of its objective function levels. An important feature of solving the GP is that no pair of deviation variables which stem from the same decision variable, are both nonzero.

gp_solve

Input:

1. A GP: α—The problem objectives (including region-bounds)

F_{α}—The goal constraints

S_{B}—The hard-constraints (including the bounds)

Output:

A proposed solution P_{agent}^{new}, in which no pair of deviation variables of the same decision variable are both nonzero, which consists of:

1. A tuple a of the optimal objective-function values.

2. A tuple T=[X|D] of the corresponding values for the deviation and decision variables, respectively.

Description:

Solves a lex-min GP via iterative calls to the Simplex algorithm.

1. For I=1, . . . , k and objective function αᵢεα (solve a new LP)

a. Set the objective αᵢ as the current LP objective.

b. Solve the LP and find αᵢ^{new}, the optimal objective value for the LP problem.

c. Add a new goal-constraint (αᵢ≦αᵢ^{new}) into the LP.

1.1. Check for pairs of deviation variables, for the same decision variable, s.t. (δᵢ⁻>0) [symbol] (δᵢ⁺>0).

If no such pairs exist proceed to step 2.

1.2. For every goal constraint (fᵢ+δᵢ⁻−δᵢ⁺=tᵢ) s.t. (δᵢ⁻>0 [symbol] δᵢ⁺>0), add the suitable disjunction constraints to eliminate such redundancy.

1.3. Remove the constraints added in steps i.e. above.¹ ¹ Usually, in ordinary GP's non-zero pair exceptions never occur. In our case, since a deviation variable may appear in more than one constraint or objective, a non-zero pair situation may happen. To overcome this difficulty, the problem is re-solved, from the beginning, with the addition of constraints on the pair of deviation variables, in order to eliminate redundant solutions with pairs of deviation variables having non-zero values

1.4. Go back to step 1 with the same value of k, i.e., stay at this level.

2. Set the Hanan-objective as the next objective². ² See Hanan's Method (Pareto Efficiency).

3. Solve the LP and find α_{Hanan}^{new}, the solution of the LP with the above objective and current constraints.

4. Return.

Elimination of Non-Zero Deviation Pairs

We solve GP problems in a non-direct way, by employing the simplex algorithm, level by level, for every level of the objectives vector.

This may easily lead to solutions where a pair of deviation variables, corresponding to the same goal will have non zero values, violating the basic requirement that (δᵢ⁻·δᵢ⁺=0), for every goal {gᵢ+δᵢ⁻−δᵢ⁺=tᵢ}.

The solution described herein adds linear constraints to insure that at least one of the deviation-variables-pair is zero.

For every goal {gᵢ+δᵢ⁻−δᵢ⁺=tᵢ}, such that (δᵢ⁻·δᵢ⁺≠0), i.e., (δᵢ⁻>0 [symbol] δᵢ⁺>0):

1. Add to the GP problem a new binary variable zᵢ as follows:

a. zᵢ assumes only integer values

b. Bound it: 0≦zᵢ≦1

2. Add to the GP problem the following two constraints:³ ³The values ub(dᵢ⁻),ub(dᵢ⁺) are the upper-bound constants of the {dᵢ⁻, dᵢ⁺} values, respectively.

$$\begin{matrix}\{ {δ}_{i}^{-} - ub ( {δ}_{i}^{-} ) \cdot {z}_{i} \leq 0 \} & \text{fulfilling} \{ {δ}_{i}^{-} \leq ub ( {δ}_{i}^{-} ) \cdot {z}_{i} \} \\ \{ {δ}_{i}^{+} + ub ( {δ}_{i}^{+} ) \cdot {z}_{i} \leq ub ( {δ}_{i}^{+} ) \} & \text{fulfilling} \{ {δ}_{i}^{+} \leq ub ( {δ}_{i}^{+} ) \cdot ( 1 - {z}_{i} ) \}\end{matrix}$$

When {Z, =0} d=0 is forced, when {Z, =1} δᵢ⁺=0 is forced.

Observe that when binary variables are used we use Integer Programming techniques such as branch-and-bound on top of Simplex (as usually provided by commercial tools.)

After adding all the above constraints for every pair of deviation variables, we re-solve the GP problem with the original objective function.

Hanan's Method (Pareto Efficiency)

Generating the Hanan Method

This method is used to ensure that the optimal solution obtained for the GP problem, is not inferior (see Romero 1991). Thus, obtaining a Pareto Efficient solution.⁴ ⁴ This implies, actually, that when the user defines in the GUI an indifference range, we assume that the user will be happier if we improve the solution within this range. For interval goal programming, some of the deviation variables need to appear with zero coefficients in the objectives.

Finding an optimal solution for a GP problem guarantees that the list of objective functions has the minimal possible values. However, this is not always the best solution of the original problem (before it was formulated in GP terms). Specifically, it does not guarantee the optimal values of the decision variables, when there are many solutions for the same optimal objective values.

Basically, Hanan's method tries to maximize the values of the deviation-variables for which there is an implicit preference to move in their respective direction (syntactically, these are deviation variables that did not participate in any objective function).⁵ ⁵ We may consider the lex-min objective-vector as a requirement to minimize the damage of deviating from the targets set on the goal-constraints in the undesirable direction (minus or plus). Thus, Hanan tries to maximize the benefit of deviating from the target in the desirable direction.

Therefore the “Hanan objective” is of the form: {−Σδᵢ⁻}+{−Σδⱼ⁺} for those δᵢ⁻,δⱼ⁺ that did not appear in any objective function of the original GP problem.

Relationship Between Hanan and Non-Zero Deviation Pairs

Hanan's method is one of two methods we use to enhance the quality of the solutions we provide for a GP problem. The other method ensures that no pair of deviations variables (participating in the same goal-constraint) will have a non-zero value for both of the variables.

Next, we show that Hanan's method cannot eliminate, nor prevent, deviation variables from fulfilling the requirement: δᵢ⁺·δᵢ⁻=0 (cases of non-fulfillment do exist). This explains why we need to handle such cases explicitly.

### Example 1

This example shows that Hanan's method cannot eliminate a solution, where a pair of deviation variables has non-zero values.

| | |
|---|---|
| Min_Lex{−δᵢ⁻} | Solving the lex-min above, we get the solution: |
| X + δᵢ⁻ − δᵢ⁺ = 100 | {X = 70}, {δᵢ⁻ = 150}, {δᵢ⁺ = 120} |
| X = 70 | Before solving Hanan we add the constraint, |
| δᵢ⁻ ≦ 150 | which corresponds to the level we just solved: |
| δᵢ⁺ ≦ 150 | {−δᵢ⁻ ≦ −150}. This is in preparation for |
| Hanan : Min{−δᵢ⁺} | handling the next level. |
| | It is trivial to see that adding the Hanan objective |
| | cannot change the above solution, thus, it cannot |
| | eliminate a solution where the pair of deviation |
| | variables are non-zero. |

### Example 2

Hanan's method forces a solution where both deviation variables are non-zero.

| | |
|---|---|
| MinLex{−δᵢ⁻} | Solving the lex-min above, we get the solution: |
| X + δᵢ⁻ − δᵢ⁺ = 100 | {δᵢ⁻ = 50}. And possibly: {X = 50}, {δᵢ⁺ = 0}. |
| 50 ≦ X ≦ 150 | Before solving Hanan we add the constraint: |
| δᵢ⁻ ≦ 50 | {−δᵢ⁻ ≦ −50} in preparing for the next level. |
| δᵢ⁺ ≦ 50 | Applying Hanan will force the solution: |
| Hanan: Min{− δᵢ⁺} | {δᵢ⁻ = 50}, {δᵢ⁺ = 50}, {X = 100}. |
| General Purpose | This causes both deviation variables to have non- |
| Utilities Suggest | zero values. |

Input:

1. A GP: α—The problem objectives

F_{α}—The goal constraints

S_{B}—The hard-constraints

2. Mode of operation: [Optimal, Worst, Any, Percent, Average]

3. [An optional percentage ρ, for the Percent mode]

4. [An optional reference value α⁰ to improve, for the Percent mode]

Output:

A proposed solution P_{B}^{new}, consisting of

1. A tuple T=[D|X] of values for the deviation, D, and decision variables, X.

2. A tuple α of the objective-function values.

Description:

The function suggests a solution, according to the mode of operation, as follows:

Optimal

Derives the optimal solution for the GP. ⁶ ⁶ The utility layer has no preference to minimization problems over maximization ones.

1. Call gp_solve(GP) and return its result⁷: T*=[D*|X*] and α*. ⁷ We use * in superscripts to indicate best and in subscript to indicate worst.

Worst

Derives the maximum solution for the GP (recall that all GP variables are bound).

1. Invert the objective functions in the GP formulation. That is, at every level change the Min operator to Max (and vice versa, depending on its original direction).

2. Call gp_solve(GP) and return its output: T_{*}=[D_{*}|X_{*},] and a_{*}.

Any

Derives an Arbitrary Feasible Solution.

1. Prepare a single objective function as follows.

For every pair of deviation variables of the original GP:

Randomly choose one of them, and randomly assign a coefficient for the chosen deviation variable in the range [0,b] where b is a system parameter. Insert the deviation variable multiplied by its coefficient into the objective function. The coefficient for the other member of the pair is set to zero.

2. Call gp_solve(GP) and return its output.⁸ ⁸ The function must generate a feasible solution, unless the goal-constraints and bounds have no feasible solution.

Percent (ρ) ⁹ ⁹ This is considered as a general and simple Improve function. It also works Level-by-Level.

Derives a solution that is worse than α⁰ values by no more than ρ%. The current solution reduces each objective at a time, using the same percentage ρ% for all objectives. Other variations are possible (e.g., do it only for the first, and most important, level).

1. Add to the GP the following goal-constraints and bounds:

a. For every objective function αᵢ and its value αᵢ^{0 10} ¹⁰ The α_{Bi}^{last} values are taken from P_{B}^{last}.

Add the goal constraint: αᵢ+δᵢ⁻−δᵢ⁺=αᵢ⁰+ρ·|αᵢ⁰|

2. Replace the objective-function vector of GP:

a. Insert the function

$${\sum }_{i = 1}^{k} ( {ω}_{i}^{+} {δ}_{i}^{+} + {ω}_{i}^{-} {δ}_{i}^{-} )$$

(ωᵢ⁺δᵢ⁺+ωᵢ⁻δᵢ⁻) as the first priority level; here the weights ωᵢ⁺, ωᵢ⁻ are such that the lower i is, the higher the weight, e.g., use powers of ten.

b. Set the rest of the priority levels according to the original α objective function (that is, each function in the original objective is pushed one level down, in order).

3. Call gp_solve(GP) and return its output.

Average

Derives a solution that is as close as possible to the average (between the optimal and the worst solutions) of the objective function values¹¹. ¹¹ The derived solution will be feasible since it is generated by a GP formulation where feasibility is guaranteed.

1. Find the optimal solution X*, α* and the worst solution X_{*}, α_{*}

2. Add to the GP the following goal-constraints and bounds:

a. For every objective function aᵢ:¹² ¹² The α_{B(i)}^{last} values are taken from P_{B}^{last}.

Add the goal constraint: aᵢ+δᵢ⁻−δᵢ⁺=(αᵢ+α_{i*})/2

3. Replace the objective-function vector of GP:

a. Insert the function:

$${\sum }_{i = 1}^{k} ( {ω}_{i}^{+} {δ}_{i}^{+} + {ω}_{i}^{-} {δ}_{i}^{-} )$$

(ωᵢ⁺δᵢ⁺+ωᵢ⁻δᵢ⁻) as the first priority level; here the weights ωᵢ⁺, ωᵢ⁻ are such that the lower i is, the higher the weight, e.g., use powers of ten.

b. Set the rest of the priority levels according to the original a objective function (that is, each function in the original objective is pushed one level down, in order).

4. Call gpsolve(GP) and return its output.

Rank

Input:

1. A GP: α—The problem objectives

F_{α}—The goal constraints

S_{B}—The hard-constraints

2. A set of h tuples of values {T^{j}=[D^{j}|X^{j}]}¹³ 1≦j≦h. ¹³ The tuples may be partial or complete.

Output:

1. A sorted set of h tuples of values: {T^{j}^{^{′}}=[D^{j}^{^{′}}|X^{j}^{^{′}}]} if each with its rank number.

Description:

Calculates the objective function values for each tuple, and performs a lexicographical ordering of the objective vectors to sort the tuples. As a result, the tuples are ordered from most preferred to least preferred.

1. For every input tuple T^{j}, 1≦j≦h.

a. If the tuple T^{j} is partial, complete it to the optimal possible values. ¹⁴ ¹⁴ This is done by calling Complete(GP, T^{j}, Optimal)

b. Calculate the objective function values (α^{j})—each element in the α^{j} vector is a weighted sum of deviation values.

c. If the tuple is not feasible, then discard it from the sorting process.

2. Lexicographically, sort the tuples α¹ . . . α^{h} into α¹^{^{′}} . . . α^{h}^{^{′}}.

3. Re-arrange and return the tuples T¹^{^{′}} . . . T^{h}^{^{′}} according to the arrangement of α¹^{^{′}} . . . α^{h}^{^{′}} (h′<h is possible in case some input tuples are discarded as not feasible).

Choose

Input:

1. A GP: α—The problem objectives

F_{α}—The goal constraints

S_{B}—The hard-constraints

2. A set of h tuples of values {T^{j}=D^{j}|X^{j}}¹⁵ 1≦j≦h. ¹⁵ The tuples may be partial or complete.

3. The number m of best tuples to be chosen (out of h).

4. A maximum threshold vector H on the objective values of the tuples.¹⁶ ¹⁶ This threshold indicates whether a tuple is too bad to be considered by the Choose function.

Output:

1. A sorted set of m tuples of values {Tᵢ′=[Dᵢ′|Xᵢ′]} of values, each with its rank number.

Description:

The purpose of this function is to choose the best m good-tuples out of the suggested input tuples T. A tuple is considered as “good”, when its objective-vector value does not exceed the maximal threshold H.

1. For every input tuple T^{j}, 1≦j≦h

a. If the tuple T^{j} is partial, complete it to the optimal possible values. ¹⁷ ¹⁷ This is done by calling Complete(GP, T^{j}, Optimal)

b. Calculate the objective function α^{j} values.

c. If the tuple is not feasible, then discard it from the sorting process.

d. If α^{j}>H ¹⁸, then discard it from the sorting process. < becomes > ¹⁸ Lexicographical comparison.

2. Lexicographically sort¹⁹ the tuples α¹ . . . α^{h} into α¹^{^{′}} . . . α^{h}^{^{′}}. ¹⁹ This may require sorting or just finding the best tuples, see the next section about Max_Rank

3. Re-arrange and return the best up to m tuples T¹^{^{′}} . . . T^{m}^{^{′}} according to the arrangement of α¹^{^{′}} . . . α^{h}^{^{′}}.

Max_Rank

As mentioned in the previous section, the Choose function should sort the objective functions, to find the best m tuples.

However, suppose m=1, in this case we are required to return the best tuple. Thus, it is enough to solve the minimum (or maximum) problem, rather than the sort problem.

We chose an arbitrary threshold of seven, so that if m≦7, we solve a max/min problem, and otherwise we sort the tuples.

Therefore, this function is needed only for efficiency reasons. It is considered as an auxiliary function.

The algorithm is a trivial extension that finds the maximal value within a set of values:

Sketch of the Max_rank algorithm:

Let the sorted set, Max7, hold the current best up to seven tuples out of those examined thus far. Initially, the first 7 tuples are loaded. (The number 7 could be replaced with any other number that is judged as “small” in the problem domain.)

1. For every tuple αⁱ, iε[1 . . . h]

a. If αⁱ is better than one of the vectors in Max7, then:

i. Delete the lowest, i.e. worst, member of the set.

ii. Add αᵢ to Max7.

Complete (handling of partial tuples)

Input:

1. A GP: α—The problem objectives

F_{α}—The goal constraints

S_{B}—The hard-constraints

2. A partial tuple of values for decision variables ²⁰. Each value is associated with a {generous, tough} flag where “generous” means that the program is allowed to change the respective value to overcome potential infeasibilities and “tough” means that no change is allowed. ²⁰ The fixed variables are provided explicitly, that is, for every fixed variable, the function is provided with the variable name and its value. Hence, there is no need to indicate which variables are left undetermined.

3. Mode of operation: [Optimal, Worst, Any, Percent, Average].

4. [An optional percentage ρ, for the Percent mode].

5. [An optional reference value α⁰ to improve, for the Percent mode].

Output:

A proposed solution P_{B}^{new}, which consists of

1. A complete tuple T=[D|X] of values for the GP problem variables

2. A tuple a of the objective-function values

Description:

This function provides a solution that keeps the given values for those decision variables that were specified as inputs, and assigns values to the rest of the variables according to the mode of the operation.²¹ ²¹ For example, if the mode of operation is Optimal, the function attempts to find the minimal values possible for the objective function, while keeping the values for the partial input tuple unaltered. In a similar way, the function completes the partial tuple towards a Worst, Any, Average, and Percent solution.

1. For every decision variable xᵢ with given value Xᵢ (input values Xᵢ will not change)

a. Add to the GP a new hard-constraint: (xᵢ=Xᵢ)²². ²²These are hard-constraints with no deviation values allowed; therefore, the solver is forced to assign to the input variables the given values.

2. Call gp_solve(GP, mode) and return an output if possible (i.e., the supplied fixed values do not lead to a contradiction). Otherwise, an exception message is provided together with a solution as described in the next step.

3. Turn each fixed value Xᵢ for variable xᵢ into a goal constraint of the form xᵢ+δᵢ⁻−δᵢ⁺⁺=Xᵢ and add a new objective of the form

$${\sum }_{i = 1}^{k} ( {ω}_{i}^{+} {δ}_{i}^{+} + {ω}_{i}^{-} {δ}_{i}^{-} )$$

(ωᵢ⁺δᵢ⁺+ωᵢ⁻δᵢ⁻) as the first priority level; here we assume that the variables xᵢ are ordered in their order of appearance in the objective functions of α, the weights ωᵢ⁺,ωᵢ⁻ as are such that the lower i is, the higher the weight, e.g., use powers of ten (if such an order is not provided, the weight is 1 for all, this is essentially the same concept used in prescribing “stay close” in the utilities supporting the ignorant mode). The weights associated with variables classified as “tough”, are multiplied by a system constant s>1.

4. Set the rest of the priority levels according to the original a objective function (that is, each function in the original objective is pushed one level down, in order).

Negotiation Support Utilities

Switch Level Utilities

In these utilities, we differentiate between versions specialized to parties' state of knowledge. Here, ignorant means lacks knowledge of the other parties GP. Informed means a party that is knowledgeable concerning the GP of the other party.

Switch Level

Level-by-Level Negotiation Strategy: Motivation

1. Negotiation may take many shapes and forms, over the whole problem at once, or some specific subset of the decision variables, or specific objective-levels. Here we detail how the operations of the various Improve functions are altered by specifying bounds for certain objective levels, ignoring certain levels and minimizing (or maximizing) other objective levels.

2. Crossover Effect

This problem has different effects in each of the improve algorithms.

As the negotiation proceeds over more than one level, it may proceed faster in one level than the other. Furthermore, the agents will not terminate in agreement until they agree upon the values of the first level, the most important one.

Therefore, if the negotiation proceeds faster over the lower levels, an agent, say Sue, may start suggesting values for the lower values, such that Bob already agreed upon, or worse, Bob already suggested better values from Sue's viewpoint.

Implementation Required

The negotiation takes place upon one level at a time, the same level for both agents. That is, the agents negotiate only over the first level of both agents, then after agreement on the values of their first level objective values, they should proceed to negotiate over the second level, etc.

The agreement has the selfish meaning, of how far is the opponent willing to give up in terms of my objective level-value. E.g., suppose that two agents agree on the i^{th} level with objective values αᵢ, βᵢ for Bob's and Sue's values respectively, then Sue relies on the fact that Bob is willing to agree for Sue's value βᵢ in any final agreement they have.

Switch Level {Ignorant, Any}

If the agent, say Bob, is ignorant, then after the agreement over the i^{th} level objective value, Bob will add to his GP formulation, the hard constraint as follows:

αᵢ≦α_{Bi}.

Switch Level {Informed, Any}

If the agent, say Sue, is knowledgeable, then the agent adds constraints on both values as follows:

βᵢ≦β_{Si};

αᵢ≦α_{Si}

First-Offer {Informed, any} (Sue's viewpoint)

Input:

1. Agent's GP: (GP_{β})

β—Sue's objectives

F_{β}—Sue's goal constraints

S_{S}—Sue's hard-constraints

2. The opponent's GP: (GP_{α})

α—Bob's objectives

F_{α}—Bob's goal constraints

S_{B}—Bob's hard-constraints

3. The new level k of negotiation.

Output:

A proposed solution P_{S}^{new}, which consists of:

1. A tuple T′=[D′|X′] of values for the variables.

2. A tuple β′ of the corresponding objective-functions values.

Description:

This utility is used by the 1-1 negotiation mechanism to construct first offers for negotiation over a ne,” level.

Basically, the function combines the GPs of both agents, and tries to find the best offer for the agent then the worst offer for the opponent. This is done level-by-level, working on the first effective level of the agent objective (k), followed by the first effective level of the opponent's objective, then the second effective level of both objectives, etc.

Notice that when the function is called after agreeing on the k^{th} level, then both GPs already contain the achievement values of the previous k objective levels.

1. Add to (GP_{β}) the following goal-constraints and bounds:

a. Add the opponent's goal-constraints and bounds (GP_{α})

2. Replace the objective-functions vector of (GP_{β}):

a. The first level will minimize the k^{th} level objective function of the agent, its second level will maximize the k^{th} level of the objective function of the opponent, its third level will minimize the (k+1)^{st} level objective function of the agent and so on. Of course, the switch level constraints of both parties are carried over into this newly constructed GP.

b. Set a suitable Hanan objective level as the last objective function.

Note: If one of the agents has fewer levels than the other, then the extra levels will still be added at the end of the objective function.

3. Call gp_solve (GP_{β}) and return its output.

First-Offer {Ignorant, any} (Bob's viewpoint)

Input:

1. Agent's GP: (GP_{α})

α—Bob's objectives

F_{α}—Bob's goal constraints

S_{B}—Bob's hard-constraints

2. A tuple X^{last} of values for the decision variables that caused the agreement on the last level.

3. The new level k of negotiation.

Output:

A proposed solution P_{S}^{new}, which consists of:

1. A tuple T′=[D′|X′] of values for the variables.

2. A tuple α′ of the corresponding objective-functions values.

Description:

This utility is used by the 1-1 negotiation mechanism to construct first offers for negotiation over a new level.

The Ignorant agent computes the very first offer of the whole negotiation by calling the Suggest(Optimal) function. Moreover, notice that the knowledgeable agent uses the First-Offer function for the very first offer, and for the first offers after switching (upon agreement) a level. The Ignorant agent therefore requires special care on this matter.

1. Add to (Gin) the following goal-constraints and bounds:

a. For every decision variable xᵢ and its input value XᵢεX^{last}

Add the goal constraint: xᵢ+γᵢ⁻−γᵢ⁺=Xᵢ

2. Replace the objective-function vector of (GP_{α}):

a. Set the first priority ordering for functions according to the original α objective function.

b. Set the last priority function as

$${\sum }_{i = 1}^{k} {V}_{i}^{+} {γ}_{i}^{+} + {V}_{i}^{-} \cdot {γ}_{i}^{-} .$$

(Stay close, the V weights are discussed in the improve utilities).

c. Set a suitable Hanan objective level.

3. Call gp_solve (GP_{α}) and return its output.

Motivation

The difference between this function and the Suggest (Optimal) one is in the stay-close constraints and objective-level. This is required to keep the Ignorant tuned with the correct direction of the decision variables values towards the agreement tuple X^{last}. Otherwise, both Ignorant agents negotiation may get into many rounds of infeasible values after every level agreement, because each Ignorant agent will keep his value and totally forget the correct deviation required for a decision variable, to get the agreement of the other agent.

Level-By-Level Initialization

When switching from one level to the next there is a need to update some of the system parameters in light of what was agreed upon in the previous level(s). Specifically, the My_best and My_worst values for the present lexicographical level (denoted as α* and α_{*}) might change as a result of the α* values that were achieved at upstream levels and the presence of hard constraints that link variables across more than one level. The following example will illustrate the need for this update.

### EXAMPLE

(L₁) Min δₓ⁻+2·δₓ⁺

(L₂) Min δ_{y}⁻+δ_{y}⁺+3·δ_{z}⁻+2·δ_{z}⁺

s.t.

x+δₓ⁻−δₓ⁺=50

y+δ_{y}⁻−δ_{y}⁺=80

z+δ_{z}⁻−δ_{z}⁺=70

x+y+z=200

x,y,z,δₓ⁻, δₓ⁺, δ_{y}⁻, δ_{y}⁺, δ_{z}⁻, δ_{z}⁺≧0

Assume that the opposing party was also interested only in the x variable at L₁ and that his target was 20. Let us suppose that the outcome of the negotiations in L₁ was α₁*=20 (as a result of the values x=30, δₓ⁻=20, δₓ⁺=0). We incorporate the constraint α₁=20 into the goal constraint of x in L₂. Notice that this is not equivalent to setting x=30 since the L₂ program has an option of choosing between x=30 and x=60 as both of these values satisfy the additional constraint on α₁. Regardless of which of these two values is selected, the hard constraint will no longer fit the targets of variables y and z. Thus, while the original α* value for L₂ was zero, the updated value is α₂*=10 (resulting from the values x=60, y=z=70, δ_{y}⁻=10,δ_{y}^{+=δ}_{z}⁻=δ_{z}⁺=0).

Notice that to find the updated values of α* and α_{*} for an ignorant agent we add an equality-type constraint rather than an inequality-type constraint (i.e., α₁=20). Otherwise, if we were to add the constraint α₁≦20, there would have been no effective changes in α* and α_{*} of our current level (since α₁=0 would have still been feasible). This difficulty is not present when the agent is aggressive (informed) since the latter incorporates both the constraint representing his own α₁ value and the β₁ value of his opponent in his GP. Thus, in the aggressive-improve implementation, both of these additional constraints can be written as inequalities.

Improve Utilities

In these utilities, again, we differentiate between versions specialized to parties' state of knowledge. Here, ignorant means lacks knowledge of the other parties GP. Informed means a party that is knowledgeable concerning the GP of the other party. The layer that calls these improve routines decides as to which improvement style is preferable. The layering is part of the improve utility feature but is not discussed further herein. Intuitively, an ignorant party may find it difficult to improve on his previous offer for the other party due to his ignorance as to the other party's GP. The opposite holds for an informed party. However, an informed party will usually not blindly improve the offer for the other party, usually some constraints on the worsening of his position, as judged by his very own GP, will be applied.

We note that these improve procedures may be turned into “worsening” procedures by “changing directions”, for brevity we do not detail these changes.

Improve {Ignorant, any} (Bob's viewpoint)

Input:

1. A GP: α—The problem objectives

F_{α}—The goal constraints

S_{B}—The hard-constraints

2. P_{B}^{last}—The reference proposal, that is the previous offer Bob made which serves as a reference point.

3. A tuple X_{S}^{last} of values for the decision variables that appeared in Sue's last offer.

4. A percentage ρ.

5. α*—The optimal objective values of Bob.

6. α_{*}—The worst values of Bob.

7. gap_flag—A flag to determine the way to calculate the new objective function values. Possible values are: fixed, dynamic.

8. Max_gap—The maximal value allowed for changing the objective function.

9. Min_gap—The minimal value allowed for changing the objective function.

10. gc—The gap constant for the fixed gap_flag.

11. i—The current level under negotiation.

Output:

A proposed solution P_{B}^{new}, which consists of

1. A tuple T′=[D′|X′] of values for the variables.

2. A tuple α′ of the corresponding objective-functions values.

Description:

Given input values (corresponding to objective function α), this utility finds a new objective function values α′, that worsens the values of P_{B}^{last} by at most ρ% ²³. The worsening is done with respect to the differential value (α_{S}^{last}−α*) where the first value is the value of the counter-proposal X, and the second is the optimal value. ²³ The same percentage may be used for all levels of the objectives list.

1. If the tuple X_{S}^{last} is not complete, call Complete(GP, X_{S}^{last}, Optimal)²⁴. ²⁴ This is required so that we can evaluate α_{S}^{last} (see next footnote).

2. Add to (GP) the following goal-constraints and bounds:

a. Calculate the objective-values α_{S}^{last}=(α_{S1}^{last}, . . . , α_{Sk}^{last})²⁵ where k is the number of levels in the lexicographical objective function. ²⁵ Calculated according to the completed tuple X_{S}^{last}.

b. For the current objective function-level αᵢ ²⁶ and its value α_{Bi}^{last},²⁷ add a constraint to set the new range of the objectives as follows: ²⁶ See Level-by-Level negotiation strategy. ²⁷ The α_{B(i)}^{last}, αᵢ*, and α_{*i} values are taken from P_{B}^{last}, P_{B}*, and P_{*B} respectively.

i. Calculate the gap value of the increase in the region value, this is done according to the value of gap_flag;

currently we support two modes of operation:

Fixed: gap=(α_{*i}−αᵢ*)/gc; here gc (gap constant), e.g., 25.

Dynamic: gap=(α_{Si}^{last}−α_{Bi}^{last}); differential between proposals.

ii. Cut off the value of gap, if necessary:

If gap>Max_gap then set gap=Max_gap.

If gap<Min_gap then set gap=Min_gap.

iii. Add the goal constraint: αᵢ+δ_{B}⁻−δ_{B}⁺=α_{Bi}^{last}+ρ·gap.

c. For every decision variable xⱼ and its input value XⱼεX_{S}^{last 28} ²⁸ This step is concerned with the original X_{S}^{last} (before completing it), as there is no reason why we should constrain the algorithm to stay close to values generated by the complete function (i.e. those values that were not provided by the opposite agent).

Add the goal constraint: xⱼ+γⱼ⁻−γⱼ⁺=Xⱼ

3. Replace the objective-function vector of (GP_{α}):

a. Set the first priority level function as {100·δ_{B}⁺+δ_{B}⁻}. This objective tries to achieve the improvement value for the opponent. If the new value cannot be reached, then try to improve further in order to avoid not improving at all.

b. Set the second priority function as

$${\sum }_{i = 1}^{m} ( {V}_{j}^{+} {γ}_{j}^{+} + {V}_{j}^{-} \cdot {γ}_{j}^{-} )$$

(Vⱼ^{+γ}ⱼ⁺+Vⱼ⁻·γⱼ⁻) where m is the number of decision variables (the length of the vector x). This objective is called stay close. The idea is to stay as close as possible, under the constraints, to Sue's last offer. Furthermore, we would like to actually improve the offer from Sue's viewpoint. This implies that we need to estimate which decision variables are more important to Sue. The rule of thumb here is that if in subsequent offers Sue made little relative change, it is likely that either she is incapable of affecting greater changes or that this decision variable is highly important for her. Therefore, the weights Vⱼ⁺, Vⱼ⁻ are set as follows. The last two offers made by Sue are compared. For each decision variable, the percentage increase or decrease from the previous offer is calculated. The weights are set between c₁ and c₂ (typical values may be 1.0 and 2.0). For a minor change of say up to 1%, the weight is set as c₂. For a major change, say above 75%, the weight is set as c₁. In the intermediate range, the weight for a percentage change p is set proportionately between c₁ and c₂, that is c₂−(p/(75−1))*(c₂−c₁).

c. Set a suitable Hanan objective level as the last objective function.

4. Call gp_solve (GP_{α}) and return its output.

The complete formulation of the model is therefore:

$$Lex\_min \{ 100 \cdot {δ}_{B}^{+} + {δ}_{B}^{-} \} , \{ {\sum }_{j = 1}^{m} ( {V}_{j}^{+} \cdot {γ}_{j}^{+} + {V}_{j}^{-} \cdot {γ}_{j}^{-} ) \} , {α}_{i + 1} , {α}_{i + 2} , … , {α}_{k} \qquad ( 1 )$$

Subject to:

(2a) Ignorant 1: α_{B}^{new}+δ_{B}⁻−δ_{B}⁺=α_{B}^{last}+ρ_{B}·(Ign1_gap) Worsen mine: Dynamic gap

(2b) Ignorant 3: α_{B}^{new}+δ_{B}⁻−δ_{B}⁺=α_{B}^{last}+ρ_{B}·(Ign3_gap) Worsen mine: Static gap

$${x}_{Bj}^{new} + {γ}_{j}^{-} - {γ}_{j}^{+} = {x}_{Bj}^{last} + {ρ}_{B} \cdot ( Max\_gap ) \text{Stay close.} \\ Max\_gap = \{ \begin{matrix}( {x}_{Sj}^{last} - {x}_{Bj}^{last} ) & \text{if} \vert {x}_{Sj}^{last} - {x}_{Bj}^{last} \vert \geq \vert {x}_{sj}^{last - 1} - {x}_{sj}^{last} \vert \\ ( {x}_{sj}^{last - 1} - {x}_{sj}^{last} ) & \text{if} \vert {x}_{Sj}^{last} - {x}_{Bj}^{last} \vert < \vert {x}_{sj}^{last - 1} - {x}_{sj}^{last} \vert\end{matrix} \qquad ( 3 )$$

(4) α_{B}^{new}≦R_{B} Protect thyself

(5) All: x_{B}^{new}εF_{α} x_{B}^{new}εS_{B} (6)

$$Ign1\_gap = \{ \begin{matrix}MinGap = \frac{( {α}_{*} - {α}^{*} )}{20} , \text{if} {α}_{S}^{last} - {α}_{B}^{last} \leq MinGap \\ MaxGap = \frac{( {α}_{*} - {α}^{*} )}{5} , \text{if} {α}_{S}^{last} - {α}_{B}^{last} \geq MaxGap \\ {α}_{S}^{last} - {α}_{B}^{last} , \text{elsewhere}\end{matrix} \\ Ign3\_gap = \frac{( {α}_{*} - {α}^{*} )}{10}$$

Further Explanation

(1) The first level of this objective is related to the “worsen-mine” constraint (either (2a) or (2b)). The penalty for under-deviation is much larger than that of over-deviations since in general we intend to worsen our situation. The need to incorporate δ_{B}⁻ is to enable the program to escape from infeasible situations (e.g., when due to integer variable requirements it is impossible to worsen α but possible to slightly improve it.) The second level handles deviations from the stay-close constraint. Then, from level 3 onwards we minimize (lexicographically) the remaining alpha values from i+1 through k. The minimization of these additional alpha values is optional.

(2) An “Ignorant” agent can't be sure he improves his opponent's situation since he is not aware of the latter's GP. Thus, by worsening his own status (albeit in a moderate manner) he implicitly assumes that his opponent will gain something. There are two versions for this worsening procedure that are further explained through the definitions of the gaps in (6).

(3) Here, since we lack other information, we try to gain whatever we can from the recent moves of the opponent. Observing his last two offers we see the “gradient” of change in the values of x. If he makes a small move on that variable we may conclude that this variable is important to him and therefore we are reluctant to make a relatively large step towards him (as might happen when the p factor is multiplied by a difference that might be large).

Notice that if the opponent performs a big step in the value of some variable, Xⱼ, then the value x_{Bj}^{last}+ρ(xₛⱼ^{last-1}−xₛⱼ^{last}) may be even better than the value xₛⱼ^{last} suggested by the opponent. However, the stay close is expressed in the second level of the objective, and is subject to the opponent's objective value allowed which is expressed in the first level of the objective function.

(4) Protection against “over-enthusiasm” in the worsening action of (2).

(5) The ordinary GP constraints.

(6) The gap we implement in (2) can either be static or dynamic. The dynamic option (Ign_gap1) is based on the current difference between the last offer made by the other party and my own best solution. A certain proportion (p) will be taken of that difference unless it becomes too small (at which point we truncate it with the MinGap parameter) or too large (at which point we truncate it with the MaxGap parameter). The static option uses a fixed value (a certain proportion of the difference between best and worst solutions) to determine the step size taken in (2).

Improve-Aggressive {Informed, any} (Sue's viewpoint)

Input:

1. Agent's GP: (GP_{β})

β—Sue's objectives

F_{β}—Sue's goal constraints

S_{S}—Sue's hard-constraints

2. P_{S}^{last}—The reference proposal, that is the previous offer Sue made which serves as a reference point.

3. The opponent's GP:²⁹ (GP_{α}) ²⁹ The opponent's information is subject to the mechanism's strategy. For example, the opponent may not provide all of his preferences (constraints or objectives), or even may not provide true preferences!

α—Bob's objectives

F_{α}—Bob's goal constraints

S_{B}—Bob's hard-constraints

4. The opponent agent's optimal result α* ³⁰. ³⁰ Calculated according to our knowledge about the opponent (see previous footnote).

5. A tuple X_{B}^{last} of values for the decision variables.

6. A percentage ρ_{BS} for the maximum improving to the opponent objective.

7. A percentage ρ_{SS} for the maximum worsening of the agent objective.

8. Agent's optimal result β*.

9. i—The current level under negotiation.

Output:

A proposed solution P_{S}^{new}, which consists of:

1. A tuple T′=[D′|X′] of values for the variables.

2. A tuple β′ of the corresponding objective-functions values.

Description:

Given input values (corresponding to Sue 's objective function β), this utility constructs a new objective function β′ that improves the values of the objective function value for Bob by at least ρ%³¹. Taking into consideration Bob's constraints and goals as represented by his GP, we try to improve the value of the opponent's objectives in a controlled manner. ³¹ The same percentage may be used for all levels of the objectives list.

1. Add to (GP_{β}) the following goal-constraints and bounds:

a. Calculate the objective-values α_{S}^{last}=(α_{S1}^{last}, . . . , α_{Sk}^{last}) ³² ³² Calculated according to the last tuple proposed by the Sue X_{S}^{last}.

b. For the current objective function-level αᵢ and its value α_{Si}^{last}

Add the goal constraint:³³ αᵢ+δᵢ⁻−δᵢ⁺=α_{Si}^{last}−ρ_{BS}·(α_{Si}^{last}−αᵢ*)³⁴ ³³ The sign of the addition |αᵢ|·p% depends on the flag, that is, a negative sign for improve, and positive sign for reduce. ³⁴ See Level-by-Level negotiation strategy.

c. For every decision variable xⱼ

Add the goal constraint: xⱼ+γⱼ⁻−γⱼ⁺=X_{Sj}^{last}−ρ_{BS}·(X_{Sj}^{last}−X_{Bj}^{last})

d. Add the goals F_{α} and bounds S_{B} of the opponent agent's (GP_{α}).³⁵ ³⁵ Both agents must agree on the decision variables representation.

e. For the current objective function-level βᵢ and its value β_{Si}^{last}

Add the goal constraint: βᵢ≦β_{Si}^{last}+ρ_{SS}·(β_{*i}−β_{Si}^{last})

2. Replace the objective-functions vector of (GP_{β}):

a. Set the first priority function as (a·δᵢ⁺+b·δᵢ⁻) where a and b are weights that reflect Sue's preferences for over or under improvements for Bob (default values are a=b=1).

b. Set the following priority functions according to the original β objective functions from level i onwards.

c. Set the next priority function as

$${\sum }_{j = 1}^{m} ( {V}_{j}^{+} {γ}_{j}^{+} + {V}_{j}^{-} \cdot {γ}_{j}^{-} ) ,$$

(Vᵢ⁺γⱼ⁺+Vⱼ⁻·γⱼ⁻), the weights Vⱼ⁺, Vⱼ⁻ are set as in the previous Improve routine.

d. Set a suitable Hanan objective as the last level

3. Call gp_solve (GP_{β}) and return its output.

The complete formulation of the model is therefore:

$$Lex\_min \{ {δ}_{i}^{+} + {δ}_{i}^{-} \} , \{ {β}_{i} , {β}_{i + 1} , … , {β}_{k} \} , \\ \{ {\sum }_{j = 1}^{m} ( {V}_{j}^{+} \cdot {γ}_{j}^{+} + {V}_{j}^{-} \cdot {γ}_{j}^{-} ) \} \qquad ( 1 )$$

Subject to:

(2) α_{S}^{new}+δᵢ⁻−δᵢ⁺=α_{S}^{last}−ρ_{S}·(α_{S}^{last}−α*) Improve other

(3) x_{Sj}^{new}+γⱼ⁻−γⱼ⁺=x_{Sj}^{last}−ρ_{S}·(x_{Sj}^{last}−x_{Bj}^{last}) Stay close

(4) β_{S}^{new}≦R_{S}, Explicitly: βᵢ≦β_{Si}^{last}+ρ_{SS}·(β_{i*}−β_{Si}^{last}) Protect thyself

(5) All: αεF_{α}, βεF_{β}, Lⱼ≦Xⱼ≦Uⱼ Original GP constraints

Further Explanations:

(1) The first level of the objective tries to improve the current objective level of the opponent party (here, Bob's α). A user-given proportion dictates the improvement. Sometimes it won't be possible to improve (e.g., due to discontinuities) and then we allow worsening of the opponent's objective—but, the penalty on moving in that direction is much larger than the deviation under the new target for his alpha value.

The second level tries to improve my own objective (here, Sue's β).

The third level prevents decision variables that are not strongly affected by the first two levels (say, because they are associated with less important levels of the GP) from either “jumping around” in a senseless manner or from approaching too fast the values desired by the other side.

(2) The assignment of the new values for the decision variables that Sue is going to offer, x_{Sj}^{new}, will yield for Bob a new value of α that will be better (smaller) than the previous value offered by Sue. The improvement for Bob is determined by a proportion ρ_{S} of the distance between the last Sue's offer and the best value possible from Bob's viewpoint (α*).

(3) This constraint relates the new offer to the last offer by the same party with some adjustments to accommodate for the preferred values of the other party. Thus, for example, if the value for xⱼ in Sue's last offer was higher (lower) than the corresponding value in Bob's last offer, the new value offered by Sue will be smaller (larger) than that offered earlier.

(4) This constraint protects Sue from situations in which the direction determined by the first constraint (that improves the outcome for the opponent) hurts his own objectives too severely. Notice that the protection value is calculated is a similar way to the improve-other value, according to the interval left for progress. I.e. the improvement is calculated as a percent according to the interval (α_{S}^{last}−α*) while the worsening (protection) value is calculated according to the interval (β_{*}−β_{S}^{last})

(5) The rest of the ordinary constraints: α,β, defined through F_{α}, F_{β}, respectively and the upper and lower bounds on the decision variables.

Improve-Cooperative {Informed, any} (Sue's viewpoint)

Input:

1. Agent's GP: (GP_{β})

β—Sue's objectives

F_{β}—Sue's goal constraints

S_{S}—Sue's hard-constraints

2. P_{S}^{last}—The reference proposal, that is the previous offer Sue made which serves as a reference point.

3. The opponent's GP:³⁶ (GP_{α}) ³⁶ The opponent's information is subject to the mechanism's strategy. For example, the opponent may not provide all of his preferences (constraints or objectives), or even may not provide true preferences!

α—Bob's objectives

F_{α}—Bob's goal constraints

S_{B}—Bob's hard-constraints

4. The agent's optimal result β* ³⁷. ³⁷ Calculated according to our knowledge about the opponent (see previous footnote).

5. A tuple X_{B}^{last} of values for the decision variables.

6. A percentage ρ.

Output:

A proposed solution P_{S}^{new}, which consists of

1. A tuple T′=[D′|X′] of values for the variables.

2. A tuple β′ of the corresponding objective-functions values.

Description:

Given input values (corresponding to objective function β), this utility constructs a new objective function β′ that worsens the values of Sue 's objective function by at most ρ%³⁸. Taking into consideration the opponent's constraints and goals represented by the opponent's GP we try to improve the value of the opponent's objectives the best we can, as long as we do not exceed an upper limit on our own objective values. ³⁸ The same percentage may be used for all levels of the objectives list.

1. Add to (GP_{β}) the following goal-constraints and bounds:³⁹ ³⁹ Note that in the cooperative algorithm we do not need the completed X_{B}^{last} tuple.

a. For every objective function βᵢ and its value β_{Si}^{last 40} ⁴⁰ The α_{Bi}^{last} values are taken from P_{B}^{last}.

Add the constraint: β_{Si}≦β_{Si}^{last}+ρ·(β_{Si}^{last}−βᵢ*) ⁴¹ ⁴¹ See Level-by-Level negotiation strategy.

b. For every decision variable xⱼ and its input value XⱼεX_{B}^{last}

Add the goal constraint: xⱼ+γⱼ⁻−γⱼ⁺=Xⱼ

c. Add the goals F_{α} and bounds S_{B} of the opponent agent's (GP_{α}). ⁴² ⁴² Both agents must agree on the decision variable representation.

2. Replace the objective-functions vector of (GP_{β}):

a. Set the first priority function as the opponent's a objective functions.

b. Set the rest of the priority functions according to the original β objective functions.

c. Add at the bottom of the priority functions another level as

$${\sum }_{j = 1}^{m} ( {V}_{j}^{+} {γ}_{j}^{+} + {V}_{j}^{-} \cdot {γ}_{j}^{-} )$$

(Vⱼ⁺γⱼ⁺+Vⱼ⁻·γⱼ⁻) with weight settings as in the other improve routines.

d. Add at the bottom of the priority functions another level and put there a suitable Hanan function (see above).

3. Call gp_solve (GP_{β}) and return its output.

Improve-function Initialization ⁴³ ⁴³ Basically, this issue should be under the subject of the mechanisms that use the utility layer (and not utilities). However, we cover this issue here for completeness. Moreover, the initialization may be dependent upon the mechanism's strategy!

All the versions of the improve function (Ignorant, Aggressive, Cooperative) require as an input, the P_{agent}^{last}, which is the result of the agent's function last calculation that was presented already to the other party.

This section describes how to initialize this structure, i.e. how to calculate P_{agent}^{FIRST 44}. ⁴⁴ Note that P_{B}^{FIRST} in the Sue's function, for example, consists of α_{S}^{FIRST} and the corresponding X tuple of values for the decision variables.

Note that a proposal P may be required either by Sue or Bob (when the algorithm is informed). Hence, for clarity reasons, each proposal below is assigned an explicit agent, say B for Bob, or S for Sue, when concluding the initial proposal for the other agent should be trivial.

Improve-Ignorant

The algorithm, say from Bob's viewpoint, requires its last proposal P_{B}^{last} so that it can set goal constraints upon the region of its objective values, of the form:

αᵢ≦α_{B(i)}^{last}+ρ·(α_{S(i)}^{last}−αᵢ*)

Initialization: P_{B}^{FIRST}=P_{B}(α*), i.e., an optimal offer from Bob's point of view.

No special initialization is required here. The initial proposal will assign the objective-functions values as the optimal solution values, and the values for the decision-variables tuple are those in the optimal solution found.

Improve-Aggressive

The algorithm, say from Sue's viewpoint, requires Bob's P_{B}^{last} (⁴⁵) so that it can set goal constraints upon the desirable values of the opponent's objective-functions values, of the form: ⁴⁵ Notice that this algorithm is informed, and it calculates P_{B}^{last} according to its information about Bob's problem.

αᵢ+δᵢ⁻−δᵢ⁺=α_{Si}^{last}−ρ·(α_{Si}^{last}−αᵢ*)

Initialization: P_{B}^{FIRST}=P_{B}(α_{β*}).⁴⁶ ⁴⁶ The expression P_{B}(α_{β*}) means: the objective functions solution values of Bob (as they are represented at the informed Sue), when they are calculated according to the values of the Sue's optimal values β*.

That is, the initial proposal for Bob's objective values will be calculated according to the tuple X, which is generated when computing β*.

Note that this sets α_{S}^{FIRST} as big as possible in β terms, and (in each iteration) the Improve function will decrease it towards α*.

Improve-Cooperative

Sue's algorithm requires its P_{S}^{last} so that it can set goal constraints upon the region of its objective values, of the form:

β_{S(i)}≦β_{S(i)}^{last}+ρ·(β_{S(i)}^{last}−βᵢ*)

Initialization: β_{S(i)}^{FIRST}1+κ and κ=0.01 (Σr.h.s/#constraint)

When (Σr.h.s) is the sum of all the Right-Hand-Sides (r.h.s) of the original goals.

And (# constraint) is the number of the above goals.

Remarks:

1. The value of κ calculated above should be very close to the coefficient 0.01, this is due to the fact that all the goals are normalized, the (r.h.s<1).

2. The initialization of β_{B}^{FIRST} is concerned with pushing its value by a small amount from the value of βᵢ*. Otherwise, the iterative function will be stuck with similar constraints of the form β_{S(i)}≦βᵢ*.

Using Hanan's Method in the Improve Utilities

In the improve function, we build a new objective-functions list. Of course, we are interested in applying Hanan, on the agent's objectives, with the deviations that participated in the agent's original goal-constraints. This objective forms the least important objective layer. However, we note the following concerning the levels added to the original GP of the agent. There are three kinds of objective-levels added:

1. X-close constraints (trying to keep close to the opposite offer): All the deviation variables participating in the goal-constraints are considered, therefore, none of them can participate in the Hanan objective level.

2. Objective-close constraints in the Aggressive and Ignorant functions: All the deviation variables participating in the goal-constraints are considered, therefore, none of them can participate in the Hanan objective level.

3. Opposite-Agent Constraints

In this case there seems to be no reason to apply Hanan on the deviations of the opposite-agent's GP problem. We should not be interested in generating non-inferior solutions using the opposite-agent's GP problem.

Advanced Utilities

Testing the Necessity for Negotiations

This is a pre-negotiation procedure whose objective is to test whether negotiation is needed. It is executed after unification and before one-to-one negotiations start.

1. Using the Suggest_optimal utility, solve for each agent (Bob and Sue) separately their goal programs and obtain their “independent” optimal solutions.

2. Construct a joint goal program whose set of constraints is the union of the two sets of constraints associated with the two agents plus two additional goal constraints requiring that the two independent optimal values that were obtained earlier will hold. The objective of the joint program is to minimize the deviations associated with the last two constraints.

3. Solve the joint program. If its optimal value is zero we can skip negotiations, assign the optimal values of the joint program to the vector of decision variables (x) and guarantee that both agents can not achieve a better solution by any form of negotiations. If the optimal value of the joint program is not equal to zero, at least one of the agents may be able to obtain some gains through negotiations. In that case, we must enter negotiations.

Mediation Option at Any Level

This utility can be called either before the negotiation were started or at any level during the negotiation. It is useful for several reasons:

Applying the mediation option before negotiations were started provides the system with an “objective” outcome that can be compared against the outcome of negotiations later on. This will help various validation tests during development.

If negotiations broke down at some intermediate level we might use mediation to “rescue” the deal. It will preserve the satisfaction levels achieved during the levels that were already finished successfully and generate a compromise solution for the level in which negotiations broke. This will strengthen our modeling foundations as it bypasses potential roadblocks on the way towards successful outcomes.

From a marketing point of view, the users will appreciate the option to resort to a mediated solution if it is proven to be superior (for both sides) to the one they have achieved through negotiations.

Suppose we are now at level k≧1 of the objective function. The mediation option is then given by the following formulation. Below, j is used as an index over deviation variables.

$$\begin{matrix}Min\_lex ( k ) & \{ \frac{{\sum }^{} {w}_{kj}^{+} \cdot {δ}_{kj}^{+} + {\sum }^{} {w}_{kj}^{-} \cdot {δ}_{kj}^{-}}{{\sum }^{} {w}_{kj}^{+} + {w}_{kj}^{-}} \} + \{ \frac{{\sum }^{} {v}_{kj}^{+} \cdot {γ}_{kj}^{+} + {\sum }^{} {v}_{kj}^{-} \cdot {γ}_{kj}^{-}}{{\sum }^{} {v}_{kj}^{+} + {\sum }^{} {v}_{kj}^{-}} \} \\ ( k + 1 ) & \{ \frac{{\sum }^{} {w}_{k + 1 j}^{+} \cdot {δ}_{k + 1 j}^{+} + {\sum }^{} {w}_{k + 1 j}^{-} \cdot {δ}_{k + 1 j}^{-}}{{\sum }^{} {w}_{k + 1 j}^{+} + {\sum }^{} {w}_{k + 1 j}^{-}} \} + \{ \frac{{\sum }^{} {v}_{k + 1 j}^{+} \cdot {γ}_{k + 1 j}^{+} + {\sum }^{} {v}_{k + 1 j}^{-} \cdot {γ}_{k + 1 j}^{-}}{{\sum }^{} {v}_{k + 1 j}^{+} + {\sum }^{} {v}_{k + 1 j}^{-}} \} \\ ⋯ & \\ ( last level q ) & \{ \frac{{\sum }^{} {w}_{qj}^{+} \cdot {δ}_{qj}^{+} + {\sum }^{} {w}_{qj}^{-} \cdot {δ}_{qj}^{-}}{{\sum }^{} {w}_{qj}^{+} + {\sum }^{} {w}_{qj}^{-}} \} + \{ \frac{{\sum }^{} {v}_{qj}^{+} \cdot {γ}_{qj}^{+} + {\sum }^{} {v}_{qj}^{-} \cdot {γ}_{qj}^{-}}{{\sum }^{} {v}_{qj}^{+} + {\sum }^{} {v}_{qj}^{-}} \} \\ s . t . & \end{matrix}$$

Goal constraints of Bob

Goal constraints of Sue

Hard constraints of both Sue and Bob

Hard constraint to enforce satisfaction of objective levels 1. , , , . k−1 at the values that were achieved before

Form Offers

This procedure is concerned with forming a “compromise proposal” based on the GP's of two parties, Bob and Sue. Intuitively, it takes their preferences and constraints and finds a “middle ground” based on their targets. Using adjustable parameters, it may favor one party's interests over the other party's interests. This is superficially similar to the mediation procedure described earlier. The differences are that here we assume no prior negotiation session (and hence no achievements to preserve), in producing the mediated offer we do not normalize weights as previously done, and we “blur” all the levels whereas previously we followed the level structure. Hence, the current utility Form Offer is simpler and cruder than the previously described one.

Input

1. A tuple L of lower bounds for the decision variables.⁴⁷ ⁴⁷ Note that both parties agree upon the bounds of the problem.

2. A tuple U of upper bounds for the decision variables.

3. Bob's GP: (GP_{α})

α—The problem objectives of Bob

F_{α}—The goal constraints

S_{B}—The hard-constraints

4. Sue's GP: (GP_{β})

β—The problem objectives of Sue

F_{β}—The goal constraints

S_{S}—The hard-constraints

5. Bob's weight: ρ, implicitly Sue's weight is (1−ρ).

Output

A tuple D, this is a proposed solution for the decision variables values.

Description:

Given two players, {player^{k}}, kε{1,2}, we denote Bob as k=1 and Sue as k=2. Solving the following problem provides the initial offer:

$$\begin{matrix}Min\_Lex & ρ \cdot \{ {\sum }_{j ∈ {S}^{1}}^{} ( {δ}_{j}^{-} + {δ}_{j}^{+} ) \} + ( 1 - ρ ) \cdot \{ {\sum }_{j ∈ {S}^{2}}^{} ( {δ}_{j}^{-} + {δ}_{j}^{+} ) \} \\ s . t . & \\ {x}_{j} + {δ}_{j}^{-} - {δ}_{j}^{+} = {T}_{j}^{1} & j ∈ {player}^{1} \\ {x}_{j} + {δ}_{j}^{-} - {δ}_{j}^{+} = {T}_{j}^{2} & j ∈ {player}^{2} \\ {S}_{B} , {S}_{S} & \\ {L}_{j} \leq {x}_{j} \leq {U}_{j} & ∀ j\end{matrix}$$

The program above is a “watered-down” version of the parties' Goal Programs. It considers only the bounds on individual variables and the targets of both players. String-Final-Offer {Informed, Informed} (Sue's viewpoint)

See the Discrete variables compilation in the compilation section.

Input:

1. Agent's GP: (GP_{β})

β—Sue's objectives

F_{β}—Sue's goal constraints

S_{S}—Sue's hard-constraints

2. The opponent's GP:⁴⁸ (GP_{α}) ⁴⁸ The opponent's information is subject to the mechanism's strategy. For example, the opponent may not provide all of his preferences (constraints or objectives), or even may not provide true preferences!

α—Bob's objectives

F_{α}—Bob's goal constraints

S_{B}—Bob's hard-constraints

3. A tuple X_{S}^{last} of values for the discrete-weight auxiliary variables that caused the agreement on the last level. An auxiliary variable represents the ‘goodness’ of its associated discrete variable.

4. A tuple X_{B}^{last} of values for the discrete-weight auxiliary variables that caused the agreement on the last level.

5. Agent's agreement values for the objective function levels β_{S}^{agree}.

6. Opponent's agreement values for the objective function levels α_{B}^{agree}.

Note: The input GPs of this function must not contain level-by-level information. After all this is a mediation function, trying to find a suitable offer for both agents, hence, it is not wise to stick to the values already achieved.

Output:

A proposed solution P_{S}^{new}, which consists of:

1. A tuple T′=[D′|X′,] of values for the variables. Especially the original discrete (string) decision variables.

2. A tuple β′ of the corresponding objective-functions values.

Description:

This utility is used by the 1-1 negotiation mechanism to construct a mediation offer for the discrete (string) variables.

The negotiation should progress over the relaxed-binary variables (which are continuous), and once an agreement is achieved for the auxiliary variables, this mediator function tries to find the closest offer that keeps the agreed values and objectives.

The caller of this function is the one that decides to stop the negotiation, and agree to the opponent last offer; therefore that mediator gives more importance to the values of the opponent, expressed by bigger weights for the opponent deviation variables in the objective function.

1. Add to (GP_{β}) the following goal-constraints and bounds:

a. Add the opponent's goal-constraints and bounds (GP_{α})

b. For every auxiliary variable x_{Si} and its input value XᵢεX_{S}^{last}

Add the goal constraint: x_{Si}+γ_{Si}⁻−γ_{Si}⁺=X_{Si}

c. For every decision variable x_{Bi} and its input value X_{Bi}εX_{B}^{last}

Add the goal constraint: x_{Bi}+γ_{Bi}⁻−γ_{Bi}⁺=X_{Bi}

d. For every objective function-level of the agent βᵢ and its value β_{Si}^{agree}

Add the goal constraint: βᵢ+δ_{Si}⁻−δ_{Si}⁺=β_{Si}^{agree}

e. For every objective function-level of the opponent αᵢ and its value α_{Bi}^{agree}

Add the goal constraint: αᵢ+δ_{Bi}⁻−δ_{Bi}⁺=α_{Bi}^{agree}

2. Replace the objective-function vector of (GP_{α}):

a. Set the first priority level as:

1000·Σδ_{Bi}⁺+100·Σδ_{Si}⁺+10·Σ(γ_{Bi}⁻+γ_{Bi}⁺)+Σ(γ_{Si}⁻+γ_{Si}⁺)

3. Call gp_solve (GP_{β}) and return its output.

Notice that this is a mediation function therefore, the input GPs are the original agent's GPs, therefore the indexes β_{S} and α_{B} instead of the usual indexes β_{S} and α_{S}.

Second-price-bid {Informed, Ignorant} (Bob's viewpoint)

This function is presented from Bob's viewpoint, as it will be called when Bob is participating in a second-price auction.

Input:

1. Agent's GP: (GP_{β})

β—Sue's objectives

F_{β}—Sue's goal constraints

S_{S}—Sue's hard-constraints

2. The opponent's GP: (GP_{α})

α—Bob's objectives

F_{α}—Bob's goal constraints

S_{B}—Bob's hard-constraints

3. Agent's private values for the objective function levels α_{B}^{privatee}.

4. Opponent's minimum price values for the objective function levels β_{B}^{min}.

Output:

1. A proposed bid of the auctioneer objective values β′.

Description:

This utility is used by the 1-N negotiation mechanism (second-price auction) to construct a second-price bid, given the private value of the agent (Bob), and the minimum price of the auctioneer (Sue).

1. Add to (GP_{α}) the following goal-constraints and bounds:

a. Add the opponent's goal-constraints and bounds (GP_{β})

b. For every objective function-level of the agent αᵢ and its value α_{Bi}^{private}

Add the goal constraint: αᵢ≦α_{Bi}^{private}

c. For every objective function-level of the opponent βᵢ and its value β_{Bi}^{min}

Add the goal constraint: βᵢ≦β_{Bi}^{min}

2. Set the objective-functions vector for (GP_{β}) as of the opponent β_{B}.

3. Call gp_solve (GP_{β}) and return its output.

Note: The only concern of the function is to generate objective values, that is why the objective function is kept simple; e.g. we do not need the Hanan level, or to minimize the agent's own objective, as these will only affect the decision variables.

Catalog Purchasing of a Single Item

Introduction

This section addresses the special case of negotiations which are held, either in a 1-1 or 1-N settings, between buyer(s) and a supplier who sells items out of a catalog. The catalog is organized by families (or groups) of items (e.g., a car catalog organized by 3 groups: luxury, sedan, 4×4). Within each family, items are listed according to their attributes. The attributes are typically given in a discrete fashion (e.g., engine size may be limited to a vector of 4 values {1600, 1800, 2000, 2400}). Each item in the catalog represents a specific vector of attribute values that are permissible for sale from the point of view of the seller. For example, item no. x in the catalog is defined by

{engine size=1800}, {color=white}, {model=GLX}, {list price=$16000}.

Not all the combinations of attribute values are feasible in the catalog. Thus, for example, the combination

{engine (E)=1800}, {color (C)=silver}, {model (M)=GLX}, {price (P)=$16000}

is not available although there are other cars in the catalog whose color is silver.

We address several scenarios that are distinguished according to the following characteristics:

Access to catalog

The catalog was published and every potential buyer has access to it

The supplier is the only one who knows the contents of the catalog

Knowledge of buyer's intention

The seller knows the GP according to which the buyer evaluates offers

The seller is ignorant of the buyer's GP

Number of relevant items

There are a few relevant items

There are possibly many relevant items.

In all cases we assume that the unification procedure is capable of generating the appropriate upper and lower bounds on the various attribute dimensions (e.g., 1600≦E≦2400). The negotiation procedure will be composed of two stages. In the first stage, negotiations will be held along the relevant feasible intervals of the various attributes without regard to whether or not an offer corresponds to an item that actually exists in the catalog. In a variation, usually employed in the context of multiple-item deals, the presentation of an offer to the buyer is in terms of actual items. At the second stage, the seller's intention will be duplicated to a number of intentions that will run in the system in parallel where each intention corresponds to a particular item in the catalog. The motivation for the first step is to limit the number of items on which negotiation will eventually take place. Since it is reasonable to think that in most practical cases the catalog will consist of a large number of items we want to avoid representing each catalog item by an integer variable (which will result in a large integer programming problem).

To facilitate the execution of these two stages we require two additional parameters:

K: a threshold number of candidate items. Once that number is reached, the seller duplicates its original intention into K separate intentions, each corresponding exactly to a particular item in the catalog. All K sub-intentions continue into the second stage where they are engaged in parallel negotiations with the buyer's intention and maintain an OR condition among them. The value of K should be fairly small (say, about 10) to scalability problems. Also, in case the buyer is operating in a manual mode of negotiations, K should be even smaller (say, not exceeding 5).

S: a subset of candidate items out of the complete catalog. This subset is defined differently according to the possible scenarios. If the seller is knowledgeable, then S is defined according to the last offer made by the seller as it is evaluated by the buyer's objective function. All the catalog items whose attributes would lead to improvement from the buyer's standpoint are in S. If the seller is ignorant, S is defined by a certain proportion by which the seller is ready to worsen his offers. All items whose values, according to the seller's own objective, are not worse than the current seller's offer by more than the given proportion are in S.

Negotiation Procedure

Stage 1

Buyer and seller exchange offers that are generated through the ordinary GP procedures without regard to whether or not there are items in the catalog that actually correspond to these offers. In each iteration, before sending his counter-offer, the seller finds the item in the catalog whose GP value is the closest to the one he has just computed. If he is ignorant, then he looks for the items whose values are closet from the perspective of his own GP. Otherwise, he looks for items that are closest from the perspective of the buyer's GP. Also, in each iteration the seller checks whether the number of items in S is still bigger than K. If not, he initiates a switch into the second stage. Computationally, the testing of how many items are in S is performed as follows:

If the seller is knowledgeable he uses the buyer's GP to pre-process the entire catalog. Each item gets a “score” according to the buyer's objective and these scores are then used to rank order the items in a descending order of utility to the buyer. Given the value of the seller's current offer according to the buyer's objective function, all items whose rank position is smaller than or equal to the item with the closest value to the one computed are in S.

If the seller is ignorant he uses his own GP to pre-process the entire catalog. Each item receives a score and the scores are used to rank order the items in an ascending order of their utility to the seller. Given the value of the buyer's current offer (from the seller's perspective), all the items whose rank positions are smaller than or equal to the item with the closest value to the one computed for the current buyer's offer are in S.

Stage 2

This stage can be executed in two ways.

a. The seller duplicates his original intention into K duplicates that maintain an OR relations as they enter into parallel 1-1 negotiations with the buyer's single intention. Each of the duplicate intentions corresponds to a particular item in the catalog—that is, in each such intention the variables that describe the item are fixed according to the relevant item from the catalog. For example, engine size, color and model type are fixed and negotiation can continue on variables that were not fixed such as price, warranty period, delivery date, etc.

b. The seller formulates a single GP that uses integer variables to define the K specific alternatives that are relevant to the negotiation. This approach is somewhat more difficult to run due to the presence of integer variables but, on the other hand, it doesn't require an external procedure that verifies the OR relations as in the first approach. Another advantage here (from the seller's standpoint) is the extra flexibility to move among the catalog items during the negotiation—a possibility that doesn't exist in the first approach.

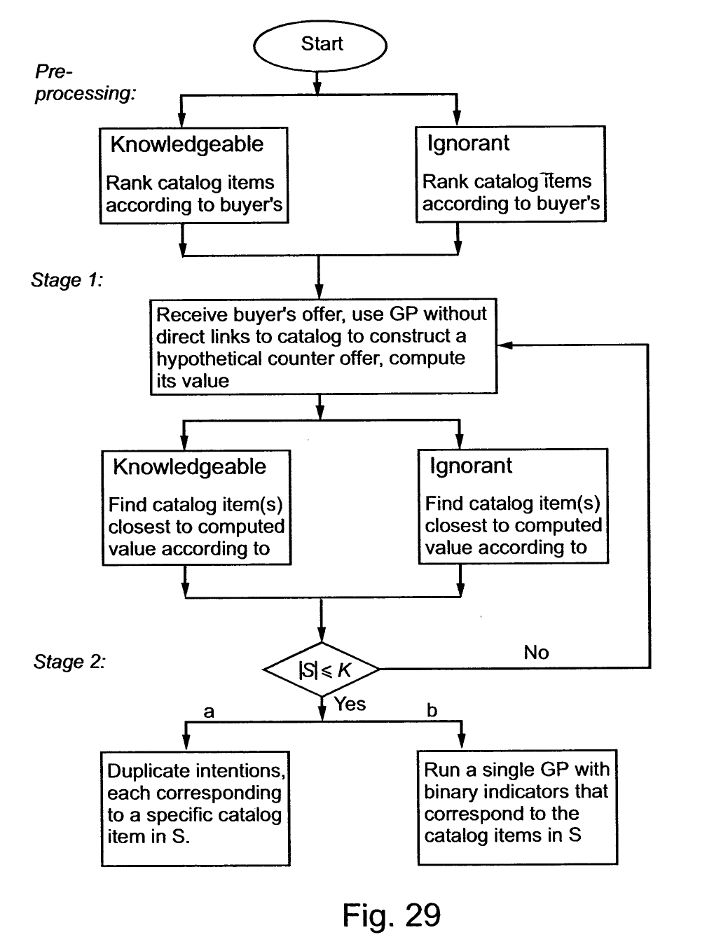

Reference is now made to FIG. 29, which is a simplified flow diagram which further explains the procedure from the seller's standpoint. In FIG. 29, the procedure is shown in three stages, pre-processing, stage 1 and stage 2.

### EXAMPLE

The Buyer's Intention:

At importance level no. 1 the buyer is interested in price (as low as possible) and warranty (as high as possible). At importance level no. 2, his preferred engine size is 1800, deviations below it are 4 times worse than the other way around. The buyer has no preference on color. His intention is then formulated as the following GP:

$$\begin{matrix}Min\_Lex & \{ {δ}_{W}^{-} + {δ}_{P}^{+} \} , \{ 4 \cdot {δ}_{E}^{-} + {δ}_{E}^{+} \} \\ s . t . & \\ \frac{E}{800} + {δ}_{E}^{-} - {δ}_{E}^{+} = \frac{1800}{800} , & 1600 \leq E \leq 2400 \\ \frac{P}{60000} + {δ}_{P}^{-} - {δ}_{P}^{+} = \frac{50000}{60000} , & 50000 \leq P \leq 110000 \\ \frac{W}{5} + {δ}_{W}^{-} - {δ}_{W}^{+} = \frac{5}{5} , & 1 \leq W \leq 5\end{matrix}$$

Notice that scaling of the goal constraints is done by their intervals (both here and later on for the seller). The buyer's GP stays the same as we switch from stage 1 to stage 2 (in fact, the switch is transparent to him).

The Seller's Intention:

Assume that the items in the seller's catalog are given in the following table:

| | | | | Manufacturing | Target | Target |
|---|---|---|---|---|---|---|
| Item | Engine | Warranty | Color | cost | price | profit |
| | 1600 | 1 | Blue | 63000 | 76000 | 13000 |
| | 1600 | 1 | Red | 62500 | 75000 | 12500 |
| | 1600 | 1 | White | 62000 | 74000 | 12000 |
| | 1800 | 3 | White | 74500 | 89000 | 14500 |
| | 1800 | 3 | Blue | 75000 | 90000 | 15000 |
| | 2000 | 4 | Silver | 93000 | 110000 | 17000 |
| | 2000 | 4 | White | 90000 | 108000 | 18000 |

At his first importance level the seller desires to maximize his profits and at the second level he wishes to minimize the warranty period. The seller is willing to move only one year above or below its catalog definition of the warranty period. Notice that in this example:

The seller's main decision variable is profit. The buyer is totally unaware of this variable as well as the “manufacturing cost” column that was used to generate it.

The largest profit is not necessarily associated with the item whose target price is the largest.

The seller's GP in the first stage would look like this:

$$\begin{matrix}Min\_Lex & \{ {δ}_{R}^{-} \} , \{ {δ}_{W}^{+} \} \\ s . t . & \\ \frac{E}{400} + {δ}_{E}^{-} - {δ}_{E}^{+} = \frac{2000}{400} & \\ \frac{W}{5} + {δ}_{W}^{-} - {δ}_{W}^{+} = \frac{1}{5} & \\ \frac{P - 90000}{6000} + {δ}_{P}^{-} - {δ}_{P}^{+} = \frac{18000}{6000} & \end{matrix}$$

Suppose that k=3 and that the seller's first offer was car no. 7 (with list price of 108000). Then, S was composed of all the cars in the catalog. Let us say that after some iterations the seller's GP led to a hypothetical car {E=1600, C=silver, W=2, P=75800}. The actual car closest to it is car no. 1. At this point S is composed of only 3 items and the seller switches to the second stage.

Approach a: To formulate the seller's GP in terms of the discrete options that are available in his catalog we need to define a set of binary variables (say, Xᵢ) where each such variable indicates the selection of a particular item (car) in the catalog. In this case we write:

$$\begin{matrix}Min\_Lex & & \{ {δ}_{R}^{-} \} , \{ {δ}_{W}^{+} \} \\ s . t . & & \\ E = 1600 \cdot ( {X}_{1} + {X}_{2} + {X}_{3} ) + 1800 \cdot ( {X}_{4} + {X}_{5} ) + 2000 \cdot ( {X}_{6} + {X}_{7} ) & & \\ C = Blue \cdot ( {X}_{1} + {X}_{5} ) + Red \cdot ( {X}_{2} ) + White \cdot ( {X}_{3} + {X}_{4} + {X}_{7} ) + Silver \cdot ( {X}_{6} ) & & \\ W + {δ}_{W}^{-} - {δ}_{W}^{+} = 1 \cdot ( {X}_{1} + {X}_{2} + {X}_{3} ) + 3 \cdot ( {X}_{4} + {X}_{5} ) + 4 \cdot ( {X}_{6} + {X}_{7} ) & & \\ P + {δ}_{P}^{-} - {δ}_{P}^{+} = 76000 \cdot {X}_{1} + 75000 \cdot {X}_{2} + … + 108000 \cdot {X}_{7} & & \\ \frac{P - 76000 \cdot {X}_{1} + 75000 \cdot {X}_{2} + … + 108000 \cdot {X}_{7}}{6000} & + {δ}_{R}^{-} - {δ}_{R}^{+} = \frac{18000}{6000} & \\ {\sum }_{i}^{} {X}_{i} = 1 , {X}_{i} ∈ \{ 0 , 1 \} , ∀ i & & \\ 0 \leq {δ}_{W}^{-} , {δ}_{W}^{+} \leq 1 & & \end{matrix}$$

Notice that in this formulation deviations in engine size and color are not allowed for any of the seven possible items. These two represent fixed dimensions in the item's attribute space that cannot be changed by negotiations.

Approach b: The seller constructs 3 sub-intentions (one for each of the cars with E=1600) and let them run in parallel 1-1 sessions. For example, the GP that corresponds to item no. 1 in the catalog will then look like:

$$\begin{matrix}Min\_Lex & \{ {δ}_{R}^{-} \} , \{ {δ}_{W}^{+} \} \\ s . t . & \\ E = 1600 & \\ C = Blue & \\ \frac{W}{5} + {δ}_{W}^{-} - {δ}_{W}^{+} = \frac{1}{5} & \\ \frac{P}{60000} + {δ}_{P}^{-} - {δ}_{P}^{+} = \frac{76000}{60000} & \\ \frac{P - 63000}{6000} + {δ}_{R}^{-} - {δ}_{R}^{+} = \frac{13000}{6000} & \end{matrix}$$

Implementation Comments

1. There is a need to find an efficient way to perform the pre-processing stage as it requires an exhaustive computation effort across all items in the catalog. Hence, when moving from one item in the catalog to its neighbor we might use the previous solution as the starting solution for the next run of the “Complete-Optimal” utility (see the Utilities chapter).

2. Finding the “closest” actual item requires a utility that will be based on the ranking achieved in the pre-processing stage. It does NOT require re-running one of the optimization utilities.

Catalog Purchasing of Multiple Items

Introduction

This section extends the single item procedures to address complex deals that are composed of several items that need to be purchased simultaneously from (possibly) several catalogs. Here are some examples:

A computer system including a PC, terminal and a printer

A car with a trailer (we will refer to this example in the remainder of this document).

A travel package including flight ticket and hotel reservation.

Within each intention we assume that there exists a natural ordering of the items according to their importance (e.g., a car is more important than a trailer). If some items are equally important, an arbitrary order can be established among them. We distinguish between two basic cases (the remainder of this document will address the second case):

1. Independent sub-intentions—There are no constraints of any kind (e.g., trade-offs, hard constraints) that tie the sub-intentions to one another. In such cases, each sub-intention can be dealt with according to the procedure outlined for single-item purchasing.

2. Dependent sub-intentions—There exist some constraints that link the sub-intentions. For example, due to differences in standards, trailers of type A can be mounted only on European made cars while trailers of type B can be mounted only on American made cars. The relevant constraint will be: Trailer_hook_type=Car_hook_type

The Problem Statement

In a multi-item deal there may be many combinations of items (from a collection of catalogs) that may satisfy the constraints. Treating each one of these possibilities separately is often infeasible. An added complication is that if we generate an intention per combination, we lose significant bargaining power since in each negotiation session we deal with exactly one such item combination and it is not possible to move from one combination to another. Of course, a large number of parallel negotiation sessions is infeasible when one of the parties works manually.

The Proposed Solution

Unification Stage:

In this stage an intention that is compatible with both seller's and buyer's original intentions is formed. We perform the unification stage under the optimistic assumption that, within the given ranges of values for the relevant attributes, all possible items exist in their respective catalogs. Therefore, we actually perform no catalog searches during unification. At the conclusion of the unification stage we have an offer for which there might exist many possible combinations of specific catalog items. Let I be the joint intention at this point. Referring to our previous example, we describe the process assuming that intention I includes two items, a car and a trailer. The car (respectively, trailer) component in I is a hypothetical car (respectively, a hypothetical trailer). For example, I might be defined by:

Hypothetical Car: {Color=red, 1600<Engine<3000 cc, 60000<Price<120000}

Hypothetical Trailer: {80<weight<300, 0<height<65 cm, 0<capacity<2.5 ton}

Pre-Processing Stage:

We compile a list of potentially feasible cars (C_{S0}) by enacting the following query. Find the list of cars that could possibly unify with the hypothetical car in I and for which there exists at least one “matching” trailer (effectively computing a semijoin of trailers into cars, satisfying all the relevant GP constraints on cars and trailers). Thus, for the example above, any car whose color is not red will not enter C_{S0}. We grade each car in C_{S0} according to the highest possible grade (least penalty) it could achieve using the seller's GP. For this grading we assume that any trailer we may want is available. We sort the list C_{S0} from best to worst. Next, we compile a list of potentially feasible trailers (T_{S0}) by employing a similar process for the trailers. In case the buyer's GP is known, we compute two similar lists (C_{B0} and T_{B0} for the cars and trailers, respectively) using the buyer's GP. In case the buyer's GP is not available, we just consider the relevant trailers as the semijoin of cars into trailers. Returning to the example above, this stage may lead to four lists as demonstrated below.

| | | No. | | | | | | |
|---|---|---|---|---|---|---|---|---|
| | | 1 | 2 | . . . | 12 | 13 | . . . | 521 |
| C_{S0} | Car sku | 17 | 122 | . . . | 33 | 177 | . . . | 24 |
| | no. | | | | | | | |
| | Seller's | 25 | 28 | . . . | 45 | 48 | . . . | 1330 |
| | value | | | | | | | |

| | | No. | | | | | | |
|---|---|---|---|---|---|---|---|---|
| | | 1 | 2 | . . . | 26 | 27 | . . . | 138 |
| T_{S0} | Trailer sku | 111 | 27 | . . . | 22 | 26 | . . . | 88 |
| | no. | | | | | | | |
| | Seller's | 5 | 12 | . . . | 42 | 49 | . . . | 572 |
| | value | | | | | | | |

| | | No. | | | | | | |
|---|---|---|---|---|---|---|---|---|
| | | 1 | 2 | . . . | 21 | 22 | . . . | 221 |
| C_{B0} | Car sku no. | 33 | 48 | . . . | 167 | 93 | . . . | 189 |
| | Buyer's | 12 | 16 | . . . | 39 | 52 | . . . | 125 |
| | value | | | | | | | |

| | | No. | | | | | | |
|---|---|---|---|---|---|---|---|---|
| | | 1 | 2 | . . . | 9 | 10 | . . . | 77 |
| T_{B0} | Trailer sku | 27 | 88 | . . . | 67 | 21 | . . . | 26 |
| | no. | | | | | | | |
| | Buyer's | 8 | 19 | . . . | 37 | 59 | . . . | 134 |
| | value | | | | | | | |

Negotiation Stages—Introduction

Negotiation proceeds in two stages. In stage 1 the seller operates with hypothetical items when offers are computed. However, when the seller presents an offer to the buyer, a concrete offer, based on actual catalog items, is presented. We shall explain how to locate such a concrete set of items for such a concrete offer. In stage 2 the seller only operates with concrete items. This is done either by (1) duplicating intention I, at this point, for each particular combination, or (2) employing an integer programming formulation that explicitly represents the choices still possible for the intention. The passage from stage 1 to stage 2 is performed when stage 1 fails to identify a combination that will meet its self-imposed requirements.

Negotiation Stage 1

(1) Suppose the seller has to respond to the buyer's last offer (given by the vector x). We distinguish between “non-negotiable” and “negotiable” attributes in the catalogs. For a given car, attributes such as color and engine size are non-negotiable while price and warranty period are negotiable. The seller first tries to generate a counter offer by operating an appropriate utility (“knowledgeable” when he knows the buyer's GP and “ignorant” otherwise) with the additional restriction that changes are allowed only in negotiable attributes. Only when this is not feasible, he employs the following procedure (he will also use this procedure when he has to provide an initial offer).

(2) First, assume the buyer's GP is known. The seller produces a hypothetical offer x using the “knowledgeable” utility with no additional restrictions. Denote the value for x to the seller as v and its value to the buyer's as w. Intersect the sets C_{S1} and C_{B1}, where C_{S1} contains all the cars in C_{S0} whose values for the seller are not worse by more than u% than v, and C_{B1} contains all cars in C_{B0} whose values for the buyer are not worse by more than q% than w. Both u and q are parameters. A similar computation is performed to find the trailer sets T_{S1} and T_{B1}. Let C₁ and T₁ be the resulting intersections, where C₁ is a set of cars and T₁ is a set of trailers. In the context of our example, suppose v=46.5 and w=40.4 and let u=q=3.5%. Then, C_{S1} will contain the first 13 cars in C_{S0} and C_{B1} will contain the first 21 cars in C_{B0}. The cardinality of the intersection set C₁ will be smaller than or equal to 13 and it will contain at least the car whose sku no. is 33.

Next, consider the case in which the buyer's GP is not known. In this case, C₁=C_{S1} and T₁=T_{S1} (notice that these sets contain the sets C₁ and T₁ as prescribed above). As we shall see, in this case we may need to work harder at finding a combination with the desired properties.

Now, the seller needs to perform a sequential scanning of combinations of items from C₁ and T₁ until he either finds a valid combination whose value is “close enough to w” or until he finds that no such combination exists. Offers are generated only for valid combinations of items (car-trailer in our example; we assume that cars are more important than trailers).

(i) Order the cars in C₁ from worst to best in terms of their value to the buyer, select the first car and denote it as Candidate_Car

(ii) Order the trailers in T₁ from worst to best in terms of their value to the buyer, select the first trailer and denote it as Candidate_Trailer

(iii) Assign the values of both Candidate_Car and Candidate_Tar into the GP of I. If the GP is feasible and its value is not better by more than p% (p is a paremeter) than w, then go to (vii)

(iv) Else, make the next trailer in T₁ the Candidate_Trailer and return to (iii)

(v) If T₁ was exhausted, make the next car in C₁ the Candidate_Car and return to (ii)

(vi) If C₁ was exhausted, move to stage 2 of the negotiations

(vii) Generate offer

Negotiation Stage 2

The seller needs to backtrack one step to the previous instance of stage 1. There, instead of finding the FIRST combination that meets his self-imposed restrictions, he needs to perform an exhaustive scan to find ALL such combinations. We naturally assume that this will be a fairly small number since in the next iteration NO such combination was found. After finding all the combinations that meet the requirements, the seller either duplicates I according to each car-trailer combination or formulates a single integer-programming GP model (see the explanation for the single item catalog purchasing) to continue the negotiations.

Buyer's Operation:

There are two basic possibilities for the buyer, namely knowledgeable and ignorant (of the seller's GP). These possibilities dictate how the buyer computes his offers, as usual. Additionally, there are two sub-cases, one in which the buyer has access to the catalog and one in which he does not. In the latter sub-case, the buyer works in terms of hypothetical cars. In the first sub-case, the buyer may still choose to work with hypothetical cars (and leave the seller the responsibility to come up with concrete ones); alternatively, the buyer may choose to work with concrete cars as well. In that case the buyer's situation is analogous to that described previously for the seller. He too may maintain lists and derive appropriate combinations. This option is costly and as default the buyer will work with hypothetical cars, unless he explicitly indicates willingness to employ the slower and more expensive option of locating concrete combinations of items for each offer. Should the buyer choose to work manually, he may choose items from the catalog and the system may assist him in grading the combinations.

Negotiation Mechanisms

Background

This section focuses on negotiation technologies for multi-attribute, multi-items deals where parties have constraints, preferences and trade-offs. Here, parties may be human participants, devices, or in general any sort of agent. The technology is applicable to eCommerce, resource allocation and interpersonal or inter-organizational negotiations. We cover:

1-N negotiations (auctions and reverse auctions)

1-1 (human-like) negotiations

Profiles for 1-1 negotiations

We categorize the handling of intentions into the following logical layers:

Building intentions, (done at the graphical user interface GUI) level; this level may correspond to both humans and automatic tools.

The Unification of intentions (which uses the utility level).

The Mechanism layer which can implement 1-1, 1-N mechanisms.

The Utility level that handles various optimization and basic negotiation functionalities.

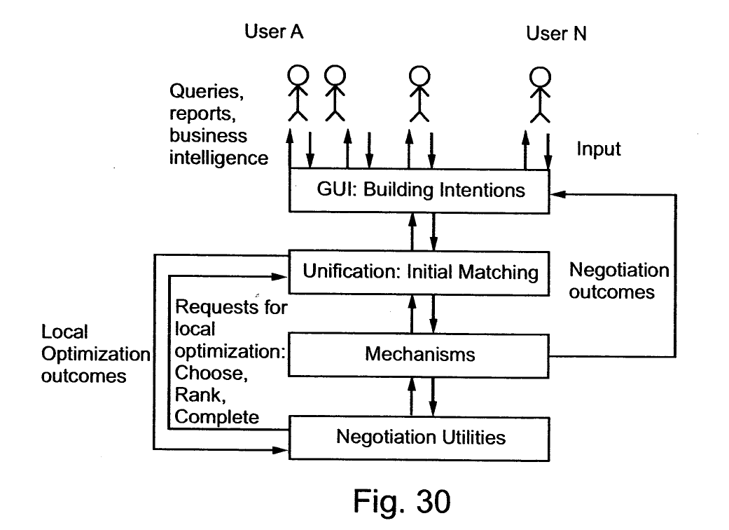

A schematic illustration of the architecture is shown in FIG. 30, which shows the various layers as described above.

Centralized and Distributed Systems

The description in this section is for the most part in terms of a centralized system. However, the techniques here are applicable to the case of a distributed system in which the negotiating parties either have a local copy of the system, each with its own layers (e.g., utility layer) and they communicate via messages, or they send messages to a central site where a single negotiating system is in operation. There are cases in which knowledge of another party's data is needed; in this case we assume that the relevant party sends it.

### Section A: The One-To-N Mechanism

In this section we present procedures for markets characterized by a single seller and a few buyers where the goal is to maximize the seller's revenue from the deal. The analog mirror images of these procedures are suitable for the case of one buyer and a few sellers.

We start by defining the private value and interdependent value models. For simplicity we first assume that the only variable left to agree upon is the price. Later on the relaxation of this assumption will be discussed.

In the private value setup, the values that an agent assigns to the different possible deals do not depend on information provided by other agents. Putting it differently, the agent's values of the different deals depend only on his own information. An example of such deals might be the purchase of a certain component by a purchasing officer. He knows the price of the final product (P), the cost of labor (L), and the margin required by the firm (M). These parameters determine for him an upper bound on the cost of the part (C) given through: C≦P−L−M . Regardless of what other buyers in this market are willing to pay our purchasing officer will fix his private value according to C.

In the interdependent value model, an agent's value depends not only on his own assessment but also on the information other agents possess. An important aspect of this model is that agents not only do not know each other's valuation, they also do not know their own value. An example of such a deal is an auction of land for oil drilling. In this example each agent performs some test to assess the amount and quality of oil in the ground. Clearly, having the results of all tests refines one's own assessment.

The Private Value Model

If buyers' values are private, and every buyer's value is independently drawn from the same distribution, then the famous “Revenue Equivalence” Theorem holds. This theorem states that all auctions in which the bidder with the highest value wins, and the one with the lowest value loses and pays zero, are equivalent from the seller's point of view. Note that the procedure we present below, which is a second price auction with reserved price, does not belong to this class and hence the Theorem is not applicable (this is because we allow the seller to announce a positive reservation price which might result with no trade).

A Second Price Auction With a Reservation Price.

The rules are as follows:

Seller chooses a reservation price r, which is then revealed, to all buyers.

Buyers simultaneously submit bids. We denote by pⱼ the bid of buyer j, j=1, 2, . . . , N. (The buyers do not have to bid simultaneously but it is important that no buyer sees the bid of the others before he submits his bid).

If all bids are below the seller's reservation price, then the procedure is terminated with no trade. Otherwise,

The winner is the bidder whose bid was the highest (if there is a tie then the winner is chosen by a random device).

If buyer k is the winner then he pays Max[max_{jεk}{pⱼ), r] to the seller and the other buyers pay zero.

In case more than one item, say k, are the subject of the auction (either sold or bought by the auctioneer) while each bidder supplies/buys a single item, the price is that of the losing bidder with the highest bid.

Remarks:

1) At first blush, such an auction procedure looks inferior from a revenue point of view when compared, say, with the first price auction (a similar procedure except that the winner pays his own price and not the second). However, such a naive view ignores the effect of the procedure's type on how competitive the bidders are.

2) An important advantage of this procedure is that it is very simple and transparent to follow. When the bidders and the auctioneer argue on the same variables a dominant strategy for a buyer is to bid his value! That is, regardless of what other buyers intend to do, bidding one's own value is always optimal. However, notice that in multi-dimensional settings the bidders may be concerned with different variables than those that are of interest to the auctioneer. In these situations the bidders will have to solve a GP to generate their optimal bid (see below).

3) For a seller to choose a positive reservation price makes sense only if it is a credible threat to terminate the procedure without a trade. If such a threat is not credible, then buyers are going to take it into account, and adjust their bids. While choosing the right bid is a simple matter in such a set up, choosing the optimal reservation price is a more difficult task. In particular, the optimal reservation price depends on the seller's belief on how the buyers' values are distributed.

Multi-Dimensional Deal Auction

In case the only detail yet to agree upon is price, then all sides understand the preferences of the other sides. The seller is interested in a higher price and the buyer prefers a lower price. This is not the case when we have multi-dimensional deals. In this case we denote the buyer's value function by f(.) and that of the seller by g(.). For the sake of consistency with our conventional representation of objective functions we shall treat both f(.) and g(.) as functions that represent penalties (i.e., weighted deviations from targets). So, in terms of these penalty functions, “less means better”.

In such a case, it is important to first reveal the value function g(.) of the seller to the bidders.

One possibility is to reveal to the bidders the true value function g(.), which was submitted by the seller. Another possibility is to give the seller an option to reveal a modified value function, denoted by g′(.), according to his strategic choice.

So, first the seller reveals his g′(.) (by publishing his constraints, preferences and targets possibly arranged in K≦2 levels in lexicographical order) his reservation price (given in terms of maximal allowed values for his objective function levels—gₖ). The limitation on K is because the auction utility (see code below) concentrates on the first level objective function and hence actually works in a mode where all important issues, properly weighted should be al level one, and all the other issues at level 2.

Then, buyers bid. Let b=(b₁, . . . bₙ) denote the vector of submitted bids where each bid is a value for the seller's first level objective function. Let fᵢₗ(.) be bounds on the first level value function of bidder i, GPᵢ is his corresponding goal-program and GP_{A} is the goal program of the auctioneer. Then, to generate a bid, bidder i solves a program that maximizes the seller's utility subject to his own constraints as well as those of the seller (i.e., both GPᵢ and GP_{A}) and while not crossing the threshold values specified for his own objective function level at level 1 as well as the thresholds for level 1 that were specified by the seller:

$$\begin{matrix}Lex\_Min & \{ {β}_{1} \} , \{ {β}_{2} \} \\ s . t . & \\ & {α}_{i1} \leq {f}_{il} \\ & {β}_{1} \leq {g}_{1} \\ & {GP}_{i} \\ & {GP}_{A}\end{matrix}$$

The first hard constraint forces the solution to meet the bidder's threshold specifications (fᵢ₁) at the 1^{st} level of his objective function. The second constraint restricts the bid so that it gives the auctioneer at least what he announced as his threshold level g₁. In the objective function of the program above, the bidder tries to respond (the response being values for the seller's two objective functions), as best as he can under the constraints, to the auctioneer's two objectives (according to their lexicographical order).

The auctioneer selects the winning bid as the one associated with the smallest value for g′(.). Let bidder m be the winner. That is

bₘ=arg minᵢ[g′(bᵢ)]

Let s denote the second winning bidder. That is,

bₛ=arg min_{i≠m}[g′(bᵢ)]

The traded deal, denoted by d, is then obtained by solving:

Lex_Min αₘ₁,αₘ₂,β_{A1},β_{A2}

s.t.

β_{A1}≦g₁′(bₛ)

GPₘ

GP_{A}

In words, the winning buyer selects values for the vector of decision variables x so as to optimize his own objective function subject to the constraint that the selected values will give the seller at level 1 at least the utility obtained through bₛ. Following that, there will be an attempt to optimize the seller's utility, at the next priority levels (A denotes auctioneer). If, for some reason (e.g., discrete variables), bidder m can not offer g′(bₛ) the program will lead him to offer a smaller value for level 1—possibly even that of g₁′(bₘ)! The auctioneer will have no problem in accepting such an offer, which goes beyond what is generally accepted out of a second-price auction.

The seller then verifies the deal d. In case of disagreement, the winner and the seller need to further negotiate on this deal in a one-to-one fashion or offline.

Remarks:

1) In general the seller has an incentive to reveal his true g(.) as this will encourage the buyers to make the best bids from his point of view. However, there might be situations in which a seller will prefer to reveal a modified rather than true value function. For example, this may happen when he is engaged in 1-N negotiations at present but plans to move on to 1-1 negotiations with the same buyers in the immediate future. If he reveals his true value function now it will make his future “opponents” knowledgeable and that might give them an advantage.

2) If the seller's goal is to achieve an efficient outcome (that is to select the bidder with the smallest g(.) value) then his reservation price must be set to infinity. A finite reservation price is to ensure maximization of seller's utility.

3) Another option which the system will provide is for a seller to reveal partial or modified information about his value function, let the auction procedure work as explained above but have the option to select whichever bid he likes (not necessarily the one who “won” the bid in the regular sense). This is equivalent to existing bids in which the agent who issued the RFP states that he is not obliged to select the cheapest offer. In our terminology this means that he revealed part of his value function (money) but not all of it (other components may involve data on the reliability of the bidders, their tendency to meet lead times, etc.).

The English Auction

When agents have private values, the second price auction and the English auction are equivalent from a strategic point of view. Yet it is often claimed that the English auction is more intuitive for the players to understand and follow. While this might be true in real life, it is not necessarily so in automatic negotiation environments. To see why, we first describe the English auction. We will do it at once for the case of whole complex deal.

The Rules of the English Auction

Before the auction starts the seller's (possibly modified) value function g′(.) is revealed to the bidders. The value of g′(.) is set to the reservation value set by the seller and starts decreasing continuously. As in the case of second price auction, we limit the number of levels in the seller's objective function to 2. Furthermore, the auction is carried out in terms of values related to the objective function values of ONLY the FIRST LEVEL! Bidders signal when they want to opt out. The auction ends and the clock stops when there is only one bidder left. At that point, the bidder that “stayed” must produce an offer with the appropriate value (the g′(.) that was reached). This offer must be approved by the seller (in verifying the offer, both sides may need to consult external data sources and other decision data). Denote the level of the auction clock at that point by v. The winner then produces a deal d such that g′(d)=v. The seller then verifies this deal. In case of disagreement, the winner and the seller need to further negotiate on this deal in a 1-1 fashion or offline.

In case more than one item, say k, are the subject of the English auction (either sold or bought by the auctioneer) while each bidder supplies/buys a single item, the auction stops when there are less than k bidders is that of the losing bidder with the highest bid.

To implement the English Auction procedure the auctioneer needs to define a “profile” that will be used to decrease his reservation value. These decreases can be based on constant absolute term (reflecting “neutral” or “indifferent” auctioneer), a constant relative term (leading to a convex shape that might be associated with an “aggressive” auctioneer), decreasing step sizes (leading to concave-shaped value functions that might signal “soft” approach towards the bidders), etc. At any rate, given a new value g′(b) that was computed through the profile data, the auctioneer needs to solve the following program that tests whether this value is feasible. If it is feasible, it will be announced to the bidders. If not, the program will find the closest value g′(x*) that is possible. Again, we restrict to K≦2. Note that the term in the Lex_Min below is designed to favor decreasing of the auctioneer's objective value at level 1 in case an offer with exactly the desired value is not feasible.

$$\begin{matrix}Lex\_Min & \{ \cdot {δ}_{1}^{-} + 100 {δ}_{1}^{+} \} \\ s . t . & {g}_{1}^{′} ( x ) + {δ}_{1}^{-} - {δ}_{1}^{+} = {g}_{1}^{′} ( b ) \\ & {GP}_{A}\end{matrix}$$

Given a value function g′(b) stated by the auctioneer, a bidder has to determine if he stays in the auction. This is determined by computing a vector of decision variables x that satisfies the auctioneer's current requirement and provides the bidder with the best solution for his own value function f(.). This is done through the following program. Observe that the vector x may not be actually required by the auctioneer, it is computed just for the case where actual offers are required by the auctioneer rather than just a “stay/quit” answer. Below, B denotes bidder and A denotes auctioneer.

$$\begin{matrix}Min & {α}_{B1} , {α}_{B2} , {β}_{A1} , {β}_{A2} \\ s . t . & {β}_{A1} \leq {g}_{1}^{′} ( b ) \\ & {GP}_{B} \\ & {GP}_{A}\end{matrix}$$

The bidder's profile allows him to choose one of four approaches to determine whether to stay in the bid in light of the optimal value f(x*) that was achieved as shown above.

1. The bidder may stay until he reaches his worse objective value (i.e., he stays as long as the program above is feasible, regardless of the objective).

2. The bidder may specify a percentage of the difference between his best and worse solutions. The value f(x*) will be compared to the value associated with that percentage and if it's still above it, the bidder stays.

3. The bidder may specify a value (instead of the percentage in the previous approach) between his best and worse solutions. This value is used to compare against f(x*) as above.

4. The bidder may be unable to specify either a value or a percentage but capable of providing an example from which we can deduce his implicit limit. The system will enable him to specify such a deal through a “deal generation” module.

A dominant strategy for the buyer in this auction is to opt out exactly at the value of g′(.) that coincides with the buyer's private value, i.e. for any lower value of g′(.) the buyer's private value is exceeded (worsened)—that thus leads to a zero payoff. It is easy to check that this is exactly the same bid a bidder would bid in the second price auction. However, a major difference between the second-price auction and the English auction is that in the latter the action of one bidder may depend on the actions of other bidders. We implement a dependency on the number of bidders that remain active at any given step. Thus, the bidder profile enables an optional departure from the bid process that is given as a probability function that depends on the percentage of bidders who are still in the “race” at the present step. Insecure bidders may thus increase their chances of leaving the auction before it reaches its conclusion if the number of remaining bidders indicates to them that the “market” has little appreciation to the current offer by the auctioneer.

Closing the Deal:

Let us assume that the seller attempted to sell n identical duplicates of a certain item. Several situations may arise:

1. One iteration before the clock stopped (say, when the value for the auctioneer was ν) there were still m>n active bidders. At the last iteration, the auctioneer decreased the value to ν−δ and only k<n bidders remained. In that case, the auctioneer leaves aside the k active bidders and returns to the m−k bidders that dropped with a value that is half way between his last two values (i.e., ν−δ/2). He will continue to drop the value (or return half-way upwards) until he either gets the additional n−k bidders he needs to complete his desired deal or until he can't slice the values by a half any longer (due to a restriction on step sizes in the value functions). In the first case, all the n “winning” bidders are committed to the same value (say, after two such iterations the value was ν−3δ/4). Note that although there were some bidders that were ready to commit to a better value for the auctioneer (there were k bidders who were ready to go to the value ν−δ) all the n winning bidders must “pay the same price” to maintain a fair auction process.

2. One iteration before the clock stopped (say, when the value for the auctioneer was ν) there were m>n active bidders. At the next (and last) iteration, when the value is dropped to ν−δ, exactly n bidders remained. Then, the bidding process stops and the n “winning” bidders are committed to the ν−δ value.

Remark:

While the first price auction yields the same revenue to the seller it is much more difficult to find an optimal strategy and hence is not recommended.

The Interdependent Value Model

In the interdependent setup, agents should update their own valuation of the deals as they learn more about other agents' values. As a general principle in such a set up, it is optimal to employ a procedure in which as much of the agents' private information is revealed in due time to his rivals. This is why in this setup the different auctions are not equivalent any more. Indeed, when there is only one deal to agree upon, the best mechanism (the one that maximizes the seller's revenue) is the English auction. This is why in this setup it is important that all bidders know the history of the auction. We redefine the auction to take this into account.

Remark: As it is clear from the discussion above, this section deals with the (rather remote for us) case in which the bidders know each other and have some idea regarding how the information of others affects them.

The English Auction

We present the discussion in terms of a seller auctioneer and buying bidders. In general, in the English auction the price of the object rises and bidders indicate whether they are willing to buy the object at that price or not. A bidder that is willing to buy at the current price is said to be an active bidder. At a price of 0 all bidders are active and as the price rises bidders can choose to drop out of the auction. The decision to drop out is both public and irrevocable. Thus, if bidder j drops out at price p, the bidders commonly know both the identity of the bidder dropping out and the price p at which he dropped out. Furthermore, once bidder j drops out he cannot then “re-enter” the auction at a higher price.

It may be useful to think of each bidder as pressing a button to signify that he is active. A number light that is publicly observed indicates the number of active participants to all bidders. Once a bidder drops out, his light goes off and the bidder cannot reenter the auction. At any time during the auction the active bidders can see the number of other bidders still active. In this form, the auction specified above is sometimes referred to as the “button auction.” Note that while in the classical English auction the participants know both the number and the identity of the active buyers, here they know only the number but not the identity.

As previously discussed with regard to the English auction, since we deal with whole complex deals, both seller and buyers need to verify intermediate offers as feasible.

Remarks:

1) By making the drop out price a function of who dropped before and when, a bidder takes into account the information other bidders have, as revealed by their dropping out price.

2) When values are private (see above), this auction is exactly like the second price auction and it is enough for a bidder to specify a price to drop out, as there is nothing to gain by using the information on other bidders dropping out prices.

3) It follows that the main difference between this case and the one for private value is in the strategies of the players. A drop out price for a bidder is going to be a function of the history of the play.

The Auction's Rules

1) Seller's (possibly modified) value function g′(.) is revealed to all bidders. The seller chooses a reservation value r, which defines the maximal value under which he is willing to sell. Again, we limit the seller to two levels and run the auction according to the values of the first level.

2) The value of r is revealed to bidders.

3) Bidders choose whether to participate or not.

4) The price clock starts falling until the point where all bidders but one dropped out. Denote the winner by m and the value at which he won by p*.

5) The traded deal denoted by d, then solves

fₘ(d)=min[fₘ(x)] subject to g(p*)≧g(x)

Strategies:

Seller: A strategy for the seller is to choose the value for r. Additionally, a seller need to specify the increments (percentage or fixed) by which the auction proceeds from round to round.

Buyer: A strategy for a buyer is to choose a drop out value as a function of who dropped out in the past and at what value.

We suggest using a decision table as follows:

The table rows correspond to the current “price” in the buyer's currency. Note that the buyer makes decisions in terms of his currency. Intuitively, the last table row refers to the bidder's worst possible situation in terms of price (in his currency). We can obtain this by running worst on the bidder's GP. Alternatively, we may obtain it from the user in one of the ways we obtained his reservation values in the cases previously described.

Each column corresponds to a range of original participants, for example, if column one is 2-12, it means that the auction started with 2 to 12 buyers.

Each entry in the table includes two numbers, to be understood as “the percentage of original participants that is still present currently and the probability of dropping out”. For example, suppose we observe that for a certain row that corresponds to seller's value 200 and a column that corresponds to 21-30 original participants, the entry numbers are {40,0.5}. This means that when the auction value reaches 200 and the number of original participants left in the auction is 40% of the original number (21-30) who started, then drop out of the game with probability of 0.5.

### Section B: The One-To-One Mechanism

This section discusses the 1-1 functionality of the mechanism layer. One-to-one is a complex trading mechanism as compared to one-to-N (auctions). Part of this complication is due to issues of symmetry—who starts, who responds, at what intervals, how to respond and when and how to terminate.

We begin by explaining the situation in a price-only negotiation. We then outline the needed changes when more general deals, containing multi-items and multi-attributes, are treated. We define the parameters that specify the user as a negotiating entity, these include:

User negotiation classification parameters

User operational profile

The combination of the two dictates the actual negotiation behavior. Once executing, this information is used to dictate how to respond to the other side's offers. Here, the other side's offers are essentially values for the decision variables.

The profile is constructed in two ways:

Choose from a pre-determined set of profiles (see the profiles section). This choice can then be adjusted.

Based on answers to a set of questions, a profile is composed to express the desired behavior.

User Negotiation Classification Parameters Include:

1. Negotiation type: I offer, I respond, Symmetric (and if so, I start, the other party starts, I don't care who starts, a randomly selected starter).

2. Negotiation focus: all deal parameters, part of the parameters (could be just price), multi-phases (e.g., two phases) and for each phase, which decision variables participate in each phase.

3. Relayed information to other side: My value functions, part of my value functions, other value functions (e.g., such as the g′( ) function that was described above).

4. A Worst offer I'll accept (an example of such an offer is used to derive the corresponding value functions values; alternatively, it can be specified as percentage off/above average/best/worst offers, these standard offers can be calculated by the utility layer).

5. A Starting offer I'll suggest to the other side (again, this is specified via an example or via offsets from standard offers).

6. Timing parameters, the most important is time to completion of all negotiations. Another time parameter is the maximum time per single negotiation process. These parameters are used to ‘speed-up’ moving through the columns (rounds) in profile tables. Specifically, if the table has N columns that have not yet been used and a round takes currently t seconds and the time to completion of this negotiation session is T, the number of columns to skip is (N/(T/t) rounded to the nearest integer. The user may also specify: a maximum skip and reaction delay to the other side's offers.

User Operational Profile Includes the Following Components:

User's tables and negotiation control data. The tables basically explain how to react to the other side's moves based on the ‘round number’ as well as the other side's previous offer.

User's value functions. These functions determine how the user values offers. One possibility is a multi-level specification of objectives as done in goal programming (GP). Another possibility is a value function based on the Analytic Hierarchy Process (AHP) method (see Saaty, 1990). A third possibility is a scoring function designed for the particular application domain.

Multi-Level Mechanism:

For a multi-level specified value function, the one-to-one negotiations may be instructed, if so desired, to proceed on a level-by-level basis, along the value functions objective functions, where negotiation on a level starts once “agreement” about the preceding level is achieved. This also means that the time factors in negotiations should be understood in the context of levels. Therefore, if we consider about 4 levels as the maximum per value functions, we can allocate 9/16to level 1, ¼ to level 2, ⅛ to level 3 and 1/16 to level 4.

In what follows, we first describe a mechanism for one-to-one negotiations on a single parameter, say price. In so doing, we specify the data structures used to determine a negotiating party's behavior. This is then generalized to the complex settings of multi-items, multi-attributes deals. This setting is also referred to as a multi-dimensional negotiation.

Part 1: Price Only Negotiation (from a Seller's Viewpoint)

(A) Assume the negotiation is on price only, and consider a seller's strategy (a mirror image strategy is specified for the buyer).

In what follows, we denote by round a proposal by one party and a response to it, with either Yes or No by the other party. The elicitation of parameters is described in terms of filling a ‘questionnaire’. This is, of course, an abstraction and other ways are possible such as calls to an application-programming interface (API).

Check applicable entries:

1) ______ Fill in the time to end all negotiations and specify the maximum time for a single negotiation session ______.

2) ______ Fill in the time delay (percentage, 5% means that you add 5% to the delay of the other side or to a constant delay, −5% means you are quicker to respond). This time delay may also be a function of round number, in which case a table such as Table 2 below is used.

3) ______ I insist on playing only if I make all offers and the other side responds only with Yes or No answers.

4) ______ I insist on playing only if the other side makes all offers and I respond only with Yes or No answers.

5) ______ I insist on playing only through a symmetric mechanism. That is, if in round t the seller was the one proposing and the buyer was the responder, then in round t+1, the buyer is the one proposing and the seller is the responder. In this procedure,

5.1 ______ I start

5.2 ______ The other side starts

5.3 ______ The starter is determined randomly

5.4 ______ I do not care who starts

6) ______ I do not care in what procedure to play.

If the procedure is not symmetric, but one in which the seller makes all offers, then point (4) in the procedure above should be deleted. If instead, the procedure is the one in which the seller only reacts by {Yes, No}, then delete all points in (B) below except for point (B4) which defines acceptance.

(B) Assume the procedure is symmetric, that is, the parties alternate in issuing offers (see below for a modified rule for a non-symmetric procedure), then

(B1) ______ Fill in the starting high price if you are the first to propose. If in the first round you are a responder, then fill in your starting high price in the second round as a function of the first proposal (see table below).

| First round proposal in the range | My second round starting proposal |
|---|---|
| 0-200 | 1900 |
| 200-400 | 1400 |
| . | . |
| . | . |
| . | . |
| 1200-1300 | Y |
| | Y |

In the table above one needs to specify the range of first price offers he's willing to accept. That is, if in some of the entries you specify Y instead of the number, this implies that you want to accept and hence do not specify a counter offer.

(B2) ______ Fill in the percentage decrease in each round (see different possible rules below).

(B3) ______ Fill in a floor price.

(B4) ______ Fill in the acceptance rule (assume the buyer makes the first proposal)

| | Round | | | | |
|---|---|---|---|---|---|
| | 1 | 3 | 5 | . . . | |
| Accept if current | 400 | 390 | 360 | | 250 |
| proposal is equal | | | | | |
| to or greater than | | | | | |

In the above example, the seller will accept an offer of 360 or more in round five.

(B5) ______ Fill in the stopping rule. This rule introduces a potential cost in rejecting an offer. Introducing a probability of termination after rejection does this. In that event, the session may be over and it's unclear when and if a new session will be possible. For example, if the floor price is $100 the following table describes the probability of termination given the current rejected offer by the buyer. Filling these entries may affect both the duration and the outcome of negotiations.

| | Current offer | | | | | | | |
|---|---|---|---|---|---|---|---|---|
| | 300-280 | 280-250 | . . . | . . . | . . . | . . . | . . . | 100 |
| Probability | .05 | .10 | .15 | .20 | | | | 1.00 |
| of | | | | | | | | |
| termination | | | | | | | | |

For example, if the price is $275 then the probability of stopping the negotiation is 0.10.

We may want to have different tables for different rounds. In particular, for a given offer p, we may want to terminate in probability q if this is round 3, but probability q′ if this is round 8 (say).

Some alternatives for (B2):

(B2′) Let t be the current round, let Pₜ denote the offer made by the buyer in round t. Finally let xₜ=([Pₜ/Pₜ₋₂]−1). Fill in the following table for the percentage decrease in round t. Note that you can express some “good will” by reacting positively to the buyer. That is, if he increases his rate of raising his offers, you in return increase the rate in which you decrease your offers. Alternatively, you can interpret his “good will” as a sign of weakness and be more stubborn. Consider the following example table as filled by the seller (assume the buyer is the first to propose):

| | t | | | |
|---|---|---|---|---|
| xₜ | 4 | 6 | 8 | |
| .05 | .005 | .006 | .05 | . . . |
| .10 | .002 | .009 | .10 | . . . |
| .15 | .00 | .00 | .15 | . . . |
| .20 | .00 | .00 | .20 | . . . |
| . . . | . . . | . . . | . . . | |

In this table, for example, if in round 3 (say) the buyer's price is 1.10 times his price in round one, that is xₜ=0.10, then the seller's price in round six will be 0.991 times his price in round two.

We may want to allow a few tables like the one above, each one for a different range of the starting proposal of the other side. For example, one table (as above) if the buyer first proposal p was such that 1000≦p<2000, and a different table is 2000≦p<4000.

(B2″) The same as in (B2′), except that a different table is constructed for different buyer's price ranges. For example, if the current buyer's price is up to 500, use table one, otherwise use table two.

(B2′″) Same as (B2′) but now xₜ=a*Pₜ/Pₜ₋₁+b*Pₜ₋₁/Pₜ₋₂+c*Pₜ₋₂/Pₜ₋₃ etc.

Choose the appropriate values for a,b,c. etc.

(B2″″) Let xₜ be the amount (in $US, say) change (toward agreement) of the buyer in the previous round. Then the seller's amount change toward agreement in round t+1 is axₜ+b. Fill in a value for a, and for b. It is also possible to allow for different a and b for different rounds. In that case there is a need to fill a table for the different aₜ and bₜ.

Part 2: Negotiation on Complex Deals

Here we start by setting the ground rules and accompany them with an illustrative example. One can envision a sequence of questions specifying the phases of negotiation and what decision variables are to be negotiated in each phase. The presentation is from the seller's viewpoint.

Check the applicable entries:

1. ______ I'd like to negotiate the whole deal in a single phase.

2. ______ I'd like to work in a multi-phase mode (we show an example of two phases)

i. In phase 1, I'd like to negotiate on the following attribute(s) ______ using the following method ______ (can be “price only” or “knowledge mode” as defined below).

ii. In phase two, I'd like to negotiate on the following attribute(s) ______ using the following method ______ (can be “price only” or “knowledge mode” as defined below).

As an example, suppose in phase (a) the parties negotiate on all attributes except for price and in phase (b) just on price. In phase (a), the negotiation procedure completely ignores the price attribute and therefore cannot consider price-related tradeoffs as well. Except for that, negotiations are carried out in any of the “knowledge modes” detailed below. Once the deal is agreed upon, except for price, the price is negotiated upon as per part 1. Observe that this necessitates filling tables twice, once for the first “non-price” phase, and then for the second “price-only” phase. This is because in both phases there is an underlying value function.

2) a) ______ I am ready to disclose my value function to the other side.

b) ______ I am willing only to disclose a “subset” value function to the other side. This subset needs to be specified.

c) ______ I am willing only to disclose a “different” value function to the other side. If so, this value function needs to be specified.

d) ______ I am ready to disclose my true value function only if the other side is ready to disclose his true value function.

e) ______ I am not ready to disclose my value function.

f) ______ I am ready to disclose my percentage worsening to the other party.

g) ______ I am not ready to disclose my percentage worsening to the other party.

h) ______ I am ready to disclose my percentage worsening to the other party provided the other party also discloses his worsening percentages.

Note that the seller needs to fill information for the true value function and for the subset to be used, or for the modified function.

3) In the following we examine the various possibilities of the parties' knowledge of each other's value function. As before, we denote these functions by f(.) for the buyer's function and g(.) for the seller's one. The goal of each agent is to reach a deal with the highest possible value of his value function (in the context of GP, the highest possible value is achieved when the objective functions are minimized).

Basically there are four basic knowledge state possibilities:

| | Seller | Buyer |
|---|---|---|
| 1 | K | K |
| 2 | K | I |
| 3 | I | K |
| 4 | I | I |

Here “K” means knows the other side's value function and “I” means ignorant of the other side's value function. We continue to consider the seller's problem.

Now, instead of price we have a value function. (When negotiations proceed level-by-level, this value function is specific to the current level that is being discussed.) In general, we have a buyer with a value function a and a seller with a value function P. Observe that the buyer and the seller may give different values to the same offer. We can therefore think of “buyer's currency” and “seller's currency”. Let us review the filling up of negotiation parameters in (B) in the case of complex deals, again from the seller's point of view:

1. Negotiation type, as in the price only case.

2. Point B1, starting high price. Here the seller needs to provide an excellent offer from his point of view. The implied objective function(s) values will then be used in the actual negotiations at the appropriate level. Alternatively, this may be specified as an offset from a standard offer that can be generated by the utility layer.

The situation is a bit more complex for the table detailing second offer in response to first offer. Because this is not just number filling, the response will still be with values corresponding to those in an excellent offer.

3. Point B2 is the same, fill in the percentage decrease.

4. Point B3, floor price, is handled by asking for a worst offer (again, via an example or in terms of a standard offer).

5. Point B4, acceptance rule. Here the seller needs to provide ‘typical’ acceptable deals for these rounds. The system will use the objective value functions on these offers to set acceptance rules. Again, specification in terms of standard offers is possible.

6. Point B5, stopping rule, as in the case of price only.

7. Alternatives for (B2). Here we only treat a variant of (B2′). This variant will have three values in each table entry:

i. Percentage by which seller is ready to go down.

ii. Percentage by which seller is ready to improve the buyer's offer.

iii. Percentage (may be negative), indicating response time relative to buyer's response time or a constant. The measurement here should be in units that clearly indicate a strategic delay rather than a system delay, further delay should be measured above a reasonable threshold, say 5 minutes. If this entry is 0, it means answer immediately.

The precise interpretation of these percentages may change depending on the primary negotiation procedure used at the utility level, as well as the knowledge mode used.

A critical issue is that of how to interpret the other party's offer. When both parties are knowledgeable this is simple, and each party uses its own “currency”. However, when receiving an offer from an ignorant party this is not so simple. The obvious solution is that the receiving party only uses its own currency. However, since the other party is ignorant this may miss the other party's willingness to reach agreement and the negotiation may get stuck.

Looking then in terms of the other party's currency (i.e., how much he gave up in his own currency) seems reasonable. This information is available for a knowledgeable party. For an ignorant receiving party we can consider the possibility that this parameter is actually provided by the system, that is the system supplies information on how much the other side degraded his position in his currency (but without actually revealing the other party's value function).

| | Seller | Buyer | p | q | r |
|---|---|---|---|---|---|
| 1 | K | K | use | ignore | N/A |
| 2 | K | I | use | use | N/A |
| 3 | I | K | use | N/A | ignore/use |
| 4 | I | I | use | N/A | use |

The above table adds three columns to the previous table. Here p, q and r are parameters. They indicate the relative weights that should be assigned to percentage improvement of this buyer's offer as compared to his previous one. Parameter p refers to measuring the improvement in the seller's currency. Parameter q refers to measuring degradations in the buyer's currency. Parameter r also refers to degrading in the buyer's currency, the difference here is that r is supplied by the buyer and is not computed based on knowledge of the buyer's value function. Looking at degradations in terms of the buyer's currency is meaningful only when the buyer is ignorant. In that case the buyer's “goodwill” can only be manifested by how much he degraded his position. The precise relative weights ascribed to p, q and r may be system parameters that can be further modified by advanced users.

For example, the vector p=0.7, q=r=0.3 indicates an evaluation of buyer's offers that gives high weight to actual improvement as experienced by the seller and a somewhat lesser weight to the “buyer's efforts”. We note that giving low weights to buyer's efforts may lead to a “spiraling down” negotiations. This means the buyer's offer is considered as not good enough which may lead to a tough, i.e. low percentage improvement, counter offer by the seller, which may then trigger a tough buyer's response and so on.

The third line needs further explanation. The obvious choice here is “ignore” in the r column. The rational is that the other party is knowledgeable and therefore his offer should be judged in the seller's currency only. The option of “use” will usually assign a very small weight to his degradations.

Part 3: Rules for Starting the Negotiation Process

Negotiations commence by the party who wanted to start (or at random if both parties were willing to start). The initial values in the first offer are specified as follows:

Aggressive Mode

Solve: Best for me in my first objective level (Min α_{1,}_{₁}=α₁*) s.t. my own GP

Solve: Worst for the other party at his first objective level (Max β_{1,}_{₁}=\overline{β}₁*) s.t. his GP and α_{1,}_{₁}=α₁*

Solve: Best for me in my second objective level (Min α_{1,}_{₂}=α₂*) s.t. my own GP and α_{1,}_{₁}=α₁*,β_{1,}_{₁}=\overline{β}₁*

Solve: Worst for the other party at his second objective level (Max β_{1,}_{₂}=\overline{β}₂*) s.t. his GP and α_{1,}_{₁}=α₁*,β_{1,}_{₁}=\overline{β}₁*,α_{1,}_{₂}=α₂*

Continue this sequence of optimizations until you exhaust all levels of the objective function for both parties.

Ignorant Mode

Solve: Best for me in my first objective level (Min α_{L}_{₁}=α₁*) s.t. my own GP. Notice that here (and elsewhere in places where we solve LP problems) variables that do not affect the objective function receive values that are arbitrarily assigned to them by the solver (typically at one of the end-points of their feasible ranges).

Solve: Best for me in my second objective level (Min α_{L}_{₂}=α₂*) s.t. my own GP and α_{L}_{₁}=α₁*

Continue this sequence of optimizations until you exhaust all the levels of your own objective function.

Part 4: Rules for Ending the Negotiation Process

Negotiations may be stopped either due to a successful conclusion (a deal is reached), or due to technical reasons such as the passage of time, the ‘end of the profile’ or the lack of progress. In this part we outline a representative collection of criteria for either accepting an offer or for stopping the exchange of offers and counter offers. In case of stopping we have the option of considering the negotiations as failed or, alternatively, we may generate a compromise offer based on the current state of the negotiations as well as the original intentions of the parties.

Acceptance Criteria for Proposition Acceptance:

1. Decision variables—the offer that I am going to suggest is similar to the last offer that I received from the other party.

2. Better offer—the last offer that I received is better for me as compared to the offer I am going to suggest (according to the objective values).

3. Acceptance rules—the quality of the offer that I received is higher than the quality of offers I am ready to accept at this point in the negotiation.

4. Additional application specific rules.

Stopping Rules:

1. Non-improve increase—the previous K offers I received are similar to each other.

2. Time limit—I have reached the deadline I specified for this negotiation process or for the intention (deal) as a whole.

3. User directive, either human generated or tool generated.

Remarks:

When the parties end the negotiation according to the above stopping rules, it means that they didn't reach agreement. At this point, the system can provide a compromise offer that will be presented to both parties as the result of the negotiation process, along with an indication that this is a compromise offer.

By similar we mean that the offers are sufficiently close, the closeness is a system parameter, e.g., 0.75% or less difference per coordinate value, or average difference over all coordinates; other measures are possible.

### Section C: Profiles in Depth

A profile is composed of the following components:

1. Counter offers generation table. The table contains four parameters in each entry.

i) Worsen mine—the percentage by which I am willing to worsen an offer in terms of my objective functions values.

ii) Improve opposite—the percentage by which I am willing to improve the other side's objective functions values.

iii) Delay time—a positive factor indicating by how much I want to increase, or decrease, the delay in producing an offer as compared to the time it took the counter offer to reach me. Values smaller than one indicate reduction in delay time while values larger than one indicate increase in delay time. In addition, there is a constant by which the delay reaction factor is multiplied; it is either ‘system delay’ or a specific unit of time, e.g., 10 minutes. The particular constant used may change from one table entry to another.

iv) Probability for quitting—the probability of quitting the negotiation at the next round. Intuitively, this is deterrence against prolonged negotiations.

All these parameters depend on the number of rounds and the percentage by which the other side improved his latest offer as compared to its previous offer⁴⁹. ^{!}The parameters can depend on the latest offer by the opposite side or on the cumulative percentage improvement offered by the opposite side from the beginning of the negotiation process, or over a “sliding window”.

2. Acceptance rules. These rules specify the quality of offers I'm ready to accept, as a function of the round number and the latest improvement presented by the other party. When I'm ready to accept offers of a certain quality, which is specified in terms of my objectives (either via an example or as a percentage off/above standard offers such as optimal, average, worst). Any offer presented to me thus far is eligible for being accepted; for example at round 6 I may decide to accept an offer made in round 2.

3. My negotiation parameters. A collection of technical parameters including, among others: (i) whether I like to disclose my value functions (in whole or in part, or a surrogate thereof), (ii) whether I want to start, and (iii) a list of parameters, (deal components) to be negotiated on.

In order to create a profile, we present the trader with several questions.

The possible answers are (numerical scales are also possible): (LL=very low, L=low, M=medium, H=high, HH-very high, EQ=equal):

1. As time goes on how would you like to react towards the other party?

i. I would like to be (LL, L, M, H, HH) positive towards the other party.

(I am under time pressure and I don't want to exert time pressure on the other party.)

ii. I would like to be (LL, L, M, H, HH) negative towards the other party.

(I am not under time pressure and I want to exert time pressure on the other party.)

iii. My reactions are not influenced by the progression of time.

(I am not under time pressure and I don't want to exert time pressure on the other party.)

2. During the rounds, would you like to:

i. Increase (LL, L, M, H, HH) the quality of acceptable offers.

(Intuitively, this means that I am not under time pressure and I want to exert time pressure on the other party.)

ii. Decrease (LL, L, M, H, HH) the quality of the acceptable offers.

(Intuitively, this means that I am under time pressure.)

iii. The quality of acceptable offers stays the same.

(Intuitively, this means that I am not under time pressure and I don't want to exert time pressure on the other party.)

3. If the other party improves his offer by X% (in a block as determined by the percentages range and the rounds range, see below).

i. You are ready to improve your previous offer by a percentage, say Y% (LL, L, EQ, H, HH) X%, and all this provided that

ii. Your new offer is not worsened, i.e., degraded, by more than a percentage, say Z% (LL, L, EQ, H, HH) X%.

4. How eager are you to close a deal (LL, L, EQ, H, HH)?

(This influences the acceptance rule and the quitting probability.)

Profile Name: Indifferent (1)

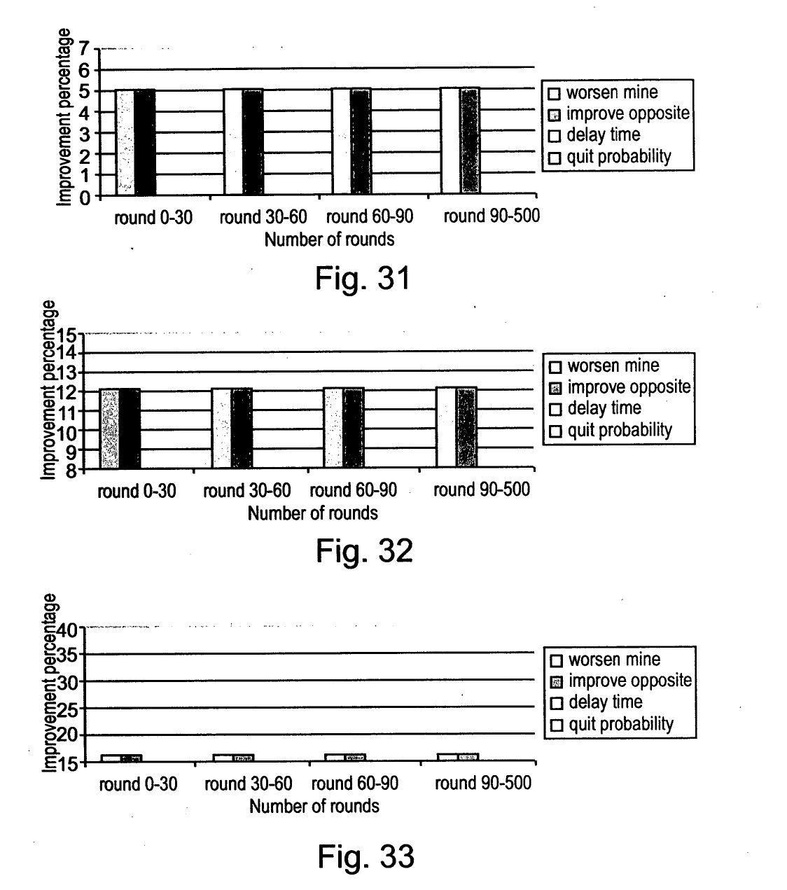

Reference is now made to FIGS. 31, 32, and 33, which are percentage tables demonstrating the indifferent profile. Observe that we do not specify any delay or quitting probabilities here. This means we produce counter offers as soon as possible and we do not impose a “termination threat”. Also observe that each of the three sub-tables is specialized to a particular improvement move of the other side. The first sub-table refers to minor improvements by the other side, the second sub-table corresponds to medium improvements and the last one is associated with major improvements.

Acceptance rules describe what quality of offers is the trader ready to accept, as a function of the round number. Note that the higher the quality the better the offer. The oval in the figure below represents a starting quality level. This level may be specified by (1) presenting an example whose quality is extracted, (2) by specifying quality relative to a standard offer such as best, average, worst (the percentage may be off or above).

Quality

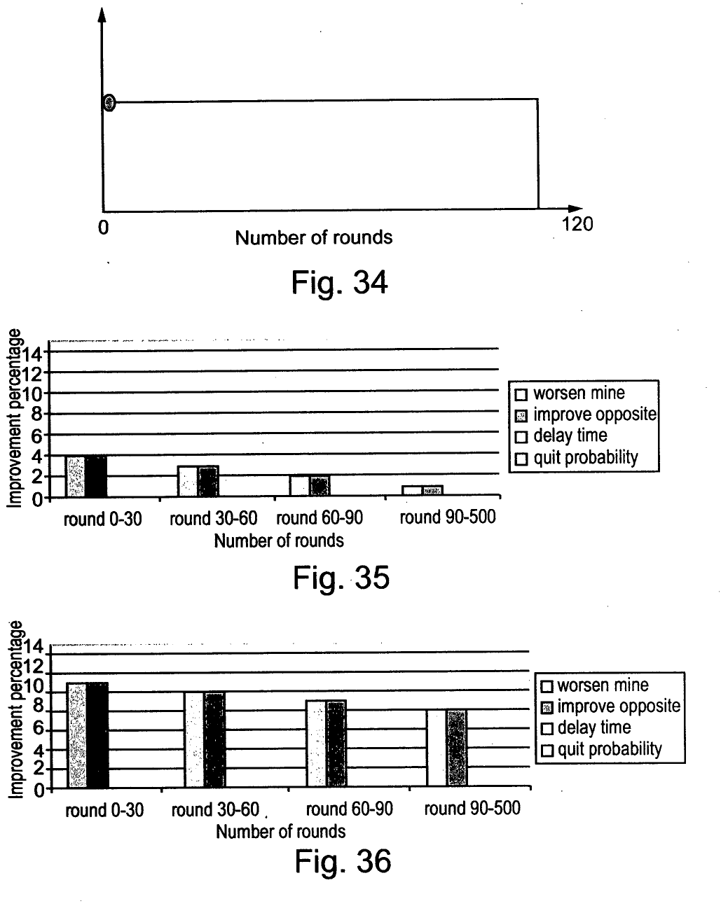

Reference is here made to FIG. 34 which is a simplified diagram showing the relationship between quality and number of rounds.

Profile Description:

1. As time goes on how would you like to react towards the other party?

a. I would like to be (LL, L, M, H, HH) positive towards the other party.

(I am under time pressure and I don't want to exert time pressure on the other party.)

b. I would like to be (LL, L, M, H, HH) negative towards the other party.

(I am not under time pressure and I want to exert time pressure on the other party.)

iii. c. My reactions are not influenced by the progression of time. (I am not under time pressure and I don't want to exert time pressure on the other party.)

2. During the rounds, would you like to:

a. Increase (LL, L, M, H, HH) the quality of acceptable offers. (Intuitively, I am not under time pressure and I want to exert time pressure on the other party.)

b. Decrease (LL, L, M, H, HH) the quality of the acceptable offers. (I am under time pressure.)

1. c. The quality of acceptable offers stays the same. (I am not under time pressure and I don't want to exert time pressure on the other party.)

3. If the other party improves his offer by X% (in a block as determined by the percentages range and the rounds range, see below).

a. You are ready to improve your previous offer by a percentage, say Y% (LL, L, EQ, H, HH) X%, and all this provided that

b. Your new offer is not worsened, i.e., degraded, by more than a percentage, say Z% (LL, L, EQ, H, HH) X%.

4. How eager are you to close a deal (LL, L, M, H, HH)?

(This influences the acceptance rule and the quitting probability.)

Discussion:

This profile describes an indifferent trader. Answers 1 and 2 mean that reactions are fairly independent of the round number. Answer 3 implies an identical type response to the other party's moves. Answers 2 and 4 imply a low quitting probability and an average acceptance rules.

Profile Name: Tough (2)

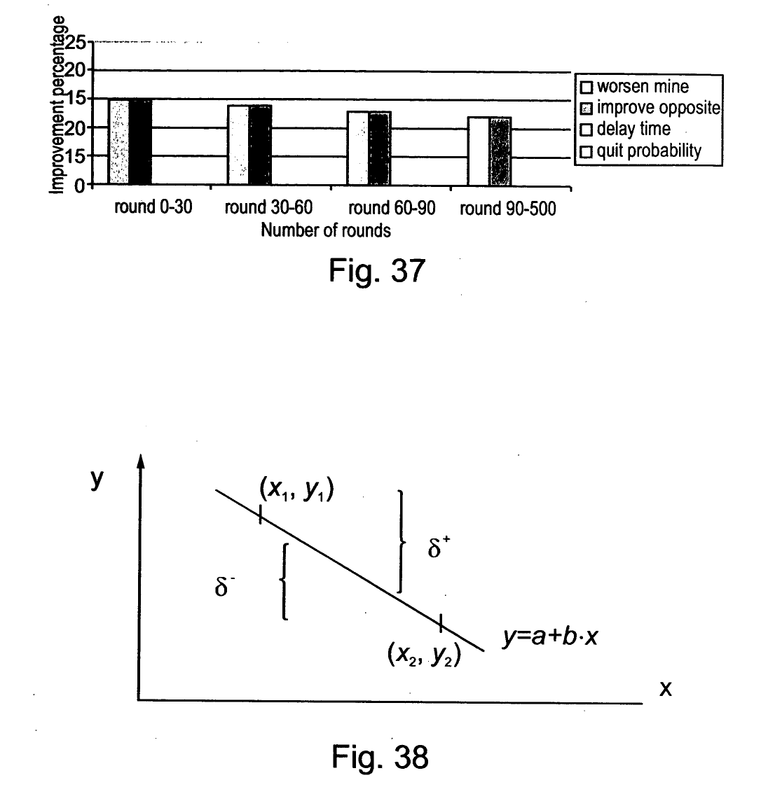

Reference is herein made to FIGS. 35, 36 and 37, which are percentage tables illustrating the tough profile. Observe that we do not specify any delay or quitting probabilities here. Also observe that each of the three sub-tables is specialized to a particular improvement move of the other side. The first sub-table refers to minor improvements by the other side, the second sub-table corresponds to medium improvements and the last one is associated with major improvements.

Acceptance rules

Quality

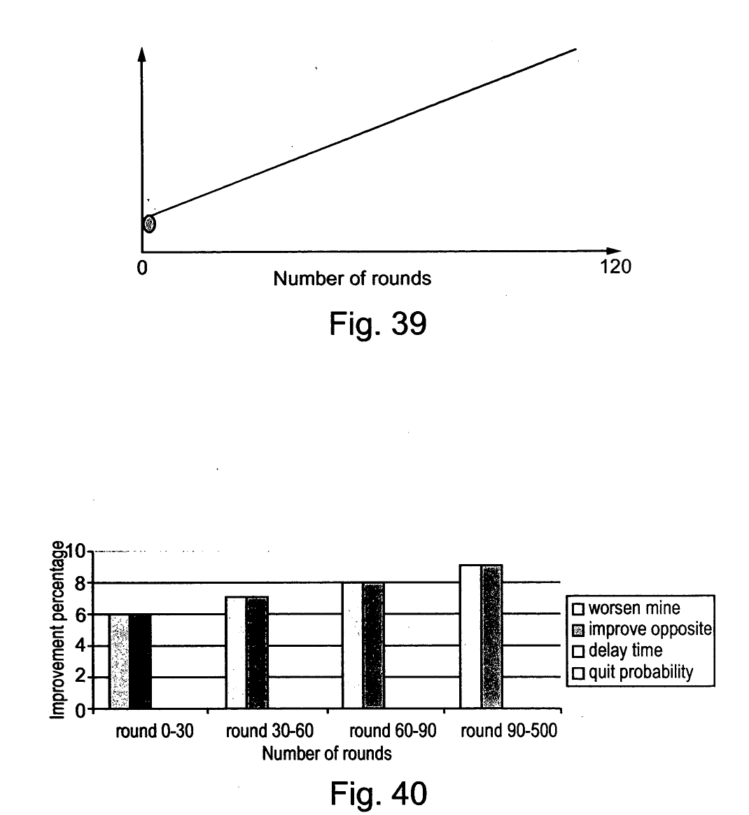

The quality function is shown in FIG. 39.

Profile description:

1. As time goes on how would you like to react towards the other party?

a. I would like to be (LL, L, M, H, HH) positive towards the other party. (I am under time pressure and I don't want to exert time pressure on the other party.)

b. I would like to be (LL, L, M, H, HH) negative towards the other party.

(I am not under time pressure and I want to exert time pressure on the other party.)

c. My reactions are not influenced by the progression of time. (I am not under time pressure and I don't want to exert time pressure on the other party.)

2. During the rounds, would you like to:

i. Increase (LL, L, M, H, HH) the quality of acceptable offers. (Intuitively, I am not under time pressure and I want to exert time pressure on the other party.)

ii. Decrease (LL, L, M, H, HH) the quality of the acceptable offers. (I am under time pressure.)

iii. The quality of acceptable offers stays the same. (I am not under time pressure and I don't want to exert time pressure on the other party.)

3. If the other party improves his offer by X% (in a block as determined by the percentages range and the rounds range, see below).

i. You are ready to improve your previous offer by a percentage, say Y% (LL, L, EQ, H, HH) X%, and all this provided that

ii. Your new offer is not worsened, i.e., degraded, by more than a percentage, say Z% (LL, L, EQ, H, HH) X%.

4. How eager are you to close a deal (LL, L, M, H, HH)?

(This influences the acceptance rule and the quitting probability.)

Discussion:

This profile describes a tough trader. Answers 1 and 2 mean that reactions depend on the number of rounds. Answer 3 implies a less equal type response to the other party's moves. Answers 2 and 4 imply high quitting probabilities.

Profile Name: Eager (3)

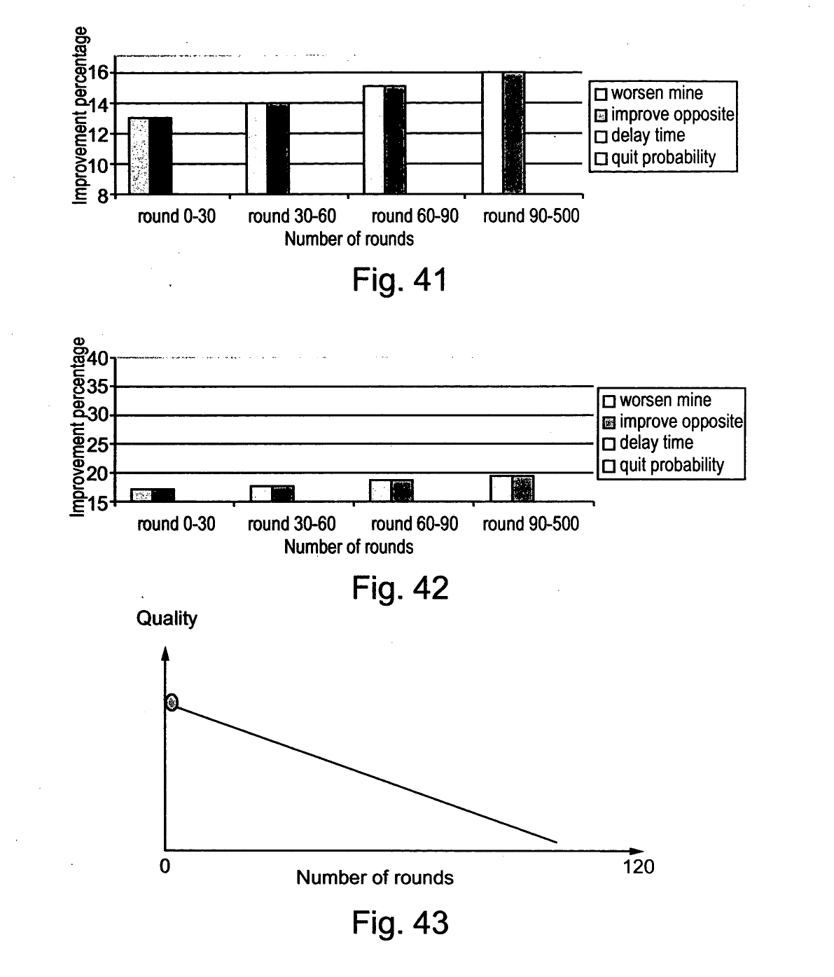

The percentage table for the eager profile is shown in FIGS. 40, 41 and 42. Observe that we do not specify any delay or quitting probabilities here. Also observe that each of the three sub-tables is specialized to a particular improvement move of the other side. The first sub-table refers to minor improvements by the other side, the second sub-table corresponds to medium improvements and the last one is associated with major improvements.

Acceptance rules

Quality

The quality profile for the eager profile is shown in FIG. 43.

Profile description:

1. As time goes on how would you like to react towards the other party?

a. I would like to be (LL, L, M, H, HH) positive towards the other party. (I am under time pressure and I don't want to exert time pressure on the other party.)

b. I would like to be (LL, L, M, H, HH) negative towards the other party. (I am not under time pressure and I want to exert time pressure on the other party.)

c. My reactions are not influenced by the progression of time. (I am not under time pressure and I don't want to exert time pressure on the other party.)

2. During the rounds, would you like to:

i. Increase (LL, L, M, H, HH) the quality of acceptable offers. (Intuitively, I am not under time pressure and I want to exert time pressure on the other party.)

ii. Decrease (LL, L, M, H, HH) the quality of the acceptable offers. (I am under time pressure.)

iii. The quality of acceptable offers stays the same. (I am not under time pressure and I don't want to exert time pressure on the other party.)

3. If the other party improves his offer by X% (in a block as determined by the percentages range and the rounds range, see below).

a. You are ready to improve your previous offer by a percentage, say Y%. (LL, L, EQ, H, HH) X%, and all this provided that

b. Your new offer is not worsened, i.e., degraded, by more than a percentage, say Z% (LL, L, EQ, H, HH) X%.

4. How eager are you to close a deal (LL, L, EQ, H, HH)?

(This influences the acceptance rule and the quitting probability.)

Discussion:

This profile describes a trader who's under significant time pressure. Answers 1 and 2 mean that reactions depend on the number of rounds. Answer 3 implies a great equal type response to the other party's moves. Answers 2 and 4 imply low quitting probabilities.

Summarizing the Basic Profiles

As we can see, different answers for the questions imply different profiles.

In this section we have identified three basic profiles with many possible variations around them. Each profile affects the profile counter offer generator table and the profile acceptance rules.

The three basic profiles identified are the indifferent, the eager and the tough.

Counter Offer Generator Table:

Indifferent—the percentages are the same for all rounds.

Eager—the percentages increase during the negotiation.

Tough—the percentages decrease during the negotiation.

Acceptance Rules:

Indifferent—the quality of the acceptable offers is the same at all rounds.

Eager—the quality of the acceptable offers decreases during the negotiation.

Tough—the quality of the acceptable offers increases during the negotiation.

According to these rules, there are three clear profiles that are described in this document and in the table below. The eager and the tough profiles can be emphasized with the (LL, L, HH, H, M) parameters for each decrease or increase in the first three questions.

| Questions | Indifferent | Tough | Eager |
|---|---|---|---|
| 1. As time goes on how would you like to react towards | C | B (L) | A (L) |
| the other party? | | | |
| a. I would like to be (L, M, H) positive towards | | | |
| the other party. | | | |
| (I am under time pressure and I don't want to | | | |
| exert time pressure on the other party.) | | | |
| b. I would like to be (L, M, H) negative towards | | | |
| the other party. | | | |
| (I am not under time pressure and I want to exert time pressure | | | |
| on the other party.) | | | |
| c. My reactions are not influenced by the | | | |
| progression of time. | | | |
| (I am not under time pressure and I don't want to exert time | | | |
| pressure on the other party.) | | | |
| 2. During the rounds, would you like to: | C | A (L) | B (L) |
| i. Increase the quality of acceptable offers. | | | |
| (Intuitively, I am not under time pressure and I want to exert | | | |
| time pressure on the other party.) | | | |
| ii. Decrease the quality of the acceptable offers. (I | | | |
| am under time pressure.) | | | |
| iii. The quality of acceptable offers stays the same. | | | |
| iv. (I am not under time pressure and I don't want | | | |
| to exert time pressure on the other party.) | | | |
| 3. If the other party improves his offer by X % (In a block | EQ | L | H |
| as determined by the percentages range and the rounds range, | | | |
| see below). | | | |
| i. You are ready to improve your previous offer | | | |
| by a percentage, say Y % (LL, L, EQ, H, HH) X %, all this | | | |
| provided that | | | |
| ii. Your new offer is not worsened, i.e., degraded, | | | |
| by more than a percentage, say Z % (LL, L, EQ, H, HH) X %. | | | |
| How eager are you to close a deal? (LL, L, HH, H, M)? | M | L | H |

Mediation, External Effects and Pre-Screening

Mediation option At any stage during the negotiations a mediation option that will go into effect only if BOTH sides agree to it. The mediation option will employ a Unification-like procedure to generate a fair proposal that takes into account the goals of sides as well as their preferences and weights. The mediation option will be facilitated through two flags installed within each cell of the profile matrix. The first flag will be denoted as: “Propose Mediation” and the second one will be denoted as “Accept Mediation”. Thus, if during the negotiations the system detects that one of the users have “activated” the Propose Mediation flag, it will check to see whether the other side have activated the flag of “Accept Mediation”. Only if both of these flags are active will the system issue a mediation offer. Notice that in such a case, the negotiations will stop and both sides are obligated to accept the mediator's offer.

One of the ways in which mediation may be implemented is for the purpose of fixing the values of some decision variables on which there is a mutual agreement of both parties to go to mediation. Each user may flag variables that might be negotiated through mediation during the GUI session. The system selects all the variables that were flagged by both sides and then calls a mediation procedure that fixes values for these variables. This could be done either before the negotiation started or at any time during the negotiations. The end-result of such “partial” mediation implementation is a reduction in the number of decision variables whose values are yet to be determined.

Dynamic shells—some negotiations may be affected by market-driven events that are taking place during the negotiations. For example, in trading for oil one may want to adjust his negotiation profile according to the changes that are observed in real-time in the spot and forward markets for oil. To handle such situations we will construct a shell of logical conditions that will choose one of the basic profiles according to the values observed in real-time. It should be noted that such dynamic frameworks should be supported by the utility layer which should have the capability of treating parameters such as S&P500 index, or USD-to-Euro conversion rate, etc.

Dynamic Tables—Here profile table entries may be arithmetically manipulated (e.g., multiplied) by external variables that may change over time (e.g., inventory level). Such variables may also reflect the progress of other negotiation session undertaken by the party.

Post unification screening Sometimes simultaneous 1-1 negotiations may not be allowed. In these cases we will want to screen intentions and rank them according to the likelihood of reaching a deal. The likelihood measure will be created from two sources: differences in the assignment of decision variables to levels in the objective function and differences in their target values. Denoting by S the set of variables that belong to intention i, Lⱼⁱ the objective level of variable j in intention i and Tⱼⁱ its target value, we define the likelihood measure between intentions i and k as:

$${\sum }_{j ∈ {S}_{j} ⋂ {S}_{k}}^{} {\vert {T}_{j}^{i} - {T}_{j}^{k} \vert}^{( \frac{1}{1 + \vert {L}_{j}^{i} - {L}_{j}^{k} \vert} )}$$

The intentions are ordered in an increasing order according to this likelihood measure, i.e. the smaller the number the higher the likelihood, as illustrated in the example below (where Intention 3 is preferred to Intention 2).

### EXAMPLE

| Variable | Intention 1 | Intention 2 | Intention 3 |
|---|---|---|---|
| X₁ | 100 (L₁) | 20 (L₁) | 80 (L₁) |
| X₂ | — | 40 (L₁) | 40 (L₁) |
| X₃ | 30 (L₁) | 120 (L₂) | 50 (L₁) |
| Likelihood measure for Intention 1 | N/A | 89.48 | 40 |

### Rank Computation

An objective function can be used as a ranking function which expresses constraints, preferences, and trade-offs on a set of attributes (decision variables). This set of attributes can be thought of as the attributes of relations in a relational database, the columns in a spreadsheet, or the attributes (i.e., class members) in an object-oriented database. The ranking function may be either minimizing or maximizing. We explain how ranking functions may be used in the context of databases. Observe that the compilation of a ranking function may be interval based (default) or target-based.

We denote a ranking function as a tuple f=<o, d, C, P, T>. Here o is the objective, C is a set of constraints, P is a set of weighted preferences, T is a set of weighted trade-offs and d is either Min or Max indicating the optimization required at level i. Without loss of generality, assume d=Min. This representation will be used later on when we introduce a sub-language for defining ranking functions. Then, f, when applied to a table or database, orders a maximal subset of the table's rows so that:

Each row satisfies the constraints in C. The extraction of satisfying rows can be done via an SQL statement. It can also be done via scanning of rows and direct application of the constraints.

The ranking function when applied to each row is less than or equal to to the application of the ranking function of the subsequent row.

So, the rows of the table are ordered in terms of their desirability, as indicated by the ranking function. In fact, we can form a sequence of ranking functions: f₁, . . . , fₙ and first order the rows according to f₁ and then, given a sequence of rows with the same f₁ value, order within these rows according to f₂, and among those agreeing on both f₁ and f₂ order according to f₃ and so on. In this case we can think of <f₁, . . . , fₙ> as a generalized (lexicographic) ranking function. The end result is that rows are ordered in their order of desirability. Of course, we define the ranking function to simply be a GP as discussed in previous sections, the motivation for piecewise definition is to ease bridging the gap to database query languages.

The technique outlined above may be applied to electronic spreadsheets, as an example of a database (set of tables). Here, columns and rows play the same role as in a relational table. Examples, shown below, display a possible interface for specifying constraints, preferences and trade-offs in Microsoft Excel.

Additional Functionality

1. Instead of a table of data, a ranking function may be applied to a file, a spreadsheet or the result of an SQL or OQL query. In case of a file, rows may be scanned, by using some access method (sequential, index based etc.).

2. We can extend SQL (versions 2 and 3, and future versions) with a rank clause as follows:

Select . . . .

From . . . .

Where . . . .

Group by . . . .

Rank by f /* f is a ranking function, either compiled separately or using a sub-language such as the one presented subsequently */

Here, the Select clause defines the columns (attributes) of a result table. The ranking function, conceptually, operates on this result table. In ranking such a SQL statement, the optimizer may take the ranking function into account when determining how to optimize the query. Observe that if rank by is used then order by cannot be used.

3. The SQL query above may be defined as a view. Additionally, it may be defined as a view to be maintained over time. In case many such views are defined concurrently, one may maintain only the first k (a parameter) rows per view. Alternatively, a different k value may be assigned to different views based on, say, historical usage. Observe that a user may define a number of similar views differing only in their ranking function.

4. The ranking function may be defined in terms of external variables, i.e., not in the database. For example, suppose each row in a table is associated with a column Company. Suppose further that each company is traded on a stock market. Then, one can write stock value(Company) and this is interpreted by an external function that checks the current stock value of the company of this row.

5. Comparison between two, or more, ranking functions, all applied to the same table. Graphically, deviations from ordering according to the first ranking function are indicated.

6. The ranking functions may be built incrementally where at each stage the new order is calculated and shown relative to the previously computed one(s).

7. Specification of default values via rules. This feature is useful especially in the case of null values. Here, rules can be applied, on a row or table basis, for the generation of such values. The generated values can replace null values or existing values, as indicated by rules.

8. Values may be specified for hypothetical columns. Here, one can add column(s) that are not present in the original table and specify values, via rules as above, for these columns.

9. Values may also be specified for rows. This is the idea of generate and test. Tuples (rows) are generated as needed. This may be in addition to actual physical tuples present at the table. Alternatively, the whole table content (i.e., its rows) may be non-physical (i.e., generated).

10. Aggregation-based-objective functions may be specified. Here, the conditions, and rules, are based on aggregations (e.g., AVG, MAX, MIN).

11. Ranking functions may be synthesized out of examples. Here, given a table, a subset of the rows is ordered according to their desirability (preferably, the top rows). The idea is to fit the parameters of ranking functions so that the synthesized functions derive the specified order of desirability. The resulting function may be then applied to test rows in order to verify the synthesis. The fitting of parameters may be done in many ways (e.g., neural networks, regression), one such way is as described below.

12. The trade-off compilation is usually penalty oriented. That is, we “punish” from being “away from the trade-off line”. Alternatively, we can use a “substitution based” trade-off (still using the same syntax). For example, we can trade m units of, say, Xᵢ for n units of, say, Xⱼ. Mathematically, we can introduce new variables, xᵢs, and use them as the resulting values for the Xᵢs variables. Observe that this provides the underlying solver with an opportunity to take actual values of the Xᵢs variables and “think” about them in terms of the new xᵢ variables. Consider how we need to alter the original goal constraints by using the new variables and adding conservation equations:

Xᵢ+D⁻ᵢ−D⁺ᵢ=Vᵢ /** Original i'th goal constraint **/

Xⱼ+D⁻ⱼ−D⁺ⱼ=Vⱼ /** Original j'th goal constraint **/

xᵢ+D⁻ᵢ−D⁺ᵢ=Vᵢ /** Use new variable and form new goal constraint **/

xⱼ+D⁻ⱼ−D⁺ⱼ=Vⱼ /** Use new variable and form new goal constraint **/

/** Add a “conservation equation”, note that it's linear **/

m(xᵢ−Xᵢ)=n(Xⱼ−xⱼ) /** What we “gained” in Xᵢ we “give” in Xⱼ **/

The translation depicted above can be applied to more than two variables by simply writing a more complex conservation equation for each trade-off statement. Observe that in case of a number of trade-off statements, each one is compiled separately. We have two options here that imply different semantics. The first is to use the same xᵢs in these separate trade-off statement compilations. The second is to use distinct new xᵢs in each such translation. Both semantics have their advantages and disadvantages. A major drawback of the second option is that there is no unique deviation variable for Xᵢ as there are many new distinct xᵢs. The question is which deviation variable to use in the original objective function. One possibility is to use an “average deviation”. However, this is not very convincing which lends more credibility to option one.

Synthesizing Ranking Functions

We consider the problem of synthsizing a ranking function from example preferences. The first issue to consider is obtaining the desired values Vᵢ for attribute Xᵢ. The simplest case is when these values are provided explicitly by the user. Next, the user may indicate that (1) desirability is high at a point (target) and decreases for both decreasing and increasing values, (2) desirability is linear, (3) a more complex pattern, for example, desirability is constant on an interval and decreases on both sides.

Case 1: We employ the following heuristics. For each attribute Xᵢ, the desired value, Vᵢ, is determined as the average value for that attribute over the first (i.e., most preferable) k (a parameter, usually 2 or 3) rows. For each attribute Xᵢ, a target equation of the form Xᵢ+D⁻ᵢ−D⁺ᵢ=Vᵢ is introduced Here, D⁻ᵢ, D⁺ᵢ are deviation variables.

Generate inequalities, representing the order of desirability of rows. Consider for example two consecutive (in terms of desirability) rows: r and s. For each deviation variable, calculate its actual deviation based on the values for columns in rows r and s. Suppose, without loss of generality that there are only two variables X₁ and X₂.

Suppose that the deviations are as follows:

Deviation for

| Row | D⁻₁ | D⁺₁ | D⁻₂ | D⁺₂ |
|---|---|---|---|---|
| r | b | 0 | 0 | c |
| s | d | 0 | e | 0 |

Observe that in both rows there is “undershooting” for variable X₁, whereas for variable X₂, there is “overshooting” for row r and “undershooting” for row s. The resulting inequality is: C₁₁b+C₁₂0+C₂₁0+C₂₂c<C₁₁d+C₁₂0+C₂₁e+C₂₂0. Similarly, generate such an inequality for each pair of consecutive rows. Further add inequalities indicating that each coefficient is bigger than or equal to zero.

We consider the set of first ranked m (a parameter) rows and generate inequalities for each pair of consecutive rows. Let S be the set of resulting inequalities. Solve S and obtain values for the coefficients Cᵢⱼ's. If some of these coefficients are not uniquely determined, choose arbitrarily within their domain of satisfaction, for example, if (1<C₂₂<5) then choose C₂₂=3. If S is inconsistent, one of the m rows is dropped and the procedure is retried. (If too many rows (a parameter) are dropped this way, the procedure fails.) Next, test the values obtained in solving S by ranking the remaining rows. If the resulting order is acceptable (as tested on other rows), a solution is achieved. Otherwise, there must be two “offenders” that are wrongly ordered. The procedure is redone with the two new “offenders” included in the group of rows used in generating inequalities. This process may either lead to an acceptable ranking function; alternatively, it may fail to produce such a function.

Introducing equations for trade-offs may enhance the procedure above by providing additional degrees of freedom. This is because the introduction of trade-offs simply manifests itself with additional components, namely trade-off deviation variables, within objective functions.

Case 2: The user indicates that the preference function is a simple linear additive function (as opposed to the more complex penalty functions described above). Given a vector of multi-attribute alternatives (“rows”), ordered by their desirability to the decision maker, we seek to determine a unique vector of weights to be associated with the attributes. We assume a linear scoring (or utility) function:

$${S}_{i} = {\sum }_{j}^{} {a}_{ij} \cdot {w}_{j}$$

Where aᵢⱼ are the data (value of attribute j in alternative i), Sᵢ is the score of alternative i and wⱼ is the weight of attribute j.

The decision maker (DM) is capable of expressing pairwise preferences among any pair of alternatives. Such comparisons would lead to k preference constraints out of a given set of m alternatives where

$$k \leq \frac{m \cdot ( m - 1 )}{2} .$$

This inequality is expected to be strong since in some cases the DM is unable (or unwilling) to express preferences between some of the possible pairs of alternatives. We denote the set of preferences as P.

To obtain the set of weights that will result in maximal discrimination power among the alternatives we implement a Max_Min modeling approach as follows:

$$Max ϵ$$

$$s . t . \\ {S}_{i} - {S}_{h} \geq ϵ ∀ \{ i , h \} ∈ P$$

$${S}_{i} = {\sum }_{j}^{} {a}_{ij} \cdot {w}_{j} ∀ i$$

$${\sum }_{j}^{} {w}_{j} = 1$$

$${w}_{j} \geq 0$$

A positive optimal value (ε*>0) indicates that we found a set of weights that clearly separates each pair of alternatives for which preference was expressed. A zero-value optimal solution indicates that the resultant weight vector leads to one or more weak preferences relations and a negative value for the optimal solution (notice that epsilon is unbounded) indicates inconsistency on the part of the DM in the way he described his pairwise preferences.

The formulation above might be refined if we attach an ever-decreasing level of importance to the preference constraints as we move down the ordered list. Then, the objective function can be reformulated as a weighted sum of differences rather than maximum of the minimal difference:

$$Max {10}^{k - 1} {ϵ}_{1} + {10}^{k - 2} {ϵ}_{2} + … + {ϵ}_{k}$$

$$s . t . {S}_{1} - {S}_{2} \geq {ϵ}_{1}$$

$${S}_{2} - {S}_{3} \geq {ϵ}_{2}$$

$$⋯$$

$${S}_{k - 1} - {S}_{k} \geq {ϵ}_{k}$$

$${S}_{i} = {\sum }_{j}^{} {a}_{ij} \cdot {w}_{j} ∀ i$$

$${\sum }_{j}^{} {w}_{j} = 1$$

$${w}_{j} \geq 0$$

Case 3: A more complex pattern. A heristics here is to assume that the top m (a parameter) rows delimit the interval in which desirability is high. This determines the compilation of preferences and the coeficients are determined as in case 1.

### A Ranking Sub-language

This sub-language can express ranking functions in a textual form. It can then be used as an extension to SQL or to other programming or database languages, e.g., OQL.

Constraints

Consider a single database table. The constraints part can be thought of as a filter applied to a table of data. For example (X=7) AND (Y>6) where X and Y are table columns. The constraints we consider include integer/linear inequalities, simple inequalities, membership in a set and more. In fact, the precise constraint language is dependent upon the constraint solver component we utilize. There are many possibilities for such solvers, e.g., ILOG's CPLEX or ILOG's CSP solver.

Preferences

Preferences indicate where, within the constraints, are values more preferable. For example, Prefer(X=8) indicates that the preferred value for X is 8, and Prefer(Y, 7,9) indicates that the interval [7,9] is the preferred one for values of Y. Preferences may be associated with weights. For example, 0.7:Prefer(Y,7,9) indicates that the interval [7,9] is preferred with importance factor 0.7. In general, an importance factor can be any non-negative number.

Deviations

A deviation is expressed within the context of a preference. A deviation is oriented as either ⁺ or ⁻. For example dev(Prefer(X=8))⁺ indicates a deviation in the positive direction from X=8, that is, a value of X larger than 8. Deviations may be associated with weights. For example, 0.7:Prefer(X=8)⁺ indicates that a deviation from the value X=8 in the positive direction has importance 0.7. Deviations may also be associated with intervals as in 0.7:Prefer(X,7,9)⁺. A preference with no indicated deviation is assumed to have default weights associated with positive and negative deviations. One possibility is associating a weight of 0.5 with both positive and negative deviations although other default settings are possible.

Trade-Offs

A simple trade-off is of the form trade-off([a,b],X,[c,d],Y,(x,y), mX for nY). It means that when X is in the interval [a,b] and Y is in the interval [c,d], m units of X are tradable for n units of Y. Further, the point (X=x, Y=y) with x in the interval [a, b] and y in the interval [c,d], fixes the trade-off line. Here too, trade-offs may be weighted, for example, 0.5:trade-off([1,10],X,[100,120],Y,(110,2),3X for 2Y) indicates, with an importance factor of 0.5, that in the appropriate intervals and point, 3 units of X are tradable for 2 units of Y. More general trade-off statements involving more than two attributes are possible. For example, 0.5:trade-off([1,10],X, [100,120],Y,[50,400],Z,(2,101,58), X for 2Y+3Z) indicates that in the appropriate ranges and point, a unit of X is tradable for 2 units of Y plus 3 units of Z.

The penalty for deviating from the trade-off may depend on whether the deviation from the trade-off is “above” or “below”. If nothing is indicated than “below” and “above” deviations are treated equally. Consider a trade-off, where X is Dollars and Y is days, of the form: 0.5: trade-off([1,1000],X,[100,120],Y,(100,102),−100X for 1Y) indicating readiness to pay $100 less per each extra day. Now, an actual (Dollar amount. Delivery day) pair chosen maybe “above”, i.e., less than $100 was discounted for an extra day, or “below”, i.e., more than $100 was discounted for an extra day. To differentiate between these cases, we again use the ⁺ (for above) and ⁻ (for below) superscripts. So, we may write:

0.8: Trade-off([1,1000],X,[100,120],Y,(100,102),−100X for 1Y)⁺ and

0.1: trade-off([1,1000],X, [100, 120], Y, (100, 102),−100X for 1Y)⁻, indicating that not discounting enough is less desirable (higher weight) than a severe discount (alternatively, we could refrain for penalizing for a deeper discount at all).

Objective Functions

Each objective function can be specified using a general programming statement. In this presentation we only present single level objective functions.

### RANKING FUNCTION EXAMPLE

First, let us consider a simple example. The example describes the implementation of a ranking function on a single table that substantially simplifies the exposition. The simple example will be followed by a more general description.

Imagine the given Flights table and C containing the following constraint:

Flights.Stops < 2
(A nonstop or one stop flight.)
And the following set of Preferences P, Deviations and Trade-offs T:
4.0: Prefer(Flights.Stops = 0)⁺ (I don't want intermediate stops.)
2.7: Prefer(Flights.Price = 1000)⁺ (I don't want to pay much more.)
0.3: Prefer(Flights.Price = 1000)⁻ (Too cheap means low quality.)

1.5: Trade-off([0, 2,000$ Flights. Price, [0,3], Flights.Stops,(1000,0), −100 Price for 1 Stops)+

(For each additional stop, within the interval, I expect a $100 discount on the price.)

First let us consider the Flights table records satisfying the constraint.

| Record # | Carrier | Origin | Destination | Stops | Class | Price | Departure | Arrival |
|---|---|---|---|---|---|---|---|---|
| 1 | AF | TLV | LHT | 1 | Economy | $675 | 09:00 AM | 12:25 PM |
| 2 | AF | TLV | LHT | 1 | Business | $1,200 | 09:00 AM | 12:25 PM |
| 3 | BA | TLV | LHT | 0 | Economy | $725 | 08:00 AM | 11:00 AM |
| 4 | BA | TLV | LHT | 0 | Business | $1,200 | 08:00 AM | 11:00 AM |
| 5 | Lufthansa | TLV | LHT | 1 | Economy | $550 | 06:00 AM | 01:00 PM |
| 6 | Lufthansa | TLV | LHT | 1 | Business | $875 | 06:00 AM | 01:00 PM |
| 7 | LY | TLV | LHT | 0 | Economy | $530 | 07:00 AM | 10:15 AM |
| 8 | LY | TLV | LHT | 0 | Business | $900 | 07:00 AM | 10:15 AM |
| 9 | Swiss Air | TLV | LHT | 1 | Economy | $700 | 08:10 AM | 01:30 PM |
| 10 | Swiss Air | TLV | LHT | 1 | Business | $1,165 | 08:10 AM | 01:30 PM |

Next, we rank the above resulting table based on the set of Preferences, Deviations and Trade-offs we specified, resulting in the following Ranked table. Notice that the order of records in the ranked table is different when compared with The original one. For example, records that represent a nonstop flight with the closest price distance below $1,000 are ranked highest, thus appear at the top.

| Record # | Carrier | Origin | destination | Stops | Class | Price | Depart. | Arrival |
|---|---|---|---|---|---|---|---|---|
| 8 | LY | TLV | LHT | 0 | Business | $900.00 | 07:00 AM | 10:15 AM |
| 3 | BA | TLV | LHT | 0 | Economy | $725.00 | 08:00 AM | 11:00 AM |
| 7 | LY | TLV | LHT | 0 | Economy | $530.00 | 07:00 AM | 10:15 AM |
| 4 | BA | TLV | LHT | 0 | Business | $1,200.00 | 08:00 AM | 11:00 AM |
| 6 | Lufthansa | TLV | LHT | 1 | Business | $875.00 | 06:00 AM | 01:00 PM |
| 9 | Swiss Air | TLV | LHT | 1 | Economy | $700.00 | 08:10 AM | 01:30 PM |
| 1 | AF | TLV | LHT | 1 | Economy | $675.00 | 09:00 AM | 12:25 PM |
| 5 | Lufthansa | TLV | LHT | 1 | Economy | $550.00 | 06:00 AM | 01:00 PM |
| 10 | Swiss Air | TLV | LHT | 1 | Business | $1,165.00 | 08:10 AM | 01:30 PM |
| 2 | AF | TLV | LHT | 1 | Business | $1,200.00 | 09:00 AM | 12:25 PM |

The ranking was based on the Ranking function (f=<Min, C, P, T>). In this case the objective is:

| Min (Z_{Stops Preference}+ Z_{Price Preference}+ Z_{Price-Stops Trade-off)} | |
|---|---|
| The objective function formula for Z_{Stops Preference} is: | |
| If Flights.Stop>0 | Then Z_{Stops Preference= 4*Flights.Stops} |
| | Else Z_{Stops Preference= 0} |

The objective function formula for Z_{Price Preference} is:
If Flights.Price>=1000
Then Z_{Price Preference= 2.7*(Flights.Price-1000)/1000}
Else Z_{Price Preference= 0.3*(1000-Flights.Price)/1000}

And the relevant portion of the objective function formula for Z_{Price-Stops Trade-off} is:

| If Flights.Stop= | Then |
|---|---|
| If Flights.Price>=1000 | |
| Then Z_{Price-Stop Trade-off= 1.5*(Flights.Price-1000)/1000} | |
| Else Z_{Price-Stop Trade-off= 0} | |
| Else If Flights.Stop=1 | Then |

If Flights.Price>=900
Then Z_{Price-Stop Trade-off= 1.5*(Flights.Price-900)/900}
Else Z_{Price-Stop Trade-off= 0}

The formulas above are slightly different than the compilation described previously. Here, the deviations are measured by normalizing the absolute deviation distance relatively to the expected point on the trade-off line (hence the division once into 1000 and once into 900). The table below depicts this computation:

| | | Stops | Price | Z |
|---|---|---|---|---|
| Record # | Price-Stops Trade-off | Preference | Preference | (Sum of z) |
| 8 | 0 | 0 | 0.03000 | 0.03000 |
| 3 | 0 | 0 | 0.08250 | 0.08250 |
| 7 | 0 | 0 | 0.14100 | 0.14100 |
| 4 | 0.30000 | 0 | 0.54000 | 0.84000 |
| 6 | 0 | 4 | 0.03750 | 4.03750 |
| 9 | 0 | 4 | 0.09000 | 4.09000 |
| 1 | 0 | 4 | 0.09750 | 4.09750 |
| 5 | 0 | 4 | 0.13500 | 4.13500 |
| 10 | 0.44167 | 4 | 0.44550 | 4.88717 |
| 2 | 0.50000 | 4 | 0.54000 | 5.04000 |

A more complex example may consider two or more tables with a more complex set of constraints, preferences, deviations and trade-offs. In this case, the method of calculating the resulting table, will start with enforcing the constraints, creating a join table consisting of the constraints-satisfying data and ranking the resulting join table based on the set of preferences, deviations and trade-offs.

### DEPLOYMENT EXAMPLE, EXCEL

Below, we provide a deployment example within the Microsoft Excel environment. The example describes a possible Excel environment GUI for the definition of constraints, both continuous and discrete, preferences, deviations and trade-offs.

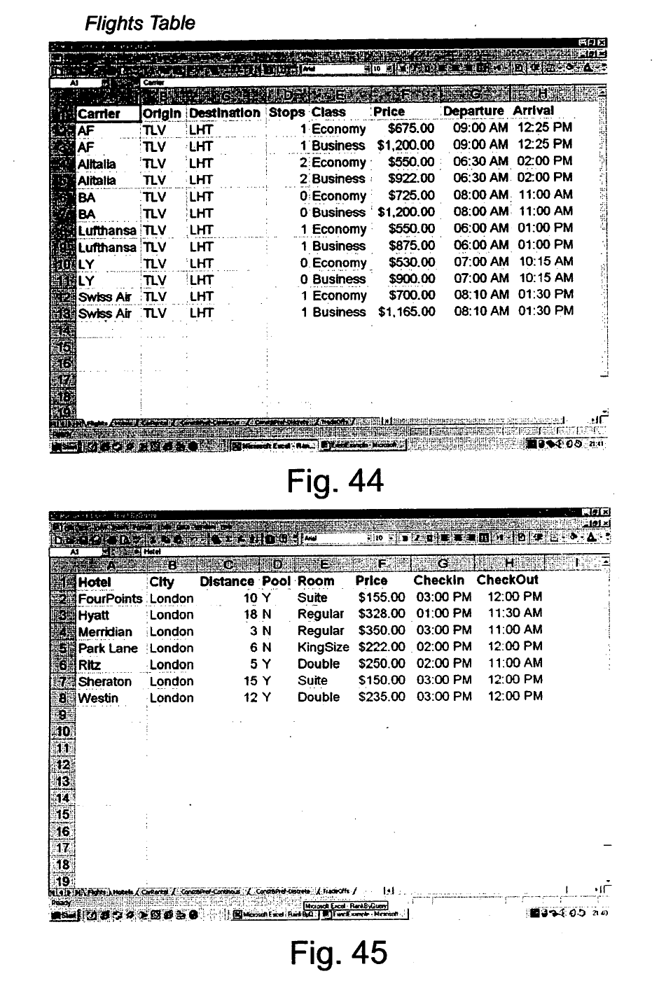

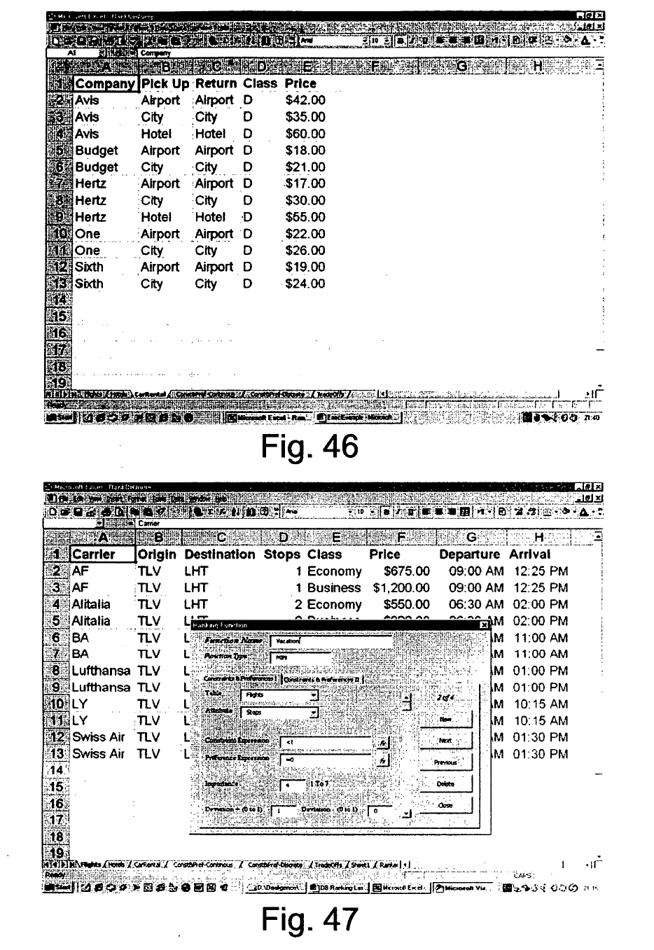

A typical flights table is shown in FIG. 44. A typical hotels table is shown in FIG. 45. A typical car rentals table is shown in FIG. 46.

Constraints, Preference and Deviations (Continuous Attribute)

Reference is now made to FIG. 47, which is a simplified diagram showing a constraints and preferences form in front of the flights table, and illustrating how it can be used to select preferred flights. In the form, we have the following components:

| | |
|---|---|
| Ranking function (f=<d, C, P, T>): | Vacation (d=Min) |
| The table of interest in this case: | Flights |
| Constraint expression: | Flights.Stops<1 |
| | (A nonstop flight.) |
| Preferences expression: | 4:Prefer(Flights.Stops=0)⁺ |
| | 0:Prefer(Flights.Stops =0)⁻ |

Note that in section 1 we had a single Importance factor, in this form it is broken into an overall Importance (in this case 4) and the separate specification of both Positive and Negative Deviations factors. In this case the importance of deviation for each stop in the positive direction, above zero, is 1 while the importance of deviation of each stop in the negative direction, below zero, is 0 (since the number of stops cannot be less than 0). Thus, in this case, the overall importance for Deviation ⁺ is 1*4=4).

The result for the Flights. Stops<1 constraint includes the following records:

| | Ori- | | | | | | |
|---|---|---|---|---|---|---|---|
| Carrier | gin | Dest. | Stops | Class | Price | Departure | Arrival |
| BA | TLV | LHT | 0 | Eco- | $725.00 | 08:00 AM | 11:00 AM |
| | | | | nomy | | | |
| BA | TLV | LHT | 0 | Busi- | $1,200.00 | 08:00 AM | 11:00 AM |
| | | | | ness | | | |
| LY | TLV | LHT | 0 | Eco- | $530.00 | 07:00 AM | 10:15 AM |
| | | | | nomy | | | |
| LY | TLV | LHT | 0 | Busi- | $900.00 | 07:00 AM | 10:15 AM |
| | | | | ness | | | |

Since all the records satisfying the constraint are with Flights.Stops=0, they all get the same ranking.

Constraints, Preference and Deviations, (Discrete Attribute)

Reference is now made to FIG. 48, in which a form is shown for selecting a car hire offer in accordance with user defined preferences. In the form, we have the following additional components:

| | |
|---|---|
| Ranking function f=<d, C, P, T>): | Vacation (d=Min) |
| The table of interest in this case: | CarRental |
| Constraint expression: | CarRental.Pickup=(‘Airport’, Train |
| | Station’, ‘Hotel’) |
| Preferences expression: | 1.5:Prefer(CarRental.Pickup=‘Hotel’) |
| Preferences expression: | 2.4:Prefer(CarRental.Pickup= |
| | Train Station’) |

Again, the single Importance factor is broken into an overall Importance (in this case 3.0) and the separate specification of a fraction associated with each item. The larger the fraction, the unhappier you are with that option. This fraction is then multiplied by Importance to generate an overall Importance.

The result for the CarRental.PickUp=(‘Airport’ or ‘Hotel’ or ‘Train Station’) constraint includes the following records:

| Company | Pick Up | Return | Class | Price |
|---|---|---|---|---|
| Avis | Airport | Airport | D | $42.00 |
| Avis | Hotel | Hotel | D | $60.00 |
| Budget | Airport | Airport | D | $18.00 |
| Hertz | Airport | Airport | D | $17.00 |
| Hertz | Hotel | Hotel | D | $55.00 |
| One | Airport | Airport | D | $22.00 |
| Sixth | Airport | Airport | D | $19.00 |

Since the CarRental.PickUp=‘Airport’ is preferred over the CarRental.PickUp=‘Hotel’ we get the following ranking:

| Company | Pick Up | Return | Class | Price |
|---|---|---|---|---|
| Avis | Airport | Airport | D | $42.00 |
| Budget | Airport | Airport | D | $18.00 |
| Hertz | Airport | Airport | D | $17.00 |
| One | Airport | Airport | D | $22.00 |
| Sixth | Airport | Airport | D | $19.00 |
| Avis | Hotel | Hotel | D | $60.00 |
| Hertz | Hotel | Hotel | D | $55.00 |

Trade-Offs

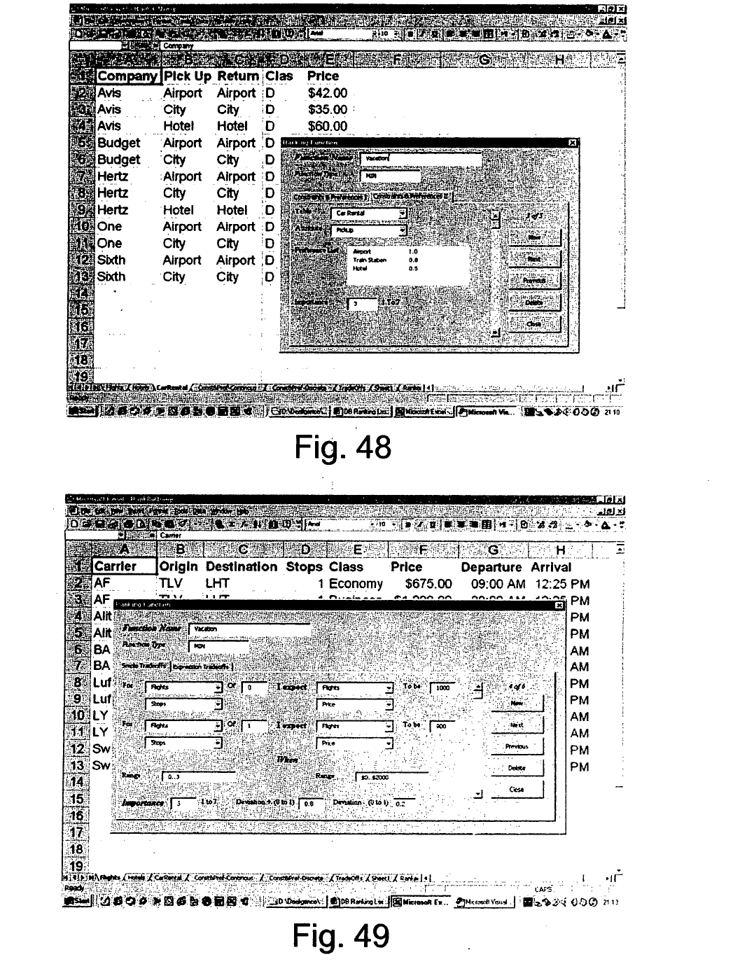

Reference is now made to FIG. 49, which is a simplified diagram showing a form for setting preferences for ranking flights according to preference.

In the form of FIG. 49, we have the following components:

| | |
|---|---|
| Ranking function (f=<d, C, P, T>): | Vacation (d=Min) |
| The table of interest in this case: | Flights |
| The attributes of interest in this case: | Stops, Price |
| Trade-off expression for Deviation +: | 2.4:Trade-off([0, 2,000], |
| | Flights.Price, [0,3], |
| | Flights.Stops,(1000,0), |
| | −100 Price for 1 Stops)⁺ |
| Trade-off expression for Deviation -: | 0.6:Trade-off([0, 2,000], |
| | Flights.Price, [0,3], |
| | Flights.Stops,(1000,0), |
| | −100 Price for 1 Stops)⁻ |

The expression indicates that the importance factor for positive deviation is 2.4 (3*0.8) while the importance factor for the negative deviation is 0.6 (3*0.2), in the appropriate intervals; each additional stop discounts $100 of the flight price.

Again, the single Importance factor is broken into an overall Importance (in this case 3.0) and the separate specification of the Positive and Negative Deviations factors.

### Algorithms for Deal Splitting With Published Prices

1. Problem Statement

We consider the following optimization problem. We are given a set of in suppliers. Initially, we assume that each supplier, Sᵢ, can sell items of a single type; the cost of a unit of the item depends on the number of units ordered from Sᵢ. Suppose that Sᵢ can sell items with mᵢ different costs per unit. These costs are given in the price table of Sᵢ, in which the l-th entry gives the cost of a unit of the item in range l, 1≦l≦mᵢ. The l-th entry in the table contains an interval [r_{i,l}, u_{i,l}] and the cost per unit, denoted by c_{i,l}. This cost will be used when the number of units supplied by Sᵢ is r_{i,l}≦x≦u_{i,l.} The maximal number of items which Sᵢ can supply is given by Tᵢ, 1≦i≦m. Suppose that we need to supply n units of the item to some client. The deal splitting (DS) problem is to determine how many units will be supplied by Sᵢ, 1≦i≦m, such that the overall cost of the deal is minimized, and the total number of supplied items is at least n.

Formally, let n be the size of the order and let costᵢ(xᵢ) be the total cost of xᵢ units of the item when supplied by Sᵢ; then, we need to find a set of integers xₗ, . . . , xₘ such that

$${\sum }_{i = 1}^{m} {x}_{i} \geq n and {\sum }_{i = 1}^{m} {cost}_{i} ( {x}_{i} )$$

is minimized, where costᵢ(xᵢ) is the cost of buying xᵢ units from Sᵢ.

We use in our study two common properties of price tables.

Definition 1.1 (Monotonicity): The price table of Sᵢ is monotone if for any 1≦l≦mᵢ−1

c_{i,l.+1}≦c_{i,l}

The monotonicity condition captures the tendency of the market to favor larger orders: thus, the cost per unit cannot increase if we buy more units of the item.

Definition 1.2 (Rationality): The price table of Sᵢ is rational if for any n₁, n₂≧1,

n₁<n₂ [symbol] cost₁(n₁)≦costᵢ(n₂).

In words, the rationality condition implies that if we need n₁ units of the item, it never pays to buy n₂>n₁ units from Sᵢ. A common example of a rational table is the “Buy one, get one free” rule, in which we pay the same total price for one or two units of the item. Note that when buying two units we get that the price per unit is half the original price; however, since our measure is the total cost of the deal, if the order size is n=1, we would buy a single unit.

Remark: Note that when we cannot buy s units of the items from the supplier Sᵢ, for some 1≦s≦Tᵢ, we define costᵢ(s)=∞. Therefore, if the price table of Sᵢ is monotone and rational, then we implicitly assume that it is also continuous in the range [1,Tᵢ]. We can buy from Sᵢ any number of units in this range.

2. Hardness Result

The DS problem is NP-complete. This holds also in the special case where the price tables satisfy the monotonicity and rationality conditions, as given in Definitions 1.1 and 1.2.

The following is a sketch of the reduction from PARTITION [GJ-79] used in the proof of hardness:

Input: A set of elements, A, where the element aᵢ has the size s(aᵢ), and

$${\sum }_{i ∈ A}^{} S ( {a}_{i} ) = B$$

Question: Is there a subset of the elements A′ [symbol] A, such that

$${\sum }_{i ∈ {A}^{′}}^{} S ( {a}_{i} ) = B / 2 ?$$

For the above instance of PARTITION we define an instance for DS. We need to supply at least n=B/2 units from the item. There are |A| suppliers: Sᵢ can supply at most s(aᵢ) units from the item; if Sᵢ sells less than s(aᵢ) units, the cost per unit is 1+1/(s(aᵢ)−1), otherwise the cost per unit is 1.

Claim: There is a partition iff there is a deal with the total cost B/2.

3. Optimal Algorithms for Restricted Deal Splitting

3.1 A Single Item

In the restricted deal splitting (RDS) problem we need to solve the DS problem, with the additional constraint that the number of suppliers participating in the deal is at most 1≦k≦m, where k is a fixed constant. The following is a polynomial time algorithm that solves optimally the RDS problem.

We define for each supplier, Sᵢ, a set of mᵢ sub-suppliers: the cost per unit of sub-supplier S_{i,l} corresponds to the l-th entry in the price table of Sᵢ.

Algorithm IP proceeds in two stages:

1. Guess a subset Sₚ of at most k sub-suppliers that will participate in the deal.

2. Find an optimal deal for the subset Sₚ.

We now describe in further detail stage 2. For convenience we represent our problem as an integer program (IP). Let r_{i,l} be the minimal number of units of the item that can be supplied by S_{i,l}; u_{i,l} is the maximal number of units that S_{i,l} is allowed to sell. Denote by Tᵢ the maximal number of units of the item that can be supplied by S_{i;}; then, w.l.o.g. we assume that Tᵢ=u_{i,m}_{ᵢ}.

The cost of a unit of the item when supplied by S_{i,l} is denoted by c_{i,l}. We assume in our discussion of the single item case, that the price tables are monotone. This implies that in any optimal solution, each supplier would be represented by at most one sub-supplier. Finally, the number of units sold by S_{i,l} is denoted by x_{i,l}, where x_{i,l}≧0 is an integer.

In stage 2. we need to solve the following IP:

$$\begin{matrix}Minimize {\sum }_{i = 1}^{m} {\sum }_{l = 1}^{m i} {c}_{i , l} {x}_{i , l} \\ Subject to {\sum }_{i = 1}^{m} {\sum }_{l = 1}^{m i} {x}_{i , l} \geq n\end{matrix}$$

$$\begin{matrix}{x}_{i , l} \geq {r}_{i , l} & {S}_{i , l} ∈ {S}_{p} \\ {x}_{i , l} \leq {u}_{i , l} & {S}_{i , l} ∈ {S}_{p} \\ {x}_{i , l} = 0 & {S}_{i , l} ∉ {S}_{p}\end{matrix}$$

The above program is solved optimally by the following greedy procedure:

(i) For any sub-supplier S_{i,l}εSₚ, assign to S_{i,l} r_{i,l} units; update u_{i,l}=u_{i,l}˜r_{i,l}. If the number of assigned units is at least n, stop.

(ii) Sort the sub-suppliers in Sₚ in non-decreasing order, by cost per unit.

(iii) Starting from the first sub-supplier in the list, assign to each sub-supplier the maximal possible number of units, until the overall number of units is at least n.

It can be shown (by an interchange argument) that the above procedure yields a deal whose cost is minimal.

The complexity of the algorithm IP is determined by the number of guesses plus sorting the sub-suppliers (which can be done once, as a preprocessing step).

Since the price tables are monotone, we can get a sorted list of all the sub-suppliers by merging m sorted lists, where the i-th sorted list represents the mᵢ sub-suppliers of Sᵢ. This can be done in O

$$O ( log m \cdot {\sum }_{i = 1}^{m} {m}_{i} )$$

steps. Let mᵢ=maxᵢmᵢ be the maximal number of sub-suppliers of any supplier. Then the overall running time of the algorithm is

$$O ( log m \cdot {\sum }_{i = 1}^{m} {m}_{i} + {\sum }_{i = 1}^{m} {( m \cdot {m}_{s} )}^{i} ) = O ( log m \cdot {\sum }_{i = 1}^{m} {m}_{i} + {\sum }_{i = 1}^{m} {( m \cdot {m}_{s} )}^{k + l} ) .$$

3.2 Multiple Items

When the deal consists of R item types, for some R≧1, we define a sub-supplier for each possible combination of the items, with a corresponding range (i.e., number of units from each item), such that the cost of a unit of each item is fixed.

We assume that each supplier, Sᵢ, 1≦i≦n, can provide at most T_{i,j} units from item j, 1≦j≦R.

In this generalized version of the problem we define monotonicity and rationality as follows.

Definition 3.1 (Monotonicity-M): The multi-item price table of Sᵢ is monotone if, for all 1≦j≦R, the price per unit cannot increase if we increase the number of units of item j bought from Sᵢ. Formally, for any 1≦l₁,l₂≦mᵢ, if we buy n₁, n₂ units of item j from sub-suppliers l₁, l₂ respectively, then

n₁<n₂ [symbol] c_{i,l}_{₁}ⱼ≧c_{i,l}_{₂}ⱼ

for all 1≦j≦R, where c_{i,l,j} denotes the cost of buying a unit of item j from the l-th sub-supplier of supplier i.

For defining the rationality condition we denote by the R-tuple (a₁, . . . , a_{R}) a combination of the R items supplied by Sᵢ, that is, aⱼ units are supplied from item j. Denote by costᵢ (a₁, . . . , a_{R}) the total cost of the R-tuple (a₁, . . . , a_{R}) when supplied by Sᵢ: costᵢ (·) applies to one of the ranges of Sᵢ.

Definition 3.2 (Rationality-M): The multi-item price table of Sᵢ is rational if for any pair of R-tuples (a₁, . . . , a_{R}), (b₁, . . . , b_{R}), if (a₁, . . . , a_{R})<(b₁, . . . , b_{R}) (coordinate-wise), then

costᵢ(a₁, . . . , a_{R})≦costᵢ(b₁, . . . , b_{R}).

Note that, in general, we do not require any of the above properties (i.e., monotonicity or rationality) to hold.

### Example 3.2

Suppose that R=3 and the items are printers (item no. 1), cartridges (item no. 2) and paper boxes (item no. 3). The following is the price table of the supplier S₁.

TABLE 3.2
A price table for multiple (3) items.

| | printers | cartridges | paper |
|---|---|---|---|
| range | [0,2] | [0,5] | [0,9] |
| unit cost | 300 | 30 | 15 |
| range | [2,5] | [7,9] | [10,100] |
| unit cost | 280 | 25 | 10 |
| range | [6,20] | [10,50] | [10,100] |
| unit cost | 250 | 23 | 10 |

Note that we do not require continuity in the number of units that we can buy from an item, when moving from one sub-supplier to another. Thus, for example, in Table 3.2, the sub-supplier S_{1,1} can supply upto 5 units of item 2, while S_{1,2} supplies at least 7 unit. (Therefore we cannot buy 6 units from S₁).

For the IP formulation we define for S₁ three sub-suppliers: S_{1,1,} S_{1,2} and S_{1,3}. For S_{1,1} each line below presents the cost per unit and minimal/maximal number of units sold from each item (e.g., the first line refers to item 1, i.e., printers).

c_{1,1,1}=300; r_{1,1,1}=0; u_{1,1,1}=2;

c_{1,1,2}=30; r_{1,1,2}=0; u_{1,1,2}=5;

c_{1,1,3}=15; r_{1,1,3}=0; u_{1,1,3}=9;

Similarly, we define prices and ranges for S_{1,2} and S_{1,3}. Suppose that S₁ can provide overall 40 printers, 100 cartridges and 300 paper boxes; then,

T_{1,1}=40; T_{1,2}=100; T_{1,3}=300;

We proceed to describe our problem as an integer program.

Let Sₚ denote the subset of sub-suppliers that participate in the deal. As before, the total number of sub-suppliers of Sᵢ is denoted by mᵢ.

Denote by nⱼ the number of units required from item j, 1≦j≦R.

Let x_{i,l,j} be the number of units that S_{i,l} provides from item j, 1≦j≦R.

Note that a few sub-suppliers of the same supplier may participate in the deal.

In the next example we give an input for which the optimal solution has this characteristic. First, we introduce the concept of a package that is often used in the multiple-item market.

Definition 3.3: A package is an R-tuples (a₁, . . . , a_{R}), in which aⱼ is the number of units supplied from item j. Let cⱼ denote the cost per unit of item j in the package; then, the price of the package is

$${\sum }_{j = 1}^{R} {c}_{j} {a}_{j} .$$

### Example 3.3

As in Example 3.2, suppose that the items are printers (item no. 1), cartridges (item no. 2) and paper boxes (item no. 3). There are two suppliers,

S₁ and S₂.

S₁ supplies the packages

(3,5,5) at the total cost of 395;

(2,3,4) at the total cost of 350.

(Thus, S₁ is represented by two sub-suppliers).

S₂ supplies the package (5,10,10) at the total cost of 750.

Assume that T_{1,1}=T_{2,1}=7, T_{1,2}=T_{2,2}=10 and T_{1,3}=T_{2,3}=10.

Suppose that we need to order 5 printers, 8 cartridges and 8 paper boxes.

An optimal deal would be to buy two packages from S₁: one package of (3,5,5) and one package of (2,3,4).

As before, we denote by Sₚ the set of sub-suppliers that participate in the deal.

The following is the IP formulation of the RDS problem with multiple items:

$$Minimize {\sum }_{i = 1}^{m} {\sum }_{l = 1}^{m i} {\sum }_{j = 1}^{R} {c}_{i , l , j} {x}_{i , l , j}$$

$$Subject to {\sum }_{i = 1}^{m} {\sum }_{l = 1}^{m i} {x}_{i , l , j} \geq {n}_{j} ∀ 1 \leq j \leq R$$

$${x}_{i , l , j} \geq {n}_{i , l , j} {S}_{i , l} ∈ {S}_{p} ∀ 1 \leq j \leq R$$

$${x}_{i , l , j} \leq {u}_{i , l , j} {S}_{i , l} ∈ {S}_{p} ∀ 1 \leq j \leq R$$

$${x}_{i , l , j} = 0 {S}_{i , l} ∉ {S}_{p} ∀ 1 \leq j \leq R$$

$${\sum }_{l = 1}^{{m }_{i}} {x}_{i , l , j} \leq {T}_{i , j} ∀ 1 \leq j \leq R , ∀ 1 \leq i \leq m$$

As in the single item case, we can solve this program optimally, by assigning first r_{i,l,j} units of item j to the sub-supplier S_{i,l}εSₚ and updating u_{i,l,j}=u_{i,l,j}−r_{i,l,j}^{, T}_{i,j}=T_{i,l,j}−r_{i,l,j}. Then we can assign to each sub-supplier the maximal possible number of units from each item type, by using R lists, each sorted in non-decreasing order, by costs-per-unit. This procedure yields an optimal solution to the above IP.

Unless specified otherwise, in the following sections we do not assume either monotonicity or rationality on the price tables. In the next sections we refer to the general DS problem, in which the number of sub-suppliers participating in the deal may be arbitrarily large.

4. Greedy Approximation Algorithms

4.1 Single Item

4.1.1 The Residual Greedy Algorithm

We consider first a natural greedy algorithm, that attempts to satisfy in each stage a maximal fraction of the order at minimal cost. Formally, the Residual Greedy (RG) algorithm proceeds as follows. Let need denote the number of units that still need to be supplied, to satisfy the order. Initially, we set need=n. Now, RG keeps a list of sub-suppliers. In step s, s≧1,

1. Find the sub-supplier S_{i,l} of some supplier 1≦i≦m, satisfying

r_{i,l}≦need, (1)

such that c_{i,l} is minimal.

2. Let x_{i,l}=min (u_{i,l} need): buy from S_{i,l} x_{i,l} units of the item.

3. Update the maximal number of units that can be provided by Sᵢ, that is,

Tᵢ=Tᵢ−x_{i,l}; update the set of sub-suppliers of Sᵢ, omitting sub-suppliers S_{i,l} for which r_{i,l}>Tᵢ.

4. need=need−x_{i,l}; if need>0 goto 1.

### Example 4.1

Suppose that we have 4 suppliers, with the price tables given in Table 4.1. We need to supply at least 30 units of the item. Also, assume that

T₁=50; T₂=40; T₃=5; and T₄=6.

TABLE 4.1
A price table for Example 4.1 (the RG algorithm)

| | S₁ | S₂ | S₃ | S₄ |
|---|---|---|---|---|
| range | [1,5] | [1,4] | [1,2] | [1,2] |
| unit cost | 34 | 32 | 31 | 35 |
| range | [5,10] | [5,15] | [3,5] | [3,6] |
| unit cost | 31 | 30 | 19 | 20 |
| range | [11,50] | [16,20] | | |
| unit cost | 30 | 24 | | |
| range | | [25,40] | | |
| unit cost | | 21 | | |

The algorithm RG operates as follows. Initially, it selects S₃, which supplies 5 units at the price of 19 per unit; then, it selects S₄, which supplies 6 units at the price of 20 per unit. Finally, it selects S₂, which supplies 17 units at the price of 24 per unit. The overall cost of the deal is 689.

Note that we can get a better deal if we choose to buy 5 units from S₃, and the remaining units from S₂. We get that the overall cost is 515.

While RG is very simple to implement, it can perform poorly compared to the optimum, as stated in the next result.

Observation 4.1: RG is an Ω(n) approximation for the DS problem with a single item, even when the price tables are monotone and rational.

Proof: Consider the following instance. We need to buy at least n units of the item. The supplier S₀ can provide at least (n+1) units at the cost of c/(n+1)≧1 per unit, while each of the suppliers, S₁, . . . , Sₙ can provide one unit of the item at the cost c. Now, OPT buys n+1 units from S₀ and pays the total cost c; RG buys a single unit from each of the suppliers S₁, . . . , Sₙ, and overall pays n·c. ▪

4.1.2 A Better Greedy Algorithm

As we have shown, the algorithm RG, which considers in each stage only a subset of the sub-suppliers (those satisfying (1)), may be far from the optimal. Indeed, in some cases it may be better to buy more than need units, with the promise that the overall cost of the deal is minimized. The algorithm RG′that we describe below, allows to consider also sub-suppliers who can provide only more than need units.

1. Sort the sub-suppliers in non-decreasing order by the price per unit. Denote the sorted list by L, and let r[j] (u[j]) and c[j] denote the minimal (maximal) number of units provided by the sub-supplier S[j], that is in position j in L, and the price per unit for this sub-supplier. Sub-suppliers with the same price per unit appear in the list in arbitrary order.

2. Let need=n;

3. j=1;

4. While r[j]<need {buy from S[j] x[j]=min(need, u[j]) units of the item; need=need−x[j]; if need=0 then stop else {Let Sᵢ be the supplier such that S[j] is a sub-supplier of Sᵢ. Update the maximal number of units of the item available from Sᵢ; that is, Tᵢ=Tᵢ−x[j]; update accordingly the entries of the set of sub-suppliers of Sᵢ; if the sub-supplier S[j] was omitted from L then j=j+1};

5. Let C_{RG′}(need) be the overall cost of buying need units of the item, if we apply RG′ recursively with n=need, starting from the first entry j* in L, such that j*>j, and r[j*]≦need; let C_{f} be the minimal possible total cost of buying (at least) need units from a single sub-supplier, S[f], who can complete the deal.

If C_{RG′}(need)<C_{f} then {let j*=min {j′>j: r[j]≦need}; j=j*; goto 4} else buy from S[f] r[f] units and stop.

### Example 4.2

Suppose that we have 4 suppliers with price tables as given in Table 4.1. As before, assume that T₁=50, T₂=40, T₃=5 and T₄=6. Initially, we set need=24. First, RG′ sorts the sub-suppliers in the table. The resulting list is:

L=(([3,5],19), ([3,6], 20),([25,40], 21),([16,20], 24), ([5,15]), 30), ([11,50], 30), ([5,10],31), ([1,2], 31), ([1,4], 32), ([1,5], 34), ([1,2], 35)]

(For example, the first entry refers to the second sub-supplier of S_{3,} for which the minimal and maximal number of units are 3 and 5, respectively, and the price per unit is 19. This sub-supplier becomes S[1]).

RG′ starts to scan the list L from left to right.

1) In the first step, RG′ buys 5 units at the cost of 19 per unit from S[1]. Then we get that need=need−5=19, total=195=95. Now, no units of the item are available from S₃: thus, S[1] and S[8] are omitted from L.

2) In the second step RG′ buys 6 units from S[2], at the cost of 20 per unit. We get that need=need−6=13; total=total+20·6=215. Now, no units of the item are available from S₄; thus, S[2] and S[11] are omitted from L.

3) In the third step RG′ finds that r[3]>need, then it computes

C_{f}=16·24=384 and C_{RG′}(need)=13·30=390;

Since C_{RG′}(need)>C_{f} RG′ completes the deal, buying 16 units from S[4], and total=total+384=599.

Note that the minimal cost of the deal satisfies

Total_{OPT}≧19·5+20·6+13·21=488.

4.2 Multiple Items

We now describe a Greedy algorithm for buying multiple items. Note that in our decomposition of the suppliers to sub-suppliers (as described in Section 3.2) we allow each sub-supplier to offer many packages, because each sub-supplier has ranges associated with the various items it supplies. Now we take a different approach: given the price tables defining the set of sub-suppliers, we generate the set of all the packages possible for each sub-supplier. This is done by explicit enumeration over each range in the table of the corresponding supplier.

To simplify our approximation algorithm, called Multi-Residual Greedy (MRG), we assume that each sub-supplier can be identified with a single package of the items.

It would be convenient to describe our minimization problem in terms of finding a minimum weight set cover. In the WEIGHTED SET COVER problem [GJ79] we have a set of items U={u₁, . . . , uₙ}, and a collection of subsets of the items C={A₁, . . . A_{q}}, where each subset, Aᵢ, has a weight, w(Aᵢ). Our goal is to find a sub-collection of the subsets, C′ [symbol] C, in which each of the items in U appears at least once and the total weight

$${\sum }_{S ∈ {C}^{′}}^{} w ( S )$$

is minimized.

Given an order for items from R different types, in which we need nⱼ units from item j, we assume that U consists of R items.

Denote by covered(j) the fraction already covered from item j, and let total denote the overall cost of the deal. Initially, total=0 and for all j, covered(j)=0.

For convenience we define also need(j)=1−covered(j). We represent the set of possible packages by the collection of subsets C=(A₁, . . . , A_{q}}: w(Aᵢ) is the cost of the package offered by Aᵢ. Let f_{A}_{ᵢ}(j) denote the fraction of item j covered by Aᵢ. The algorithm computes the cost density, α_{A}_{ᵢ}, for each Aᵢ (see in Step 3.): α_{A}_{ᵢ} measures the average cost per unit of an item, when provided by Aᵢ. The average is taken over the individual contributions of Aᵢ to covering the demands of the items 1, . . . , R. (For example, if R=2 and Aᵢ covers 1/2 of the demand for item 1 and 3/4 of the demand for item 2, then overall Aᵢ covers 5/4 items out of 2). Note that we treat items of different types uniformly, and we only count the total amount of items that still need to be covered.

The algorithm MRG proceeds as follows.

1. For j=1, . . . , R covered(j)=0; need(j)=1.

2. total=0;

3. While for some I<j<R, covered(j)<1 do

For each subset, AᵢεC, let f_{A}_{ᵢ}(j)=min (f_{A}_{ᵢ}(j)), need(j)); compute

$${α}_{{A}_{i}} = \frac{w ( {A}_{i} )}{{\sum }_{j = 1}^{R} {f}_{{A}_{i}} ( j )} ;$$

Select the set Aᵢ for which α_{A}_{ᵢ} is minimal. We break ties by selecting, among sets with the same minimal cost density, the set Aᵢ for which

$${\sum }_{j = 1}^{R} {f}_{{A}_{i}} ( j )$$

is maximal. Denote this set by Aₘᵢₙ.

For any item 1≦j≦R,

if Aₘᵢₙ contributes to the covering of j the fraction f_{A}_{ₘᵢₙ}(j)>0

then covered(j)=covered(j)+f_{A}_{ₘᵢₙ}(j)

total=total+w(Aₘᵢₙ)

Update the number of available items of type 1≦j≦R for each supplier.

Omit from C subsets corresponding to packages of suppliers who have already used all the available units from some item.

4. Output the picked subsets.

The next example shows the operation of the algorithm MRG.

### Example 4.3

### Suppose that there are two suppliers, S_{1,} S₂ and three items: printers, cartridges and paper. In the following we give the price tables for

S_{1,} S₂ which describe the packages that can be provided by the two suppliers.

TABLE 4.2
The price table of S₁.

| | printers | cartridges | paper |
|---|---|---|---|
| range | [1,1] | [3,3] | [4,4] |
| unit cost | 300 | 30 | 15 |
| range | [5,5] | [10,10] | [15,15] |
| unit cost | 250 | 23 | 10 |

TABLE 4.3
The price table of S₂.

| | printers | cartridges | paper |
|---|---|---|---|
| range | [1,1] | [5,5] | [8,8] |
| unit cost | 305 | 27 | 16 |
| range | [8,8] | [20,20] | [30,30] |
| unit cost | 260 | 24 | 9 |

Suppose that we need 12 printers, 20 cartridges and 36 boxes of paper. S_{1,} S₂ can provide upto 30 printers, 100 cartridges and 150 boxes of paper. Hence,

T_{1,1}=T_{2,1}=30, T_{1,2}=T_{2,2}=100 and T_{1,3}=T_{2,3}=150.

Let

A₁=(1,3,4); A₂=(5,10,15); A₃=(1,5,8); A₄=(8,20,30)

With the corresponding weights

w(A₁)=450; w(A₂)=1630; w(A₃)=568; w(A₄)=2830;

Let C₁={A₁,A₂} and C₂={A₃,A₄}. Our collection of sets is C={C₁,C₂}.

We describe the operation of the algorithm MRG by iterations.

(i) In the first iteration we have need(1)=need(2)=need(3)=1;

Now we compute α_{A}_{₁}, . . . , α_{A}_{₄}.

$${α}_{{A}_{1}} = \frac{450}{1 / 12 + 3 / 20 + 4 / 36} = 1306.45$$

Similarly, we get that α_{A}_{₂}=1222.5, α_{A}_{₃}=1022.4 and α_{A}_{₄}=1132;

Therefore MRG selects Arnin=A₃, and updates

covered(1)=1/12; covered(2)=5/20; covered(3)=8/36;

and tolal=568;

(ii) In the second iteration we have

α_{A}_{₁}=1306.45; α_{A}_{₂}=1222.5 and α_{A}_{₃}=1022.4;

Now, when computing α_{A}_{₄}, the set A₄ contributes to item 2 only 15/20 and to item 3 only 28/36, as 8/36 are already covered; therefore,

$${α}_{{A}_{4}} = \frac{2830}{8 / 12 + 15 / 20 + 28 / 36} = 1289.62$$

MRG selects again A₃ and we get that

covered(1)=2/12; covered(2)=10/20; covered(3)=16/36;

and total=1136;

(iii) In the third iteration A₃ is selected again and we have

covered(1)=3/12; covered(2)=15/20; covered(3)=24/36;

and total=1704;

(iv) A₃ is selected again. Now we have

covered(1)=4/12; covered(2)=20/20; covered(3)=32/36;

Hence,

need(1)=8/12; need (2)=0; need (3)=4/36;

and total=2272;

(v) We compute again,

$${α}_{{A}_{1}} = \frac{450}{1 / 12 + 0 + 4 / 36} = 2314.29$$

and similarly

α_{A}_{₂}=3088.42; α_{A}_{₃}=2921.15 and α_{A}_{₄}=3638.57;

Therefore MRG selects Aₘᵢₙ=A₁, and updates

covered(1)=5/12; covered(2)=1; covered(3)=1;

and total=2722;

(vi) In the sixth iteration we find that

α_{A}_{₁}=5400; α_{A}_{₂}=3912; α_{A}_{₃}=6816 and α_{A}_{₄}=4851.43;

Therefore MRG selects Aₘᵢₙ=A₂, and updates

covered(1)=10/12; covered(2)=covered(3)=1;

and total=4352;

(vii) In the seventh iteration we have

α_{A}_{₁}=5400; α_{A}_{₂}=9780; α_{A}_{₃}=6816 and α_{A}_{₄}=16980;

Therefore MRG selects Aₘᵢₙ=A₁.

(viii) In the last iteration MRG selects again Arnin=Ai. We get that total=5252.

Note that MRG is not optimal: a better deal is to select once Al and then A₄, at the total cost 4460.

4.2.1 MRG versus RG

While it may seem initially that RG is simply MRG in the special case where R=J, we now show, that the two algorithms may behave differently.

### Example 4.4

Suppose that we have a single item and three suppliers, S₁, S₂ and S₃. We need to provide at least 30 units of the item at minimal total cost.

Each of the suppliers S₁, S₂ can provide 100 units and S₃ 10 units.

TABLE 4.4
The price table for Example 4.4.

| S₁ | S₂ | S₃ |
|---|---|---|
| [1,10] | [1,20] | [1,10] |
| 30 | 35 | 12 |
| [11,40] | [21,50] | |
| 25 | 15 | |

Now, RG initially chooses to buy 10 units from S₃, at the price of 12 per unit.

Then we get that need=20, therefore RG next selects S₁, which supplies 20 units at the cost of 25 per unit. The total cost is 620.

In contrast, MRG maintains a list with all the possible deals. First, MRG selects to buy from S₃ 10 units, at the cost of 12 per unit. Then, MRG buys 21 units from S₂, and the total cost is 435.

4.2.2 Implementation of MRG

Note that algorithm MRG uses as input the set of all possible packages offered by each of the sub-suppliers. Indeed, when the input is given as price tables, for generating the Aᵢ's we need to enumerate all the possible packages for each sub-supplier. In generating the Aᵢ's and computing the α_{A}_{ᵢ}'s we may wish to consider the following simplifications:

Since our goal in each iteration is to find Aₘᵢₙ, we can save space by generating the Aᵢ's dynamically and maintaining the minimum in each step. This, however, requires to recompute in each iteration for Aᵢ the values f_{A}_{ᵢ}(j), for j=1, . . . , R.

At the beginning of each iteration it may help to compute first the value α_{A}_{ᵢ} for the set, Aᵢ that was selected in the previous iteration to be Aₘᵢₙ. If α_{A}_{ᵢ} remains unchanged then the same set remains Aₘᵢₙ in this iteration. This is due to the fact that for any other set α_{A}_{ᵢ} cannot decrease when moving to the next iteration.

When the Aᵢ's are derived from the price tables of the suppliers, we can avoid the enumeration of all the packages of a given sub-supplier, S_{i,l}, as follows. Let needu(j)=need(j)·nⱼ. We set û_{i,l,j}=max(min(u_{i,l,j},needu(j)),r_{i,l,j}). Let

$$\begin{matrix}{g}_{j} ( {n}_{1} , … , {n}_{R} ) = \{ \begin{matrix}1 & {n}_{j} \geq needu ( j ) \\ \frac{{n}_{j}}{needu ( j )} & otherwise\end{matrix} \\ and let \\ {f}_{i , l} ( {n}_{1} , … , {n}_{R} ) = \frac{{\sum }_{j = 1}^{R} {c}_{i , l , j} \cdot {n}_{j}}{g ( {n}_{1} , … , {n}_{R} )}\end{matrix}$$

Now we find the integral point (n₁, . . . , n_{R}), r_{i,l,j}≦nⱼ≦û_{i,l,j}, in which f_{i,l}(·) gets the minimum. We take the resulting package, Aᵢ, to be the package representing the sub-supplier S_{i,l}. Thus, in each iteration of the algorithm we need to consider at most Σᵢmᵢ packages.

5. Approximation Schemes for Single Item

In this section we present algorithms that achieve a (1+ε)-approximation for the DS problem for single-item deals, for a given 0<ε<1. The input for our algorithms is the set of m price tables of the suppliers. In §5.1 we discuss an easy variant of our problem, where each of the suppliers can provide an unbounded number of units from the item. In §5.2 we refer to the bounded case. For both cases we develop approximation schemes, which yield pseudo-polynomial time optimal algorithms. We analyze these algorithms and show how their running time can be reduced when the price tables are rational and monotone.

Our algorithms use as procedures fully polynomial time approximation schemes (FPTAS) for variants of the 0-1 knapsack problem. Since we use the cost of partial deals as the “sizes” of the items in the resulting packing problems, it is implicitly assumed that the entries in the price tables are integers. This does not impose a restriction on the inputs for the DS problem. We allow the costs per unit to be any positive rationals. Before we apply our approximation schemes, we can use the following rounding procedure:

1. Given a set of price tables T₁, . . . , Tₘ, for the suppliers S₁, . . . , Sₘ, write each entry as a rational number.

2. Find the least common denominator, D, of all entries.

3. Multiply all entries by D.

Thus, we get that all entries become integral.

5.1 Unbounded Case

Assume first that we can repeatedly buy from some sub-supplier, S_{i,l}, i.e., for any 1≦i≦m, Tᵢ≧n, where n is the number of units ordered from the item. The algorithm is based on an FPTAS for the INTEGER KNAPSACK problem [GJ-79] (also known as the Unbounded Knapsack [L-79]):

Input: A set of items, U, where each item uεU has the size s(u)εZ⁺ and the value v(u)εZ⁺, and positive integers, B, K.

Question: Is there an assignment of a non-negative integer c(u) to each item uεU, such that

$${\sum }_{u ∈ U}^{} s ( u ) c ( u ) \leq B , and {\sum }_{u ∈ U}^{} v ( u ) c ( u ) \geq K ?$$

The problem is known to be NP-complete and solvable in pseudo-polynomial time (see, e.g., in [GL-79], [L-79]). Lawler developed in [L-79] FPTAS for the optimization version of this problem, in which we need to assign a non-negative integer c(u) to each item uεU, such that

$${\sum }_{u ∈ U} s ( u ) c ( u ) \leq B , \text{and} {\sum }_{u ∈ U} v ( u ) c ( u )$$

is maximized. The running time of the scheme is O(|Uβ+1/ε³) for any ε>0, where |U| is the number of items in the input.

Denote by A_{ε}(I), OPT(I) the values of the approximate and optimal solutions for a given input. I, of INTEGER KNAPSACK. Let V=max_{uεU}v(u) be the maximal profit of any item in U. Then, OPT(I)≦B·V, since we can take at most B copies of the item whose profit is maximal. Hence, if we choose ε=(B·V)⁻¹, and run some approximation scheme A_{ε} on an instance I, we get that

A_{ε}(I)≧(1−ε)OPT(I),

or

1≧ε·OPT(I)≧OPT(I)−A_{ε}(I)

and since the solution for INTEGER KNAPSACK is integral, we get an optimal solution. The running time of A_{ε} is O(|U|+B³V³).

We describe below an approximation scheme for the unbounded DS problem. The idea is to define building blocks of sizes 1≦s≦nₒ for some nₒ≧1 (defined below), and to find the combination of blocks that yields the minimal total cost (Since we refer to the unbounded case, we allow to take any number of blocks of each type). The input parameter, ε, can get any value in the range (0,1). The scheme proceeds as follows.

1. Run algorithm RG on the input instance, to obtain an upper bound for the minimal cost, Cₘᵢₙ. Initially, set Cₘᵢₙ=C_{RG}.

2. Let ĉ be the minimal unit cost offered by any sub-supplier. For a given value of Cₘᵢₙ, let nₒ=Cₘᵢₙ/ĉ be the maximal possible number of units bought by an optimal algorithm, OPT.

3. Let cost(s) be the minimal cost of buying s units of the item from a single sub-supplier, 1≦s≦nₒ. (It may be the case that it is impossible to buy s units of the item from a single sub-supplier, for some values of s. For these values we set cost(s)=Cₘᵢₙ+1).

4. For each pair of values (Cₘᵢₙ, nₒ), generate an instance of the INTEGER KNAPSACK problem: the universe, U, consists of nₒ items, u₁, . . . , uₙ_{ₒ}εU, such that s(uₛ)=cost(s) and v(uₛ)=s, 1≦s≦nₒ. Given ε>0, find the maximal profit from packing items in U in a knapsack of capacity B=Cₘᵢₙ. (This can be done by using, e.g., the FPTAS for INTEGER KNAPSACK given in [L-79]).

5. Use a binary search to find the minimal value of Cₘᵢₙ, 1≦Cₘᵢₙ≦C_{RG}, which yields a feasible solution, i.e., the profit (=number of items provided) is at least n.

For the time complexity of the above scheme, we first note that for each guess of Cₘᵢₙ, for which we define nₒ=Cₘᵢₙ/ĉ, and for any ε>0, we can get a (1+ε)-approximation for the resulting instance of INTEGER KNAPSACK in O(nₒ+1/ε³) steps [L-79]. Hence, we get that the complexity for each guess of Cₘᵢₙ is

O(Cₘᵢₙ+1/ε³)=O(C_{RG}+1/ε³).

Now, the number of guesses of Cₘᵢₙ equals to log_{1+ε} C_{RG}, hence, for a given value Of C_{RG}, the running time of the scheme is

O(log_{1+ε}C_{RG}(C_{RG}+1/ε³))

Denote by cₘₐₓ the maximal unit price for any sub-supplier, then C_{RG}≦n cₘₐₓ, and the overall time complexity is

O(log_{1+ε}(n·cₘₐₓ)(n·cₘₐₓ+1/ε³))

Finally, recall that the number of sub-suppliers of supplier i is mᵢ; the running time of RG is linear in the total number of sub-suppliers, given by

M=Σᵢmᵢ (2)

Thus, overall, we get that the running time of the scheme is

O(log_{1+ε}(n·cₘₐₓ)(n·cₘₐₓ+1/ε³)+M).

When the price tables are rational and monotone, we can reduce the number of elements in the instance of INTEGER KNAPSACK to log_{1+ε} nₒ. Suppose that

for some 1≦s≦nₒ, the supplier that can provide s units of the item at minimal cost is Sₕ, for some 1≦h≦m. For 1≦s<s′≦(1+ε)s, let cᵤ, c′ᵤ be the cost per unit, for buying s and s′ units from Sₕ, respectively. Since the table of Sₕ is rational,

c′ᵤ·s′=costₕ(s′)≧costₕ(s)=cᵤ·s

Hence,

$$\frac{{c}_{u}}{{c}_{u}^{′}} \leq \frac{{s}^{′}}{s} \leq 1 + ϵ$$

In addition, since the table is monotone, cᵤ≧c′ᵤ. It follows, that

costₕ(s′)≦cᵤ·s′=cᵤ·(s′/s)·s≦(1+ε)costₕ(s)

Hence, instead of taking in the instance of INTEGER KNAPSACK all the values 1≦s≦nₒ, we can take only values of s which are (rounded) integral powers of (1+ε). From the above discussion, it is guaranteed, that if

(1+ε)^{r-1}<s≦(1+ε)^{r}, and we buy from the supplier Sₕ└(1+ε)^{r}┘ units, then the total cost of the deal may increase by at most factor (1+ε).

Thus, when the price tables are monotone and rational, the complexity of solving the INTEGER KNAPSACK is

O((log_{1+ε}nₒ)+1/ε³)=O(log_{1+ε}C_{RG}+1/ε³)

As before, the number of guesses is log_{1+ε} C_{RG}. Hence, the overall complexity is

O((log_{1+ε}C_{RG})²+log_{1+ε}C_{RG}/ε³+M)=O((log_{1+ε}(n·cₘₐₓ)²+log_{1+ε}(n·cₘₐₓ)/ε³+M)

5.2 Bounded Case

Now, we describe an approximation scheme for the case where each supplier, Si, has a limited number of units from the item, given by Tᵢ, 1≦i≦m. As before, we use building blocks, that will represent the deals in which we buy all the items from a single supplier; thus, the number of “blocks” for a supplier Si is at most Tᵢ, 1≦i≦m. Also, to guarantee that Sᵢ provides at most Tᵢ units from the item, we assign to each supplier, Sᵢ, at most one “building block”, whose size is in the range [1, Tᵢ].

We assume in the analysis of our scheme, that we can find in O(1) steps the minimal cost of buying s units of the item from Sᵢ. Clearly, this holds when the price tables are rational and monotone; for general tables, some preprocessing may be required. As in the unbounded case, the input parameter, ε, can get any value in the range (0, 1).

The algorithm is based on an FPTAS for the 0-1 MULTIPLE CHOICE KNAPSACK problem (MCK) [GJ-79]:

Input: A universe U of n items, partitioned into m sets, U₁, . . . , Uₘ, and the positive integers, B, K. There are kᵢ items in Uᵢ,

$${\sum }_{i = 1}^{m} {k}_{i} = n ;$$

sᵢⱼ and vᵢⱼ are the size and the value, respectively, of the j-th item in Uᵢ, 1≦j≦kᵢ.

Question: Is there an assignment of xᵢⱼε{0,1}, for all i,j, such that

$${\sum }_{i = 1}^{m} {\sum }_{j = 1}^{{k}_{i}} {s}_{ij} {x}_{ij} \leq B , \text{and} {\sum }_{i = 1}^{m} {\sum }_{j = 1}^{{k}_{i}} {v}_{ij} {x}_{ij} \geq K ,$$

and for all 1≦i≦m

$${\sum }_{j = 1}^{{k}_{i}} {x}_{ij} \leq 1 ?$$

The problem is known to be NP-complete and solvable in pseudo-polynomial time (see, e.g., in [GL-79], [L-79]). Lawler developed in [L-79] an FPTAS for the optimization version of this problem, in which we look for an assignment of xᵢⱼε{0,1}, for all i,j, such that

$${\sum }_{i = 1}^{m} {\sum }_{j = 1}^{{k}_{i}} {s}_{ij} {x}_{ij} \leq B , \text{for all} 1 \leq i \leq m {\sum }_{j = 1}^{{k}_{i}} {x}_{ij} \leq 1 \text{and} {\sum }_{i = 1}^{m} {\sum }_{j = 1}^{{k}_{i}} {v}_{ij} {x}_{ij}$$

is maximized. The running time of the scheme is O(n log n+mn/ε) for any ε>0. We use this scheme as a procedure in our scheme for DS with single item.

Our scheme proceeds as follows.

1. Run algorithm RG on the input instance, to obtain an upper bound for the minimal cost, Cₘᵢₙ. Initially, set Cₘᵢₙ=C_{RG}.

2. Let

$$T = {\sum }_{i = 1}^{m} {T}_{i}$$

denote the total number of units of the item available from all the suppliers. For each value of Cₘᵢₙ, generate the following instance of the MCK problem. The universe, U, consists of n=T items, partitioned to m sets U₁, . . . , Uₘ. The set Uᵢ represents the supplier Sᵢ; the size of Uᵢ is Tᵢ, the maximal number of units available from Sᵢ. For the j-th item in Uᵢ, sᵢⱼ is the minimal cost of buying j units from Sᵢ, and vᵢⱼ=j. Now, we find the maximal profit from packing items from U₁, . . . , Uₘ in a knapsack of capacity B=Cₘᵢₙ, with the restriction, that from each set we choose at most one item.

3. Use a binary search to find the minimal value of Cₘᵢₙ, 1≦Cₘᵢₙ≦C_{RG}, which yields a feasible solution, i.e., the profit (=number of items provided) is at least n.

For the time complexity of the above scheme, we first note that for each guess of Cₘᵢₙ, and for any ε>0, we can get a (1+ε)-approximation for the resulting instance of MCK in O(T log T+mT/ε) steps [L-79].

Now, the number of guesses of Cₘᵢₙ equals to log_{1+ε} C_{RG}, hence, for a given value of C_{RG}, the running time of the scheme is

O(log_{1+ε}C_{RG}(T log T+mT/ε))=O(log_{1+ε}(n·cₘₐₓ) (T log T+mT/ε))

Note, that since Tᵢ≧mᵢ, for 1≦i≦m, adding the running time of RG

$$( = {\sum }_{i = 1}^{m} {m}_{i} )$$

does not affect the overall complexity of the scheme.

When the price tables are rational and monotone, we can reduce the number of elements in the instance of MCK to

$${T}^{′} = {\sum }_{i = 1}^{m} ⌈ {log}_{1 + ϵ} {T}_{i} ⌉ \text{:}$$

from each supplier, Sᵢ, we allow to buy number of units, which is an integral power of (1+ε). This may increase the overall cost of the deal at most by factor (I+E), as argued in Section 5.1 Thus, the number of items in the set Uᵢ is at most ┌log_{1+ε}Tᵢ┐; sᵢⱼ is the cost of buying (1+ε)^{j} units from Sᵢ, and vᵢⱼ=(1+ε)^{j}. Now, we add also the running time of RG, and get that the overall running time of the scheme is

O(log_{1+ε}(n·cₘₐₓ)(T′ log T′+mT′/ε)+M).

Let Tₘₐₓ=maxᵢTᵢ, then T′=O(m log Tₘₐₓ), and we get that the overall complexity is

O(log_{1+ε}(n·cₘₐₓ)(m(log Tₘₐₓ)²+m² log Tₘₐₓ/ε)+M).

6. Approximation Schemes for Multiple Item Deals

Assume now that the unit cost for each item is given in various ranges, and that each supplier offers combinations of the appropriate number of units, from the R items, in each of the ranges (see e.g. in Table 3.2).

6.1 Unbounded Case

We assume first that the number of units of each item is unbounded, for any supplier. For this case we propose an approximation scheme that uses as input the set of all possible packages offered by the suppliers. Thus, the complexity of our scheme is measured relative to the size of this set of packages. We use as procedure an approximation scheme for a variant of the Integer Multi-Dimensional Knapsack problem [CHW-76]. (We describe this problem in detail below). Our general scheme proceeds as follows.

1. Run algorithm MRG on the input instance, to obtain an upper bound for the minimal cost, Cₘᵢₙ. Initially, set Cₘᵢₙ=C_{MRG}.

2. For a given value of Cₘᵢₙ, scale the package prices as follows: round up the price of each package to the nearest multiple of ε·Cₘᵢₙ/m, where m is the number of suppliers.

Divide by ε·Cₘᵢₙ/m the prices of all packages, such that all prices are in the range {0, . . . , m/ε}. Finally, round up the price of each package to the nearest integral power of (1+ε). Now we have O(ln(m/ε)) price categories for the packages. Let L denote the number of price sets. That is, we partition the packages to L sets: the l-th set contains all packages whose price is (1+ε)^{l},

1≦l≦L.

3. For the l-th set, we find the number of units of each item that will be bought for the deal, by taking packages in this set. (This is done by exhaustive search, on a set of vectors whose size is polynomial in the input size; we give the details below).

4. Given the number of units from each item, to be bought by taking packages in the l-th set, we find a subset of packages in this set that provides these units at minimal cost.

5. We use binary search to find the minimal value of Cₘᵢₙ, 1≦Cₘᵢₙ≦C_{MRG}, which yields a feasible solution, i.e., the number of units provided from item j, for all 1≦j≦R is at least nⱼ.

Completing Parts of the Deal at Minimum Cost.

We now describe in detail Step 4. of the scheme. In this step we need to find a combination of packages from the l-th price set, 1≦l≦L, which provides certain amount of items from each of the R types, at minimum cost. We represent the number of units from each item that needs to be provided by the l-th price set, by a vector of length R. The entries of the vector are integral values, 1≦aⱼ≦1/ε, 1≦j≦R, describing the amount of items of each type provided by the l-th set. We say that the l-th set covers the vector (a₁, . . . , a_{R}) if overall, the packages selected for the deal from this set provide at least bⱼ=aⱼ·εnⱼ units from item i, 1≦j≦R.

We use the following LP relaxation of our problem. We call this problem SUP. Suppose that there are Nₗ packages in group l, 1≦Nₗ≦N. Given the non-negative rational values cᵢ, bⱼ and aᵢⱼ (to be specified below), where 1≦i≦Nₗ, and 1≦j≦R, we solve the following linear program.

$$Minimize {\sum }_{i = 1}^{{N}_{l}} {c}_{i} {x}_{i}$$

$$\text{Subject to} {\sum }_{i = 1}^{{N}_{l}} {a}_{ij} {x}_{i} \geq {b}_{j} j = 1 , … , R$$

$${x}_{i} \geq 0 i = 1 , … , {N}_{l}$$

For such a system of inequalities there is a solution in which at most R values,

xᵢ_{₁}, . . . , Xᵢ_{_{R}} get non-zero values (see e.g. in [L-76]). Hence, it suffices to solve the above linear program for the

$$( \begin{matrix}{N}_{l} \\ R\end{matrix} )$$

possible subsets of R variable out of (x₁, . . . , x_{N}_{ₗ}). Note that we rely here strongly on the fact that R is a fixed constant. This guarantees that the number of possible subsets is polynomial in N.

We now describe an approximation scheme, based on an optimal solution for the above program.

Algorithm Multi-dimensional Cover (MDC): Let xᵢ_{₁}, . . . , xᵢ_{_{R}} be an optimal solution for the problem SUP. We take ┌xᵢ₁┐, . . . , ┌x_{iR}┐ as approximate solution.

Denote by C_{SUP} the optimal cost for the problem SUP; C_{MDC} is the cost of algorithm MDC and Cₒ is the optimal cost for our original covering problem (in which we can take an integral number of units from each package). We denote by

cᵢ_{₁}, . . . , cᵢ_{_{R}} the costs of the packages that are supplied in the optimal solution for SUP. Note that Cₒ≧C_{SUP}. Hence we get that

C_{MDC}−Cₒ≦C_{MDC}−C_{SUP}<cᵢ_{₁}+ . . . +cᵢ_{_{R}}≦R·max(c₁, . . . , c_{N}_{₁}}.

We now describe an (1+ε)-approximation scheme.

Given a vector x we sort the entries such that c₁≧ . . . ≧c_{N}_{₁}. For a given ε>0, let ε′=ε/(1+ε), and δ=┌k·((1/ε′)−1)┐. Denote by Ω the set of integer vectors x=(x₁, . . . , x_{N}_{₁}) satisfying xᵢ>0 and

$${\sum }_{i = 1}^{{N}_{l}} {x}_{i} \leq δ .$$

For any vector xεΩ we run algorithm MDC for the following problem.

Let d≧1 be the maximal integer i for which xᵢ≠0. Then we solve the LP for the problem SUP, given by

$$\begin{matrix}Minimize {\sum }_{i = d + 1}^{{N}_{l}} {c}_{i} {z}_{i} \\ Subject to {\sum }_{i = d + 1}^{{N}_{l}} {a}_{ij} {z}_{i} \geq {b}_{j} - {\sum }_{i = 1}^{{N}_{l}} {a}_{ij} {x}_{i} j = 1 , … , R \\ {z}_{i} \geq 0 i = 1 , … , {N}_{l}\end{matrix}$$

Denote by C_{MDC}(x) the value obtained from running MDC on the fractional solution of the above program, with a given vector x, and let

$$c ( x ) = {\sum }_{i = 1}^{{N}_{i}} {c}_{i} {x}_{i} .$$

The algorithm MDC_{ε} selects the vector x for which

C_{MDC}_{_{ε}}(x)=minₓεΩ(c(x)+C_{MDC}(x))

Using arguments similar to those in [CHW-76] it can be shown that (i) The running time of algorithm MDC_{ε} is O(N^{┌R/ε┐}), and its space complexity is O(N); (ii) If Cₒ≠0, ∞ then C_{MDC}_{_{ε}}/Cₒ<1+ε.

This completes our detailed description of Step 4. of the scheme.

Analysis of the Scheme.

We now turn to compute the overall time complexity of our approximation scheme. The running time of the scheme consists of the running time of MRG (in Step 1.), to which we add Steps 3.-5. The heart of the scheme is Step 4. For a given value of Cₘᵢₙ we run algorithm MDC_{ε}, for each cost group l, 1≦l≦log_{1+ε} (m/ε) taking all the possible allocation vectors (α₁, . . . , α_{R}).

We define a configuration to be a given set of allocation vectors for all the cost groups. The running time of Step 4. for each configuration is

O(log_{1+ε}n·N^{┌R/ε┐}), and the possible number of configurations is O((m/ε)^{R·ln(1/ε)/ε}).

Hence, for a given value of Cₘᵢₙ the running time of Step 3. and 4. is

$$O ( {log}_{1 + ϵ} n \cdot {N}^{⌈ R / ϵ ⌉} \cdot {( \frac{m}{ϵ} )}^{R \cdot ln ( 1 ϵ ) ϵ} ) .$$

As before, we need to multiply the above complexity by the number of guesses of the value of Cₘᵢₙ, which equals to log_{1+ε} (n·cₘₐₓ) and add the running time of algorithm MRG, which is linear in the total number of packages. This gives the overall running time of

O(N+log_{1+ε}(n·cₘₐₓ)·log_{1+ε}n·N^{┌R/ε┐}·(m/ε)^{R·ln(1/ε)/ε}).

6.2 The Bounded Case

In the bounded case we associate each supplier Sₕ with a set of packages, {i_{h,l}, . . . , i_{h,N}_{ₕ}}, where Nₕ is the number of distinct packages offered by Sₕ. 1≦h≦m. Denote now by Tₕ^{j} the total number of units of item j held in the stock of Sₕ. We describe below an approximation scheme, which uses Steps 1.-5. as in §6.1. However, we need to slightly modify algorithm MDC_{ε} (in Step 4.).

We use in our scheme the following assumptions: (i) The number of suppliers is a fixed (but arbitrary) constant. (ii) There exists an optimal (possibly fractional) deal, where the number of units bought from each item, for any supplier h is at most Tₕ^{j}/2. Assumption (ii) implies that the order sizes are small relative to the amount of units available of the items, from each supplier. Thus, we refer here to small customers.

Our scheme for the bounded case proceeds similar to the scheme described in §5.1. In Step 4., we need to find a deal of minimum cost that covers the allocation vector assigned to group l. While doing so, we also need to verify that the overall number of units covered in our solution is bounded by Tₕ^{j} for all 1≦j≦R and 1≦h≦m. This is done by allocating to each cost group l some fraction of the stock of item j supplied by Sₕ. We define for group l a stock vector of length R·m, β=(β_{1,1}, . . . β_{1,R}, . . . , β_{m,1}, . . . , β_{m,R}), where 1≦β_{g,j}≦1/(2ε). We select the set of stock vectors for the cost groups, such that the total number of units that can be allocated from item j by Sₕ is at most Tₕ^{j}/2. By Assumption (ii) there exists an optimal solution that uses at most half of the stock of item j, for each supplier. The stock allocated to the group l by Sₕ from item j is then given by t_{h,j}=β_{h,j}·εTₕ^{j}.

Note that in this partition of the stock of each item for specific supplier, we allow non-integral number of units to be supplied by some groups. These non-integral values are used in the LP, and are later rounded by algorithm MDC.

We summarize below the modified scheme.

1. Run algorithm MRG on the input instance, to obtain an upper bound for the minimal cost, Cₘᵢₙ. Initially, set Cₘᵢₙ=C_{MRG}.

2. For a given value of Cₘᵢₙ, scale the package prices as follows. Round up the price of each package to the nearest multiple of ε·Cₘᵢₙ/N, where N is the overall number of packages offered by the suppliers;

divide by ε·Cₘᵢₙ/N the prices of all packages, such that all prices are in the range {0, . . . , N/ε}; round up the price of each package to the nearest integral power of (1+ε).

3. For group l (i) find a vector α of length R, given as a set of integral values, 1≦αⱼ≦1/ε, describing the amount of items of each type covered by that group; if group l covers the vector (α₁, . . . , α_{R}) then the packages selected for the deal will cover at least bⱼ=αⱼ·εnⱼ units from item j, 1≦j≦R. (ii) Find a vector β of length Rm, given as a set of integral values, 1≦β_{h,j}≦1/(2ε), describing the amount of items of type j allocated to group l from the stock of the supplier Sₕ.

4. Given a covering vector β and a stock vector β for group l, find a subset of packages in this group that covers α while satisfying the stock restrictions given by β, at minimal cost.

5. Use binary search to find the minimal value of Cₘᵢₙ, 1≦Cₘᵢₙ≦C_{MRG}, which yields a feasible solution.

We now describe in detail Step 4. of the modified scheme. Define the set of vectors Ω and δ as in §5.1. For any vector xεΩ we run algorithm MDC for the following problem.

Let d≧1 be the maximal integer i for which xᵢ≠0. Then we solve for group l the LP:

$$\begin{matrix}Minimize {\sum }_{i = d + 1}^{{N}_{l}} {c}_{i} {z}_{i} \\ Subject to {\sum }_{i = d + 1}^{{N}_{l}} {a}_{ij} {z}_{i} \geq {b}_{j} - {\sum }_{i = 1}^{{N}_{l}} {a}_{ij} {x}_{i} j = 1 , … , R \\ {\sum }_{i = d + 1}^{{N}_{l}} {a}_{ij} {z}_{i} \leq {t}_{h , j} - {\sum }_{i = 1}^{{N}_{l}} {a}_{ij} {x}_{i} j = 1 , … , R h = 1 , … , m \\ {z}_{i} \geq 0 i = 1 , … , {N}_{l}\end{matrix}$$

Denote by C_{MDC}(x) the value obtained from running MDC on the fractional solution of the above program, with a given vector x, and let

$$c ( x ) = {\sum }_{i = 1}^{{N}_{l}} {c}_{i} {x}_{i} .$$

The algorithm B-MDC_{ε} selects the vector x for which

C_{B-MDC}_{_{ε}}(x)=minₓεΩ(c(x)+C_{MDC}(x))

As before, we can use arguments similar to those in [CHW-76] to show that (i) The running time of algorithm MDC_{ε} is O(N^{┌Rm/ε┐}), and its space complexity is O(N); (ii) If Cₒ≠0, ∞ then C_{B-MDC}_{_{ε}}/Cₒ<1+ε.

We now compute the overall time complexity of the modified scheme.

As in §5.1, the running time of the scheme consists of the running time of MRG, to which we add Steps 3.-5. For a given value of Cₘᵢₙ we run algorithm B-MDC, for each cost group l, 1≦l≦log_{1+ε} (N/ε), taking all the possible allocation vectors (α₁, . . . , α_{R}) and stock vectors (β_{1,1}, . . . , β_{m,R}). We define a configuration to be a given set of allocation and stock vectors for all the cost groups. The running time of Step 4. for each configuration is O(log_{1+ε}n·N^{┌Rm/ε┐}), and the possible number of configurations is O((N/ε)^{Rm·ln(1/ε)/ε}). Hence, for a given value of Cₘᵢₙ the running time of Steps 3. and 4. is

$$O ( {log}_{1 + ϵ} n \cdot {N}^{⌈ Rm / ϵ ⌉} \cdot {( \frac{N}{ϵ} )}^{R \cdot m \cdot ln ( 1 ϵ ) \cdot ϵ} ) .$$

Finally, we multiply the above complexity by the number of guesses of the value of Cₘᵢₙ, which equals to log_{1+ε}(n·cₘₐₓ), and add the running time of algorithm MRG. This gives the overall running time of

$$O ( N + {log}_{1 + ϵ} ( n \cdot {c}_{max} ) \cdot {log}_{1 + ϵ} n \cdot {( \frac{N}{ϵ} )}^{R \cdot m \cdot ln ( 1 ϵ ) ϵ} ) .$$

### Deal Splitting for Quantity-Additive Deals Terminology and Definitions

We start by introducing new concepts.

DS Algorithm

A DS algorithm accepts a collection of sellers and a request from a buyer, and finds a purchasing deal that satisfies the buyer's request with a minimum price.

Supplier, Seller

Each seller is a collection of sub-sellers, such that each sub-seller defines a collection of items that must be bought, together, within the ranges of their respective quantities. The seller also has an availability vector of quantity in stock, per each item.

Notes:

1. So far we used the terms Suppliers, and their respective Sub-Suppliers, whereas the Utility-Layer sections mention the term Seller; this section considers Sellers and Suppliers as synonyms, and similarly for the terms Sub-Supplier and Sub-Seller (see below).

2. A human trader, in light of the received buyer's RFQ, may define a sub-seller explicitly. Furthermore, a collection of sub-sellers may be derived automatically from a seller's intention.

Sub-Supplier, Sub-Seller

A sub-seller represents an entry in a price-table of the seller. It identifies the seller's preference for selling one or more items with specific quantities for a specific price. A sub-seller is represented by two data-structures: (1) An RFQ containing the requirements and ranges for quantities of items. (2) A relevant GP model, which contains constraints and preferences upon the items. The GP model is actually a sophisticated price formula for calculating the price of a package, instead of using a simple price-per-unit equation.

Package

The DS algorithm operates on packages. A package is an explicit deal, generated from a sub-seller. A package specifies exact quantities of the items to be purchased with a total price for the purchase.

Final Deal

The final deal is a collection of packages with their relevant total prices. The final deal's total price is the sum of these prices.

General Item (GI):

This is a virtual item. It contains a collection of real items that must be supplied by the same supplier. Notice that it is the buyer who defines GIs. A supplier that knows the buyer's published RFQ may define its sub-suppliers while taking into account the buyer's GIs, however, this should not impose any preference to use such sub-suppliers in the system's solution.

Item ID.

An item is identified via a notion (i.e., type, e.g., Mouse, KB, CPU) and a name. A name is usually a serial identification number, which is usually used to distinguish simple items that should be provided within a GI and those that should be provided as “stand alone” simple items.

RFQ

Request For Quote is a general term describing a buyer's request for purchasing specific items with specific quantities (or ranges of quantities). See example below in the description of the input.

RRFQ or RRF

Response to RFQ is a general term describing a seller's offer for selling specific items of specific quantities (or ranges of quantities). An RRF also specifies a price-per-unit for each of the items provided, or a general function for calculating a total-price of a package from the RRF.

### Input

Buyer (A Single Buyer)

1. RFQ (Buyer's Requirement)

An RFQ of Simple Items and General Items With Their Relevant Attributes

### EXAMPLE

| GI | | Item | | | |
|---|---|---|---|---|---|
| Flag | Item Notion | Name | Quantity | | |
| F | Mouse | 0 | 30-80 | | |
| F | KB | 0 | 30-80 | | |
| G | “Computer” | N/A | 25-30 | | This is a General Item |
| T | CPU | 0 | 1 | | called “Computer”; which |
| T | Screen | 0 | 1 | {close oversize brace} | is composed of one CPU, |
| T | KB | 1 | 1 | | one Screen and one KB. |

Notice that this is the exact requirement of the buyer, so that the suppliers can respond according to this explicit request by the buyer.

GP Model

The buyer preferences and constraints are represented via a GP model. Notice that the model may be very complex. It may impose constraints upon the attributes of each item, such as on delivery date, color, quality, etc. as well as trade-offs between these attributes. Moreover, the GP contains objectives, describing penalties or bonuses upon deviating from the specified goal target(s).

The model is used to evaluate the packages of the suppliers in terms of the buyer's currency (that is, his GP), via a special utility that evaluates the packages even when a certain package does not fulfill the whole requirement of the buyer (according to the “quantity additive deals” assumption; see Stage III. Evaluating the packages.)

Supplier (Multiple Sub-Suppliers)

1. Availability Vector

This is a vector describing the available quantities for the items that the supplier provides. General Items are not specified here, as only the buyer defines them.

### EXAMPLE

EXAMPLE

Item

| | Tire | Body | Radio | Car |
|---|---|---|---|---|
| Quantity | 200 | 10 | 50 | na |

2. Sub-Suppliers

A sub-supplier represents a collection of items that must be bought together as a whole. Each item in the package has specific attributes and ranges of values for the attributes.

A sub-supplier is represented, similarly to a buyer, via an RRF (Response to RFQ) and a GP model.

### Algorithm Flow

Stage I. “Splitting” the Buyer

The input RFQ of the buyer may include ranges of desired quantities, of the various items, for purchase. However, the DS system used is based upon exact quantities. That is, given a vector need of the required quantities for each item, a DS algorithm seeks a solution such that the purchase includes at least need quantities for every item, with minimum overall price. Moreover, the need values express minimum required quantities, and the DS algorithm cannot handle maximum values, and therefore cannot handle ranges in the need vector.

a. Input:

Buyer RFQ, quantities and GI clearly marked

K, number of maximum specified deals allowed.

b. Output

Up to K different derived “new” RFQs for the Buyer, where each RFQ contains explicit values (non-ranges) for the quantity variables of all the items (i.e., a need vector expressing quantities in terms of (simple) items and GIs).

c. Algorithm Outline

The basic idea is to choose the most important R items (the user should define the importance of the items); and allow quantity combinations only for these items, when the other items will have a randomly chosen quantity value within their range. Alternatively, we will allow users to specify desired quantities for items and use these targets for the less important items (these targets need not affect the GP's objective functions).

### EXAMPLE

Suppose we have five items with the ranges below, when I2 and I4 are the important items, and we would like to have at most K=8 combinations:

I1: [1-10], I2: [20-70], I3: [1-100], I4: [50-70], and I5: [2-6]

Then, for instance, I2 and I4 will have the representative combinations:

[30,50], [30,57], [30,63], [30,70], [50,50], [50,57], [50,63], [50,70]

For the other items, we'll choose at random, within their ranges, quantity values for each combination. Alternatively, if target quantities were specified for the other items, these will be used instead of a random selection.

Stage II. Preparing Sellers' Packages

The MRG algorithm (MI-DS greedy algorithm) works upon explicit packages of values for the attributes, where each package has a specific price value for purchasing it. As such, it considers only the quantity attribute, and prepares all the possible packages of a sub-supplier by generating all the possible combinations of unique quantity values for all items.

The algorithm described herein is used in order to generate all the possible packages for the MRG algorithm. However, due to the concept of General Items, further treatment is required, as introduced in Stage IV.

a. Input:

A list of Sellers, with a list of RFQs (sub-suppliers) for each seller.

K, the number of maximum allowed packages per one seller. The default value, which is Infinity, allowing all the possible packages.

S (optional), if K is a finite number, then the user must specify the most important items. Target quantities may be specified for the items.

The buyer 's RFQ (indicating the GIs, if any).

b. Output

Up to K (or all the possible) quantity-based packages per seller.

c. Algorithm outline

1. If (K=Infinity) then create all the basic packages.

2. Else, choose the most important items (defined in S) and allow combinations only for these items, when the other items will have a randomly chosen quantity value within their ranges. See the algorithm outline of Stage I. “Splitting” the buyer. In case target quantities were specified for items not in S, they may be used instead of a random

d. Discussion

It is recommended that a pre-processing check be done to verify that each of the buyer's items may be supplied by at least one seller.

Stage III. Evaluating the Packages

Partial evaluation of GP objective function (first level of GP only)

a. Input:

Buyer's GP model.

Buyer's Need Vector.

A seller's GP model.

A seller's offered package to evaluate.

b. Output

The value of the buyer's objective function first level.

c. Algorithm outline

1. Build a new GP model (GPₑᵥₐₗ):

Merge the seller's GP and the buyer's one, and set the objective of the new GP to be the first level of the buyer's objective.

2. Set values for the GI variables:

See discussion below.

3. Set values for the quantity variables:

For every quantity variable in the Need vector, set the relevant quantity value (add a hard-bound constraint to GPₑᵥₐₗ).

4. Adjust the objective function for all the variables:

a. For all the variables that are in the RFQ, multiply the relevant deviation variables (in the objective function) with the fraction quantity, which is the offering package quantity value divided by the Buyer Need Vector quantity value (the intuition here is discussed subsequently).

b. For missing variables in the offering package, deviation variables are set to zero.

5. Solve the GPₑᵥₐₗ model and return the value of its single level objective function.

d. Discussion

1. Note the following concerning the evaluation of a package:

The value of a package (price) is evaluated in the buyer's currency.

Still, a package is at all valid, if it conforms to the seller's constraints (as expressed in the sub-seller's GP).

Therefore, the calculation of price can be thought of as that of a “knowledgeable” sub-seller who knows his own restrictions as well as the buyer's GP.

2. The evaluation of a package is done according to the estimated final-total-quantity of the deal, as it appears in the Buyer's Need Vector. However, the DS algorithm may solve the problem with higher quantity values than those that appear in the Need vector, and in this case the value we calculate here is not accurate and is therefore an approximation.

Stage IV. Preparing GI Packages

a. Input:

Packages with their prices as computed in Stage III.

b. Output

Additional packages containing GIs.

c. Algorithm outline

For every basic package in the input:

1. For all the GIs in the Buyer's RFQ, g₁, . . . , gₕ

i. And for every basic package generated in stage II

a. Generate all the possible combined multiplicities of g₁, . . . , gₕ whose overall item total is within the package, leaving the residue values in the original items.

b. Keep the basic package's price with the new packages thus generated.

d. Discussion

We can enhance the support for GIs by trying to combine more than one sub-seller of the same seller. We may run the MRDS algorithm upon a specific seller, and generate semi-deals representing combined sub-sellers that can provide the GIs.

Stage V. Execute MRG

This stage is concerned with running the MRG algorithm, after preparing its input, to find an approximate solution to the best combination of packages (with minimum price).

1. MRG

a. Input

A buyer 's Need Vector.

A collection of quantity-based packages and their explicit prices from all sellers. These are the packages prepared in stages II and IV with their prices calculated in stage III.

b. Output

A Deal structure: A list of packages specifying a deal composed of sub-suppliers together with an identification of their original suppliers.

c. Algorithm outline

See the section describing MRG.

Note (MRG implementation issue): The Need Vector is already in terms of GIs and the MRG will work transparently using MRG-alpha values accordingly.

Stage VI. Final Deal Price for a “Split-Buyer”

Re-calculate the price of each package in the final deal, but this time instead of using the Need Vector uses the actual quantity values as calculated by MRG.

The final price is the sum of prices of the deal's packages.

Note: It might be instructive to display the difference between the two sums of the packages' prices (according to the Need Vector, and according to the MRG result) so as to hint at the accuracy of the approximation.

Stage VII. Final Overall Deal Price for the Buyer

Among all the deals of split buyers calculated in stage VI, obtain the best one for the buyer.

Reference is now made to FIG. 50, which is a simplified diagram of a process of deal splitting.

Discussion

A deal is made of several packages. We need to explain how to assign a value, or a score, to a deal. One desirable property is that rearranging the same package in a different way, as a deal split into sub-packages will not result in a different value. For this, we define the notion of a consistent deal composition scheme.

We would also like to combine different packages in a deal and weight each package's contribution according to the quantities of items it has. Naturally, the question arises as to whether this operation is the “right thing to do”. We show, however, that if our package evaluation function enjoys a certain desirable property, i.e., quantity-additive or good, then this relative weighting composition defines a consistent composition.

This lends credibility and legitimacy to our weighting scheme.

Our argument is expressed below through a series of definitions and claims:

Deal Composition Functions (for Deal Splitting Evaluation)

If a buyer's RFQ were to be satisfied by one package, then we can calculate the exact cost of the package in terms of the buyer's “currency”. However, as we are using deal-splitting techniques, we'll usually need many packages (offers from different sub-sellers) to cover the buyer's request. Below we explain how and when is it possible to split a deal and calculate its price by combining the prices of its packages. Suppose that:

The deal is a collection of packages P₁, . . . , Pₘ.

Each package Pᵢ is a collection of items I₁, . . . , Iₖ.

In package Pᵢ, each item Iⱼ is associated with values a_{i,j,1}, . . . , a_{i,j,at(j)} for attribute set Aⱼ₁, . . . , Aₐₜ₍ⱼ₎. Without loss of generality, for all j: Aⱼ₁ is the quantity attribute for item j, and its values a_{i,j,1} will be described using the symbol qᵢⱼ.

f(package): The value of a package is the sum of the values of the individual items in the package. That is, the package evaluation function evaluates each item independently of the other items, and as such, changing the attribute values of one item may not alter the evaluation of any other item in the package.

F_{f}(deal): The value of a deal is the sum of the values of the individual packages. As such, F_{f} is called a deal composition scheme.

Consistent Deal Composition Schemes

Consider a deal D=P₁, . . . , Pₘ where for each item j each attribute Aⱼᵢ, such that i>1 (i.e., the non-quantity attributes), has the same value (e.g., for item 5, all the date attributes have the same value).

Also consider a single package deal, whose only package is P_{D}, which for each item j, has the same attribute values as in D for the non-quantity attributes, and whose quantity attributes are

$${q}_{Dj} = {\sum }_{i = 1 … m}^{} {q}_{ij} .$$

That is, all the items of certain kind are coalesced.

We define a deal composition scheme to be consistent, when:

f(P_{D})=F_{f}(D).

Intuitively, this means that taking a package and breaking it quantity-wise while keeping the other attributes unchanged, results in a deal with the same value as that of the pre-split package.

Reasonable Package Evaluation Functions

First we define the following properties over functions for evaluating packages. Recall that a package evaluation function is the sum of individual items in the package.

1. A quantity independent function over packages, f_{α}, is such that given a package Pᵢ, then for each item t, given quantities qᵢⱼ=0, j≠t

f_{α}(0, . . . , a_{i,1,at(1)}, . . . , qᵢₜ, . . . , a_{i,t,at(t)}, . . . , 0, . . . , a_{i,k,at(k)})=f_{α}(0, . . . , a_{i,1,at(1)}, . . . , 1, . . . a_{i,t,zt(t)}, . . . , 0, . . . , a_{i,k,at,(k)})

2. Given a deal D=P₁, . . . , Pₘ, and a quantity independent function f_{α}, we define a quantity additive function over packages, fee such that given a package Pᵢ then for each item t, given quantities qᵢⱼ=0, j≠t,

f_{α*}(•)=(qᵢⱼ/Qⱼ)·f_{α}(•) where • denotes the argument in 1.

Notice that

$${Q}_{j} = {\sum }_{i = 1 … m}^{} {q}_{ij} ,$$

i.e., the total quantity of item j in all the packages of D.

3. A consistent function over packages, f_{β}, is such that given a package Pᵢ then for each item t, given quantities qᵢⱼ=0, j≠t

f_{β}(0, . . . , a_{i,1,at,(1)}, . . . , qᵢₜ, . . . , a_{i,t,at(t)}, . . . , 0, . . . , a_{i,k,at(k)})=qᵢₜ·f_{β}(0, . . . , a_{i,1,at(1)}, . . . , 1, . . . , a_{i,t,at(t)}, . . . , 0, . . . , a_{i,k,at(k)})

That is, the value of a package consisting of one item with quantity qᵢₜ, is qᵢₜ times the value of the same package with only one quantity purchased.

4. Given a quantity additive function f_{α*}, and a consistent function f_{β}, we define a good function over packages, as follows:

f_{good}(p)=f_{α*}(p)+f_{β}(p)

Claim. For every quantity additive function f the scheme F_{f} is consistent.

Claim. For every good function f the scheme F_{f} is consistent.

Note. The deal-splitting algorithms described in the DS section evaluate packages by requiring a price-per-unit specification per each item. However, in this section we are presenting an approach where a package is evaluated as a whole via a general mathematical method, such as GP models. Therefore, we ask for a weaker relationship between the items prices and the package's price in the form of the quantity-additive property.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description.

1. A platform for supporting negotiation between parties to achieve an outcome, the platform comprising:
a party goal program unit for:
defining respective party's goal program in respect of said outcome, said goal program comprising at least one objective function, having at least one goal expressed by at least one constraint comprising at least one of a deviation variable, a decision variable and a target value, said deviation variable being usable to form said objective function,
for associating each of said objective functions with a level of importance, and
for assigning each of said goals an importance weighting within its level, and
for assigning to deviation variables within each objective function a respective importance weighting, said party goal program unit comprising a party input unit for allowing a party to provide data for a respective goal program,
a negotiator associated with said party goal program unit for receiving a goal program of at least one of said respective parties, and carrying out negotiations using said at least one goal program by considering said objective functions levelwise in the respective goal program to approach at said mutually compatible outcome by carrying out minimization at a respective level, therewith to form an offer,
an output unit for offering said offer to said respective parties,
a response receiver for receiving from respective parties either counter offers or acceptances, said response receiver being operable to provide counter offers expressed as modified goal programs to said goal program negotiator for further negotiation, said platform advancing to a next level upon an acceptance.

2. The platform of claim 1, further comprising a goal program unifier, associated with said party goal program unit for receiving goal programs of respective parties, and carrying out unification of said goal programs to determine whether two goal programs have a common field of interest from which a mutually compatible outcome is derivable.

3. The platform of claim 1, wherein said party goal program unit comprises a constraint arrangement unit for arranging goal constraints levelwise in a first party's goal program such that conditional weakening from said outcome for a goal in a trade-off involves strengthening of other goals within the same level of said first party.

4. The platform of claim 1, wherein said goal program unit comprises a trade-off unit for arranging goals levelwise in a first party's goal program such that goals of a given level are negotiated with goals of a same level of another party.

5. The platform of claim 1, wherein said party goal program unit is operable to place said objective functions in a hierarchy according to the respective associated level of importance, and to express each goal in terms of at least one decision variable and at least one deviation variable.

6. The platform of claim 5, wherein said party goal program unit is operable to use data from said party data input unit to apply coefficients to said deviation variables.

7. The platform of claim 6, wherein said party goal program unit is operable to apply user input to provide different values of coefficients to said deviation variables for deviations from a corresponding target value in respective positive and negative directions.

8. The platform of claim 7, wherein said party goal program unit is operable to apply said user input to apply said coefficient values to define any one of a group comprising:
a strong one sided goal,
a weak one sided goal,
a complex single sided goal,
a simple two sided goal,
a complex two sided goal,
a simple first side-complex second side goal,
a simple two-sided goal with an range of indifference,
a complex two sided goal with an range of indifference, and
a simple first side-complex second side goal with an indifferent range.

9. The platform of claim 1, wherein at least one goal comprises a series of discrete values.

10. The platform of claim 9, wherein said party goal program unit is operable to apply user input to formulate weightings for respective ones of said discrete values, thereby to express a preference between said discrete values.

11. The platform of claim 5, wherein at least one goal constraint comprises a continuous variable, and wherein said party goal program unit is operable to apply user input to determine whether said at least one of said goal's deviation variables is to be maximized or to be minimized.

12. The platform of claim 5, wherein said negotiator is operable to set a maximum bound per deviation.

13. The platform of claim 5, wherein said negotiator is operable to modify said goal program.

14. The platform of claim 5, wherein said negotiator is operable to modify said goal program by at least one of adding and deleting objective functions.

15. The platform of claim 5, wherein said negotiator is operable to modify said goal program by at least one of adding and deleting constraints.

16. The platform of claim 5, wherein said negotiator is operable based on a received offer, to modify said objective function via respective constraints.

17. The platform of claim 5, wherein said negotiator is operable to carry out minimization for an expression comprising first ones of said deviation variables and then to modify at least one of said constraints for a further minimization stage.

18. The platform of claim 1, wherein said party input unit is configured to receive data from a user interface.

19. The platform of claim 1, wherein said party input unit is configured to receive data from a software agent.

20. The platform of claim 1, wherein said party input unit is operable to identify parameter data missing from an input and wherein said party goal program unit further comprises a default value generator for generating said missing parameter.

21. The platform of claim 1, wherein said party input unit is operable to identify parameter data missing from an input and wherein said party goal program unit further comprises a default register of values for expected parameters, said default register being associated with said party input unit, to provide said missing parameters.

22. The platform of claim 1, wherein said party input unit is operable to request lower and upper bounds for at least some of said decision variables.

23. The platform of claim 22, wherein said party goal program unit further comprises a trade-off unit, said trade-off unit being operable to use said upper and lower bounds to express deviations of a respective decision variable from a target value relative to an interval defined by said lower and said upper bound, thereby to render said deviations subject to comparison by said negotiator.

24. The platform of claim 1, wherein said party input unit is operable to request a decision variable interval, and a penalty specification for deviating from a target within said interval, and wherein said unifier is operable to define a working interval as an intersection between respective intervals of two parties.

25. The platform of claim 24, wherein said trade-off unit is operable to determine that a target value of one of said objective functions is outside said working interval, and to modify said target value to approach a closest boundary of said working interval.

26. The platform of claim 25, wherein said trade-off unit is operable to apportion said penalty in accordance with said target value modification.

27. The platform of claim 26, wherein said intersection is a point.

28. The platform of claim 26, wherein said party goal program unit comprises operability for determining that an intersection is small to the satisfaction of respective parties and, when said intersection is recognized as small, said negotiator is operable to select a point within said intersection being a midpoint between respective target values.

29. The platform of claim 23, wherein said negotiator is operable to measure deviations within said interval as a fraction of a total size of said interval.

30. The platform of claim 29, wherein said party goal program unit is operable to obtain importance values for deviations from said target and wherein said negotiator is operable to use said importance value as a multiplier to weigh said deviation.

31. The platform of claim 24, wherein said unifier is operable to identify intersections that are small and distant from a target value compared to one of said objective functions and large and inclusive of a target value compared to another of said objective functions, to set an effective target at the closest intersection boundary and to set a transformed deviation as giving an original deviation when multiplied by the effective target and then added to the difference between the old target and the effective target, to produce a result which is divided by the old target.

32. The platform of claim 1, wherein said party input unit is operable to permit a party to define at least one single dimension interval goal in respect of said outcome, and to associate said goal with a range of indifference having an upper bound and a lower bound, a first weighting value for deviations below said lower bound, a second weighting value for deviations above said upper bound and a relative importance for said goal,
said unifier being operable to use said range of indifference, said weightings and said relative importance to unify said at least one goal with at least one other goal to determine said compatibility.

33. The platform of claim 32, wherein said at least one other goal is a corresponding goal in a goal program of an opponent.

34. The platform of claim 1, wherein said party input unit is operable to permit a party to define a two dimensional trade-off goal constraint by entering two two-dimensional points, said party goal program unit being operable to define a trade-off line between said two points.

35. The platform of claim 34, wherein said party input unit is operable to permit a party to define weights for deviation from said trade-off line.

36. The platform of claim 34, said party input unit being operable to permit a party to define a relative importance for said two dimensional trade-off goal constraint.

37. The platform of claim 36, wherein said party input unit is operable to permit a party to associate said two dimensional trade-off goal constraint levelwise with other goal constraints.

38. The platform of claim 37, wherein party enterable weightings, said relative importance, and an associated level are usable by said trade-off unit to insert additional terms to said objective function of a respective level.

39. The platform of claim 1, wherein said party input unit is operable to allow a party to define at least one single dimension two-point goal in respect of said outcome, and to associate said goal with an upper point of preference, and a lower point of preference, a first weighting value for deviations below said lower point of preference, and a second weighting value for deviations above said upper point of preference, said goal program unit being operable to provide a first and a second included weighting to a region included between said points of preference by assigning a first included weighting value below said upper point of preference and a second included weighting value above said lower point of preference and defining an overall weighting within said region as a minimum of said weighting values.

40. The platform of claim 39, wherein said party input unit is operable to permit a party to define a relative importance for said single dimensional two point goal.

41. The platform of claim 40, wherein said party input unit is operable to permit a party to associate said single dimensional two point goal levelwise with other goals.

42. The platform of claim 41, wherein said weights and said relative importance is usable by said trade-off unit to insert additional terms into respective objective functions.

43. The platform of claim 1, wherein said party input unit is operable to permit a user to define a piecewise linear two-dimensional goal by entering at least three two-dimensional points, said party goal program unit being operable to define a trade-off line between said three points,
said trade-off unit being operable to apply penalty values to points away from said trade-off line in accordance with respective distances from said line.

44. The platform of claim 43, wherein said party input unit is operable to permit a user to define a first deviation weight for deviating in a first direction from said trade-off line and a second deviation weight for deviating in a second direction therefrom.

45. The platform of claim 1, wherein said party input unit is operable to permit parties to define goals comprising pairwise variable trade-offs having at least two points and a trade-off function defined for distance from a line joining said points.

46. The platform of claim 45, wherein said party goal program unit is operable to prevent inconsistent trade-offs to be defined within the platform by preventing said party input unit from accepting more than one trade-off from referring, directly or indirectly, to any given pair of decision variables.

47. The platform of claim 45, wherein said party goal program unit is operable to warn users of inconsistent trade-offs by outputting a warning whenever a trade-off being entered has already been determined directly or indirectly.

48. A platform according to claim 1, wherein said party input unit further comprises a trade-off unit, wherein said party input unit is further operable to allow a party to define disjunctive constraints in respect of decision variables, and wherein said goal program unit comprises a disjunctive constraint processor, associated with said trade-off unit, for translating a disjunctive expression into a plurality of conjoined expressions, and wherein said unifier is operable to utilize said conjoined expressions to unify said at least one disjunctive constraint with other constraints to determine said compatibility.

49. The platform of claim 48, wherein said disjunctive expression comprises a series of relationships including equality relationships.

50. The platform of claim 49, wherein said disjunctive constraint processor is operable to carry out said translation by expressing at least one of said equality relationships as the union of two corresponding inequalities that meet at a point of equality of said equality relationship.

51. The platform of claim 49, wherein said disjunctive constraint processor is operable to define binary variables for said relationships, for setting wherever said relationships are satisfied, and wherein said negotiator is operable to sum said variables to determine a satisfaction level for said disjunctive constraint.

52. The platform of claim 51, wherein said trade-off unit is operable to set a requirement of a minimum number of satisfied relationships by said negotiator.

53. The platform of claim 1, wherein:
said party input unit is further operable to permit each party to define weighting values for a discrete variable predefined per outcome, for use in said goal program definition, and
said negotiator is operable to carry out negotiation of said goal programs by considering said weighting values to arrive at an outcome comprising an offered one of said values.

54. The platform of claim 53, wherein said party goal program unit is operable to use said weightings for respective values of said discrete variable to arrange values for said variable in an order of desirability, said order being usable by said negotiator to arrive at said offered one of said discrete values.

55. The platform of claim 54, wherein said party goal program unit is operable to use said values and respective weightings and continuous relaxation variables to build summation functions, therefrom to create goal constraints, for use by said platform.

56. The platform of claim 55, wherein said negotiator is operable to attempt offer formation by converting said relaxation variables into binary values, thereby setting one of said binary variables to one and the remainder to zero, and thereby determining said discrete value.

57. The platform of claim 56, wherein said negotiator is operable to reattempt offer formation.

58. The platform of claim 1, wherein said party goal program unit is operable to represent date information as accumulated units of time from a threshold starting date, and further to modify said dates relative to upper and lower bounds entered via said party input unit.

59. The platform of claim 58, wherein said units of time are minutes.

60. A platform according to claim 1, wherein said party input unit is further operable to allow input of variables in association with said objective functions and a linkage between a first and a second of said variables, said linkage defining a trade-off line and deviations thereof with respect to said target values, said negotiator being operable to use said series of variables including said trade-off line to negotiate an outcome in respect of said at least one objective function with other objective functions, thereby to arrive at formation of an offer.

61. The platform of claim 60, further comprising a trade-off unit operable to express said second variable as a function of said first variable, thereby to represent said linkage, and wherein said negotiator is operable to represent deviations from respective target values as deviations from the target value of said first variable.

62. The platform of claim 60, further comprising a trade-off unit operable to express said trade-off as separate deviation variables in respect of said first variable and in respect of said second variable.

63. The platform of claim 60, wherein said trade-off unit is operable to permit an association of a relative importance level to said trade-off.

64. The platform of claim 60, wherein said trade-off unit is operable to calculate a relative importance level for said trade-off as an average of respective relative importance of goals involving said first and second variables.

65. The platform of claim 1, wherein said unifier comprises a goal program generalizer to form a modification of received goal programs for use in said negotiation.

66. The platform of claim 1, wherein said party goal program unit is operable to translate said input received from said party input unit into said objective functions and respective constraints on said objective functions within said goal program, said negotiator comprising an optimizer to find best values for said objective functions and constraints, therewith to obtain a best solution for the goal program for output as a first offer, and then iteratively to produce further solutions until an offer is accepted, thereby to achieve said outcome.

67. The platform of claim 66, wherein said negotiator comprises a percentage modifier for taking ones of said objective functions in turn, and modifying them by a predetermined percentage, thereby to produce said further solutions.

68. The platform of claim 67, wherein said percentage modifier is settable to take each of said objective functions in turn beginning with a most important objective function, until a solution is accepted.

69. The platform of claim 67, wherein said objective functions are arranged in levels and said percentage modifier is settable to take an objective function of a first of said levels only.

70. The platform of claim 66, wherein said negotiator comprises a worst case calculator for determining a worst case level for ones of said objective functions, thereby to obtain a worst acceptable offer.

71. The platform of claim 66, wherein said deviation variables are arranged pairwise, said negotiator comprises an arbitrary case calculator for taking one of each said pair of deviation variables, attaching thereto an arbitrary coefficient, creating therefrom an objective function and using a minimization of said objective function to generate an arbitrary solution.

72. The platform of claim 70, wherein said negotiator further comprises an average case calculator, associated with said optimizer and with said worst case calculator, for
taking said best solution and said worst solution, each solution having corresponding values,
associating ones of said corresponding values, and
constraining variables of said goal program towards an average of each of said corresponding values, therewith to provide an average solution.

73. The platform of claim 72, wherein said goal program objective functions are arranged levelwise and said average case calculator is operable to carry out said associating and said constraining successively levelwise, thereby to produce said series of iterative solutions.

74. The platform of claim 1, wherein said negotiator comprises a solution sorter for comparing goal program solutions by solving said goal program constrained by each one of a series of solutions and ranking the solutions, said negotiator being operable to use said ranking to apply preference to different solutions.

75. The platform of claim 74, wherein said negotiator further comprises a thresholder associated with said solution sorter for applying a threshold to said evaluations to exclude ones of said series of solutions.

76. The platform of claim 75, wherein said solution sorter further comprises a solution completer for applying best values to incompleted variables in incomplete ones of said solutions, thereby to allow said goal program to be evaluated for said incomplete solutions.

77. The platform of claim 74, wherein said solution sorter is settable to find the best solution from said series of solutions by identifying the highest ranked solution and discarding the remaining solutions.

78. The platform of claim 74, wherein said solution sorter comprises a memory, set to hold a predetermined number of solutions, and a comparator to compare a new solution with each solution in said memory, and further comprising a control unit for adding said new solution to said memory if its evaluation is larger than any solution in said memory, and for discarding a lowest ranked solution in said memory.

79. The platform of claim 1, wherein said goal program unit comprises a data input unit for receiving user defined output values, and wherein said goal program unit is operable to set said output values as single value constraints and to flag said constraints as unchangeable.

80. The platform of claim 79, wherein said goal program unit is operable to output an error indicator if said single value constraints render said goal program insoluble.

81. The platform of claim 1, wherein the unifier further comprises a goal program input unit for receiving a local party's goal program and an opponent's goal program to be unified therewith, said goal programs comprising objective functions associated with deviation variables of goal constraints and being arranged in levels, and the negotiator further comprises:
an optimizer for finding best solutions to goal programs, connected to find best values for said objective functions and constraints of said local party's goal program levelwise, and
a worst case calculator for finding worst solutions for goal programs, connected to find worst values for said objective functions and constraints of said opponent's goal program levelwise,
said negotiator being operable to:
use said optimizer and said worst case calculator in succession, level by level to produce successive value sets for evaluation therefrom to form level by level unification offers, and
advance from one level to another level only following acceptance by said parties of a unification offer regarding a previous level.

82. The platform of claim 81, wherein level by level unification offers each comprise an exchange of offers between said parties.

83. The platform of claim 81, wherein said negotiator comprises a constraint updater for updating constraints upon advance from one level to another level in accordance with said respective acceptance.

84. The platform of claim 81, wherein said negotiator comprises a constraint updater for updating goal program constraints.

85. The platform of claim 84, wherein said constraint updater is operable to update goal program objective functions.

86. The platform of claim 81, wherein said negotiator further comprises an offer improver operable to provide an improved offer by making at least one change in a selected one of said variables to bring about an improvement in the evaluation of the opponent's goal program.

87. The platform of claim 86, wherein said change in said variable is calculated such that said improvement is a predetermined proportion of a difference between a previous offer made and a best possible evaluation made for the opponent.

88. The platform of claim 87, wherein said offer improver is operable to use a value of said selected variable in a last opponent's offer to moderate said change.

89. The platform of claim 87, wherein said offer improver is operable to calculate a protection value, and to use said protection value to limit a reduction in the evaluation of the local party's goal program as a consequence of said improvement to the opponent's goal program evaluation.

90. The platform of claim 89, wherein said protection value is a proportion of the difference between a worst case evaluation of the local party's goal program and an evaluation of a last previous offer thereof.

91. The platform of claim 81, further comprising an offer improver for taking goal program values of a previous local party offer and one value in turn from a previous opponent offer, testing the opponent value against local constraints, and if it fits within the constraints then substituting it into the previous local party offer thereby to provide an improved offer.

92. The platform of claim 1, wherein the negotiator further comprises a goal program input unit for receiving a local party's goal program, said goal program comprising objective functions associated with deviation variables of goal constraints and being arranged in levels, and said negotiator further comprises:
an optimizer for finding best solutions to goal programs, connected to find best values for said objective functions of said local party's goal program levelwise, and
a stay close processor for determining variable improvement directions from monitoring of received offers from said opponent and carrying out value perturbations in said directions,
said negotiator being operable to:
use said optimizer to produce a first offer for a first level,
to advance from one level to another level only following acceptance by said parties of an offer regarding a previous level, and
use said stay close processor to produce a subsequent offer, thereby to arrive at said outcome.

93. The platform of claim 92, wherein said stay close processor is operable for use during offer exchange within a level.

94. The platform of claim 92, wherein said negotiator comprises a constraint updater for updating constraints upon advance from one level to another level in accordance with said respective acceptance.

95. The platform of claim 92, wherein said negotiator further comprises
a gap value determiner, for determining a gap for use in offer improvement, and
a value improver, associated with said gap value determiner, for inserting a predetermined proportion of said gap as a constraint of said goal program, and wherein said stay close processor is associated with said value improver thereby to apply a predetermined gap proportion in said direction to provide an improved offer.

96. The platform of claim 95, wherein said stay close processor is operable to monitor two successive opponent offers for value changes therebetween, and to assign to each respective changing variable a weight for use in providing an improved offer, the magnitude of said weight being selected in accordance with a monitored relative size of a corresponding value change of said opponent.

97. The platform of claim 95, wherein said gap is a constant.

98. The platform of claim 97, wherein said constant is a difference between a best value and a worst value of a corresponding variable.

99. The platform of claim 95, wherein said gap is a difference between a last local proposal and a last opponent proposal.

100. The platform of claim 1, further comprising a negotiation necessity tester, associated with said unifier, for joint solving of said local and said other goal program to form a joint goal program comprising optimal solutions for each of said local and said other goal program, said negotiation necessity tester being set to determine whether there lies a single solution that includes both optimal solutions within said common ground, and if so, to inhibit passing of said goal programs to said negotiator.

101. The platform of claim 1, further comprising a mediation unit callable by both parties levelwise during said negotiations, said mediation unit being operable to retain agreed objective function results of previously solved levels and to apply a summation formula to solve a current level.

102. The platform of claim 101, wherein said summation formula as an objective function is:
$$\{ \frac{\sum {w}_{kj}^{+} \cdot {δ}_{kj}^{+} + \sum {w}_{kj}^{-} \cdot {δ}_{kj}^{-}}{\sum {w}_{kj}^{+} + \sum {w}_{kj}^{-}} \} + \{ \frac{\sum {v}_{kj}^{+} \cdot {γ}_{kj}^{+} + \sum {v}_{kj}^{-} \cdot {γ}_{kj}^{-}}{\sum {v}_{kj}^{+} + \sum {v}_{kj}^{-}} \}$$
wherein the respective sides of the summation represent the respective parties, k is a current level, j is is used as a running index on deviation variables at said current level, + and − represent respective sides of a target value, w and v are respective parties weighting factors, and δ and γ are respective parties deviation variables.

103. The platform of claim 1, further comprising a mediation unit, callable by both parties during said negotiations, said mediation unit being operable to stop operation of said negotiator, apply a summation formula to provide a median solution between respective goal programs, and to provide said median solution as an offer to both parties.

104. The platform of claim 102, wherein each goal program is expressed as a series of decision variables each having an upper bound, a lower bound, a target value and one or more constraints, the platform further comprising a form offer unit for providing a compromise offer to the parties, the unit being operable to assign to each of the goal programs a weighting such that the sum of the weightings is unity for each variable, and to calculate the offer by minimizing relative deviations for each variable over said goal programs weighted according to said assigned weightings.

105. The platform of claim 1, further comprising a discrete variable form offer unit operable to transform values of said discrete variable into a continuous domain, to carry out minimization in light of goal program objective functions of said two parties in said continuous domain, and to transform the minimization results related to the continuous variable back to discrete values, thereby to provide a form offer.

106. The platform of claim 1, further comprising an item catalog for storing a plurality of items to be evaluated in terms of values of said objective functions, wherein said negotiator is operable to provide offers in terms of nearest items in said catalog to user prescribed objective function values.

107. The platform of claim 106, wherein said negotiator comprises:
an item manager for determining which items of said catalog are currently within the scope of negotiations,
a first stage manager, associated with said item manager, for managing levelwise goal program negotiation to successively reduce the number of said items within said scope to a predetermined threshold number of items,
a second stage manager, associated with said item manager, for managing levelwise program negotiation to produce successive offers, and
an item associator, connected to said second stage manager and to said item manager, for expressing said successive offers in terms of items within said scope.

108. The platform of claim 107, wherein said item manager is operable to measure distance from a prescribed specification in terms of a goal program of said prescribing user.

109. The platform of claim 107, wherein said item manager is operable to measure distance from a prescribed specification in terms of a goal program of another prescribing user.

110. The platform of claim 107, wherein said item manager is operable to measure a distance from a prescribed specification in terms of a joint goal program.

111. The platform of claim 107, wherein said item manager is operable to measure distance from a prescribed specification initially in terms of a local goal program, to order said items and iteratively to remove most distant items.

112. The platform of claim 106, comprising compatibility restraints with a second item.

113. The platform of claim 106, comprising compatibility constraints amongst a plurality of items.

114. The platform of claim 106, wherein said negotiator is operable to carry out a semijoin operation to eliminate items of a first type for which no matching items of a second type are available.

115. The platform of claim 106, wherein said negotiator is operable to carry out a semijoin operation to eliminate items of a first type for which no matching items of a plurality of types are available.

116. The platform of claim 1, further comprising an offer delay timer, associated with said negotiator, for introducing determinable delays between issuance of successive offers to an opponent.

117. The platform of claim 116, wherein said offer delay timer is operable to set successively increasing delays.

118. The platform of claim 117, wherein said offer delay timer is operable to set delays to change levelwise.

119. The platform of claim 116, wherein a magnitude of said delay is based on a relative change between succeeding opponent offers.

120. The platform of claim 116, wherein said offer delay timer is operable to set user determined delays.

121. The platform of claim 1, wherein at least one of said goals comprises a dynamically changing value.

122. The platform of claim 1, wherein at least some of said constraints are associated with dynamically changing values.

123. A platform for supporting negotiation between parties to achieve an outcome, the platform comprising:
a party goal program unit comprising a party input unit for allowing each party to define a plurality of goals in respect of said outcome, and to associate each of said goals with a respective level of importance, therefrom to form for each party a goal program,
said party input unit being operable to obtain a target value and upper and lower bounds relating to at least one of said goals, said party goal program unit being operable to use said upper and lower bounds to express deviations from said target values in relative terms, thereby to render deviations from different goals' targets comparable.

124. The platform of claim 123, further comprising a negotiator, operable to define an interval between said upper bound and said lower bound and to measure deviations within said interval as a fraction of a total size of said interval.

125. A platform for supporting negotiation between parties to achieve an outcome, the platform comprising:
a party goal program unit comprising a party input unit for allowing a party to define a plurality of goals in respect of said outcome, and to associate at least one of said goals with a target value, an acceptable interval, and a penalty for deviation from said target value, and
a unifier, for determining common ground between said goal program and at least one other goal program,
and a negotiator, operable to form offers within said common ground by mutual quantifying of an objective function of said at least one goal program with objective function of said at least one other goal program having a target value and an interval, by determining an intersection between said intervals and if said target value is outside said intersection then moving said target value by a deviation amount to a closest boundary of said intersection, said negotiator further being operable to apportion said penalty for deviation amount in accordance with an extent of said deviation of said target value.

126. The platform of claim 125, wherein said intersection is a point.

127. The platform of claim 125, wherein said party goal program unit comprises operability for determining that an intersection is small to the satisfaction of respective parties and, when said intersection is recognized as small, said unifier is operable to select a point within said intersection being a midpoint between respective target values.

128. The platform of claim 125, wherein said negotiator is operable to measure deviations within said interval as a fraction of a total size of said interval.

129. The platform of claim 128, wherein said party goal program unit is operable to obtain importance values for deviations from said target and is further operable to use said importance values as a multiplier to measure said deviation.

130. The platform of claim 125, wherein said party goal program unit further comprises a trade-off unit, said trade-off unit being operable to:
recognize intersections that are small and distant from the target value of said at least one goal and at the same time large and inclusive of a target value of said other goal,
set a unified target at the intervening intersection boundary at a determinable deviation from each target,
calculate the deviation of said unified target from said distant target,
multiply said deviation by a value of the unified target,
add the result of said multiplication to the difference between values of the distant target and the unified target, and
divide the result by a value of the distant target, thereby to produce a transformed deviation value for said at least one goal.

131. The platform of claim 130, wherein said trade-off unit is further operable to normalize said deviation.

132. The platform of claim 130, wherein said trade-off unit is operable to normalize said transformed deviation.

133. The platform of claim 125, further comprising an offer delay timer, associated with said negotiator, for introducing determinable delays between issuance of successive offers to an opponent.

134. The platform of claim 133, wherein said offer delay timer is operable to set successively increasing delays.

135. The platform of claim 134, wherein said offer delay timer is operable to set delays to change levelwise.

136. The platform of claim 133, wherein a magnitude of said delay is based on a relative change between succeeding opponent offers.

137. The platform of claim 133, wherein said offer delay timer is operable to set user determined delays.

138. A platform for supporting negotiation between parties to achieve an outcome, the platform comprising:
a party goal program unit comprising a party input unit for allowing a party to define at least one goal program having a plurality of goals in respect of said outcome, and to associate a goal constraint of at least one of said goals with a range of indifference having an upper bound and a lower bound, a first weighting value for deviations below said lower bound, a second weighting value for deviations above said upper bound and a relative importance for said goal constraints,
and a negotiator, associated with said goal program unit, said negotiator being operable to use said range of indifference, said weightings and said relative importance to obtain an outcome for said at least one goal in view of other goals, by producing successive offers.

139. The platform of claim 138, wherein said party input unit further comprises a prioritizer for allowing said goal to be assigned a level to define a level by level relationship with other objective functions.

140. The platform of claim 139, wherein said party goal program unit further comprises a trade-off unit, said trade-off unit being operable to use said relative importance to establish contributions of deviation variables of respective goal constraints to a corresponding objective function.

141. The platform of claim 138, further comprising an offer delay timer, associated with said negotiator, for introducing determinable delays between issuance of successive offers to an opponent.

142. The platform of claim 141, wherein said offer delay timer is operable to set successively increasing delays.

143. The platform of claim 142, wherein said offer delay timer is operable to set delays to change levelwise.

144. The platform of claim 141, wherein a magnitude of said delay is based on a relative change between succeeding opponent offers.

145. The platform of claim 141, wherein said offer delay timer is operable to set user determined delays.

146. A platform for supporting negotiation between parties to achieve an outcome, the platform comprising:
a party goal program unit comprising a party input unit operable to permit a party to define a two dimensional trade-off goal constraint by entering two two-dimensional points, said party goal program unit being operable to define a trade-off line between said two points, and
a negotiator, associated with said goal program unit, said negotiator being operable to use said trade-off line to solve said goal program containing said at least one trade-off goal constraint taking into account other constraints to arrive at said outcome via a series of successive offers.

147. The platform of claim 146, wherein said party input unit is operable to permit a party to define weights for deviation from said trade-off line.

148. The platform of claim 146, wherein said party input unit is operable to permit a party to define a relative importance for said two dimensional trade-off goal constraint.

149. The platform of claim 148, wherein said party input unit is operable to permit a party to associate said two dimensional trade-off goal constraint levelwise with other goal constraints.

150. The platform of claim 149, wherein said relative importance is usable by said negotiator to establish contributions of deviation variables of respective goal constraints to a corresponding objective function.

151. The platform of claim 146, wherein said party goal program unit further comprises a trade-off line evaluator for assigning a trade-off penalty value to points off said trade-off line.

152. The platform of claim 151, wherein said party goal program unit further comprises a scaling unit, associated with said trade-off line evaluator for scaling said trade-off penalty value, to produce a scaled penalty value.

153. The platform of claim 146, further comprising an offer delay timer, associated with said negotiator, for introducing determinable delays between issuance of successive offers to an opponent.

154. The platform of claim 153, wherein said offer delay timer is operable to set successively increasing delays.

155. The platform of claim 154, wherein said offer delay timer is operable to set delays to change levelwise.

156. The platform of claim 153, wherein a magnitude of said delay is based on a relative change between succeeding opponent offers.

157. The platform of claim 153, wherein said offer delay timer is operable to set user determined delays.

158. A platform for supporting negotiation between parties to achieve an outcome, the platform comprising:
a party goal program unit comprising a party input unit for allowing a party to define at least one single dimension two-point goal constraint in respect of said outcome, and to associate said goal constraint with an upper point of preference, and a lower point of preference, a first weighting value for deviations below said lower point of preference, and a second weighting value for deviations above said upper point of preference, said goal program unit being operable to provide weightings to a region included between said points of preference by assigning said first weighting value below said upper point of preference and said second weighting value above said lower point of preference and defining an overall weighting within said region as a minimum of said weighting values,
and a negotiator, associated with said goal program unit, said negotiator being operable to use said included region, said weightings, and said minimum to consider said at least one goal constraint with other goal constraints to arrive at successive offers to achieve said outcome.

159. The platform of claim 158, wherein said party input unit is operable to permit a party to define a relative importance for said single dimensional two point goal constraint.

160. The platform of claim 159, wherein said party input unit is operable to permit a party to associate said single dimensional two point goal constraint levelwise with other goal constraints.

161. The platform of claim 160, wherein said relative importance is usable by said unifier to establish contributions of deviation variables of respective goal constraints to a corresponding objective function.

162. The platform of claim 158, further comprising an offer delay timer, associated with said negotiator, for introducing determinable delays between issuance of successive offers to an opponent.

163. The platform of claim 162, wherein said offer delay timer is operable to set successively increasing delays.

164. The platform of claim 163, wherein said offer delay timer is operable to set delays to change levelwise.

165. The platform of claim 162, wherein a magnitude of said delay is based on a relative change between succeeding opponent offers.

166. The platform of claim 162, wherein said offer delay timer is operable to set user determined delays.

167. A platform for supporting negotiation between parties to achieve an outcome, the platform comprising:
a party goal program unit comprising a party input unit operable to permit parties to define goal constraints comprising pairwise variable trade-offs having at least two points and a trade-off function for deviating from a line drawn between said points, wherein said party goal program unit is operable to prevent inconsistent inclination values to be defined within the platform by preventing said party input unit from accepting more than one trade-off that refers directly or indirectly to a same pair of variables,
and a negotiator for negotiating with other parties via goal programs to achieve an outcome consistent with said constraints.

168. A platform for supporting negotiation between parties to achieve an outcome, the platform comprising:
a party goal program unit comprising a party input unit operable to permit parties to define constraints relating to pairwise trade-offs having at least two points and a trade-off function for deviations from a line extending therebetween, wherein said party goal program unit is operable to warn users of inconsistent inclination values by outputting a warning whenever a trade-off being entered refers directly or indirectly to a pair of variables already included in a previously entered trade-off, and
a negotiator for negotiating with other goal programs to achieve an outcome consistent with said constraints.

169. A platform for supporting negotiation between parties to achieve an outcome, the platform comprising:
a party goal program unit comprising a party input unit for allowing a party to define at least one objective function in respect of said outcome, and to associate said objective function with a series of variables and disjunctive constraints, said goal program unit comprising a disjunctive constraint processor for translating a disjunctive expression into at least one linear conjunctive expression,
and a negotiator, associated with said goal program unit, said negotiator being operable to use said series of variables including said linear conjunctive expression to negotiate an outcome consistent with said goal program and with other goal programs.

170. The platform of claim 169, wherein said disjunctive expression comprises a series of relationships including equality relationships.

171. The platform of claim 170, wherein said disjunctive constraint processor is operable to carry out said translation by expressing at least one of said equality relationships as the union of two corresponding inequalities that meet at a point of equality of said equality relationship.

172. The platform of claim 170, wherein said disjunctive constraint processor is operable to define binary variables for said relationships, for setting wherever said relationships are satisfied, and wherein said negotiator is operable to sum said variables to determine a satisfaction level for said constraint.

173. The platform of claim 172, wherein said party goal program unit is operable to set a requirement of a minimum number of satisfied relationships for use by said negotiator.

174. A platform for supporting negotiation between parties to achieve an outcome, the platform comprising:
a party goal program unit comprising a party input unit for allowing each party to define a plurality of goals in respect of said outcome, each goal comprising a plurality of deviation variables associated with decision variables, therefrom to form for each party a goal program, wherein a variable having discrete values is predefined, and wherein said party input unit is operable to receive allowed discrete values of said variable for use in said objective function definition,
a unifier, associated with said party goal program unit for receiving goal programs of respective parties, said goals including discrete values of said variable, said unifier being operable to carry out unification of said goal programs by considering said discrete values to arrive at a common region of said discrete variables amongst said goal programs, and
a negotiator operable to utilize fulfillment levels associated with said discrete values to produce successive offers to converge on an outcome within said common region.

175. The platform of claim 174, wherein said party input unit is operable to accept weightings for respective discrete values of said variable, said weightings being usable to arrive at said fulfillment levels.

176. The platform of claim 175, wherein said party goal program unit is operable to use said discrete values and respective weightings to build summation functions, therefrom to express said variable in quantitative manner.

177. The platform of claim 176, wherein said party goal program unit is further operable to normalize said summation function by dividing by a largest one of said weightings.

178. The platform of claim 176, wherein said discrete values comprise binary zero-one variables, said binary zero-one variables serving as multipliers of respective weightings in said summation functions, wherein said negotiator is operable to reach said outcome by setting the binary zero-one variable of one of said discrete values to one and the remainder to zero, and then to calculate said summation functions, thereby to obtain a respective fulfillment level for each goal.

179. The platform of claim 178, wherein said unifier is operable to reattempt unification by setting binary zero-one variables of different ones of said discrete values to one, thereby to find a discrete value of said variable which maximizes said fulfillment levels, for setting as said unified value.

180. The platform of claim 179, wherein said negotiator is operable to use a continuous variable as a transformation of said binary zero-one variables for carrying out said negotiating, said continuous variable being transformable back into said binary zero-one variables to express said outcome.

181. The platform of claim 174, further comprising an offer delay timer, associated with said negotiator, for introducing determinable delays between issuance of successive offers to an opponent.

182. The platform of claim 181, wherein said offer delay timer is operable to set successively increasing delays.

183. The platform of claim 182, wherein said offer delay timer is operable to set delays to change levelwise.

184. The platform of claim 181, wherein a magnitude of said delay is based on a relative change between succeeding opponent offers.

185. The platform of claim 181, wherein said offer delay timer is operable to set user determined delays.

186. A platform for supporting negotiation between parties to achieve an outcome, the platform comprising:
a party goal program unit comprising a party input unit for allowing a party to define at least one objective function and at least one associated goal constraint in respect of said outcome, and to associate said goal constraint with at least two variables, said party input unit further allowing input of a linkage between a first and a second of said variables, said linkage defining a trade-off of deviations with respect to said target values,
a unifier, associated with said goal program unit, said unifier being operable to use said series of variables to unify said at least one goal constraint with other constraints to find a common area of interest, and
a negotiator, associated with said unifier, for using said trade-off to find a mutually acceptable outcome within said common area.

187. The platform of claim 186, wherein at least one of said two variables has a target value.

188. The platform of claim 186, wherein said party goal program unit is operable to express said second variable as a function of said first variable, thereby to represent said linkage, and further to represent deviations from respective target values as deviations from the target value of said first variable.

189. The platform of claim 188, wherein said deviations are weighted.

190. The platform of claim 186, wherein said party goal program unit is operable to express said trade-off as separate deviation variables in respect of said first variable and in respect of said second variable wherein said separate deviation variables are orthogonal.

191. The platform of claim 190, wherein said deviations are weighted.

192. The platform of claim 186, wherein said party input unit is operable to permit an association of a relative importance level to said trade-off, said relative importance level used to calculate contribution to respective objective function.

193. The platform of claim 186, wherein said party goal program unit is operable to calculate a relative importance level for said trade-off as an average of respective relative importance levels of said first and second variables, said relative importance level used to calculate contribution to respective objective function.

194. The platform of claim 186, further comprising an offer delay timer, associated with said negotiator, for introducing determinable delays between issuance of successive offers to an opponent.

195. The platform of claim 194, wherein said offer delay timer is operable to set successively increasing delays.

196. The platform of claim 195, wherein said offer delay timer is operable to set delays to change levelwise.

197. The platform of claim 194, wherein a magnitude of said delay is based on a relative change between succeeding opponent offers.

198. The platform of claim 194, wherein said offer delay timer is operable to set user determined delays.

199. A platform for supporting negotiation between parties to achieve an outcome, the platform comprising:
a party goal program unit for defining goal programs in respect of an outcome, the goal program unit comprising a party input unit for allowing a party to input data relating to said goal program, said goal program unit being operable to translate said values into objective functions and constraints on said objective functions within said goal program,
and a negotiator, associated with said goal program unit, said negotiator comprising an optimizer to find best values for said objective functions under constraints, therewith to obtain a best solution for the goal program for output as a first offer, and then iteratively to produce further solutions until an offer is accepted, thereby to achieve said outcome.

200. The platform of claim 199, wherein said negotiator comprises a percentage modifier for taking ones of said objective functions in turn, and worsening them by a predetermined percentage, thereby to produce said further solutions.

201. The platform of claim 200, wherein said percentage modifier is settable to take each of said objective functions in turn beginning with a most important objective function, until a solution is accepted.

202. The platform of claim 200, wherein said objective functions are arranged in levels and said percentage modifier is settable to take an objective function of a first of said levels only.

203. The platform of claim 199, wherein said negotiator comprises a worst case calculator for determining a worst case evaluation for ones of said objective functions under constraints, thereby to obtain a worst acceptable offer.

204. The platform of claim 199, wherein said goal program contains pairs of bounded deviation variables, and said negotiator comprises an arbitrary case calculator for taking one of each pair of variables, setting it to an arbitrary value within its respective bounds, taking the other of said pair of variables and setting it to zero, therefrom to calculate ones of said iterative solutions.

205. The platform of claim 199, wherein said goal program contains pairs of bounded deviation variables, and said negotiator comprises an arbitrary case calculator for taking one of each pair of variables, associating therewith an arbitrary weight, forming therefrom an objective function as a summation of said arbitrary weights and minimizing of said objective function.

206. The platform of claim 203, wherein said negotiator further comprises an average case calculator, associated with said optimizer and with said worst case calculator, for
taking said best solution and said worst solution, each solution having corresponding values,
associating ones of said corresponding values, and
constraining variables of said goal program towards an average of each of said corresponding values, therewith to provide an average solution.

207. The platform of claim 199, further comprising an offer delay timer, associated with said negotiator, for introducing determinable delays between issuance of successive offers to an opponent.

208. The platform of claim 207, wherein said offer delay timer is operable to set successively increasing delays.

209. The platform of claim 208, wherein said offer delay timer is operable to set delays to change levelwise.

210. The platform of claim 207, wherein a magnitude of said delay is based on a relative change between succeeding opponent offers.

211. The platform of claim 207, wherein said offer delay timer is operable to set user determined delays.

212. The platform of claim 206, wherein said goal program objective functions are arranged levelwise and said average case calculator is operable to carry out said associating and said constraining successively levelwise.

213. The platform of claim 199, wherein said data input unit is operable to receive user defined output values, wherein said goal program unit is operable to set said output values as single value constraints and to flag said constraints as unchangeable.

214. The platform of claim 213, wherein said goal program unit is operable to output an error indicator if said single value constraints render said goal program insoluble.

215. A platform for supporting negotiation between parties to achieve an outcome, the platform comprising:
a party goal program unit for defining goal programs in respect of an outcome, the goal program unit comprising a party input unit for allowing a party to input values, said goal program unit being operable to translate said values into objective functions and constraints on said objective functions within said goal program,
and a negotiator, comprising a solution sorter for comparing goal program solutions by evaluation of said goal program for each one of a series of proposed solutions and ranking the solutions according to said evaluations, said negotiator being operable to use said ranking to apply preference to different solutions.

216. The platform of claim 215, wherein said negotiator further comprises a thresholder associated with said solution sorter for applying a threshold to said evaluations to exclude ones of said series of solutions.

217. The platform of claim 216, wherein said negotiator further comprises a solution completer for applying best values to unspecified values of variables in incomplete ones of said solutions, thereby to allow said goal program to be evaluated for said incomplete solutions.

218. The platform of claim 215, wherein said solution sorter is settable to find the best solution from said series of solutions by identifying the highest ranked solution and discarding the remaining solutions.

219. The platform of claim 215, wherein said solution sorter comprises a memory set to hold a predetermined number of solutions, and a comparator to compare a new solution with each solution in said memory, and further comprising a control unit for adding said new solution to said memory if its evaluation is larger than any solution in said memory, and for discarding a lowest ranked solution in said memory if said memory already contains said predetermined number.

220. The platform of claim 215, further comprising an offer delay timer, associated with said negotiator, for introducing determinable delays between issuance of successive offers to an opponent.

221. The platform of claim 220, wherein said offer delay timer is operable to set successively increasing delays.

222. The platform of claim 221, wherein said offer delay timer is operable to set delays to change levelwise.

223. The platform of claim 220, wherein a magnitude of said delay is based on a relative change between succeeding opponent offers.

224. The platform of claim 220, wherein said offer delay timer is operable to set user determined delays.

225. A platform for supporting negotiation between a local party and an opponent party to achieve an outcome, the platform comprising:
a goal program input unit for receiving a local party's goal program and an opponent's goal program to be unified, said goal programs comprising objective functions associated with constraints and being arranged in successive levels,
an optimizer for finding best solutions to goal programs, connected to find best values for said objective functions and constraints of said local party's goal program levelwise, and
a worst case calculator for finding worst solutions for goal programs, connected to find worst values for said objective functions and constraints of said opponent's goal program levelwise,
said negotiator being operable to:
use said optimizer and said worst case calculator in succession level by level to produce successive best local and worst opponent value sets for evaluation therefrom to form level by level offers, and
to advance from one level to another level only following acceptance by said parties of an offer regarding a previous level.

226. The platform of claim 225, wherein each best local and worst opponent value set is obtained using a current and each remaining successive level.

227. The platform of claim 226, wherein said value sets are obtained while negotiating a current level.

228. The platform of claim 225, wherein said negotiator comprises a constraint updater for updating constraints upon advance from one level to another level in accordance with said respective acceptance.

229. The platform of claim 228, further comprising an offer improver operable to provide an improved offer by making a change in a selected one of said variables to bring about an improvement in the evaluation of the opponent's goal program.

230. The platform of claim 229, wherein said change in said variable is calculated such that said improvement is a predetermined proportion of a difference between a previous offer made and a best possible evaluation made for the opponent.

231. The platform of claim 230, wherein said offer improver is operable to use a value of said selected variable in a last opponent's offer to moderate said change.

232. The platform of claim 230, wherein said offer improver is operable to calculate a protection value, and to use said protection value to limit a reduction in the evaluation of the local party's goal program as a consequence of said improvement to the opponent's goal program evaluation.

233. The platform of claim 232, wherein said protection value is a proportion of the difference between a worst case evaluation of the local party's goal program and an evaluation of a last previous offer thereof.

234. The platform of claim 225, further comprising an offer improver for taking goal program values of a previous local party offer and one value in turn from a previous opponent offer, testing the opponent value against local constraints, and if it fits within the constraints then substituting it into the previous local party offer thereby to provide an improved offer.

235. A platform for supporting negotiation between a local party and an opponent party to achieve an outcome, the platform comprising a negotiator, and
a goal program input unit for receiving a local party's goal program, said goal programs comprising objective functions associated with constraints and being arranged in levels,
the negotiator comprising:
an optimizer for finding best solutions to goal programs, connected to find best values for said objective functions under constraints of said local party's goal program levelwise, and
a stay close processor for determining variable improvement directions from monitoring of received offers from said opponent and carrying out value perturbations in said directions,
said negotiator being operable to:
use said optimizer to produce a first offer for a first level,
to advance from one level to another level only following acceptance by said parties of a unification offer regarding a previous level, and
use said stay close processor to produce a first offer for each subsequent level.

236. The platform of claim 235, wherein said stay close processor is operable to produce successive offers while negotiating within a level.

237. The platform of claim 235, wherein said negotiator comprises a constraint updater for updating constraints upon advance from one level to another level in accordance with said respective acceptance.

238. The platform of claim 235, wherein said negotiator further comprises
a gap value determiner for determining a gap for use in offer improvement, and
a value improver, associated with said gap value determiner, for inserting a predetermined proportion of said gap as a constraint of said goal program, and wherein said stay close processor is associated with said value improver thereby to apply said predetermined gap proportion in said direction to provide an improved offer.

239. The platform of claim 238, wherein said stay close processor is operable to monitor successive opponent offers for value changes therebetween, and to assign to each respective changing variable a weight for use in providing an improved offer, the magnitude of said weight being selected in accordance with a monitored relative size of a corresponding value change of said opponent.

240. The platform of claim 238, wherein said gap is a constant.

241. The platform of claim 240, wherein said constant is a difference between a best value and a worst value of a corresponding variable.

242. The platform of claim 238, wherein said gap is a difference between a local best case and a last opponent proposal.

243. The platform of claim 242, further comprising a gap truncator for maintaining said gap between predetermined maximum and minimum bounds.

244. The platform of claim 235, further comprising an offer delay timer, associated with said negotiator, for introducing determinable delays between issuance of successive offers to an opponent.

245. The platform of claim 244, wherein said offer delay timer is operable to set successively increasing delays.

246. The platform of claim 245, wherein said offer delay timer is operable to set delays to change levelwise.

247. The platform of claim 244, wherein a magnitude of said delay is based on a relative change between succeeding opponent offers.

248. The platform of claim 244, wherein said offer delay timer is operable to set user determined delays.

249. A platform for joint processing of goal programs to produce an outcome, the platform comprising:
a party goal program unit for formulation of at least one local goal program,
a unifier for determining common ground between said local goal program and at least one other goal program,
a negotiation necessity tester, associated with said unifier, for joint solving of said local and said other goal program to form a joint goal program comprising optimal solutions for each of said local and said other goal program, said negotiation necessity tester being set to determine whether there lies a single solution, that is optimal for both parties, within said common ground, and if so, to indicate that no negotiation is necessary.

250. The platform of claim 249, further comprising an output unit for outputting said single solution when negotiation is not necessary.

251. A resource negotiator for making successive offers for usage of a resource with at least one remote party based on a goal program of a local party, the goal program comprising a plurality of objective functions, at least one of said objective functions having a goal associated with a target value, an upper bound, a lower bound and at least one constraint, the resource negotiator comprising:
an input for receiving data from said remote party,
a minimizer for producing successively worsening minimizations of said goal program, and
an offer formulator, associated with said minimizer, for formulating said minimizations into offers for resource usage for sending to said remote party.

252. The resource negotiator of claim 251, wherein said data from said remote party comprises a goal program comprising a plurality of objective functions, at least some of said objective functions being associated with goal constraints having a target value, an upper bound, a lower bound and at least one constraint, said minimizer for producing successively improving solutions of said remote party goal program, for use together with said worsening minimizations for use by said offer formulator for formulating said offers for resource usage.

253. The resource negotiator of claim 251, wherein said offer formulator comprises a behavior synthesizer for governing said offer formulation in accordance with a predetermined behavior profile.

254. The resource negotiator of claim 253, wherein said behavior profile comprises an opponent offer feedback feature for using opponent offer improvement levels for setting improvement levels for successive offer formulations.

255. The resource negotiator of claim 253, wherein said behavior profile comprises an opponent offer feedback feature for using opponent offer data for setting time intervals for successive offer outputs.

256. The resource negotiator of claim 253, wherein said profile comprises a scenario for a whole negotiation.

257. The resource negotiator of claim 253, wherein said profile is built by said resource negotiator based on input at said input unit.

258. The resource negotiator of claim 253, wherein said behavior profile comprises a negotiation refusal condition for breaking off negotiations when said condition is achieved.

259. The resource negotiator of claim 258, wherein said refusal condition comprises a predetermined number of opponent offers that fail a predetermined improvement threshold.

260. The resource negotiator of claim 258, wherein said refusal condition comprises a predetermined time during which said negotiation fails to reach a predetermined improvement threshold.

261. The resource negotiator of claim 251, wherein said input is operable to receive data from a plurality of remote parties.

262. The resource negotiator of claim 251, further being operable to negotiate with a plurality of parties.

263. The resource negotiator of claim 251, wherein said offers are based on changes to one of said variables only.

264. The resource negotiator of claim 263, comprising a bound setter for setting at least one of respective upper and lower bounds of a respective one of said variables as a function of bounds of other goals in said goal program.

265. The resource negotiator of claim 263, comprising a dynamic bound setter for setting at least one of respective upper and lower bounds of said variable as a function of data received at said input.

266. A resource negotiator for negotiating for usage of a resource with a plurality of remote parties based on a goal program of a local party, the goal program comprising a plurality of objective functions with associated goal constraints, at least one of said goal constraints having at least one variable with an upper bound, and a lower bound, the resource negotiator comprising:
an input for receiving data from said remote parties,
an objective function minimizer for calculating a value required to be provided by remote parties of said at least one objective function, and
an offer acceptor, associated with said minimizer, for receiving offers from said remote parties, comparing said calculation with said offers and for accepting one of said offers based on said minimizations.

267. The resource negotiator of claim 266, wherein said offer acceptor is operable to accept an offer representing a best offer.

268. The resource negotiator of claim 266, wherein said offer acceptor is operable to accept an offer representing a second best offer.

269. The resource negotiator of claim 266, comprising an output for revealing received offers to each of said remote parties.

270. The resource negotiator of claim 266, comprising a bound setter for setting at least one of respective upper and lower bounds of a respective variable as a function of bounds of other constraints in a respective goal program.

271. The resource negotiator of claim 266, comprising a dynamic bound setter for setting at least one of respective upper and lower bounds of said variable as a function of data received at said input.

272. The resource negotiator of claim 266, wherein said minimizer is set to perform minimization over a plurality of objective functions.

273. The resource negotiator of claim 266, wherein said minimizer is set to perform minimization over a single objective function.

274. The resource negotiator of claim 272, wherein said minimizer is set to perform minimization over a penalty function of said objective functions.

275. The resource negotiator of claim 274, further comprising a goal program output unit for sending to said plurality of remote parties at least some of said local party goal program objective functions and associated constraints and variables therewith to enable said remote parties to form or calculate potential offers in light thereof.

276. A resource negotiator for negotiating for usage of a resource with a plurality of remote parties based on a goal program of a local party, the goal program comprising at least one objective function having at least one goal comprising a variable assignable with at least one of an upper bound, and a lower bound, the resource negotiator comprising:
an active bid monitor for monitoring remote parties remaining in said negotiating,
a resource quality increaser for successively decreasing a value of said at least one predetermined objective function,
an offer acceptor, associated with said active bid monitor and with said quality increaser, for ending said negotiation at a time at which only a predetermined number of remote parties remains active, and at a corresponding value of said at least one predetermined objective function, said offer acceptor being operable to deem said negotiation successful if said corresponding value is within any assigned bounds, said predetermined number being related to a number of available resources.

277. The resource negotiator of claim 276, further comprising a bound assigner for calculating at least one bound of said predetermined variable according to other goal constraints of said local goal program.

278. The resource negotiator of claim 276, further comprising a goal program output unit for sending to said plurality of remote parties at least some of said local party goal program objective functions and associated constraints and variables to enable said remote parties to evaluate potential offers in light thereof.

279. The resource negotiator of claim 276, wherein said quality increaser is operable to reduce said value to an intermediate level between a current and a previous level when a number of remaining parties drops from a level above said predetermined number to a level below said predetermined number, thereby to raise said number of remaining parties to correspond with said number of resources.

280. The resource negotiator of claim 279 wherein said predetermined number is one.

281. The resource negotiator of claim 276, wherein said active bid monitor comprises an output unit for revealing to said remote parties a number of remote parties remaining in said negotiating.

282. The resource negotiator of claim 276, wherein said active bid monitor comprises an output unit for revealing to said remote parties identities of remote parties remaining in said negotiating.

283. The resource negotiator of claim 276, wherein said predetermined number is one.

284. The resource negotiator of claim 276, further comprising a drop out decision unit for use by one of said remote parties, said unit comprising:
a current offer evaluator for expressing a current value demand issued by said value increaser in terms of a goal program of said remote party,
an active bid unit for storing the number of remote parties remaining in said negotiating,
a drop out function for calculating a drop out probability as a function of said current value and said number of remote parties remaining in said negotiating, and
a decision maker for using said drop out probability to decide whether to leave said negotiating.

285. A platform for performing ranking between database entries, each of said entries comprising a series of values arranged in fields, the platform comprising:
a goal program unit for taking data from a user and defining therewith a goal program, variables thereof being related to said fields, and
a ranking unit for performing ranking amongst said entries in accordance with said goal program.

286. The platform of claim 285, wherein said goal program unit is operable to take said values in twos, thereby to determine tradeoffs between respective fields.

287. The platform of claim 286, wherein said trade-offs comprise a change in a first of said variables being traded for a proportional indicated change in a second of said variables.

288. The platform of claim 287, wherein said change is one of a group comprising an increase and a decrease.

289. The platform of claim 287, wherein said indicated change is one of a group comprising an increase and a decrease.

290. The platform of claim 285, wherein said goal program unit is operable to take said trade-offs in groups of three or more.

291. The platform of claim 285, wherein said goal program unit is operable to compile statements of a ranking sub-language.

292. The platform of claim 291, wherein said statements comprise at least one of a group comprising: constraint, preference, deviation, and trade-off statements.

293. The platform of claim 291, wherein said goal program unit is operable to take said trade-offs in a plurality of trade-off groups, and to compile a separate trade-off statement for each group.

294. The platform of claim 293, wherein said ranking unit is operable to determine an average of the deviations for each trade-off statement for use in said ranking.

295. The platform of claim 285, wherein said goal program unit further comprises a weight assigner for assigning weights to fields, therewith to perform summation over each of said entries.

296. The platform of claim 295, wherein said weight assigner comprises a user preference input for receiving a user defined preference order between ones of said entries, and wherein said weight assigner is operable to select weights for assignment to fields of said entries such as to enforce said user defined preference.

297. The platform of claim 296, wherein said weight selection is such as to maximize the expression of said user preferences.

298. The platform of claim 295, wherein said fields are ordered preferentially and wherein said weight assigner is operable to assign weights according to a position of a respective field in said order.

299. The platform of claim 296, wherein said weight assigner comprises a user input for receiving a parameter defining a number of entries of high desirability from the start of an ordered list, said weight assigner being operable to select weights to reflect said desirability.

300. The platform of claim 285, comprising a ranking expression unit for providing an expression basis for defining at least one of a group comprising a condition, a deviation, a deviation condition, a constraint, a simple trade-off relationship, a complex trade-off relationship, a preferred value within a range, a preferred range, a weighting, therefrom to form an objective function for use in said ranking.

301. A platform for supporting negotiation between parties to achieve an outcome, the platform comprising:
an input for receiving an overall deal request from a first party relating to multiple items, and availability data from at least one second party relating to available items,
a deal partitioner for partitioning of said deal request into a plurality of sub-deals each corresponding to at least one item of said sub-deal request that is to be obtained from a single second party, such that said deal request overall is applicable to one or more second parties, and
a deal minimizer for selecting second parties for each sub-deal such as to minimize a cost parameter for said first buyer for said deal request.

302. The platform of claim 301, wherein there are a plurality of said second parties, and each said sub-deal relates to item availability data of a single one of said second parties.

303. The platform of claim 302, wherein a sub-deal comprises a group of items defined by a first party.

304. The platform of claim 302, wherein at least one item is available from a plurality of said second parties.

305. The platform of claim 301, wherein said deal request comprises a specified quantity of a single item.

306. The platform of claim 301, wherein said deal request comprises specified quantities of each of a plurality of items.

307. The platform of claim 301, wherein said deal request comprises items some of which are only available in combinations from at least one of said second parties.

308. The platform of claim 307, wherein said combinations comprise a fixed number of each item of said combination.

309. The platform of claim 307, wherein said combinations comprise a range of number of at least one item of said combination.

310. The platform of claim 301, wherein said cost parameter is expressible via a goal program.

311. The platform of claim 301, wherein said availability data comprises quantity-variable availability data.

312. The platform of claim 301, wherein said deal splitting is carried out using an approximation price-based algorithm.

313. The platform of claim 312, wherein said approximation price-based algorithm is of the residual greedy family.

314. The platform of claim 312, wherein said approximation price-based algorithms include polynomial time approximation scheme-based algorithms.

315. The platform of claim 312, wherein said approximation price-based algorithms are exact algorithms based on linear and integer programming algorithms for use with a limited number of second parties.

316. The platform of claim 312, wherein a number of item types is fixed.

317. The platform of claim 312, wherein a number of parties is fixed.

318. The platform of claim 316, wherein said approximation-based algorithm is a (1+epsilon) approximation wherein epsilon is a number lying between 0 and 1.

319. The platform of claim 317, wherein said approximation-based algorithm is a (1+epsilon) approximation wherein epsilon is a number lying between 0 and 1.

320. The platform of claim 312, wherein a number of parties and a number of item types are unbounded.

321. The platform of claim 320, wherein said approximation-based algorithm is a (1+epsilon) approximation wherein epsilon is a number lying between 0 and 1.

322. The platform of claim 313, wherein said items are available as packages of at least one item and said residual greedy algorithm takes as input a set of all possible packages.

323. The platform of claim 322, wherein said set is subjected to a rounding procedure.

324. The platform of claim 323, wherein said rounded set is subjected to integer knapsack analysis to obtain a minimal cost of obtaining a predetermined number of units.

325. The platform of claim 313, wherein said residual greedy family of algorithms comprises at least a residual greedy algorithm, an improved residual greedy algorithm and a multi-item residual greedy algorithm.

326. The platform of claim 301, wherein said deal partitioner is operable to carry out optimal deal splitting for a single item carried by each of a predetermined maximum number of second parties, each of said second parties presenting to said deal partitioner a quantity-cost table.

327. The platform of claim 326, wherein said deal partitioner is operable to use a polynomial time algorithm to carry out said deal splitting.

328. The platform of claim 301, wherein said deal partitioner is operable to carry out optimal deal splitting for multiple items carried by a predetermined maximum number of second parties, each of said second parties offering at least some of said items and at least some of said suppliers offering items in multi-item packages.

329. The platform of claim 328, wherein said deal partitioner is operable to use a polynomial time algorithm to carry out said deal splitting.

330. The platform of claim 301, wherein there is an unrestricted number of second parties, said platform using a residual greedy approximation algorithm to carry out said deal splitting.

331. The platform of claim 330, wherein at least some of said items are available as multi-item packages.

332. The platform of claim 301, wherein each second party has an unlimited quantity of said at least one item.

333. The platform of claim 332, wherein at least some of said items are available in multi-item packages.

334. The platform of claim 332, wherein said deal splitting is carried out using a pseudo-polynomial time algorithm.

335. The platform of claim 301, wherein each second party has a limited quantity of said at least one item, said deal splitting being carried out using a pseudo-polynomial time algorithm.

336. The platform of claim 335, wherein at least some of said items are available in multi-item packages.
